(19) United States
(12) Patent Application Publication
(10) Pub. No.: US 2026/0309543 A1
(43) Pub. Date: Oct. 8, 2026

(54) DETERMINING AMBIENT LIGHT LEVELS

(71) Applicant: MOBILEYE VISION TECHNOLOGIES LTD., Jerusalem (IL)

(72) Inventors: Roni JESSELSON, Nes Harim (IL); Dov KESSELMAN, Tekoa (IL); Hananel FINKELSTEIN, Nes Harim (IL); Alberto SAUL, Jerusalem (IL)

(21) Appl. No.: 19/539,444

(22) Filed: Feb. 13, 2026

Related U.S. Application Data
(60) Provisional application No. 63/758,071, filed on Feb. 13, 2025.
(60) Provisional application No. 63/773,651, filed on Mar. 18, 2025.

(51) Int. Cl. G01J 1/42; G06T 7/12

(52) U.S. Cl. CPC G01J 1/4204; G01J 1/4209; G01J 1/4228; G06T 7/12; G01J 1/4257; G06T 2207/20081; G06T 2207/20084; G06T 2207/30252

(57) ABSTRACT

A system may receive at least one image captured by at least one camera of a host vehicle from the environment of the host vehicle. The system may obtain at least one value of at least one imaging parameter associated with the at least one camera of the host vehicle, and analyze at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

### CROSS REFERENCES TO RELATED APPLICATIONS

This application claims priority to U.S. Provisional Application No. 63/758,071, filed Feb. 13, 2025, and U.S. Provisional Application No. 63/773,651, filed Mar. 18, 2025, which are incorporated herein in their entirety.

### BACKGROUND

### Technical Field

The present disclosure relates generally to vehicle navigation and, more specifically, to a systems and methods for determining an ambient light level in an environment of a host vehicle.

### Background Information

As technology continues to advance, the goal of a fully autonomous vehicle that is capable of navigating on roadways is on the horizon. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS device, a speed sensor, an accelerometer, a suspension sensor, etc.). At the same time, in order to navigate to a destination, an autonomous vehicle may also need to identify its location within a particular roadway (e.g., a specific lane within a multi-lane road), navigate alongside other vehicles, avoid obstacles and pedestrians, observe traffic signals and signs, and travel from one road to another road at appropriate intersections or interchanges. Harnessing and interpreting vast volumes of information collected by an autonomous vehicle as the vehicle travels to its destination poses a multitude of design challenges. The sheer quantity of data (e.g., captured image data, map data, GPS data, sensor data, etc.) that an autonomous vehicle may need to analyze, access, and/or store poses challenges that can in fact limit or even adversely affect autonomous navigation. Furthermore, if an autonomous vehicle relies on traditional mapping technology to navigate, the sheer volume of data needed to store and update the map poses daunting challenges.

### SUMMARY

Embodiments of the present disclosure may improve vehicle operation by determining ambient light levels in an environment of a host vehicle using cameras and adjusting vehicle systems such as headlights and displays based on the determined light levels.

In an embodiment, a system for determining an ambient light level in an environment of a host vehicle is disclosed. The system may comprise at least one processor comprising circuitry and a memory, wherein the memory includes instructions that when executed by the circuitry cause the at least one processor to receive at least one image captured by at least one camera of a host vehicle from the environment of the host vehicle, obtain at least one value of at least one imaging parameter associated with the at least one camera of the host vehicle, and analyze at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

In an embodiment, a method for determining an ambient light level in an environment of a host vehicle is disclosed. The method may comprise: receiving at least one image captured by at least one camera of a host vehicle from the environment of the host vehicle, obtaining at least one value of at least one imaging parameter associated with the at least one camera of the host vehicle, and analyzing at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

In an embodiment, a non-transitory computer-readable medium for determining an ambient light level in an environment of a host vehicle is disclosed. The method may comprise: receiving at least one image captured by at least one camera of a host vehicle from the environment of the host vehicle, obtaining at least one value of at least one imaging parameter associated with the at least one camera of the host vehicle, and analyzing at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

In an embodiment, a system for determining an ambient light level in an environment of a host vehicle is disclosed. The system may comprise at least one processor comprising circuitry and a memory, wherein the memory includes instructions that when executed by the circuitry cause the at least one processor to receive at least one image captured by at least one camera of a host vehicle from an environment of the host vehicle, and analyze at least a portion of the at least one image to determine at least one light intensity level in the environment of the host vehicle, wherein the at least a portion of the at least one image is analyzed using at least one trained system.

In an embodiment, a method for determining an ambient light level in an environment of a host vehicle is disclosed. The method may comprise: receiving at least one image captured by at least one camera of a host vehicle from an environment of the host vehicle, and analyzing at least a portion of the at least one image to determine at least one light intensity level in the environment of the host vehicle, wherein the at least a portion of the at least one image is analyzed using at least one trained system.

In an embodiment, a non-transitory computer-readable medium for determining an ambient light level in an environment of a host vehicle according to a method is disclosed. The method may comprise: receiving at least one image captured by at least one camera of a host vehicle from an environment of the host vehicle, and analyzing at least a portion of the at least one image to determine at least one light intensity level in the environment of the host vehicle, wherein the at least a portion of the at least one image is analyzed using at least one trained system.

In an embodiment, a system for determining adjustments to headlights of a host vehicle based on an ambient light level in an environment of the host vehicle is disclosed. The system may comprise at least one processor comprising circuitry and a memory, wherein the memory includes instructions that when executed by the circuitry cause the at least one processor to receive at least one image captured by at least one camera of a host vehicle from the environment of the host vehicle, analyze at least a portion of the at least one image to determine at least one light intensity level in the environment of the host vehicle, and cause the headlights of the host vehicle to change from a first state to a second state based on the at least one light intensity level in the environment of the host vehicle.

In an embodiment, a method for determining adjustments to headlights of a host vehicle based on an ambient light level in an environment of the host vehicle is disclosed. The method may comprise: receiving at least one image captured by at least one camera of a host vehicle from the environment of the host vehicle, analyzing at least a portion of the at least one image to determine at least one light intensity level in the environment of the host vehicle, and causing the headlights of the host vehicle to change from a first state to a second state based on the at least one light intensity level in the environment of the host vehicle.

In an embodiment, a non-transitory computer-readable medium for determining adjustments to headlights of a host vehicle based on an ambient light level in an environment of the host vehicle according to a method is disclosed. The method may comprise: receiving at least one image captured by at least one camera of a host vehicle from the environment of the host vehicle, analyzing at least a portion of the at least one image to determine at least one light intensity level in the environment of the host vehicle, and causing the headlights of the host vehicle to change from a first state to a second state based on the at least one light intensity level in the environment of the host vehicle.

In an embodiment, a system for determining whether to adjust headlights of a host vehicle based on an ambient light level in an environment of the host vehicle is disclosed. The system may comprise at least one processor comprising circuitry and a memory, wherein the memory includes instructions that when executed by the circuitry cause the at least one processor to receive at least one image captured by at least one camera of a host vehicle from the environment of the host vehicle, analyze at least a portion of the at least one image to determine a first light intensity level and a second light intensity level in the environment of the host vehicle, wherein the first light intensity level is greater than the second light intensity level, determine the first light intensity level is attributed to a first portion of the environment of the host vehicle and the second light intensity level is attributed to a second portion of the environment of the host vehicle, and cause the headlights of the host vehicle to maintain an illuminated state based on a comparison of a first size of the first portion of the environment of the host vehicle relative to a second size of the second portion of the environment of the host vehicle.

In an embodiment, a method for determining whether to adjust headlights of a host vehicle based on an ambient light level in an environment of the host vehicle is disclosed. The method may comprise: receiving at least one image captured by at least one camera of a host vehicle from the environment of the host vehicle, analyzing at least a portion of the at least one image to determine a first light intensity level and a second light intensity level in the environment of the host vehicle, wherein the first light intensity level is greater than the second light intensity level, determining the first light intensity level is attributed to a first portion of the environment of the host vehicle and the second light intensity level is attributed to a second portion of the environment of the host vehicle, and cause the headlights of the host vehicle to maintain an illuminated state based on a comparison of a first size of the first portion of the environment of the host vehicle relative to a second size of the second portion of the environment of the host vehicle.

In an embodiment, a non-transitory computer-readable medium for determining whether to adjust headlights of a host vehicle based on an ambient light level in an environment of the host vehicle according to a method is disclosed. The method may comprise: receiving at least one image captured by at least one camera of a host vehicle from the environment of the host vehicle, analyzing at least a portion of the at least one image to determine a first light intensity level and a second light intensity level in the environment of the host vehicle, wherein the first light intensity level is greater than the second light intensity level, determining the first light intensity level is attributed to a first portion of the environment of the host vehicle and the second light intensity level is attributed to a second portion of the environment of the host vehicle, and cause the headlights of the host vehicle to maintain an illuminated state based on a comparison of a first size of the first portion of the environment of the host vehicle relative to a second size of the second portion of the environment of the host vehicle.

In an embodiment, a system for determining whether to adjust headlights of a host vehicle based on an ambient light level in an environment of the host vehicle is disclosed. The system may comprise at least one processor comprising circuitry and a memory, wherein the memory includes instructions that when executed by the circuitry cause the at least one processor to receive at least one image captured by at least one camera of a host vehicle from the environment of the host vehicle, analyze at least a portion of the at least one image to determine at least one light intensity in the environment of the host vehicle, obtain environment information associated with the environment of the host vehicle, and determine whether to adjust a current state of the headlights of the host vehicle based on the at least one light intensity level in the environment of the host vehicle and the environment information.

In an embodiment, a method for determining whether to adjust headlights of a host vehicle based on an ambient light level in an environment of the host vehicle is disclosed. The method may comprise: receiving at least one image captured by at least one camera of a host vehicle from the environment of the host vehicle, analyzing at least a portion of the at least one image to determine at least one light intensity in the environment of the host vehicle, obtaining environment information associated with the environment of the host vehicle, and determining whether to adjust a current state of the headlights of the host vehicle based on the at least one light intensity level in the environment of the host vehicle and the environment information.

In an embodiment, a non-transitory computer-readable medium for determining whether to adjust headlights of a host vehicle based on an ambient light level in an environment of the host vehicle according to a method is disclosed. The method may comprise: receiving at least one image captured by at least one camera of a host vehicle from the environment of the host vehicle, analyzing at least a portion of the at least one image to determine at least one light intensity in the environment of the host vehicle, obtaining environment information associated with the environment of the host vehicle, and determining whether to adjust a current state of the headlights of the host vehicle based on the at least one light intensity level in the environment of the host vehicle and the environment information.

In an embodiment, a system for determining adjustments to a display of a host vehicle is disclosed. The system may comprise at least one processor comprising circuitry and a memory, wherein the memory includes instructions that when executed by the circuitry cause the at least one processor to receive at least one image captured by at least one camera of a host vehicle from an environment of the host vehicle, analyze at least a portion of the at least one image to determine at least one light intensity level in the environment of the host vehicle, and cause a change to at least one value of at least one display parameter associated with at least a region of a display inside the host vehicle based on the at least one light intensity level in the environment of the host vehicle.

In an embodiment, a method for determining adjustments to a display of a host vehicle is disclosed. The method may comprise: receiving at least one image captured by at least one camera of a host vehicle from an environment of the host vehicle, analyzing at least a portion of the at least one image to determine at least one light intensity level in the environment of the host vehicle, and causing a change to at least one value of at least one display parameter associated with at least a region of a display inside the host vehicle based on the at least one light intensity level in the environment of the host vehicle.

In an embodiment, a non-transitory computer-readable medium for determining adjustments to a display of a host vehicle according to a method is disclosed. The method may comprise: receiving at least one image captured by at least one camera of a host vehicle from an environment of the host vehicle, analyzing at least a portion of the at least one image to determine at least one light intensity level in the environment of the host vehicle, and causing a change to at least one value of at least one display parameter associated with at least a region of a display inside the host vehicle based on the at least one light intensity level in the environment of the host vehicle.

In an embodiment, a system for determining adjustments to a display of a host vehicle is disclosed. The system may comprise at least one processor comprising circuitry and a memory, wherein the memory includes instructions that when executed by the circuitry cause the at least one processor to receive at least one image captured by at least one camera of a host vehicle from an environment of the host vehicle, analyze at least a portion of the at least one image to determine at least one light intensity level in the environment of the host vehicle, obtain environment information associated with the environment of the host vehicle, and cause a change to at least one value of at least one display parameter associated with at least a region of a display inside the host vehicle based on the at least one light intensity level in the environment of the host vehicle and the environment information.

In an embodiment, a method for determining adjustments to a display of a host vehicle is disclosed. The method may comprise: receiving at least one image captured by at least one camera of a host vehicle from an environment of the host vehicle, analyzing at least a portion of the at least one image to determine at least one light intensity level in the environment of the host vehicle, obtaining environment information associated with the environment of the host vehicle, and causing a change to at least one value of at least one display parameter associated with at least a region of a display inside the host vehicle based on the at least one light intensity level in the environment of the host vehicle and the environment information.

In an embodiment, a non-transitory computer-readable medium for determining adjustments to a display of a host vehicle according to a method is disclosed. The method may comprise: receiving at least one image captured by at least one camera of a host vehicle from an environment of the host vehicle, analyzing at least a portion of the at least one image to determine at least one light intensity level in the environment of the host vehicle, obtaining environment information associated with the environment of the host vehicle, and causing a change to at least one value of at least one display parameter associated with at least a region of a display inside the host vehicle based on the at least one light intensity level in the environment of the host vehicle and the environment information.

In an embodiment, a system for determining adjustments to a display of a host vehicle is disclosed. The system may comprise at least one processor comprising circuitry and a memory, wherein the memory includes instructions that when executed by the circuitry cause the at least one processor to receive at least one image captured by at least one camera of a host vehicle from an environment of the host vehicle, analyze at least a portion of the at least one image to determine at least one light intensity level in the environment of the host vehicle, determine a looking direction of a user of the host vehicle, determine a region of a display inside the host vehicle based on the looking direction of the user of the host vehicle, and cause a change to a value of at least one display parameter associated with the region of the display inside the host vehicle based on the at least one light intensity level in the environment of the host vehicle.

In an embodiment, a method for determining adjustments to a display of a host vehicle is disclosed. The method may comprise: receiving at least one image captured by at least one camera of a host vehicle from an environment of the host vehicle, analyzing at least a portion of the at least one image to determine at least one light intensity level in the environment of the host vehicle, determining a looking direction of a user of the host vehicle, determining a region of a display inside the host vehicle based on the looking direction of the user of the host vehicle, and causing a change to a value of at least one display parameter associated with the region of the display inside the host vehicle based on the at least one light intensity level in the environment of the host vehicle.

In an embodiment, a non-transitory computer-readable medium for determining adjustments to a display of a host vehicle according to a method is disclosed. The method may comprise: receiving at least one image captured by at least one camera of a host vehicle from an environment of the host vehicle, analyzing at least a portion of the at least one image to determine at least one light intensity level in the environment of the host vehicle, determining a looking direction of a user of the host vehicle, determining a region of a display inside the host vehicle based on the looking direction of the user of the host vehicle, and causing a change to a value of at least one display parameter associated with the region of the display inside the host vehicle based on the at least one light intensity level in the environment of the host vehicle.

In an embodiment, a system for determining adjustments to a display of a host vehicle is disclosed. The system may comprise at least one processor comprising circuitry and a memory, wherein the memory includes instructions that when executed by the circuitry cause the at least one processor to: receive at least one image captured by at least one camera of a host vehicle from an environment of the host vehicle; analyze at least a first portion of the at least one image to determine at least one first light intensity level associated with a first region within the environment that overlaps a displayable area of the display from a point of view of a driver of a vehicle; analyze at least a second portion of the at least one image to determine at least one second light intensity level associated with a region of the environment outside the first region; and cause a change to a value of at least one display parameter associated with the displayable area of the display based on the at least one first light intensity level.

Although certain features of the present disclosure are described under various headings of the text, this is not intended to delineate separate embodiments, but instead to provide assistance to the reader. In other words, the various sections of the text are intended to be utilized by one of skill in various combinations for implementation of embodiments of the present disclosure.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary system consistent with the disclosed embodiments.

FIG. 2A is a diagrammatic side view representation of an exemplary vehicle including a system consistent with the disclosed embodiments.

FIG. 2B is a diagrammatic top view representation of the vehicle and system shown in FIG. 2A consistent with the disclosed embodiments.

FIG. 2C is a diagrammatic top view representation of another embodiment of a vehicle including a system consistent with the disclosed embodiments.

FIG. 2D is a diagrammatic top view representation of yet another embodiment of a vehicle including a system consistent with the disclosed embodiments.

FIG. 2E is a diagrammatic top view representation of yet another embodiment of a vehicle including a system consistent with the disclosed embodiments.

FIG. 2F is a diagrammatic representation of exemplary vehicle control systems consistent with the disclosed embodiments.

FIG. 3A is a diagrammatic representation of an interior of a vehicle including a rearview mirror and a user interface for a vehicle imaging system consistent with the disclosed embodiments.

FIG. 3B is an illustration of an example of a camera mount that is configured to be positioned behind a rearview mirror and against a vehicle windshield consistent with the disclosed embodiments.

FIG. 3C is an illustration of the camera mount shown in FIG. 3B from a different perspective consistent with the disclosed embodiments.

FIG. 3D is an illustration of an example of a camera mount that is configured to be positioned behind a rearview mirror and against a vehicle windshield consistent with the disclosed embodiments.

FIG. 4 is an exemplary block diagram of a memory configured to store instructions for performing one or more operations consistent with the disclosed embodiments.

FIG. 5A is a flowchart showing an exemplary process for causing one or more navigational responses based on monocular image analysis consistent with disclosed embodiments.

FIG. 5B is a flowchart showing an exemplary process for detecting one or more vehicles and/or pedestrians in a set of images consistent with the disclosed embodiments.

FIG. 5C is a flowchart showing an exemplary process for detecting road marks and/or lane geometry information in a set of images consistent with the disclosed embodiments.

FIG. 5D is a flowchart showing an exemplary process for detecting traffic lights in a set of images consistent with the disclosed embodiments.

FIG. 5E is a flowchart showing an exemplary process for causing one or more navigational responses based on a vehicle path consistent with the disclosed embodiments.

FIG. 5F is a flowchart showing an exemplary process for determining whether a leading vehicle is changing lanes consistent with the disclosed embodiments.

FIG. 6 is a flowchart showing an exemplary process for causing one or more navigational responses based on stereo image analysis consistent with the disclosed embodiments.

FIG. 7 is a flowchart showing an exemplary process for causing one or more navigational responses based on an analysis of three sets of images consistent with the disclosed embodiments.

FIG. 8 shows a sparse map for providing autonomous vehicle navigation, consistent with the disclosed embodiments.

FIG. 9A illustrates a polynomial representation of a portions of a road segment consistent with the disclosed embodiments.

FIG. 9B illustrates a curve in three-dimensional space representing a target trajectory of a vehicle, for a particular road segment, included in a sparse map consistent with the disclosed embodiments.

FIG. 10 illustrates example landmarks that may be included in sparse map consistent with the disclosed embodiments.

FIG. 11A shows polynomial representations of trajectories consistent with the disclosed embodiments.

FIGS. 11B and 11C show target trajectories along a multi-lane road consistent with disclosed embodiments.

FIG. 11D shows an example road signature profile consistent with disclosed embodiments.

FIG. 12 is a schematic illustration of a system that uses crowd sourcing data received from a plurality of vehicles for autonomous vehicle navigation, consistent with the disclosed embodiments.

FIG. 13 illustrates an example autonomous vehicle road navigation model represented by a plurality of three-dimensional splines, consistent with the disclosed embodiments.

FIG. 14 shows a map skeleton generated from combining location information from many drives, consistent with the disclosed embodiments.

FIG. 15 shows an example of a longitudinal alignment of two drives with example signs as landmarks, consistent with the disclosed embodiments.

FIG. 16 shows an example of a longitudinal alignment of many drives with an example sign as a landmark, consistent with the disclosed embodiments.

FIG. 17 is a schematic illustration of a system for generating drive data using a camera, a vehicle, and a server, consistent with the disclosed embodiments.

FIG. 18 is a schematic illustration of a system for crowdsourcing a sparse map, consistent with the disclosed embodiments.

FIG. 19 is a flowchart showing an exemplary process for generating a sparse map for autonomous vehicle navigation along a road segment, consistent with the disclosed embodiments.

FIG. 20 illustrates a block diagram of a server consistent with the disclosed embodiments.

FIG. 21 illustrates a block diagram of a memory consistent with the disclosed embodiments.

FIG. 22 illustrates a process of clustering vehicle trajectories associated with vehicles, consistent with the disclosed embodiments.

FIG. 23 illustrates a navigation system for a vehicle, which may be used for autonomous navigation, consistent with the disclosed embodiments.

FIGS. 24A, 24B, 24C, and 24D illustrate exemplary lane marks that may be detected consistent with the disclosed embodiments.

FIG. 24E shows exemplary mapped lane marks consistent with the disclosed embodiments.

FIG. 24F shows an exemplary anomaly associated with detecting a lane mark consistent with the disclosed embodiments.

FIG. 25A shows an exemplary image of a vehicle's surrounding environment for navigation based on the mapped lane marks consistent with the disclosed embodiments.

FIG. 25B illustrates a lateral localization correction of a vehicle based on mapped lane marks in a road navigation model consistent with the disclosed embodiments.

FIGS. 25C and 25D provide conceptual representations of a localization technique for locating a host vehicle along a target trajectory using mapped features included in a sparse map.

FIG. 26A is a flowchart showing an exemplary process for mapping a lane mark for use in autonomous vehicle navigation consistent with disclosed embodiments.

FIG. 26B is a flowchart showing an exemplary process for autonomously navigating a host vehicle along a road segment using mapped lane marks consistent with disclosed embodiments.

FIG. 27 illustrates a block diagram of a host vehicle navigation system, consistent with disclosed embodiments.

FIG. 28 is a flowchart showing an exemplary method for determining an ambient light level in an environment of a host vehicle, consistent with disclosed embodiments.

FIG. 29 provides a schematic illustration comparing a field of view of a lux meter with a field of view of a camera for detecting light from vehicle headlights, consistent with disclosed embodiments.

FIG. 30 provides a schematic illustration of an urban street scene depicting an environment of a host vehicle, consistent with disclosed embodiments.

FIG. 31 provides a schematic illustration of an exemplary image with segmented objects for ambient light level analysis, consistent with disclosed embodiments.

FIG. 32 provides a schematic illustration of an exemplary image showing segmentation of sky and road regions, consistent with disclosed embodiments.

FIG. 33 provides a schematic illustration of an exemplary image of a tunnel entrance with a section to analyze, consistent with disclosed embodiments.

FIG. 34 is a flowchart showing an exemplary method for determining an ambient light level using a trained system, consistent with disclosed embodiments.

FIG. 35 is a flowchart showing an exemplary method for determining adjustments to headlights based on an ambient light level, consistent with disclosed embodiments.

FIG. 36A provides a graphical representation of an abrupt decrease in light intensity level over time, consistent with disclosed embodiments.

FIG. 36B provides a graphical representation of an abrupt increase in light intensity level over time, consistent with disclosed embodiments.

FIG. 36C provides a graphical representation of a gradual linear decrease in light intensity level over time, consistent with disclosed embodiments.

FIG. 36D provides a graphical representation of a gradual curved increase in light intensity level over time, consistent with disclosed embodiments.

FIG. 37 is a flowchart showing an exemplary method for determining whether to adjust headlights based on multiple light intensity levels, consistent with disclosed embodiments.

FIG. 38 provides a schematic illustration of an environment of a host vehicle showing portions with different light intensity levels, consistent with disclosed embodiments.

FIG. 39 is a flowchart showing an exemplary method for determining whether to adjust headlights based on environment information, consistent with disclosed embodiments.

FIG. 40 provides a schematic illustration of an environment of a host vehicle showing a road segment passing under an overpass, consistent with disclosed embodiments.

FIG. 41A provides a graphical representation of a temporary decrease in light intensity level for a predetermined time period, consistent with disclosed embodiments.

FIG. 41B provides a graphical representation of a temporary increase in light intensity level for a predetermined time period, consistent with disclosed embodiments.

FIG. 42 is a flowchart showing an exemplary method for determining adjustments to a display of a host vehicle, consistent with disclosed embodiments.

FIG. 43A provides a schematic illustration of a display in a first display state with reduced visibility, consistent with disclosed embodiments.

FIG. 43B provides a schematic illustration of the display of FIG. 43A in a second display state with enhanced visibility, consistent with disclosed embodiments.

FIG. 44 is a flowchart showing an exemplary method for determining display adjustments based on environment information, consistent with disclosed embodiments.

FIG. 45 is a flowchart showing an exemplary method for determining display adjustments based on a looking direction of a user, consistent with disclosed embodiments.

FIG. 46 provides a schematic illustration of a view from inside a host vehicle through a windshield, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Autonomous Vehicle (AV) Overview

As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operation without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations to control a vehicle, transportation infrastructures are built accordingly, with lane markings, traffic signs, and traffic lights are all designed to provide visual information to drivers. In view of these design characteristics of transportation infrastructures, an autonomous vehicle may include a camera and a processing unit that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

In some embodiments in this disclosure, an autonomous vehicle may use information obtained while navigating (e.g., from a camera, GPS device, an accelerometer, a speed sensor, a suspension sensor, etc.). In other embodiments, an autonomous vehicle may use information obtained from past navigations by the vehicle (or by other vehicles) while navigating. In yet other embodiments, an autonomous vehicle may use a combination of information obtained while navigating and information obtained from past navigations. The following sections provide an overview of a system consistent with the disclosed embodiments, followed by an overview of a forward-facing imaging system and methods consistent with the system. The sections that follow disclose systems and methods for constructing, using, and updating a sparse map for autonomous vehicle navigation.

### System Overview

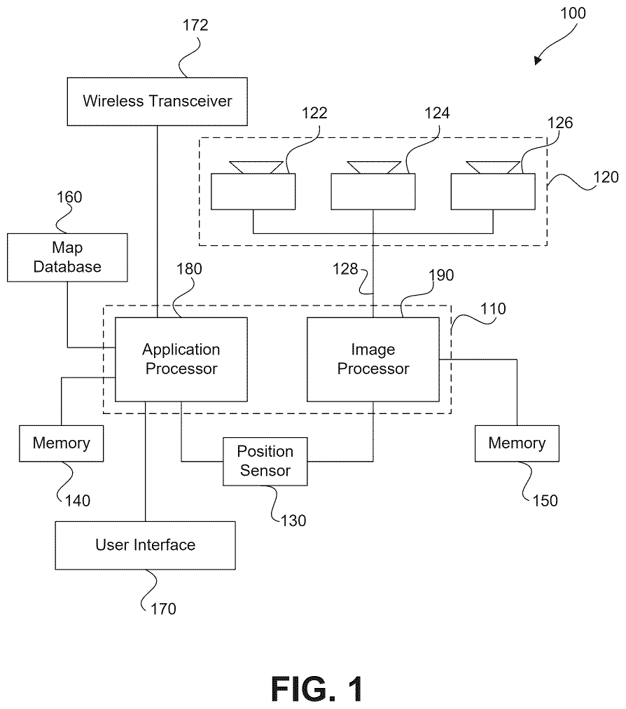

FIG. 1 is a block diagram representation of a system 100 consistent with the exemplary disclosed embodiments. System 100 may include various components depending on the requirements of a particular implementation. In some embodiments, system 100 may include a processing unit 110, an image acquisition unit 120, a position sensor 130, one or more memory units 140, 150, a map database 160, a user interface 170, and a wireless transceiver 172. Processing unit 110 may include one or more processing devices. In some embodiments, processing unit 110 may include an applications processor 180, an image processor 190, or any other suitable processing device. Similarly, image acquisition unit 120 may include any number of image acquisition devices and components depending on the requirements of a particular application. In some embodiments, image acquisition unit 120 may include one or more image capture devices (e.g., cameras), such as image capture device 122, image capture device 124, and image capture device 126. System 100 may also include a data interface 128 communicatively connecting processing device 110 to image acquisition device 120. For example, data interface 128 may include any wired and/or wireless link or links for transmitting image data acquired by image accusation device 120 to processing unit 110.

Wireless transceiver 172 may include one or more devices configured to exchange transmissions over an air interface to one or more networks (e.g., cellular, the Internet, etc.) by use of a radio frequency, infrared frequency, magnetic field, or an electric field. Wireless transceiver 172 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 180 and image processor 190 may include various types of processing devices. For example, either or both of applications processor 180 and image processor 190 may include a microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.).

In some embodiments, applications processor 180 and/or image processor 190 may include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP™ and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third generation processor and is six times more powerful that the EyeQ2®, may be used in the disclosed embodiments. In other examples, the EyeQ4® and/or the EyeQ5® may be used in the disclosed embodiments. Of course, any newer or future EyeQ processing devices may also be used together with the disclosed embodiments.

Any of the processing devices disclosed herein may be configured to perform certain functions. Configuring a processing device, such as any of the described EyeQ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 1 depicts two separate processing devices included in processing unit 110, more or fewer processing devices may be used. For example, in some embodiments, a single processing device may be used to accomplish the tasks of applications processor 180 and image processor 190. In other embodiments, these tasks may be performed by more than two processing devices. Further, in some embodiments, system 100 may include one or more of processing unit 110 without including other components, such as image acquisition unit 120.

Processing unit 110 may comprise various types of devices. For example, processing unit 110 may include various devices, such as a controller, an image preprocessor, a central processing unit (CPU), a graphics processing unit (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 110. In another instance, the memory may be integrated into the processing unit 110.

Each memory 140, 150 may include software instructions that when executed by a processor (e.g., applications processor 180 and/or image processor 190), may control operation of various aspects of system 100. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory units 140, 150 may be separate from the applications processor 180 and/or image processor 190. In other embodiments, these memory units may be integrated into applications processor 180 and/or image processor 190.

Position sensor 130 may include any type of device suitable for determining a location associated with at least one component of system 100. In some embodiments, position sensor 130 may include a GPS receiver. Such receivers can determine a user position and velocity by processing signals broadcasted by global positioning system satellites. Position information from position sensor 130 may be made available to applications processor 180 and/or image processor 190.

In some embodiments, system 100 may include components such as a speed sensor (e.g., a tachometer, a speedometer) for measuring a speed of vehicle 200 and/or an accelerometer (either single axis or multiaxis) for measuring acceleration of vehicle 200.

User interface 170 may include any device suitable for providing information to or for receiving inputs from one or more users of system 100. In some embodiments, user interface 170 may include user input devices, including, for example, a touchscreen, microphone, keyboard, pointer devices, track wheels, cameras, knobs, buttons, etc. With such input devices, a user may be able to provide information inputs or commands to system 100 by typing instructions or information, providing voice commands, selecting menu options on a screen using buttons, pointers, or eye-tracking capabilities, or through any other suitable techniques for communicating information to system 100.

User interface 170 may be equipped with one or more processing devices configured to provide and receive information to or from a user and process that information for use by, for example, applications processor 180. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 170 may include a display, speaker, tactile device, and/or any other devices for providing output information to a user.

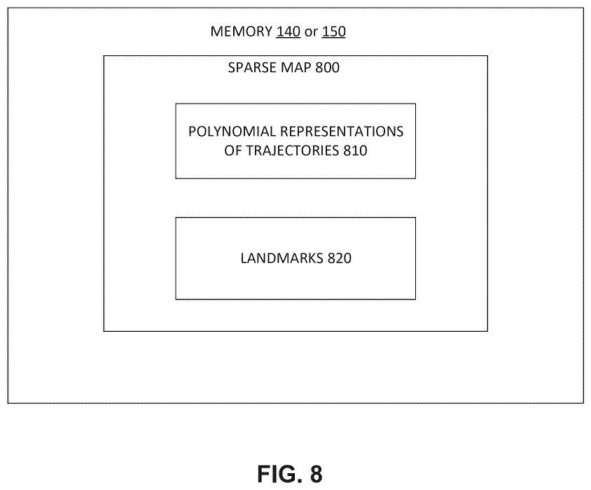

Map database 160 may include any type of database for storing map data useful to system 100. In some embodiments, map database 160 may include data relating to the position, in a reference coordinate system, of various items, including roads, water features, geographic features, businesses, points of interest, restaurants, gas stations, etc. Map database 160 may store not only the locations of such items, but also descriptors relating to those items, including, for example, names associated with any of the stored features. In some embodiments, map database 160 may be physically located with other components of system 100. Alternatively or additionally, map database 160 or a portion thereof may be located remotely with respect to other components of system 100 (e.g., processing unit 110). In such embodiments, information from map database 160 may be downloaded over a wired or wireless data connection to a network (e.g., over a cellular network and/or the Internet, etc.). In some cases, map database 160 may store a sparse data model including polynomial representations of certain road features (e.g., lane markings) or target trajectories for the host vehicle. Systems and methods of generating such a map are discussed below with references to FIGS. 8-19.

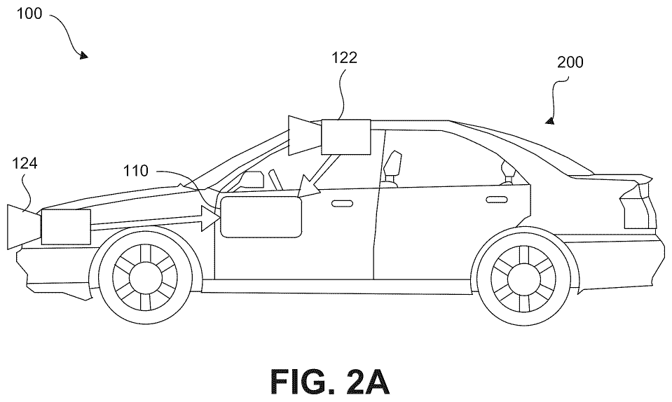

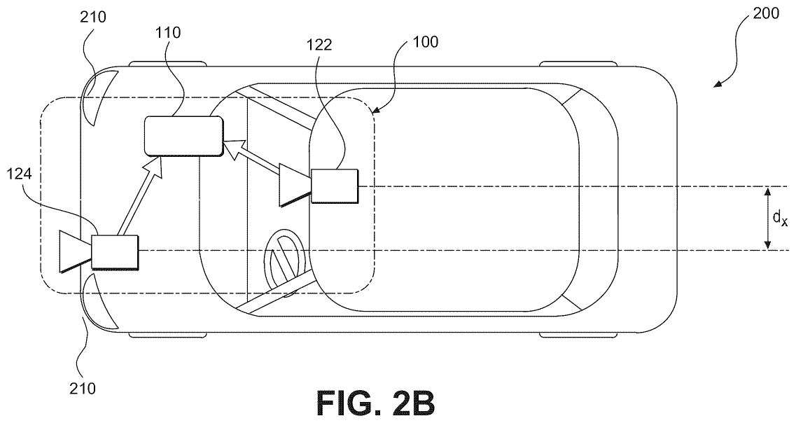

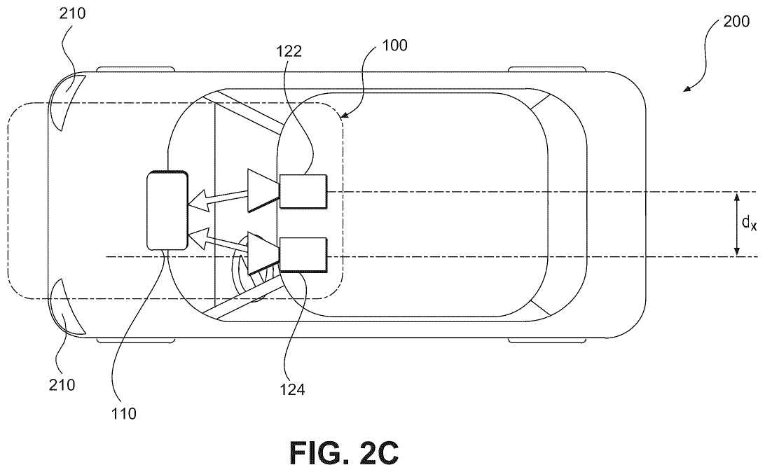

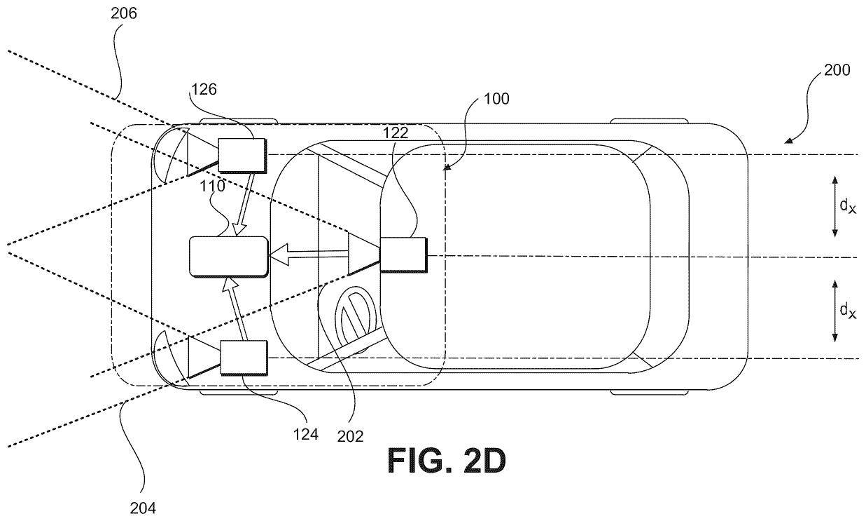

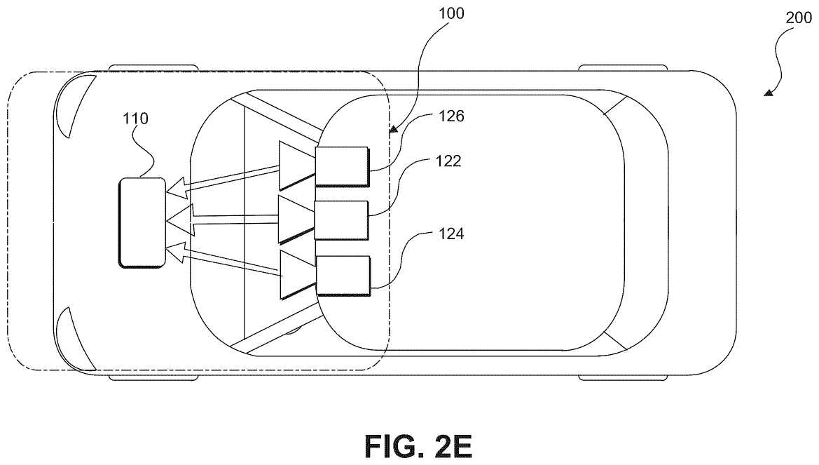

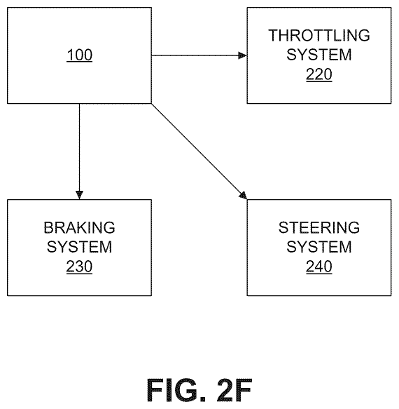

Image capture devices 122, 124, and 126 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 122, 124, and 126 will be further described with reference to FIGS. 2B-2E, below.

System 100, or various components thereof, may be incorporated into various different platforms. In some embodiments, system 100 may be included on a vehicle 200, as shown in FIG. 2A. For example, vehicle 200 may be equipped with a processing unit 110 and any of the other components of system 100, as described above relative to FIG. 1. While in some embodiments vehicle 200 may be equipped with only a single image capture device (e.g., camera), in other embodiments, such as those discussed in connection with FIGS. 2B-2E, multiple image capture devices may be used. For example, either of image capture devices 122 and 124 of vehicle 200, as shown in FIG. 2A, may be part of an ADAS (Advanced Driver Assistance Systems) imaging set.

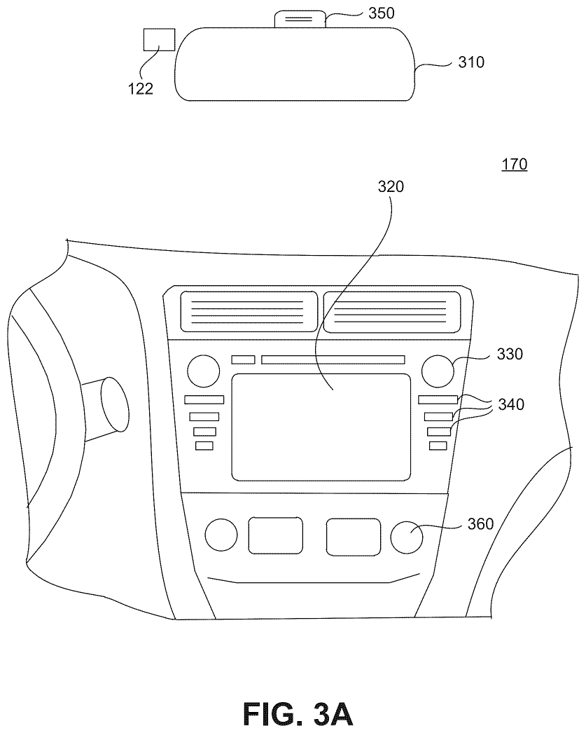

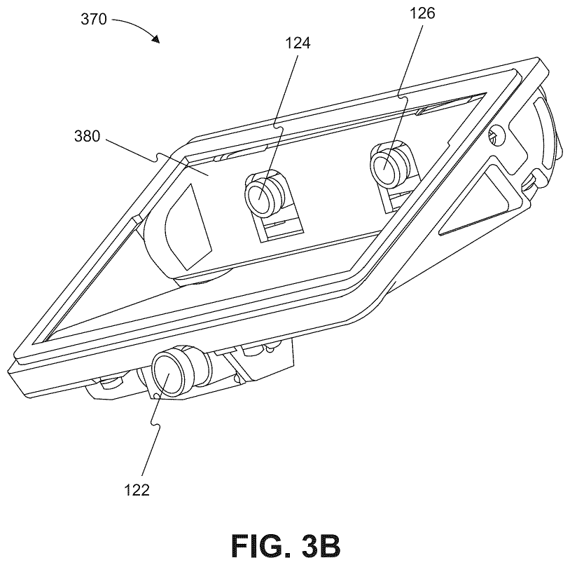

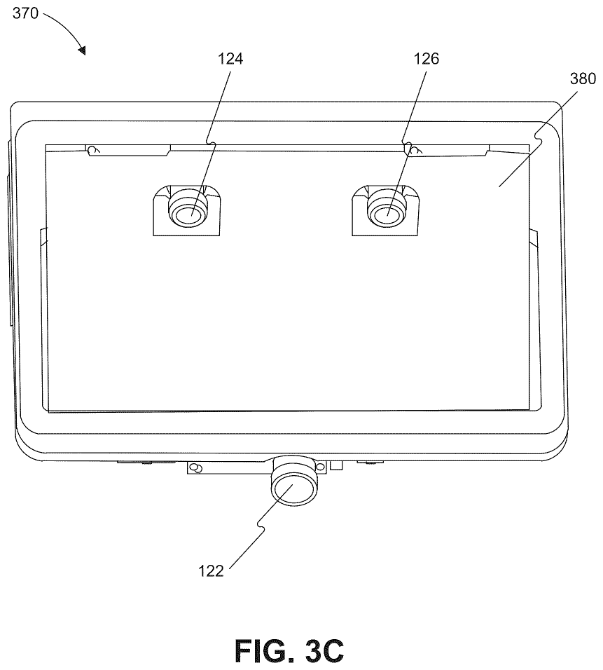

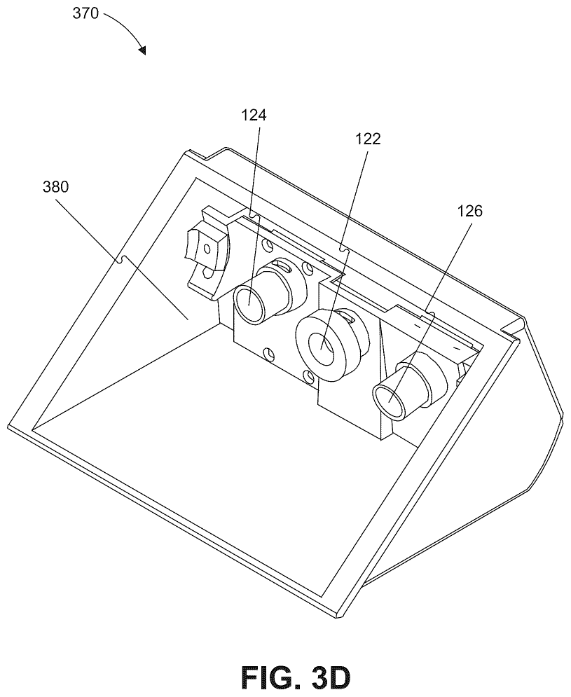

The image capture devices included on vehicle 200 as part of the image acquisition unit 120 may be positioned at any suitable location. In some embodiments, as shown in FIGS. 2A-2E and 3A-3C, image capture device 122 may be located in the vicinity of the rearview mirror. This position may provide a line of sight similar to that of the driver of vehicle 200, which may aid in determining what is and is not visible to the driver. Image capture device 122 may be positioned at any location near the rearview mirror, but placing image capture device 122 on the driver side of the mirror may further aid in obtaining images representative of the driver's field of view and/or line of sight.

Other locations for the image capture devices of image acquisition unit 120 may also be used. For example, image capture device 124 may be located on or in a bumper of vehicle 200. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 122, 124, and 126) may also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near light figures on the front and/or back of vehicle 200, etc.

In addition to image capture devices, vehicle 200 may include various other components of system 100. For example, processing unit 110 may be included on vehicle 200 either integrated with or separate from an engine control unit (ECU) of the vehicle. Vehicle 200 may also be equipped with a position sensor 130, such as a GPS receiver and may also include a map database 160 and memory units 140 and 150.

As discussed earlier, wireless transceiver 172 may and/or receive data over one or more networks (e.g., cellular networks, the Internet, etc.). For example, wireless transceiver 172 may upload data collected by system 100 to one or more servers, and download data from the one or more servers. Via wireless transceiver 172, system 100 may receive, for example, periodic or on demand updates to data stored in map database 160, memory 140, and/or memory 150. Similarly, wireless transceiver 172 may upload any data (e.g., images captured by image acquisition unit 120, data received by position sensor 130 or other sensors, vehicle control systems, etc.) from by system 100 and/or any data processed by processing unit 110 to the one or more servers.

System 100 may upload data to a server (e.g., to the cloud) based on a privacy level setting. For example, system 100 may implement privacy level settings to regulate or limit the types of data (including metadata) sent to the server that may uniquely identify a vehicle and or driver/owner of a vehicle. Such settings may be set by user via, for example, wireless transceiver 172, be initialized by factory default settings, or by data received by wireless transceiver 172.

In some embodiments, system 100 may upload data according to a “high” privacy level, and under setting a setting, system 100 may transmit data (e.g., location information related to a route, captured images, etc.) without any details about the specific vehicle and/or driver/owner. For example, when uploading data according to a “high” privacy setting, system 100 may not include a vehicle identification number (VIN) or a name of a driver or owner of the vehicle, and may instead of transmit data, such as captured images and/or limited location information related to a route.

Other privacy levels are contemplated. For example, system 100 may transmit data to a server according to an “intermediate” privacy level and include additional information not included under a “high” privacy level, such as a make and/or model of a vehicle and/or a vehicle type (e.g., a passenger vehicle, sport utility vehicle, truck, etc.). In some embodiments, system 100 may upload data according to a “low” privacy level. Under a “low” privacy level setting, system 100 may upload data and include information sufficient to uniquely identify a specific vehicle, owner/driver, and/or a portion or entirely of a route traveled by the vehicle. Such “low” privacy level data may include one or more of, for example, a VIN, a driver/owner name, an origination point of a vehicle prior to departure, an intended destination of the vehicle, a make and/or model of the vehicle, a type of the vehicle, etc.

FIG. 2A is a diagrammatic side view representation of an exemplary vehicle imaging system consistent with the disclosed embodiments. FIG. 2B is a diagrammatic top view illustration of the embodiment shown in FIG. 2A. As illustrated in FIG. 2B, the disclosed embodiments may include a vehicle 200 including in its body a system 100 with a first image capture device 122 positioned in the vicinity of the rearview mirror and/or near the driver of vehicle 200, a second image capture device 124 positioned on or in a bumper region (e.g., one of bumper regions 210) of vehicle 200, and a processing unit 110.

As illustrated in FIG. 2C, image capture devices 122 and 124 may both be positioned in the vicinity of the rearview mirror and/or near the driver of vehicle 200. Additionally, while two image capture devices 122 and 124 are shown in FIGS. 2B and 2C, it should be understood that other embodiments may include more than two image capture devices. For example, in the embodiments shown in FIGS. 2D and 2E, first, second, and third image capture devices 122, 124, and 126, are included in the system 100 of vehicle 200.

As illustrated in FIG. 2D, image capture device 122 may be positioned in the vicinity of the rearview mirror and/or near the driver of vehicle 200, and image capture devices 124 and 126 may be positioned on or in a bumper region (e.g., one of bumper regions 210) of vehicle 200. And as shown in FIG. 2E, image capture devices 122, 124, and 126 may be positioned in the vicinity of the rearview mirror and/or near the driver seat of vehicle 200. The disclosed embodiments are not limited to any particular number and configuration of the image capture devices, and the image capture devices may be positioned in any appropriate location within and/or on vehicle 200.

It is to be understood that the disclosed embodiments are not limited to vehicles and could be applied in other contexts. It is also to be understood that disclosed embodiments are not limited to a particular type of vehicle 200 and may be applicable to all types of vehicles including automobiles, trucks, trailers, and other types of vehicles.

The first image capture device 122 may include any suitable type of image capture device. Image capture device 122 may include an optical axis. In one instance, the image capture device 122 may include an Aptina M9V024 WVGA sensor with a global shutter. In other embodiments, image capture device 122 may provide a resolution of 1280×960 pixels and may include a rolling shutter. Image capture device 122 may include various optical elements. In some embodiments one or more lenses may be included, for example, to provide a desired focal length and field of view for the image capture device. In some embodiments, image capture device 122 may be associated with a 6 mm lens or a 12 mm lens. In some embodiments, image capture device 122 may be configured to capture images having a desired field-of-view (FOV) 202, as illustrated in FIG. 2D. For example, image capture device 122 may be configured to have a regular FOV, such as within a range of 40 degrees to 56 degrees, including a 46 degree fOV, 50 degree fOV, 52 degree fOV, or greater. Alternatively, image capture device 122 may be configured to have a narrow FOV in the range of 23 to 40 degrees, such as a 28 degree fOV or 36 degree fOV. In addition, image capture device 122 may be configured to have a wide FOV in the range of 100 to 180 degrees. In some embodiments, image capture device 122 may include a wide angle bumper camera or one with up to a 180 degree fOV. In some embodiments, image capture device 122 may be a 7.2M pixel image capture device with an aspect ratio of about 2:1 (e.g., H×V=3800×1900 pixels) with about 100 degree horizontal FOV. Such an image capture device may be used in place of a three image capture device configuration. Due to significant lens distortion, the vertical FOV of such an image capture device may be significantly less than 50 degrees in implementations in which the image capture device uses a radially symmetric lens. For example, such a lens may not be radially symmetric which would allow for a vertical FOV greater than 50 degrees with 100 degree horizontal FOV.

The first image capture device 122 may acquire a plurality of first images relative to a scene associated with the vehicle 200. Each of the plurality of first images may be acquired as a series of image scan lines, which may be captured using a rolling shutter. Each scan line may include a plurality of pixels.

The first image capture device 122 may have a scan rate associated with acquisition of each of the first series of image scan lines. The scan rate may refer to a rate at which an image sensor can acquire image data associated with each pixel included in a particular scan line.

Image capture devices 122, 124, and 126 may contain any suitable type and number of image sensors, including CCD sensors or CMOS sensors, for example. In one embodiment, a CMOS image sensor may be employed along with a rolling shutter, such that each pixel in a row is read one at a time, and scanning of the rows proceeds on a row-by-row basis until an entire image frame has been captured. In some embodiments, the rows may be captured sequentially from top to bottom relative to the frame.

In some embodiments, one or more of the image capture devices (e.g., image capture devices 122, 124, and 126) disclosed herein may constitute a high resolution imager and may have a resolution greater than 5M pixel, 7M pixel, 10M pixel, or greater.

The use of a rolling shutter may result in pixels in different rows being exposed and captured at different times, which may cause skew and other image artifacts in the captured image frame. On the other hand, when the image capture device 122 is configured to operate with a global or synchronous shutter, all of the pixels may be exposed for the same amount of time and during a common exposure period. As a result, the image data in a frame collected from a system employing a global shutter represents a snapshot of the entire FOV (such as FOV 202) at a particular time. In contrast, in a rolling shutter application, each row in a frame is exposed and data is capture at different times. Thus, moving objects may appear distorted in an image capture device having a rolling shutter. This phenomenon will be described in greater detail below.

The second image capture device 124 and the third image capturing device 126 may be any type of image capture device. Like the first image capture device 122, each of image capture devices 124 and 126 may include an optical axis. In one embodiment, each of image capture devices 124 and 126 may include an Aptina M9V024 WVGA sensor with a global shutter. Alternatively, each of image capture devices 124 and 126 may include a rolling shutter. Like image capture device 122, image capture devices 124 and 126 may be configured to include various lenses and optical elements. In some embodiments, lenses associated with image capture devices 124 and 126 may provide FOVs (such as FOVs 204 and 206) that are the same as, or narrower than, a FOV (such as FOV 202) associated with image capture device 122. For example, image capture devices 124 and 126 may have FOVs of 40 degrees, 30 degrees, 26 degrees, 23 degrees, 20 degrees, or less.

Image capture devices 124 and 126 may acquire a plurality of second and third images relative to a scene associated with the vehicle 200. Each of the plurality of second and third images may be acquired as a second and third series of image scan lines, which may be captured using a rolling shutter. Each scan line or row may have a plurality of pixels. Image capture devices 124 and 126 may have second and third scan rates associated with acquisition of each of image scan lines included in the second and third series.

Each image capture device 122, 124, and 126 may be positioned at any suitable position and orientation relative to vehicle 200. The relative positioning of the image capture devices 122, 124, and 126 may be selected to aid in fusing together the information acquired from the image capture devices. For example, in some embodiments, a FOV (such as FOV 204) associated with image capture device 124 may overlap partially or fully with a FOV (such as FOV 202) associated with image capture device 122 and a FOV (such as FOV 206) associated with image capture device 126.

Image capture devices 122, 124, and 126 may be located on vehicle 200 at any suitable relative heights. In one instance, there may be a height difference between the image capture devices 122, 124, and 126, which may provide sufficient parallax information to enable stereo analysis. For example, as shown in FIG. 2A, the two image capture devices 122 and 124 are at different heights. There may also be a lateral displacement difference between image capture devices 122, 124, and 126, giving additional parallax information for stereo analysis by processing unit 110, for example. The difference in the lateral displacement may be denoted by dx, as shown in FIGS. 2C and 2D. In some embodiments, fore or aft displacement (e.g., range displacement) may exist between image capture devices 122, 124, and 126. For example, image capture device 122 may be located 0.5 to 2 meters or more behind image capture device 124 and/or image capture device 126. This type of displacement may enable one of the image capture devices to cover potential blind spots of the other image capture device(s).

Image capture devices 122 may have any suitable resolution capability (e.g., number of pixels associated with the image sensor), and the resolution of the image sensor(s) associated with the image capture device 122 may be higher, lower, or the same as the resolution of the image sensor(s) associated with image capture devices 124 and 126. In some embodiments, the image sensor(s) associated with image capture device 122 and/or image capture devices 124 and 126 may have a resolution of 640×480, 1024×768, 1280×960, or any other suitable resolution.

The frame rate (e.g., the rate at which an image capture device acquires a set of pixel data of one image frame before moving on to capture pixel data associated with the next image frame) may be controllable. The frame rate associated with image capture device 122 may be higher, lower, or the same as the frame rate associated with image capture devices 124 and 126. The frame rate associated with image capture devices 122, 124, and 126 may depend on a variety of factors that may affect the timing of the frame rate. For example, one or more of image capture devices 122, 124, and 126 may include a selectable pixel delay period imposed before or after acquisition of image data associated with one or more pixels of an image sensor in image capture device 122, 124, and/or 126. Generally, image data corresponding to each pixel may be acquired according to a clock rate for the device (e.g., one pixel per clock cycle). Additionally, in embodiments including a rolling shutter, one or more of image capture devices 122, 124, and 126 may include a selectable horizontal blanking period imposed before or after acquisition of image data associated with a row of pixels of an image sensor in image capture device 122, 124, and/or 126. Further, one or more of image capture devices 122, 124, and/or 126 may include a selectable vertical blanking period imposed before or after acquisition of image data associated with an image frame of image capture device 122, 124, and 126.

These timing controls may enable synchronization of frame rates associated with image capture devices 122, 124, and 126, even where the line scan rates of each are different. Additionally, as will be discussed in greater detail below, these selectable timing controls, among other factors (e.g., image sensor resolution, maximum line scan rates, etc.) may enable synchronization of image capture from an area where the FOV of image capture device 122 overlaps with one or more FOVs of image capture devices 124 and 126, even where the field of view of image capture device 122 is different from the FOVs of image capture devices 124 and 126.

Frame rate timing in image capture device 122, 124, and 126 may depend on the resolution of the associated image sensors. For example, assuming similar line scan rates for both devices, if one device includes an image sensor having a resolution of 640×480 and another device includes an image sensor with a resolution of 1280×960, then more time will be required to acquire a frame of image data from the sensor having the higher resolution.

Another factor that may affect the timing of image data acquisition in image capture devices 122, 124, and 126 is the maximum line scan rate. For example, acquisition of a row of image data from an image sensor included in image capture device 122, 124, and 126 will require some minimum amount of time. Assuming no pixel delay periods are added, this minimum amount of time for acquisition of a row of image data will be related to the maximum line scan rate for a particular device. Devices that offer higher maximum line scan rates have the potential to provide higher frame rates than devices with lower maximum line scan rates. In some embodiments, one or more of image capture devices 124 and 126 may have a maximum line scan rate that is higher than a maximum line scan rate associated with image capture device 122. In some embodiments, the maximum line scan rate of image capture device 124 and/or 126 may be 1.25, 1.5, 1.75, or 2 times or more than a maximum line scan rate of image capture device 122.

In another embodiment, image capture devices 122, 124, and 126 may have the same maximum line scan rate, but image capture device 122 may be operated at a scan rate less than or equal to its maximum scan rate. The system may be configured such that one or more of image capture devices 124 and 126 operate at a line scan rate that is equal to the line scan rate of image capture device 122. In other instances, the system may be configured such that the line scan rate of image capture device 124 and/or image capture device 126 may be 1.25, 1.5, 1.75, or 2 times or more than the line scan rate of image capture device 122.

In some embodiments, image capture devices 122, 124, and 126 may be asymmetric. That is, they may include cameras having different fields of view (FOV) and focal lengths. The fields of view of image capture devices 122, 124, and 126 may include any desired area relative to an environment of vehicle 200, for example. In some embodiments, one or more of image capture devices 122, 124, and 126 may be configured to acquire image data from an environment in front of vehicle 200, behind vehicle 200, to the sides of vehicle 200, or combinations thereof.

Further, the focal length associated with each image capture device 122, 124, and/or 126 may be selectable (e.g., by inclusion of appropriate lenses etc.) such that each device acquires images of objects at a desired distance range relative to vehicle 200. For example, in some embodiments image capture devices 122, 124, and 126 may acquire images of close-up objects within a few meters from the vehicle. Image capture devices 122, 124, and 126 may also be configured to acquire images of objects at ranges more distant from the vehicle (e.g., 25 m, 50 m, 100 m, 150 m, or more). Further, the focal lengths of image capture devices 122, 124, and 126 may be selected such that one image capture device (e.g., image capture device 122) can acquire images of objects relatively close to the vehicle (e.g., within 10 m or within 20 m) while the other image capture devices (e.g., image capture devices 124 and 126) can acquire images of more distant objects (e.g., greater than 20 m, 50 m, 100 m, 150 m, etc.) from vehicle 200.

According to some embodiments, the FOV of one or more image capture devices 122, 124, and 126 may have a wide angle. For example, it may be advantageous to have a FOV of 140 degrees, especially for image capture devices 122, 124, and 126 that may be used to capture images of the area in the vicinity of vehicle 200. For example, image capture device 122 may be used to capture images of the area to the right or left of vehicle 200 and, in such embodiments, it may be desirable for image capture device 122 to have a wide FOV (e.g., at least 140 degrees).

The field of view associated with each of image capture devices 122, 124, and 126 may depend on the respective focal lengths. For example, as the focal length increases, the corresponding field of view decreases.

Image capture devices 122, 124, and 126 may be configured to have any suitable fields of view. In one particular example, image capture device 122 may have a horizontal FOV of 46 degrees, image capture device 124 may have a horizontal FOV of 23 degrees, and image capture device 126 may have a horizontal FOV in between 23 and 46 degrees. In another instance, image capture device 122 may have a horizontal FOV of 52 degrees, image capture device 124 may have a horizontal FOV of 26 degrees, and image capture device 126 may have a horizontal FOV in between 26 and 52 degrees. In some embodiments, a ratio of the FOV of image capture device 122 to the FOVs of image capture device 124 and/or image capture device 126 may vary from 1.5 to 2.0. In other embodiments, this ratio may vary between 1.25 and 2.25.

System 100 may be configured so that a field of view of image capture device 122 overlaps, at least partially or fully, with a field of view of image capture device 124 and/or image capture device 126. In some embodiments, system 100 may be configured such that the fields of view of image capture devices 124 and 126, for example, fall within (e.g., are narrower than) and share a common center with the field of view of image capture device 122. In other embodiments, the image capture devices 122, 124, and 126 may capture adjacent FOVs or may have partial overlap in their FOVs. In some embodiments, the fields of view of image capture devices 122, 124, and 126 may be aligned such that a center of the narrower FOV image capture devices 124 and/or 126 may be located in a lower half of the field of view of the wider FOV device 122.

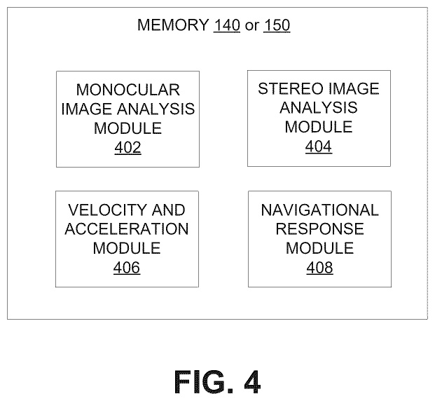

FIG. 2F is a diagrammatic representation of exemplary vehicle control systems, consistent with the disclosed embodiments. As indicated in FIG. 2F, vehicle 200 may include throttling system 220, braking system 230, and steering system 240. System 100 may provide inputs (e.g., control signals) to one or more of throttling system 220, braking system 230, and steering system 240 over one or more data links (e.g., any wired and/or wireless link or links for transmitting data). For example, based on analysis of images acquired by image capture devices 122, 124, and/or 126, system 100 may provide control signals to one or more of throttling system 220, braking system 230, and steering system 240 to navigate vehicle 200 (e.g., by causing an acceleration, a turn, a lane shift, etc.). Further, system 100 may receive inputs from one or more of throttling system 220, braking system 230, and steering system 24 indicating operating conditions of vehicle 200 (e.g., speed, whether vehicle 200 is braking and/or turning, etc.). Further details are provided in connection with FIGS. 4-7, below.

As shown in FIG. 3A, vehicle 200 may also include a user interface 170 for interacting with a driver or a passenger of vehicle 200. For example, user interface 170 in a vehicle application may include a touch screen 320, knobs 330, buttons 340, and a microphone 350. A driver or passenger of vehicle 200 may also use handles (e.g., located on or near the steering column of vehicle 200 including, for example, turn signal handles), buttons (e.g., located on the steering wheel of vehicle 200), and the like, to interact with system 100. In some embodiments, microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, system 100 may provide various notifications (e.g., alerts) via speakers 360.

FIGS. 3B-3D are illustrations of an exemplary camera mount 370 configured to be positioned behind a rearview mirror (e.g., rearview mirror 310) and against a vehicle windshield, consistent with disclosed embodiments. As shown in FIG. 3B, camera mount 370 may include image capture devices 122, 124, and 126. Image capture devices 124 and 126 may be positioned behind a glare shield 380, which may be flush against the vehicle windshield and include a composition of film and/or anti-reflective materials. For example, glare shield 380 may be positioned such that the shield aligns against a vehicle windshield having a matching slope. In some embodiments, each of image capture devices 122, 124, and 126 may be positioned behind glare shield 380, as depicted, for example, in FIG. 3D. The disclosed embodiments are not limited to any particular configuration of image capture devices 122, 124, and 126, camera mount 370, and glare shield 380. FIG. 3C is an illustration of camera mount 370 shown in FIG. 3B from a front perspective.

As will be appreciated by a person skilled in the art having the benefit of this disclosure, numerous variations and/or modifications may be made to the foregoing disclosed embodiments. For example, not all components are essential for the operation of system 100. Further, any component may be located in any appropriate part of system 100 and the components may be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and navigate vehicle 200 in response to the analysis.

As discussed below in further detail and consistent with various disclosed embodiments, system 100 may provide a variety of features related to autonomous driving and/or driver assist technology. For example, system 100 may analyze image data, position data (e.g., GPS location information), map data, speed data, and/or data from sensors included in vehicle 200. System 100 may collect the data for analysis from, for example, image acquisition unit 120, position sensor 130, and other sensors. Further, system 100 may analyze the collected data to determine whether or not vehicle 200 should take a certain action, and then automatically take the determined action without human intervention. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 may analyze the collected data and issue warnings and/or alerts to vehicle occupants based on the analysis of the collected data. Additional details regarding the various embodiments that are provided by system 100 are provided below.

### Forward-Facing Multi-Imaging System

As discussed above, system 100 may provide drive assist functionality that uses a multi-camera system. The multi-camera system may use one or more cameras facing in the forward direction of a vehicle. In other embodiments, the multi-camera system may include one or more cameras facing to the side of a vehicle or to the rear of the vehicle. In one embodiment, for example, system 100 may use a two-camera imaging system, where a first camera and a second camera (e.g., image capture devices 122 and 124) may be positioned at the front and/or the sides of a vehicle (e.g., vehicle 200). The first camera may have a field of view that is greater than, less than, or partially overlapping with, the field of view of the second camera. In addition, the first camera may be connected to a first image processor to perform monocular image analysis of images provided by the first camera, and the second camera may be connected to a second image processor to perform monocular image analysis of images provided by the second camera. The outputs (e.g., processed information) of the first and second image processors may be combined. In some embodiments, the second image processor may receive images from both the first camera and second camera to perform stereo analysis. In another embodiment, system 100 may use a three-camera imaging system where each of the cameras has a different field of view. Such a system may, therefore, make decisions based on information derived from objects located at varying distances both forward and to the sides of the vehicle. References to monocular image analysis may refer to instances where image analysis is performed based on images captured from a single point of view (e.g., from a single camera). Stereo image analysis may refer to instances where image analysis is performed based on two or more images captured with one or more variations of an image capture parameter. For example, captured images suitable for performing stereo image analysis may include images captured: from two or more different positions, from different fields of view, using different focal lengths, along with parallax information, etc.

For example, in one embodiment, system 100 may implement a three camera configuration using image capture devices 122, 124, and 126. In such a configuration, image capture device 122 may provide a narrow field of view (e.g., 34 degrees, or other values selected from a range of about 20 to 45 degrees, etc.), image capture device 124 may provide a wide field of view (e.g., 150 degrees or other values selected from a range of about 100 to about 180 degrees), and image capture device 126 may provide an intermediate field of view (e.g., 46 degrees or other values selected from a range of about 35 to about 60 degrees). In some embodiments, image capture device 126 may act as a main or primary camera. Image capture devices 122, 124, and 126 may be positioned behind rearview mirror 310 and positioned substantially side-by-side (e.g., 6 cm apart). Further, in some embodiments, as discussed above, one or more of image capture devices 122, 124, and 126 may be mounted behind glare shield 380 that is flush with the windshield of vehicle 200. Such shielding may act to minimize the impact of any reflections from inside the car on image capture devices 122, 124, and 126.

In another embodiment, as discussed above in connection with FIGS. 3B and 3C, the wide field of view camera (e.g., image capture device 124 in the above example) may be mounted lower than the narrow and main field of view cameras (e.g., image devices 122 and 126 in the above example). This configuration may provide a free line of sight from the wide field of view camera. To reduce reflections, the cameras may be mounted close to the windshield of vehicle 200, and may include polarizers on the cameras to damp reflected light.

A three camera system may provide certain performance characteristics. For example, some embodiments may include an ability to validate the detection of objects by one camera based on detection results from another camera. In the three camera configuration discussed above, processing unit 110 may include, for example, three processing devices (e.g., three EyeQ series of processor chips, as discussed above), with each processing device dedicated to processing images captured by one or more of image capture devices 122, 124, and 126.

In a three camera system, a first processing device may receive images from both the main camera and the narrow field of view camera, and perform vision processing of the narrow FOV camera to, for example, detect other vehicles, pedestrians, lane marks, traffic signs, traffic lights, and other road objects. Further, the first processing device may calculate a disparity of pixels between the images from the main camera and the narrow camera and create a 3D reconstruction of the environment of vehicle 200. The first processing device may then combine the 3D reconstruction with 3D map data or with 3D information calculated based on information from another camera.

The second processing device may receive images from main camera and perform vision processing to detect other vehicles, pedestrians, lane marks, traffic signs, traffic lights, and other road objects. Additionally, the second processing device may calculate a camera displacement and, based on the displacement, calculate a disparity of pixels between successive images and create a 3D reconstruction of the scene (e.g., a structure from motion). The second processing device may send the structure from motion based 3D reconstruction to the first processing device to be combined with the stereo 3D images.

The third processing device may receive images from the wide FOV camera and process the images to detect vehicles, pedestrians, lane marks, traffic signs, traffic lights, and other road objects. The third processing device may further execute additional processing instructions to analyze images to identify objects moving in the image, such as vehicles changing lanes, pedestrians, etc.

In some embodiments, having streams of image-based information captured and processed independently may provide an opportunity for providing redundancy in the system. Such redundancy may include, for example, using a first image capture device and the images processed from that device to validate and/or supplement information obtained by capturing and processing image information from at least a second image capture device.

In some embodiments, system 100 may use two image capture devices (e.g., image capture devices 122 and 124) in providing navigation assistance for vehicle 200 and use a third image capture device (e.g., image capture device 126) to provide redundancy and validate the analysis of data received from the other two image capture devices. For example, in such a configuration, image capture devices 122 and 124 may provide images for stereo analysis by system 100 for navigating vehicle 200, while image capture device 126 may provide images for monocular analysis by system 100 to provide redundancy and validation of information obtained based on images captured from image capture device 122 and/or image capture device 124. That is, image capture device 126 (and a corresponding processing device) may be considered to provide a redundant sub-system for providing a check on the analysis derived from image capture devices 122 and 124 (e.g., to provide an automatic emergency braking (AEB) system). Furthermore, in some embodiments, redundancy and validation of received data may be supplemented based on information received from one more sensors (e.g., radar, lidar, acoustic sensors, information received from one or more transceivers outside of a vehicle, etc.).

One of skill in the art will recognize that the above camera configurations, camera placements, number of cameras, camera locations, etc., are examples only. These components and others described relative to the overall system may be assembled and used in a variety of different configurations without departing from the scope of the disclosed embodiments. Further details regarding usage of a multi-camera system to provide driver assist and/or autonomous vehicle functionality follow below.

FIG. 4 is an exemplary functional block diagram of memory 140 and/or 150, which may be stored/programmed with instructions for performing one or more operations consistent with the disclosed embodiments. Although the following refers to memory 140, one of skill in the art will recognize that instructions may be stored in memory 140 and/or 150.

As shown in FIG. 4, memory 140 may store a monocular image analysis module 402, a stereo image analysis module 404, a velocity and acceleration module 406, and a navigational response module 408. The disclosed embodiments are not limited to any particular configuration of memory 140. Further, application processor 180 and/or image processor 190 may execute the instructions stored in any of modules 402, 404, 406, and 408 included in memory 140. One of skill in the art will understand that references in the following discussions to processing unit 110 may refer to application processor 180 and image processor 190 individually or collectively. Accordingly, steps of any of the following processes may be performed by one or more processing devices.

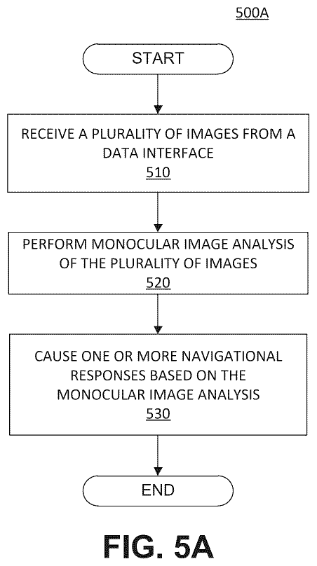

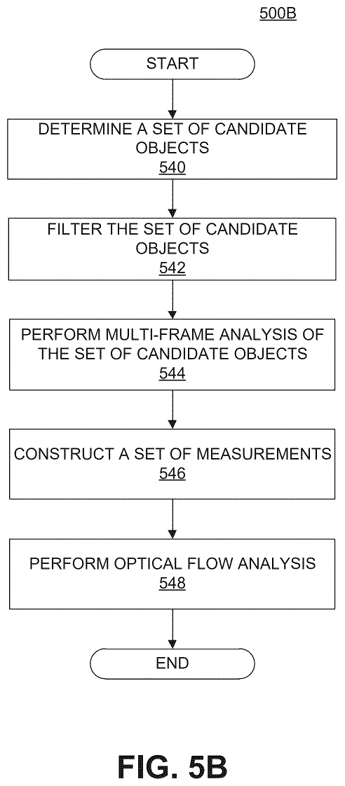

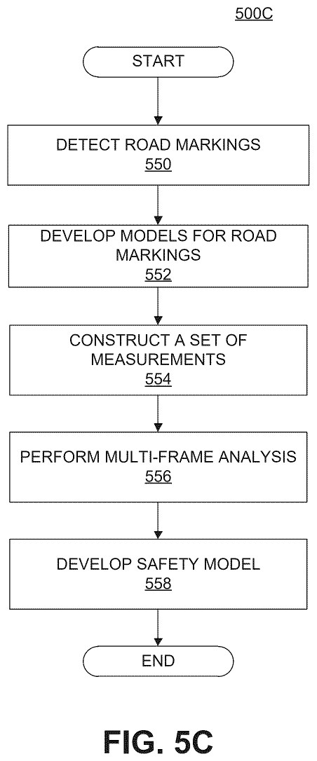

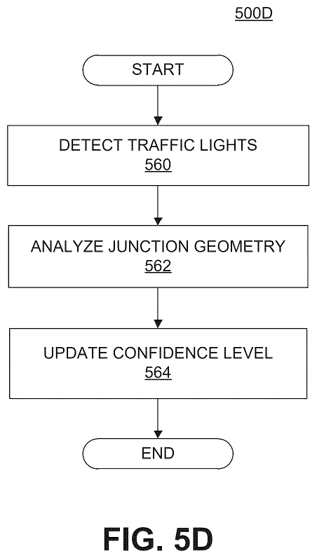

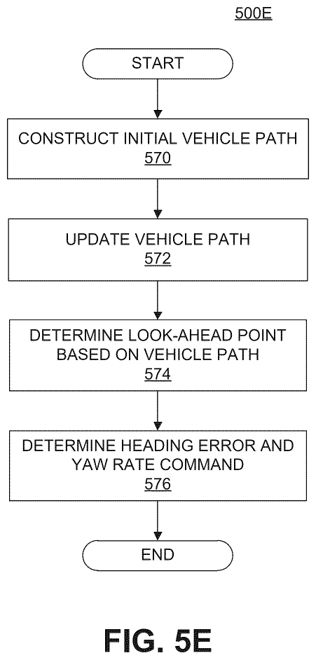

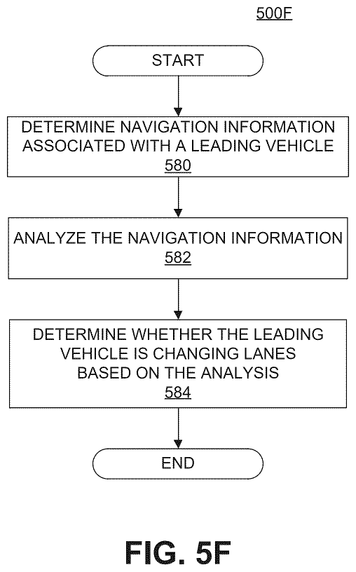

In one embodiment, monocular image analysis module 402 may store instructions (such as computer vision software) which, when executed by processing unit 110, performs monocular image analysis of a set of images acquired by one of image capture devices 122, 124, and 126. In some embodiments, processing unit 110 may combine information from a set of images with additional sensory information (e.g., information from radar, lidar, etc.) to perform the monocular image analysis. As described in connection with FIGS. 5A-5D below, monocular image analysis module 402 may include instructions for detecting a set of features within the set of images, such as lane markings, vehicles, pedestrians, road signs, highway exit ramps, traffic lights, hazardous objects, and any other feature associated with an environment of a vehicle. Based on the analysis, system 100 (e.g., via processing unit 110) may cause one or more navigational responses in vehicle 200, such as a turn, a lane shift, a change in acceleration, and the like, as discussed below in connection with navigational response module 408.

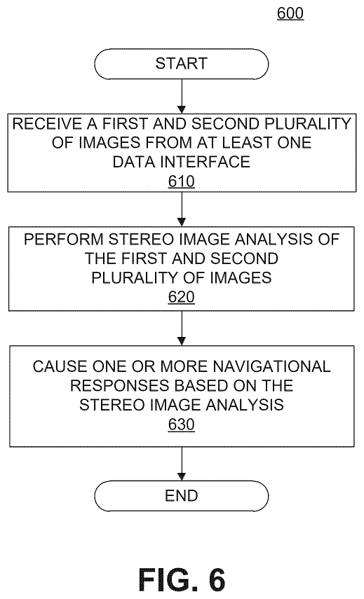

In one embodiment, stereo image analysis module 404 may store instructions (such as computer vision software) which, when executed by processing unit 110, performs stereo image analysis of first and second sets of images acquired by a combination of image capture devices selected from any of image capture devices 122, 124, and 126. In some embodiments, processing unit 110 may combine information from the first and second sets of images with additional sensory information (e.g., information from radar) to perform the stereo image analysis. For example, stereo image analysis module 404 may include instructions for performing stereo image analysis based on a first set of images acquired by image capture device 124 and a second set of images acquired by image capture device 126. As described in connection with FIG. 6 below, stereo image analysis module 404 may include instructions for detecting a set of features within the first and second sets of images, such as lane markings, vehicles, pedestrians, road signs, highway exit ramps, traffic lights, hazardous objects, and the like. Based on the analysis, processing unit 110 may cause one or more navigational responses in vehicle 200, such as a turn, a lane shift, a change in acceleration, and the like, as discussed below in connection with navigational response module 408. Furthermore, in some embodiments, stereo image analysis module 404 may implement techniques associated with a trained system (such as a neural network or a deep neural network) or an untrained system, such as a system that may be configured to use computer vision algorithms to detect and/or label objects in an environment from which sensory information was captured and processed. In one embodiment, stereo image analysis module 404 and/or other image processing modules may be configured to use a combination of a trained and untrained system.

In one embodiment, velocity and acceleration module 406 may store software configured to analyze data received from one or more computing and electromechanical devices in vehicle 200 that are configured to cause a change in velocity and/or acceleration of vehicle 200. For example, processing unit 110 may execute instructions associated with velocity and acceleration module 406 to calculate a target speed for vehicle 200 based on data derived from execution of monocular image analysis module 402 and/or stereo image analysis module 404. Such data may include, for example, a target position, velocity, and/or acceleration, the position and/or speed of vehicle 200 relative to a nearby vehicle, pedestrian, or road object, position information for vehicle 200 relative to lane markings of the road, and the like. In addition, processing unit 110 may calculate a target speed for vehicle 200 based on sensory input (e.g., information from radar) and input from other systems of vehicle 200, such as throttling system 220, braking system 230, and/or steering system 240 of vehicle 200. Based on the calculated target speed, processing unit 110 may transmit electronic signals to throttling system 220, braking system 230, and/or steering system 240 of vehicle 200 to trigger a change in velocity and/or acceleration by, for example, physically depressing the brake or easing up off the accelerator of vehicle 200.

In one embodiment, navigational response module 408 may store software executable by processing unit 110 to determine a desired navigational response based on data derived from execution of monocular image analysis module 402 and/or stereo image analysis module 404. Such data may include position and speed information associated with nearby vehicles, pedestrians, and road objects, target position information for vehicle 200, and the like. Additionally, in some embodiments, the navigational response may be based (partially or fully) on map data, a predetermined position of vehicle 200, and/or a relative velocity or a relative acceleration between vehicle 200 and one or more objects detected from execution of monocular image analysis module 402 and/or stereo image analysis module 404. Navigational response module 408 may also determine a desired navigational response based on sensory input (e.g., information from radar) and inputs from other systems of vehicle 200, such as throttling system 220, braking system 230, and steering system 240 of vehicle 200. Based on the desired navigational response, processing unit 110 may transmit electronic signals to throttling system 220, braking system 230, and steering system 240 of vehicle 200 to trigger a desired navigational response by, for example, turning the steering wheel of vehicle 200 to achieve a rotation of a predetermined angle. In some embodiments, processing unit 110 may use the output of navigational response module 408 (e.g., the desired navigational response) as an input to execution of velocity and acceleration module 406 for calculating a change in speed of vehicle 200.

Furthermore, any of the modules (e.g., modules 402, 404, and 406) disclosed herein may implement techniques associated with a trained system (such as a neural network or a deep neural network) or an untrained system.

FIG. 5A is a flowchart showing an exemplary process 500A for causing one or more navigational responses based on monocular image analysis, consistent with disclosed embodiments. At step 510, processing unit 110 may receive a plurality of images via data interface 128 between processing unit 110 and image acquisition unit 120. For instance, a camera included in image acquisition unit 120 (such as image capture device 122 having field of view 202) may capture a plurality of images of an area forward of vehicle 200 (or to the sides or rear of a vehicle, for example) and transmit them over a data connection (e.g., digital, wired, USB, wireless, Bluetooth, etc.) to processing unit 110. Processing unit 110 may execute monocular image analysis module 402 to analyze the plurality of images at step 520, as described in further detail in connection with FIGS. 5B-5D below. By performing the analysis, processing unit 110 may detect a set of features within the set of images, such as lane markings, vehicles, pedestrians, road signs, highway exit ramps, traffic lights, and the like.

Processing unit 110 may also execute monocular image analysis module 402 to detect various road hazards at step 520, such as, for example, parts of a truck tire, fallen road signs, loose cargo, small animals, and the like. Road hazards may vary in structure, shape, size, and color, which may make detection of such hazards more challenging. In some embodiments, processing unit 110 may execute monocular image analysis module 402 to perform multi-frame analysis on the plurality of images to detect road hazards. For example, processing unit 110 may estimate camera motion between consecutive image frames and calculate the disparities in pixels between the frames to construct a 3D-map of the road. Processing unit 110 may then use the 3D-map to detect the road surface, as well as hazards existing above the road surface.

At step 530, processing unit 110 may execute navigational response module 408 to cause one or more navigational responses in vehicle 200 based on the analysis performed at step 520 and the techniques as described above in connection with FIG. 4. Navigational responses may include, for example, a turn, a lane shift, a change in acceleration, and the like. In some embodiments, processing unit 110 may use data derived from execution of velocity and acceleration module 406 to cause the one or more navigational responses. Additionally, multiple navigational responses may occur simultaneously, in sequence, or any combination thereof. For instance, processing unit 110 may cause vehicle 200 to shift one lane over and then accelerate by, for example, sequentially transmitting control signals to steering system 240 and throttling system 220 of vehicle 200. Alternatively, processing unit 110 may cause vehicle 200 to brake while at the same time shifting lanes by, for example, simultaneously transmitting control signals to braking system 230 and steering system 240 of vehicle 200.

FIG. 5B is a flowchart showing an exemplary process 500B for detecting one or more vehicles and/or pedestrians in a set of images, consistent with disclosed embodiments. Processing unit 110 may execute monocular image analysis module 402 to implement process 500B. At step 540, processing unit 110 may determine a set of candidate objects representing possible vehicles and/or pedestrians. For example, processing unit 110 may scan one or more images, compare the images to one or more predetermined patterns, and identify within each image possible locations that may contain objects of interest (e.g., vehicles, pedestrians, or portions thereof). The predetermined patterns may be designed in such a way to achieve a high rate of “false hits” and a low rate of “misses.” For example, processing unit 110 may use a low threshold of similarity to predetermined patterns for identifying candidate objects as possible vehicles or pedestrians. Doing so may allow processing unit 110 to reduce the probability of missing (e.g., not identifying) a candidate object representing a vehicle or pedestrian.

At step 542, processing unit 110 may filter the set of candidate objects to exclude certain candidates (e.g., irrelevant or less relevant objects) based on classification criteria. Such criteria may be derived from various properties associated with object types stored in a database (e.g., a database stored in memory 140). Properties may include object shape, dimensions, texture, position (e.g., relative to vehicle 200), and the like. Thus, processing unit 110 may use one or more sets of criteria to reject false candidates from the set of candidate objects.

At step 544, processing unit 110 may analyze multiple frames of images to determine whether objects in the set of candidate objects represent vehicles and/or pedestrians. For example, processing unit 110 may track a detected candidate object across consecutive frames and accumulate frame-by-frame data associated with the detected object (e.g., size, position relative to vehicle 200, etc.). Additionally, processing unit 110 may estimate parameters for the detected object and compare the object's frame-by-frame position data to a predicted position.

At step 546, processing unit 110 may construct a set of measurements for the detected objects. Such measurements may include, for example, position, velocity, and acceleration values (relative to vehicle 200) associated with the detected objects. In some embodiments, processing unit 110 may construct the measurements based on estimation techniques using a series of time-based observations such as Kalman filters or linear quadratic estimation (LQE), and/or based on available modeling data for different object types (e.g., cars, trucks, pedestrians, bicycles, road signs, etc.). The Kalman filters may be based on a measurement of an object's scale, where the scale measurement is proportional to a time to collision (e.g., the amount of time for vehicle 200 to reach the object). Thus, by performing steps 540-546, processing unit 110 may identify vehicles and pedestrians appearing within the set of captured images and derive information (e.g., position, speed, size) associated with the vehicles and pedestrians. Based on the identification and the derived information, processing unit 110 may cause one or more navigational responses in vehicle 200, as described in connection with FIG. 5A, above.

At step 548, processing unit 110 may perform an optical flow analysis of one or more images to reduce the probabilities of detecting a “false hit” and missing a candidate object that represents a vehicle or pedestrian. The optical flow analysis may refer to, for example, analyzing motion patterns relative to vehicle 200 in the one or more images associated with other vehicles and pedestrians, and that are distinct from road surface motion. Processing unit 110 may calculate the motion of candidate objects by observing the different positions of the objects across multiple image frames, which are captured at different times. Processing unit 110 may use the position and time values as inputs into mathematical models for calculating the motion of the candidate objects. Thus, optical flow analysis may provide another method of detecting vehicles and pedestrians that are nearby vehicle 200. Processing unit 110 may perform optical flow analysis in combination with steps 540-546 to provide redundancy for detecting vehicles and pedestrians and increase the reliability of system 100.

FIG. 5C is a flowchart showing an exemplary process 500C for detecting road marks and/or lane geometry information in a set of images, consistent with disclosed embodiments. Processing unit 110 may execute monocular image analysis module 402 to implement process 500C. At step 550, processing unit 110 may detect a set of objects by scanning one or more images. To detect segments of lane markings, lane geometry information, and other pertinent road marks, processing unit 110 may filter the set of objects to exclude those determined to be irrelevant (e.g., minor potholes, small rocks, etc.). At step 552, processing unit 110 may group together the segments detected in step 550 belonging to the same road mark or lane mark. Based on the grouping, processing unit 110 may develop a model to represent the detected segments, such as a mathematical model.

At step 554, processing unit 110 may construct a set of measurements associated with the detected segments. In some embodiments, processing unit 110 may create a projection of the detected segments from the image plane onto the real-world plane. The projection may be characterized using a 3rd-degree polynomial having coefficients corresponding to physical properties such as the position, slope, curvature, and curvature derivative of the detected road. In generating the projection, processing unit 110 may take into account changes in the road surface, as well as pitch and roll rates associated with vehicle 200. In addition, processing unit 110 may model the road elevation by analyzing position and motion cues present on the road surface. Further, processing unit 110 may estimate the pitch and roll rates associated with vehicle 200 by tracking a set of feature points in the one or more images.

At step 556, processing unit 110 may perform multi-frame analysis by, for example, tracking the detected segments across consecutive image frames and accumulating frame-by-frame data associated with detected segments. As processing unit 110 performs multi-frame analysis, the set of measurements constructed at step 554 may become more reliable and associated with an increasingly higher confidence level. Thus, by performing steps 550, 552, 554, and 556, processing unit 110 may identify road marks appearing within the set of captured images and derive lane geometry information. Based on the identification and the derived information, processing unit 110 may cause one or more navigational responses in vehicle 200, as described in connection with FIG. 5A, above.

At step 558, processing unit 110 may consider additional sources of information to further develop a safety model for vehicle 200 in the context of its surroundings. Processing unit 110 may use the safety model to define a context in which system 100 may execute autonomous control of vehicle 200 in a safe manner. To develop the safety model, in some embodiments, processing unit 110 may consider the position and motion of other vehicles, the detected road edges and barriers, and/or general road shape descriptions extracted from map data (such as data from map database 160). By considering additional sources of information, processing unit 110 may provide redundancy for detecting road marks and lane geometry and increase the reliability of system 100.

FIG. 5D is a flowchart showing an exemplary process 500D for detecting traffic lights in a set of images, consistent with disclosed embodiments. Processing unit 110 may execute monocular image analysis module 402 to implement process 500D. At step 560, processing unit 110 may scan the set of images and identify objects appearing at locations in the images likely to contain traffic lights. For example, processing unit 110 may filter the identified objects to construct a set of candidate objects, excluding those objects unlikely to correspond to traffic lights. The filtering may be done based on various properties associated with traffic lights, such as shape, dimensions, texture, position (e.g., relative to vehicle 200), and the like. Such properties may be based on multiple examples of traffic lights and traffic control signals and stored in a database. In some embodiments, processing unit 110 may perform multi-frame analysis on the set of candidate objects reflecting possible traffic lights. For example, processing unit 110 may track the candidate objects across consecutive image frames, estimate the real-world position of the candidate objects, and filter out those objects that are moving (which are unlikely to be traffic lights). In some embodiments, processing unit 110 may perform color analysis on the candidate objects and identify the relative position of the detected colors appearing inside possible traffic lights.

At step 562, processing unit 110 may analyze the geometry of a junction. The analysis may be based on any combination of: (i) the number of lanes detected on either side of vehicle 200, (ii) markings (such as arrow marks) detected on the road, and (iii) descriptions of the junction extracted from map data (such as data from map database 160). Processing unit 110 may conduct the analysis using information derived from execution of monocular analysis module 402. In addition, Processing unit 110 may determine a correspondence between the traffic lights detected at step 560 and the lanes appearing near vehicle 200.

As vehicle 200 approaches the junction, at step 564, processing unit 110 may update the confidence level associated with the analyzed junction geometry and the detected traffic lights. For instance, the number of traffic lights estimated to appear at the junction as compared with the number actually appearing at the junction may impact the confidence level. Thus, based on the confidence level, processing unit 110 may delegate control to the driver of vehicle 200 in order to improve safety conditions. By performing steps 560, 562, and 564, processing unit 110 may identify traffic lights appearing within the set of captured images and analyze junction geometry information. Based on the identification and the analysis, processing unit 110 may cause one or more navigational responses in vehicle 200, as described in connection with FIG. 5A, above.

FIG. 5E is a flowchart showing an exemplary process 500E for causing one or more navigational responses in vehicle 200 based on a vehicle path, consistent with the disclosed embodiments. At step 570, processing unit 110 may construct an initial vehicle path associated with vehicle 200. The vehicle path may be represented using a set of points expressed in coordinates (x, z), and the distance dᵢ between two points in the set of points may fall in the range of 1 to 5 meters. In one embodiment, processing unit 110 may construct the initial vehicle path using two polynomials, such as left and right road polynomials. Processing unit 110 may calculate the geometric midpoint between the two polynomials and offset each point included in the resultant vehicle path by a predetermined offset (e.g., a smart lane offset), if any (an offset of zero may correspond to travel in the middle of a lane). The offset may be in a direction perpendicular to a segment between any two points in the vehicle path. In another embodiment, processing unit 110 may use one polynomial and an estimated lane width to offset each point of the vehicle path by half the estimated lane width plus a predetermined offset (e.g., a smart lane offset).

At step 572, processing unit 110 may update the vehicle path constructed at step 570. Processing unit 110 may reconstruct the vehicle path constructed at step 570 using a higher resolution, such that the distance dₖ between two points in the set of points representing the vehicle path is less than the distance dᵢ described above. For example, the distance dₖ may fall in the range of 0.1 to 0.3 meters. Processing unit 110 may reconstruct the vehicle path using a parabolic spline algorithm, which may yield a cumulative distance vector S corresponding to the total length of the vehicle path (i.e., based on the set of points representing the vehicle path).

At step 574, processing unit 110 may determine a look-ahead point (expressed in coordinates as (x₁, z₁)) based on the updated vehicle path constructed at step 572. Processing unit 110 may extract the look-ahead point from the cumulative distance vector S, and the look-ahead point may be associated with a look-ahead distance and look-ahead time. The look-ahead distance, which may have a lower bound ranging from 10 to 20 meters, may be calculated as the product of the speed of vehicle 200 and the look-ahead time. For example, as the speed of vehicle 200 decreases, the look-ahead distance may also decrease (e.g., until it reaches the lower bound). The look-ahead time, which may range from 0.5 to 1.5 seconds, may be inversely proportional to the gain of one or more control loops associated with causing a navigational response in vehicle 200, such as the heading error tracking control loop. For example, the gain of the heading error tracking control loop may depend on the bandwidth of a yaw rate loop, a steering actuator loop, car lateral dynamics, and the like. Thus, the higher the gain of the heading error tracking control loop, the lower the look-ahead time.

At step 576, processing unit 110 may determine a heading error and yaw rate command based on the look-ahead point determined at step 574. Processing unit 110 may determine the heading error by calculating the arctangent of the look-ahead point, e.g., arctan (x₁/z₁). Processing unit 110 may determine the yaw rate command as the product of the heading error and a high-level control gain. The high-level control gain may be equal to: (2/look-ahead time), if the look-ahead distance is not at the lower bound. Otherwise, the high-level control gain may be equal to: (2*speed of vehicle 200/look-ahead distance).

FIG. 5F is a flowchart showing an exemplary process 500F for determining whether a leading vehicle is changing lanes, consistent with the disclosed embodiments. At step 580, processing unit 110 may determine navigation information associated with a leading vehicle (e.g., a vehicle traveling ahead of vehicle 200). For example, processing unit 110 may determine the position, velocity (e.g., direction and speed), and/or acceleration of the leading vehicle, using the techniques described in connection with FIGS. 5A and 5B, above. Processing unit 110 may also determine one or more road polynomials, a look-ahead point (associated with vehicle 200), and/or a snail trail (e.g., a set of points describing a path taken by the leading vehicle), using the techniques described in connection with FIG. 5E, above.

At step 582, processing unit 110 may analyze the navigation information determined at step 580. In one embodiment, processing unit 110 may calculate the distance between a snail trail and a road polynomial (e.g., along the trail). If the variance of this distance along the trail exceeds a predetermined threshold (for example, 0.1 to 0.2 meters on a straight road, 0.3 to 0.4 meters on a moderately curvy road, and 0.5 to 0.6 meters on a road with sharp curves), processing unit 110 may determine that the leading vehicle is likely changing lanes. In the case where multiple vehicles are detected traveling ahead of vehicle 200, processing unit 110 may compare the snail trails associated with each vehicle. Based on the comparison, processing unit 110 may determine that a vehicle whose snail trail does not match with the snail trails of the other vehicles is likely changing lanes. Processing unit 110 may additionally compare the curvature of the snail trail (associated with the leading vehicle) with the expected curvature of the road segment in which the leading vehicle is traveling. The expected curvature may be extracted from map data (e.g., data from map database 160), from road polynomials, from other vehicles' snail trails, from prior knowledge about the road, and the like. If the difference in curvature of the snail trail and the expected curvature of the road segment exceeds a predetermined threshold, processing unit 110 may determine that the leading vehicle is likely changing lanes.

In another embodiment, processing unit 110 may compare the leading vehicle's instantaneous position with the look-ahead point (associated with vehicle 200) over a specific period of time (e.g., 0.5 to 1.5 seconds). If the distance between the leading vehicle's instantaneous position and the look-ahead point varies during the specific period of time, and the cumulative sum of variation exceeds a predetermined threshold (for example, 0.3 to 0.4 meters on a straight road, 0.7 to 0.8 meters on a moderately curvy road, and 1.3 to 1.7 meters on a road with sharp curves), processing unit 110 may determine that the leading vehicle is likely changing lanes. In another embodiment, processing unit 110 may analyze the geometry of the snail trail by comparing the lateral distance traveled along the trail with the expected curvature of the snail trail. The expected radius of curvature may be determined according to the calculation: (δ_{z}²+δₓ²)/2/(δₓ), where δₓ represents the lateral distance traveled and δ_{z} represents the longitudinal distance traveled. If the difference between the lateral distance traveled and the expected curvature exceeds a predetermined threshold (e.g., 500 to 700 meters), processing unit 110 may determine that the leading vehicle is likely changing lanes. In another embodiment, processing unit 110 may analyze the position of the leading vehicle. If the position of the leading vehicle obscures a road polynomial (e.g., the leading vehicle is overlaid on top of the road polynomial), then processing unit 110 may determine that the leading vehicle is likely changing lanes. In the case where the position of the leading vehicle is such that, another vehicle is detected ahead of the leading vehicle and the snail trails of the two vehicles are not parallel, processing unit 110 may determine that the (closer) leading vehicle is likely changing lanes.

At step 584, processing unit 110 may determine whether or not leading vehicle 200 is changing lanes based on the analysis performed at step 582. For example, processing unit 110 may make the determination based on a weighted average of the individual analyses performed at step 582. Under such a scheme, for example, a decision by processing unit 110 that the leading vehicle is likely changing lanes based on a particular type of analysis may be assigned a value of “1” (and “0” to represent a determination that the leading vehicle is not likely changing lanes). Different analyses performed at step 582 may be assigned different weights, and the disclosed embodiments are not limited to any particular combination of analyses and weights.

FIG. 6 is a flowchart showing an exemplary process 600 for causing one or more navigational responses based on stereo image analysis, consistent with disclosed embodiments. At step 610, processing unit 110 may receive a first and second plurality of images via data interface 128. For example, cameras included in image acquisition unit 120 (such as image capture devices 122 and 124 having fields of view 202 and 204) may capture a first and second plurality of images of an area forward of vehicle 200 and transmit them over a digital connection (e.g., USB, wireless, Bluetooth, etc.) to processing unit 110. In some embodiments, processing unit 110 may receive the first and second plurality of images via two or more data interfaces. The disclosed embodiments are not limited to any particular data interface configurations or protocols.

At step 620, processing unit 110 may execute stereo image analysis module 404 to perform stereo image analysis of the first and second plurality of images to create a 3D map of the road in front of the vehicle and detect features within the images, such as lane markings, vehicles, pedestrians, road signs, highway exit ramps, traffic lights, road hazards, and the like. Stereo image analysis may be performed in a manner similar to the steps described in connection with FIGS. 5A-5D, above. For example, processing unit 110 may execute stereo image analysis module 404 to detect candidate objects (e.g., vehicles, pedestrians, road marks, traffic lights, road hazards, etc.) within the first and second plurality of images, filter out a subset of the candidate objects based on various criteria, and perform multi-frame analysis, construct measurements, and determine a confidence level for the remaining candidate objects. In performing the steps above, processing unit 110 may consider information from both the first and second plurality of images, rather than information from one set of images alone. For example, processing unit 110 may analyze the differences in pixel-level data (or other data subsets from among the two streams of captured images) for a candidate object appearing in both the first and second plurality of images. As another example, processing unit 110 may estimate a position and/or velocity of a candidate object (e.g., relative to vehicle 200) by observing that the object appears in one of the plurality of images but not the other or relative to other differences that may exist relative to objects appearing if the two image streams. For example, position, velocity, and/or acceleration relative to vehicle 200 may be determined based on trajectories, positions, movement characteristics, etc. of features associated with an object appearing in one or both of the image streams.

At step 630, processing unit 110 may execute navigational response module 408 to cause one or more navigational responses in vehicle 200 based on the analysis performed at step 620 and the techniques as described above in connection with FIG. 4. Navigational responses may include, for example, a turn, a lane shift, a change in acceleration, a change in velocity, braking, and the like. In some embodiments, processing unit 110 may use data derived from execution of velocity and acceleration module 406 to cause the one or more navigational responses. Additionally, multiple navigational responses may occur simultaneously, in sequence, or any combination thereof.

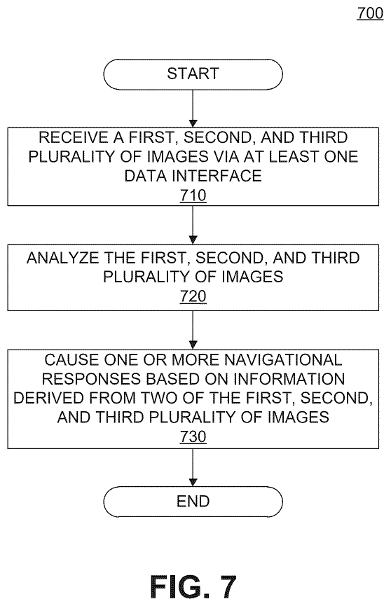

FIG. 7 is a flowchart showing an exemplary process 700 for causing one or more navigational responses based on an analysis of three sets of images, consistent with disclosed embodiments. At step 710, processing unit 110 may receive a first, second, and third plurality of images via data interface 128. For instance, cameras included in image acquisition unit 120 (such as image capture devices 122, 124, and 126 having fields of view 202, 204, and 206) may capture a first, second, and third plurality of images of an area forward and/or to the side of vehicle 200 and transmit them over a digital connection (e.g., USB, wireless, Bluetooth, etc.) to processing unit 110. In some embodiments, processing unit 110 may receive the first, second, and third plurality of images via three or more data interfaces. For example, each of image capture devices 122, 124, 126 may have an associated data interface for communicating data to processing unit 110. The disclosed embodiments are not limited to any particular data interface configurations or protocols.

At step 720, processing unit 110 may analyze the first, second, and third plurality of images to detect features within the images, such as lane markings, vehicles, pedestrians, road signs, highway exit ramps, traffic lights, road hazards, and the like. The analysis may be performed in a manner similar to the steps described in connection with FIGS. 5A-5D and 6, above. For instance, processing unit 110 may perform monocular image analysis (e.g., via execution of monocular image analysis module 402 and based on the steps described in connection with FIGS. 5A-5D, above) on each of the first, second, and third plurality of images. Alternatively, processing unit 110 may perform stereo image analysis (e.g., via execution of stereo image analysis module 404 and based on the steps described in connection with FIG. 6, above) on the first and second plurality of images, the second and third plurality of images, and/or the first and third plurality of images. The processed information corresponding to the analysis of the first, second, and/or third plurality of images may be combined. In some embodiments, processing unit 110 may perform a combination of monocular and stereo image analyses. For example, processing unit 110 may perform monocular image analysis (e.g., via execution of monocular image analysis module 402) on the first plurality of images and stereo image analysis (e.g., via execution of stereo image analysis module 404) on the second and third plurality of images. The configuration of image capture devices 122, 124, and 126—including their respective locations and fields of view 202, 204, and 206—may influence the types of analyses conducted on the first, second, and third plurality of images. The disclosed embodiments are not limited to a particular configuration of image capture devices 122, 124, and 126, or the types of analyses conducted on the first, second, and third plurality of images.

In some embodiments, processing unit 110 may perform testing on system 100 based on the images acquired and analyzed at steps 710 and 720. Such testing may provide an indicator of the overall performance of system 100 for certain configurations of image capture devices 122, 124, and 126. For example, processing unit 110 may determine the proportion of “false hits” (e.g., cases where system 100 incorrectly determined the presence of a vehicle or pedestrian) and “misses.”

At step 730, processing unit 110 may cause one or more navigational responses in vehicle 200 based on information derived from two of the first, second, and third plurality of images. Selection of two of the first, second, and third plurality of images may depend on various factors, such as, for example, the number, types, and sizes of objects detected in each of the plurality of images. Processing unit 110 may also make the selection based on image quality and resolution, the effective field of view reflected in the images, the number of captured frames, the extent to which one or more objects of interest actually appear in the frames (e.g., the percentage of frames in which an object appears, the proportion of the object that appears in each such frame, etc.), and the like.

In some embodiments, processing unit 110 may select information derived from two of the first, second, and third plurality of images by determining the extent to which information derived from one image source is consistent with information derived from other image sources. For example, processing unit 110 may combine the processed information derived from each of image capture devices 122, 124, and 126 (whether by monocular analysis, stereo analysis, or any combination of the two) and determine visual indicators (e.g., lane markings, a detected vehicle and its location and/or path, a detected traffic light, etc.) that are consistent across the images captured from each of image capture devices 122, 124, and 126. Processing unit 110 may also exclude information that is inconsistent across the captured images (e.g., a vehicle changing lanes, a lane model indicating a vehicle that is too close to vehicle 200, etc.). Thus, processing unit 110 may select information derived from two of the first, second, and third plurality of images based on the determinations of consistent and inconsistent information.

Navigational responses may include, for example, a turn, a lane shift, a change in acceleration, and the like. Processing unit 110 may cause the one or more navigational responses based on the analysis performed at step 720 and the techniques as described above in connection with FIG. 4. Processing unit 110 may also use data derived from execution of velocity and acceleration module 406 to cause the one or more navigational responses. In some embodiments, processing unit 110 may cause the one or more navigational responses based on a relative position, relative velocity, and/or relative acceleration between vehicle 200 and an object detected within any of the first, second, and third plurality of images. Multiple navigational responses may occur simultaneously, in sequence, or any combination thereof.

### Sparse Road Model for Autonomous Vehicle Navigation

In some embodiments, the disclosed systems and methods may use a sparse map for autonomous vehicle navigation. In particular, the sparse map may be for autonomous vehicle navigation along a road segment. For example, the sparse map may provide sufficient information for navigating an autonomous vehicle without storing and/or updating a large quantity of data. As discussed below in further detail, an autonomous vehicle may use the sparse map to navigate one or more roads based on one or more stored trajectories.

### Sparse Map for Autonomous Vehicle Navigation

In some embodiments, the disclosed systems and methods may generate a sparse map for autonomous vehicle navigation. For example, the sparse map may provide sufficient information for navigation without requiring excessive data storage or data transfer rates. As discussed below in further detail, a vehicle (which may be an autonomous vehicle) may use the sparse map to navigate one or more roads. For example, in some embodiments, the sparse map may include data related to a road and potentially landmarks along the road that may be sufficient for vehicle navigation, but which also exhibit small data footprints. For example, the sparse data maps described in detail below may require significantly less storage space and data transfer bandwidth as compared with digital maps including detailed map information, such as image data collected along a road.

For example, rather than storing detailed representations of a road segment, the sparse data map may store three-dimensional polynomial representations of preferred vehicle paths along a road. These paths may require very little data storage space. Further, in the described sparse data maps, landmarks may be identified and included in the sparse map road model to aid in navigation. These landmarks may be located at any spacing suitable for enabling vehicle navigation, but in some cases, such landmarks need not be identified and included in the model at high densities and short spacings. Rather, in some cases, navigation may be possible based on landmarks that are spaced apart by at least 50 meters, at least 100 meters, at least 500 meters, at least 1 kilometer, or at least 2 kilometers. As will be discussed in more detail in other sections, the sparse map may be generated based on data collected or measured by vehicles equipped with various sensors and devices, such as image capture devices, Global Positioning System sensors, motion sensors, etc., as the vehicles travel along roadways. In some cases, the sparse map may be generated based on data collected during multiple drives of one or more vehicles along a particular roadway. Generating a sparse map using multiple drives of one or more vehicles may be referred to as “crowdsourcing” a sparse map.

Consistent with disclosed embodiments, an autonomous vehicle system may use a sparse map for navigation. For example, the disclosed systems and methods may distribute a sparse map for generating a road navigation model for an autonomous vehicle and may navigate an autonomous vehicle along a road segment using a sparse map and/or a generated road navigation model. Sparse maps consistent with the present disclosure may include one or more three-dimensional contours that may represent predetermined trajectories that autonomous vehicles may traverse as they move along associated road segments.

Sparse maps consistent with the present disclosure may also include data representing one or more road features. Such road features may include recognized landmarks, road signature profiles, and any other road-related features useful in navigating a vehicle. Sparse maps consistent with the present disclosure may enable autonomous navigation of a vehicle based on relatively small amounts of data included in the sparse map. For example, rather than including detailed representations of a road, such as road edges, road curvature, images associated with road segments, or data detailing other physical features associated with a road segment, the disclosed embodiments of the sparse map may require relatively little storage space (and relatively little bandwidth when portions of the sparse map are transferred to a vehicle) but may still adequately provide for autonomous vehicle navigation. The small data footprint of the disclosed sparse maps, discussed in further detail below, may be achieved in some embodiments by storing representations of road-related elements that require small amounts of data but still enable autonomous navigation.

For example, rather than storing detailed representations of various aspects of a road, the disclosed sparse maps may store polynomial representations of one or more trajectories that a vehicle may follow along the road. Thus, rather than storing (or having to transfer) details regarding the physical nature of the road to enable navigation along the road, using the disclosed sparse maps, a vehicle may be navigated along a particular road segment without, in some cases, having to interpret physical aspects of the road, but rather, by aligning its path of travel with a trajectory (e.g., a polynomial spline) along the particular road segment. In this way, the vehicle may be navigated based mainly upon the stored trajectory (e.g., a polynomial spline) that may require much less storage space than an approach involving storage of roadway images, road parameters, road layout, etc.

In addition to the stored polynomial representations of trajectories along a road segment, the disclosed sparse maps may also include small data objects that may represent a road feature. In some embodiments, the small data objects may include digital signatures, which are derived from a digital image (or a digital signal) that was obtained by a sensor (e.g., a camera or other sensor, such as a suspension sensor) onboard a vehicle traveling along the road segment. The digital signature may have a reduced size relative to the signal that was acquired by the sensor. In some embodiments, the digital signature may be created to be compatible with a classifier function that is configured to detect and to identify the road feature from the signal that is acquired by the sensor, for example, during a subsequent drive. In some embodiments, a digital signature may be created such that the digital signature has a footprint that is as small as possible, while retaining the ability to correlate or match the road feature with the stored signature based on an image (or a digital signal generated by a sensor, if the stored signature is not based on an image and/or includes other data) of the road feature that is captured by a camera onboard a vehicle traveling along the same road segment at a subsequent time.

In some embodiments, a size of the data objects may be further associated with a uniqueness of the road feature. For example, for a road feature that is detectable by a camera onboard a vehicle, and where the camera system onboard the vehicle is coupled to a classifier that is capable of distinguishing the image data corresponding to that road feature as being associated with a particular type of road feature, for example, a road sign, and where such a road sign is locally unique in that area (e.g., there is no identical road sign or road sign of the same type nearby), it may be sufficient to store data indicating the type of the road feature and its location.

As will be discussed in further detail below, road features (e.g., landmarks along a road segment) may be stored as small data objects that may represent a road feature in relatively few bytes, while at the same time providing sufficient information for recognizing and using such a feature for navigation. In one example, a road sign may be identified as a recognized landmark on which navigation of a vehicle may be based. A representation of the road sign may be stored in the sparse map to include, e.g., a few bytes of data indicating a type of landmark (e.g., a stop sign) and a few bytes of data indicating a location of the landmark (e.g., coordinates). Navigating based on such data-light representations of the landmarks (e.g., using representations sufficient for locating, recognizing, and navigating based upon the landmarks) may provide a desired level of navigational functionality associated with sparse maps without significantly increasing the data overhead associated with the sparse maps. This lean representation of landmarks (and other road features) may take advantage of the sensors and processors included onboard such vehicles that are configured to detect, identify, and/or classify certain road features.

When, for example, a sign or even a particular type of a sign is locally unique (e.g., when there is no other sign or no other sign of the same type) in a given area, the sparse map may use data indicating a type of a landmark (a sign or a specific type of sign), and during navigation (e.g., autonomous navigation) when a camera onboard an autonomous vehicle captures an image of the area including a sign (or of a specific type of sign), the processor may process the image, detect the sign (if indeed present in the image), classify the image as a sign (or as a specific type of sign), and correlate the location of the image with the location of the sign as stored in the sparse map.

The sparse map may include any suitable representation of objects identified along a road segment. In some cases, the objects may be referred to as semantic objects or non-semantic objects. Semantic objects may include, for example, objects associated with a predetermined type classification. This type classification may be useful in reducing the amount of data required to describe the semantic object recognized in an environment, which can be beneficial both in the harvesting phase (e.g., to reduce costs associated with bandwidth use for transferring drive information from a plurality of harvesting vehicles to a server) and during the navigation phase (e.g., reduction of map data can speed transfer of map tiles from a server to a navigating vehicle and can also reduce costs associated with bandwidth use for such transfers). Semantic object classification types may be assigned to any type of objects or features that are expected to be encountered along a roadway.

Semantic objects may further be divided into two or more logical groups. For example, in some cases, one group of semantic object types may be associated with predetermined dimensions. Such semantic objects may include certain speed limit signs, yield signs, merge signs, stop signs, traffic lights, directional arrows on a roadway, manhole covers, or any other type of object that may be associated with a standardized size. One benefit offered by such semantic objects is that very little data may be needed to represent/fully define the objects. For example, if a standardized size of a speed limit size is known, then a harvesting vehicle may need only identify (through analysis of a captured image) the presence of a speed limit sign (a recognized type) along with an indication of a position of the detected speed limit sign (e.g., a 2D position in the captured image (or, alternatively, a 3D position in real world coordinates) of a center of the sign or a certain corner of the sign) to provide sufficient information for map generation on the server side. Where 2D image positions are transmitted to the server, a position associated with the captured image where the sign was detected may also be transmitted so the server can determine a real-world position of the sign (e.g., through structure in motion techniques using multiple captured images from one or more harvesting vehicles). Even with this limited information (requiring just a few bytes to define each detected object), the server may construct the map including a fully represented speed limit sign based on the type classification (representative of a speed limit sign) received from one or more harvesting vehicles along with the position information for the detected sign.

Semantic objects may also include other recognized object or feature types that are not associated with certain standardized characteristics. Such objects or features may include potholes, tar seams, light poles, non-standardized signs, curbs, trees, tree branches, or any other type of recognized object type with one or more variable characteristics (e.g., variable dimensions). In such cases, in addition to transmitting to a server an indication of the detected object or feature type (e.g., pothole, pole, etc.) and position information for the detected object or feature, a harvesting vehicle may also transmit an indication of a size of the object or feature. The size may be expressed in 2D image dimensions (e.g., with a bounding box or one or more dimension values) or real-world dimensions (determined through structure in motion calculations, based on LIDAR or RADAR system outputs, based on trained neural network outputs, etc.).

Non-semantic objects or features may include any detectable objects or features that fall outside of a recognized category or type, but that still may provide valuable information in map generation. In some cases, such non-semantic features may include a detected corner of a building or a corner of a detected window of a building, a unique stone or object near a roadway, a concrete splatter in a roadway shoulder, or any other detectable object or feature. Upon detecting such an object or feature one or more harvesting vehicles may transmit to a map generation server a location of one or more points (2D image points or 3D real world points) associated with the detected object/feature. Additionally, a compressed or simplified image segment (e.g., an image hash) may be generated for a region of the captured image including the detected object or feature. This image hash may be calculated based on a predetermined image processing algorithm and may form an effective signature for the detected non-semantic object or feature. Such a signature may be useful for navigation relative to a sparse map including the non-semantic feature or object, as a vehicle traversing the roadway may apply an algorithm similar to the algorithm used to generate the image hash in order to confirm/verify the presence in a captured image of the mapped non-semantic feature or object. Using this technique, non-semantic features may add to the richness of the sparse maps (e.g., to enhance their usefulness in navigation) without adding significant data overhead.

As noted, target trajectories may be stored in the sparse map. These target trajectories (e.g., 3D splines) may represent the preferred or recommended paths for each available lane of a roadway, each valid pathway through a junction, for merges and exits, etc. In addition to target trajectories, other road feature may also be detected, harvested, and incorporated in the sparse maps in the form of representative splines. Such features may include, for example, road edges, lane markings, curbs, guardrails, or any other objects or features that extend along a roadway or road segment.

### Generating a Sparse Map

In some embodiments, a sparse map may include at least one line representation of a road surface feature extending along a road segment and a plurality of landmarks associated with the road segment. In certain aspects, the sparse map may be generated via “crowdsourcing,” for example, through image analysis of a plurality of images acquired as one or more vehicles traverse the road segment.

FIG. 8 shows a sparse map 800 that one or more vehicles, e.g., vehicle 200 (which may be an autonomous vehicle), may access for providing autonomous vehicle navigation. Sparse map 800 may be stored in a memory, such as memory 140 or 150. Such memory devices may include any types of non-transitory storage devices or computer-readable media. For example, in some embodiments, memory 140 or 150 may include hard drives, compact discs, flash memory, magnetic based memory devices, optical based memory devices, etc. In some embodiments, sparse map 800 may be stored in a database (e.g., map database 160) that may be stored in memory 140 or 150, or other types of storage devices.

In some embodiments, sparse map 800 may be stored on a storage device or a non-transitory computer-readable medium provided onboard vehicle 200 (e.g., a storage device included in a navigation system onboard vehicle 200). A processor (e.g., processing unit 110) provided on vehicle 200 may access sparse map 800 stored in the storage device or computer-readable medium provided onboard vehicle 200 in order to generate navigational instructions for guiding the autonomous vehicle 200 as the vehicle traverses a road segment.

Sparse map 800 need not be stored locally with respect to a vehicle, however. In some embodiments, sparse map 800 may be stored on a storage device or computer-readable medium provided on a remote server that communicates with vehicle 200 or a device associated with vehicle 200. A processor (e.g., processing unit 110) provided on vehicle 200 may receive data included in sparse map 800 from the remote server and may execute the data for guiding the autonomous driving of vehicle 200. In such embodiments, the remote server may store all of sparse map 800 or only a portion thereof. Accordingly, the storage device or computer-readable medium provided onboard vehicle 200 and/or onboard one or more additional vehicles may store the remaining portion(s) of sparse map 800.

Furthermore, in such embodiments, sparse map 800 may be made accessible to a plurality of vehicles traversing various road segments (e.g., tens, hundreds, thousands, or millions of vehicles, etc.). It should be noted also that sparse map 800 may include multiple sub-maps. For example, in some embodiments, sparse map 800 may include hundreds, thousands, millions, or more, of sub-maps (e.g., map tiles) that may be used in navigating a vehicle. Such sub-maps may be referred to as local maps or map tiles, and a vehicle traveling along a roadway may access any number of local maps relevant to a location in which the vehicle is traveling. The local map sections of sparse map 800 may be stored with a Global Navigation Satellite System (GNSS) key as an index to the database of sparse map 800. Thus, while computation of steering angles for navigating a host vehicle in the present system may be performed without reliance upon a GNSS position of the host vehicle, road features, or landmarks, such GNSS information may be used for retrieval of relevant local maps.

In general, sparse map 800 may be generated based on data (e.g., drive information) collected from one or more vehicles as they travel along roadways. For example, using sensors aboard the one or more vehicles (e.g., cameras, speedometers, GPS, accelerometers, etc.), the trajectories that the one or more vehicles travel along a roadway may be recorded, and the polynomial representation of a preferred trajectory for vehicles making subsequent trips along the roadway may be determined based on the collected trajectories travelled by the one or more vehicles. Similarly, data collected by the one or more vehicles may aid in identifying potential landmarks along a particular roadway. Data collected from traversing vehicles may also be used to identify road profile information, such as road width profiles, road roughness profiles, traffic line spacing profiles, road conditions, etc. Using the collected information, sparse map 800 may be generated and distributed (e.g., for local storage or via on-the-fly data transmission) for use in navigating one or more autonomous vehicles. However, in some embodiments, map generation may not end upon initial generation of the map. As will be discussed in greater detail below, sparse map 800 may be continuously or periodically updated based on data collected from vehicles as those vehicles continue to traverse roadways included in sparse map 800.

Data recorded in sparse map 800 may include position information based on Global Positioning System (GPS) data. For example, location information may be included in sparse map 800 for various map elements, including, for example, landmark locations, road profile locations, etc. Locations for map elements included in sparse map 800 may be obtained using GPS data collected from vehicles traversing a roadway. For example, a vehicle passing an identified landmark may determine a location of the identified landmark using GPS position information associated with the vehicle and a determination of a location of the identified landmark relative to the vehicle (e.g., based on image analysis of data collected from one or more cameras on board the vehicle). Such location determinations of an identified landmark (or any other feature included in sparse map 800) may be repeated as additional vehicles pass the location of the identified landmark. Some or all of the additional location determinations may be used to refine the location information stored in sparse map 800 relative to the identified landmark. For example, in some embodiments, multiple position measurements relative to a particular feature stored in sparse map 800 may be averaged together. Any other mathematical operations, however, may also be used to refine a stored location of a map element based on a plurality of determined locations for the map element.

In a particular example, harvesting vehicles may traverse a particular road segment. Each harvesting vehicle captures images of their respective environments. The images may be collected at any suitable frame capture rate (e.g., 9 Hz, etc.). Image analysis processor(s) aboard each harvesting vehicle analyze the captured images to detect the presence of semantic and/or non-semantic features/objects. At a high level, the harvesting vehicles transmit to a mapping-server indications of detections of the semantic and/or non-semantic objects/features along with positions associated with those objects/features. In more detail, type indicators, dimension indicators, etc. may be transmitted together with the position information. The position information may include any suitable information for enabling the mapping server to aggregate the detected objects/features into a sparse map useful in navigation. In some cases, the position information may include one or more 2D image positions (e.g., X-Y pixel locations) in a captured image where the semantic or non-semantic features/objects were detected. Such image positions may correspond to a center of the feature/object, a corner, etc. In this scenario, to aid the mapping server in reconstructing the drive information and aligning the drive information from multiple harvesting vehicles, each harvesting vehicle may also provide the server with a location (e.g., a GPS location) where each image was captured.

In other cases, the harvesting vehicle may provide to the server one or more 3D real world points associated with the detected objects/features. Such 3D points may be relative to a predetermined origin (such as an origin of a drive segment) and may be determined through any suitable technique. In some cases, a structure in motion technique may be used to determine the 3D real world position of a detected object/feature. For example, a certain object such as a particular speed limit sign may be detected in two or more captured images. Using information such as the known ego motion (speed, trajectory, GPS position, etc.) of the harvesting vehicle between the captured images, along with observed changes of the speed limit sign in the captured images (change in X-Y pixel location, change in size, etc.), the real-world position of one or more points associated with the speed limit sign may be determined and passed along to the mapping server. Such an approach is optional, as it requires more computation on the part of the harvesting vehicle systems. The sparse map of the disclosed embodiments may enable autonomous navigation of a vehicle using relatively small amounts of stored data. In some embodiments, sparse map 800 may have a data density (e.g., including data representing the target trajectories, landmarks, and any other stored road features) of less than 2 MB per kilometer of roads, less than 1 MB per kilometer of roads, less than 500 kB per kilometer of roads, or less than 100 kB per kilometer of roads. In some embodiments, the data density of sparse map 800 may be less than 10 kB per kilometer of roads or even less than 2 kB per kilometer of roads (e.g., 1.6 kB per kilometer), or no more than 10 kB per kilometer of roads, or no more than 20 kB per kilometer of roads. In some embodiments, most, if not all, of the roadways of the United States may be navigated autonomously using a sparse map having a total of 4 GB or less of data. These data density values may represent an average over an entire sparse map 800, over a local map within sparse map 800, and/or over a particular road segment within sparse map 800.

As noted, sparse map 800 may include representations of a plurality of target trajectories 810 for guiding autonomous driving or navigation along a road segment. Such target trajectories may be stored as three-dimensional splines. The target trajectories stored in sparse map 800 may be determined based on two or more reconstructed trajectories of prior traversals of vehicles along a particular road segment, for example. A road segment may be associated with a single target trajectory or multiple target trajectories. For example, on a two lane road, a first target trajectory may be stored to represent an intended path of travel along the road in a first direction, and a second target trajectory may be stored to represent an intended path of travel along the road in another direction (e.g., opposite to the first direction). Additional target trajectories may be stored with respect to a particular road segment. For example, on a multi-lane road one or more target trajectories may be stored representing intended paths of travel for vehicles in one or more lanes associated with the multi-lane road. In some embodiments, each lane of a multi-lane road may be associated with its own target trajectory. In other embodiments, there may be fewer target trajectories stored than lanes present on a multi-lane road. In such cases, a vehicle navigating the multi-lane road may use any of the stored target trajectories to guides its navigation by taking into account an amount of lane offset from a lane for which a target trajectory is stored (e.g., if a vehicle is traveling in the left most lane of a three lane highway, and a target trajectory is stored only for the middle lane of the highway, the vehicle may navigate using the target trajectory of the middle lane by accounting for the amount of lane offset between the middle lane and the left-most lane when generating navigational instructions).

In some embodiments, the target trajectory may represent an ideal path that a vehicle should take as the vehicle travels. The target trajectory may be located, for example, at an approximate center of a lane of travel. In other cases, the target trajectory may be located elsewhere relative to a road segment. For example, a target trajectory may approximately coincide with a center of a road, an edge of a road, or an edge of a lane, etc. In such cases, navigation based on the target trajectory may include a determined amount of offset to be maintained relative to the location of the target trajectory. Moreover, in some embodiments, the determined amount of offset to be maintained relative to the location of the target trajectory may differ based on a type of vehicle (e.g., a passenger vehicle including two axles may have a different offset from a truck including more than two axles along at least a portion of the target trajectory).

Sparse map 800 may also include data relating to a plurality of predetermined landmarks 820 associated with particular road segments, local maps, etc. As discussed in greater detail below, these landmarks may be used in navigation of the autonomous vehicle. For example, in some embodiments, the landmarks may be used to determine a current position of the vehicle relative to a stored target trajectory. With this position information, the autonomous vehicle may be able to adjust a heading direction to match a direction of the target trajectory at the determined location.

The plurality of landmarks 820 may be identified and stored in sparse map 800 at any suitable spacing. In some embodiments, landmarks may be stored at relatively high densities (e.g., every few meters or more). In some embodiments, however, significantly larger landmark spacing values may be employed. For example, in sparse map 800, identified (or recognized) landmarks may be spaced apart by 10 meters, 20 meters, 50 meters, 100 meters, 1 kilometer, or 2 kilometers. In some cases, the identified landmarks may be located at distances of even more than 2 kilometers apart.

Between landmarks, and therefore between determinations of vehicle position relative to a target trajectory, the vehicle may navigate based on dead reckoning in which the vehicle uses sensors to determine its ego motion and estimate its position relative to the target trajectory. Because errors may accumulate during navigation by dead reckoning, over time the position determinations relative to the target trajectory may become increasingly less accurate. The vehicle may use landmarks occurring in sparse map 800 (and their known locations) to remove the dead reckoning-induced errors in position determination. In this way, the identified landmarks included in sparse map 800 may serve as navigational anchors from which an accurate position of the vehicle relative to a target trajectory may be determined. Because a certain amount of error may be acceptable in position location, an identified landmark need not always be available to an autonomous vehicle. Rather, suitable navigation may be possible even based on landmark spacings, as noted above, of 10 meters, 20 meters, 50 meters, 100 meters, 500 meters, 1 kilometer, 2 kilometers, or more. In some embodiments, a density of 1 identified landmark every 1 km of road may be sufficient to maintain a longitudinal position determination accuracy within 1 m. Thus, not every potential landmark appearing along a road segment need be stored in sparse map 800.

Moreover, in some embodiments, lane markings may be used for localization of the vehicle during landmark spacings. By using lane markings during landmark spacings, the accumulation of errors during navigation by dead reckoning may be minimized.

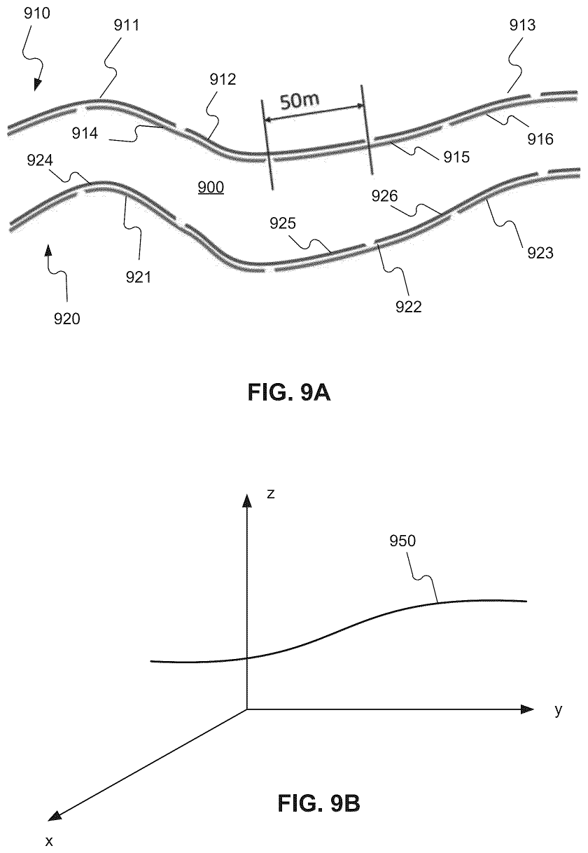

In addition to target trajectories and identified landmarks, sparse map 800 may include information relating to various other road features. For example, FIG. 9A illustrates a representation of curves along a particular road segment that may be stored in sparse map 800. In some embodiments, a single lane of a road may be modeled by a three-dimensional polynomial description of left and right sides of the road. Such polynomials representing left and right sides of a single lane are shown in FIG. 9A. Regardless of how many lanes a road may have, the road may be represented using polynomials in a way similar to that illustrated in FIG. 9A. For example, left and right sides of a multi-lane road may be represented by polynomials similar to those shown in FIG. 9A, and intermediate lane markings included on a multi-lane road (e.g., dashed markings representing lane boundaries, solid yellow lines representing boundaries between lanes traveling in different directions, etc.) may also be represented using polynomials such as those shown in FIG. 9A.

As shown in FIG. 9A, a lane 900 may be represented using polynomials (e.g., a first order, second order, third order, or any suitable order polynomials). For illustration, lane 900 is shown as a two-dimensional lane and the polynomials are shown as two-dimensional polynomials. As depicted in FIG. 9A, lane 900 includes a left side 910 and a right side 920. In some embodiments, more than one polynomial may be used to represent a location of each side of the road or lane boundary. For example, each of left side 910 and right side 920 may be represented by a plurality of polynomials of any suitable length. In some cases, the polynomials may have a length of about 100 m, although other lengths greater than or less than 100 m may also be used. Additionally, the polynomials can overlap with one another in order to facilitate seamless transitions in navigating based on subsequently encountered polynomials as a host vehicle travels along a roadway. For example, each of left side 910 and right side 920 may be represented by a plurality of third order polynomials separated into segments of about 100 meters in length (an example of the first predetermined range), and overlapping each other by about 50 meters. The polynomials representing the left side 910 and the right side 920 may or may not have the same order. For example, in some embodiments, some polynomials may be second order polynomials, some may be third order polynomials, and some may be fourth order polynomials.

In the example shown in FIG. 9A, left side 910 of lane 900 is represented by two groups of third order polynomials. The first group includes polynomial segments 911, 912, and 913. The second group includes polynomial segments 914, 915, and 916. The two groups, while substantially parallel to each other, follow the locations of their respective sides of the road. Polynomial segments 911, 912, 913, 914, 915, and 916 have a length of about 100 meters and overlap adjacent segments in the series by about 50 meters. As noted previously, however, polynomials of different lengths and different overlap amounts may also be used. For example, the polynomials may have lengths of 500 m, 1 km, or more, and the overlap amount may vary from 0 to 50 m, 50 m to 100 m, or greater than 100 m. Additionally, while FIG. 9A is shown as representing polynomials extending in 2D space (e.g., on the surface of the paper), it is to be understood that these polynomials may represent curves extending in three dimensions (e.g., including a height component) to represent elevation changes in a road segment in addition to X-Y curvature. In the example shown in FIG. 9A, right side 920 of lane 900 is further represented by a first group having polynomial segments 921, 922, and 923 and a second group having polynomial segments 924, 925, and 926.

Returning to the target trajectories of sparse map 800, FIG. 9B shows a three-dimensional polynomial representing a target trajectory for a vehicle traveling along a particular road segment. The target trajectory represents not only the X-Y path that a host vehicle should travel along a particular road segment, but also the elevation change that the host vehicle will experience when traveling along the road segment. Thus, each target trajectory in sparse map 800 may be represented by one or more three-dimensional polynomials, like the three-dimensional polynomial 950 shown in FIG. 9B. Sparse map 800 may include a plurality of trajectories (e.g., millions or billions or more to represent trajectories of vehicles along various road segments along roadways throughout the world). In some embodiments, each target trajectory may correspond to a spline connecting three-dimensional polynomial segments.

Regarding the data footprint of polynomial curves stored in sparse map 800, in some embodiments, each third degree polynomial may be represented by four parameters, each requiring four bytes of data. Suitable representations may be obtained with third degree polynomials requiring about 192 bytes of data for every 100 m. This may translate to approximately 200 kB per hour in data usage/transfer requirements for a host vehicle traveling approximately 100 km/hr.

Sparse map 800 may describe the lanes network using a combination of geometry descriptors and meta-data. The geometry may be described by polynomials or splines as described above. The meta-data may describe the number of lanes, special characteristics (such as a car pool lane), and possibly other sparse labels. The total footprint of such indicators may be negligible.

Accordingly, a sparse map according to embodiments of the present disclosure may include at least one line representation of a road surface feature extending along the road segment, each line representation representing a path along the road segment substantially corresponding with the road surface feature. In some embodiments, as discussed above, the at least one line representation of the road surface feature may include a spline, a polynomial representation, or a curve. Furthermore, in some embodiments, the road surface feature may include at least one of a road edge or a lane marking. Moreover, as discussed below with respect to “crowdsourcing,” the road surface feature may be identified through image analysis of a plurality of images acquired as one or more vehicles traverse the road segment.

As previously noted, sparse map 800 may include a plurality of predetermined landmarks associated with a road segment. Rather than storing actual images of the landmarks and relying, for example, on image recognition analysis based on captured images and stored images, each landmark in sparse map 800 may be represented and recognized using less data than a stored, actual image would require. Data representing landmarks may still include sufficient information for describing or identifying the landmarks along a road. Storing data describing characteristics of landmarks, rather than the actual images of landmarks, may reduce the size of sparse map 800.

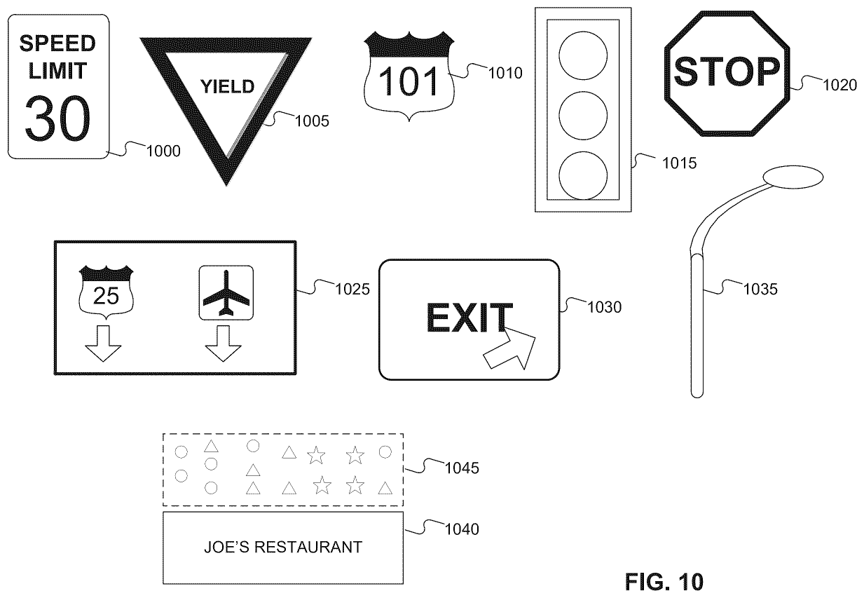

FIG. 10 illustrates examples of types of landmarks that may be represented in sparse map 800. The landmarks may include any visible and identifiable objects along a road segment. The landmarks may be selected such that they are fixed and do not change often with respect to their locations and/or content. The landmarks included in sparse map 800 may be useful in determining a location of vehicle 200 with respect to a target trajectory as the vehicle traverses a particular road segment. Examples of landmarks may include traffic signs, directional signs, general signs (e.g., rectangular signs), roadside fixtures (e.g., lampposts, reflectors, etc.), and any other suitable category. In some embodiments, lane marks on the road, may also be included as landmarks in sparse map 800.

Examples of landmarks shown in FIG. 10 include traffic signs, directional signs, roadside fixtures, and general signs. Traffic signs may include, for example, speed limit signs (e.g., speed limit sign 1000), yield signs (e.g., yield sign 1005), route number signs (e.g., route number sign 1010), traffic light signs (e.g., traffic light sign 1015), stop signs (e.g., stop sign 1020). Directional signs may include a sign that includes one or more arrows indicating one or more directions to different places. For example, directional signs may include a highway sign 1025 having arrows for directing vehicles to different roads or places, an exit sign 1030 having an arrow directing vehicles off a road, etc. Accordingly, at least one of the plurality of landmarks may include a road sign.

General signs may be unrelated to traffic. For example, general signs may include billboards used for advertisement, or a welcome board adjacent a border between two countries, states, counties, cities, or towns. FIG. 10 shows a general sign 1040 (“Joe's Restaurant”). Although general sign 1040 may have a rectangular shape, as shown in FIG. 10, general sign 1040 may have other shapes, such as square, circle, triangle, etc.

Landmarks may also include roadside fixtures. Roadside fixtures may be objects that are not signs, and may not be related to traffic or directions. For example, roadside fixtures may include lampposts (e.g., lamppost 1035), power line posts, traffic light posts, etc.

Landmarks may also include beacons that may be specifically designed for usage in an autonomous vehicle navigation system. For example, such beacons may include stand-alone structures placed at predetermined intervals to aid in navigating a host vehicle. Such beacons may also include visual/graphical information added to existing road signs (e.g., icons, emblems, bar codes, etc.) that may be identified or recognized by a vehicle traveling along a road segment. Such beacons may also include electronic components. In such embodiments, electronic beacons (e.g., RFID tags, etc.) may be used to transmit non-visual information to a host vehicle. Such information may include, for example, landmark identification and/or landmark location information that a host vehicle may use in determining its position along a target trajectory.

In some embodiments, the landmarks included in sparse map 800 may be represented by a data object of a predetermined size. The data representing a landmark may include any suitable parameters for identifying a particular landmark. For example, in some embodiments, landmarks stored in sparse map 800 may include parameters such as a physical size of the landmark (e.g., to support estimation of distance to the landmark based on a known size/scale), a distance to a previous landmark, lateral offset, height, a type code (e.g., a landmark type-what type of directional sign, traffic sign, etc.), a GPS coordinate (e.g., to support global localization), and any other suitable parameters. Each parameter may be associated with a data size. For example, a landmark size may be stored using 8 bytes of data. A distance to a previous landmark, a lateral offset, and height may be specified using 12 bytes of data. A type code associated with a landmark such as a directional sign or a traffic sign may require about 2 bytes of data. For general signs, an image signature enabling identification of the general sign may be stored using 50 bytes of data storage. The landmark GPS position may be associated with 16 bytes of data storage. These data sizes for each parameter are examples only, and other data sizes may also be used. Representing landmarks in sparse map 800 in this manner may offer a lean solution for efficiently representing landmarks in the database. In some embodiments, objects may be referred to as standard semantic objects or non-standard semantic objects. A standard semantic object may include any class of object for which there's a standardized set of characteristics (e.g., speed limit signs, warning signs, directional signs, traffic lights, etc. having known dimensions or other characteristics). A non-standard semantic object may include any object that is not associated with a standardized set of characteristics (e.g., general advertising signs, signs identifying business establishments, potholes, trees, etc. that may have variable dimensions). Each non-standard semantic object may be represented with 38 bytes of data (e.g., 8 bytes for size; 12 bytes for distance to previous landmark, lateral offset, and height; 2 bytes for a type code; and 16 bytes for position coordinates). Standard semantic objects may be represented using even less data, as size information may not be needed by the mapping server to fully represent the object in the sparse map.

Sparse map 800 may use a tag system to represent landmark types. In some cases, each traffic sign or directional sign may be associated with its own tag, which may be stored in the database as part of the landmark identification. For example, the database may include on the order of 1000 different tags to represent various traffic signs and on the order of about 10000 different tags to represent directional signs. Of course, any suitable number of tags may be used, and additional tags may be created as needed. General purpose signs may be represented in some embodiments using less than about 100 bytes (e.g., about 86 bytes including 8 bytes for size; 12 bytes for distance to previous landmark, lateral offset, and height; 50 bytes for an image signature; and 16 bytes for GPS coordinates).

Thus, for semantic road signs not requiring an image signature, the data density impact to sparse map 800, even at relatively high landmark densities of about 1 per 50 m, may be on the order of about 760 bytes per kilometer (e.g., 20 landmarks per km×38 bytes per landmark=760 bytes). Even for general purpose signs including an image signature component, the data density impact is about 1.72 kB per km (e.g., 20 landmarks per km×86 bytes per landmark=1,720 bytes). For semantic road signs, this equates to about 76 kB per hour of data usage for a vehicle traveling 100 km/hr. For general purpose signs, this equates to about 170 kB per hour for a vehicle traveling 100 km/hr. It should be noted that in some environments (e.g., urban environments) there may be a much higher density of detected objects available for inclusion in the sparse map (perhaps more than one per meter). In some embodiments, a generally rectangular object, such as a rectangular sign, may be represented in sparse map 800 by no more than 100 bytes of data. The representation of the generally rectangular object (e.g., general sign 1040) in sparse map 800 may include a condensed image signature or image hash (e.g., condensed image signature 1045) associated with the generally rectangular object. This condensed image signature/image hash may be determined using any suitable image hashing algorithm and may be used, for example, to aid in identification of a general purpose sign, for example, as a recognized landmark. Such a condensed image signature (e.g., image information derived from actual image data representing an object) may avoid a need for storage of an actual image of an object or a need for comparative image analysis performed on actual images in order to recognize landmarks.

Referring to FIG. 10, sparse map 800 may include or store a condensed image signature 1045 associated with a general sign 1040, rather than an actual image of general sign 1040. For example, after an image capture device (e.g., image capture device 122, 124, or 126) captures an image of general sign 1040, a processor (e.g., image processor 190 or any other processor that can process images either aboard or remotely located relative to a host vehicle) may perform an image analysis to extract/create condensed image signature 1045 that includes a unique signature or pattern associated with general sign 1040. In one embodiment, condensed image signature 1045 may include a shape, color pattern, a brightness pattern, or any other feature that may be extracted from the image of general sign 1040 for describing general sign 1040.

For example, in FIG. 10, the circles, triangles, and stars shown in condensed image signature 1045 may represent areas of different colors. The pattern represented by the circles, triangles, and stars may be stored in sparse map 800, e.g., within the 50 bytes designated to include an image signature. Notably, the circles, triangles, and stars are not necessarily meant to indicate that such shapes are stored as part of the image signature. Rather, these shapes are meant to conceptually represent recognizable areas having discernible color differences, textual areas, graphical shapes, or other variations in characteristics that may be associated with a general purpose sign. Such condensed image signatures can be used to identify a landmark in the form of a general sign. For example, the condensed image signature can be used to perform a same-not-same analysis based on a comparison of a stored condensed image signature with image data captured, for example, using a camera onboard an autonomous vehicle.

Accordingly, the plurality of landmarks may be identified through image analysis of the plurality of images acquired as one or more vehicles traverse the road segment. As explained below with respect to “crowdsourcing,” in some embodiments, the image analysis to identify the plurality of landmarks may include accepting potential landmarks when a ratio of images in which the landmark does appear to images in which the landmark does not appear exceeds a threshold. Furthermore, in some embodiments, the image analysis to identify the plurality of landmarks may include rejecting potential landmarks when a ratio of images in which the landmark does not appear to images in which the landmark does appear exceeds a threshold.

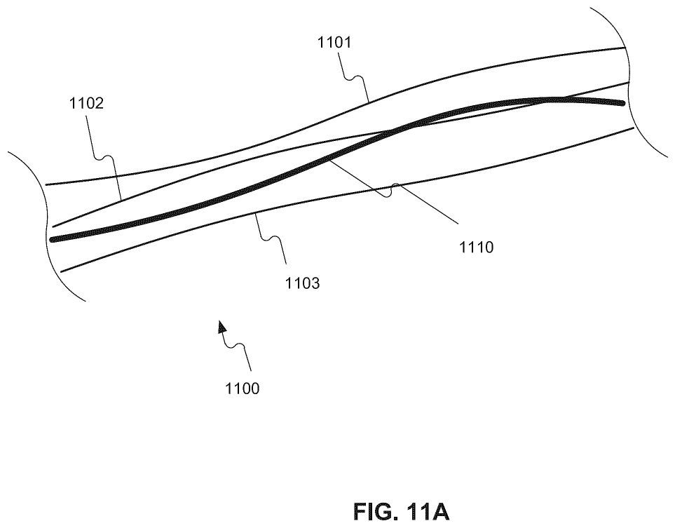

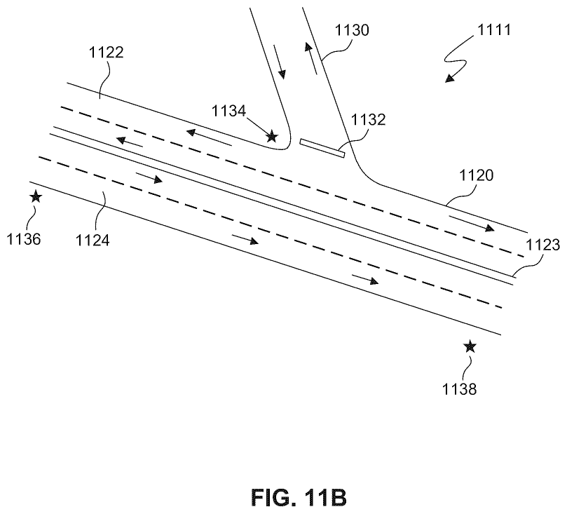

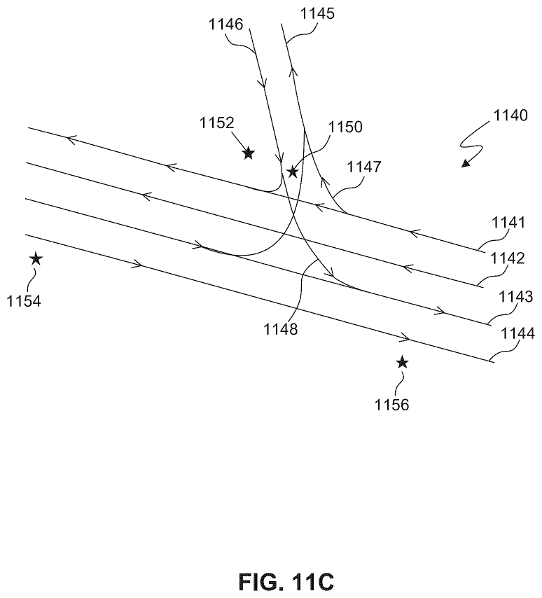

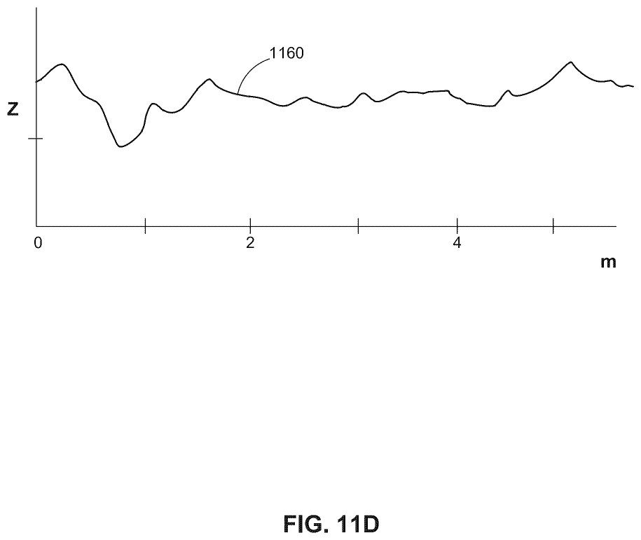

Returning to the target trajectories a host vehicle may use to navigate a particular road segment, FIG. 11A shows polynomial representations trajectories capturing during a process of building or maintaining sparse map 800. A polynomial representation of a target trajectory included in sparse map 800 may be determined based on two or more reconstructed trajectories of prior traversals of vehicles along the same road segment. In some embodiments, the polynomial representation of the target trajectory included in sparse map 800 may be an aggregation of two or more reconstructed trajectories of prior traversals of vehicles along the same road segment. In some embodiments, the polynomial representation of the target trajectory included in sparse map 800 may be an average of the two or more reconstructed trajectories of prior traversals of vehicles along the same road segment. Other mathematical operations may also be used to construct a target trajectory along a road path based on reconstructed trajectories collected from vehicles traversing along a road segment.

As shown in FIG. 11A, a road segment 1100 may be travelled by a number of vehicles 200 at different times. Each vehicle 200 may collect data relating to a path that the vehicle took along the road segment. The path traveled by a particular vehicle may be determined based on camera data, accelerometer information, speed sensor information, and/or GPS information, among other potential sources. Such data may be used to reconstruct trajectories of vehicles traveling along the road segment, and based on these reconstructed trajectories, a target trajectory (or multiple target trajectories) may be determined for the particular road segment. Such target trajectories may represent a preferred path of a host vehicle (e.g., guided by an autonomous navigation system) as the vehicle travels along the road segment.

In the example shown in FIG. 11A, a first reconstructed trajectory 1101 may be determined based on data received from a first vehicle traversing road segment 1100 at a first time period (e.g., day 1), a second reconstructed trajectory 1102 may be obtained from a second vehicle traversing road segment 1100 at a second time period (e.g., day 2), and a third reconstructed trajectory 1103 may be obtained from a third vehicle traversing road segment 1100 at a third time period (e.g., day 3). Each trajectory 1101, 1102, and 1103 may be represented by a polynomial, such as a three-dimensional polynomial. It should be noted that in some embodiments, any of the reconstructed trajectories may be assembled onboard the vehicles traversing road segment 1100.

Additionally, or alternatively, such reconstructed trajectories may be determined on a server side based on information received from vehicles traversing road segment 1100. For example, in some embodiments, vehicles 200 may transmit data to one or more servers relating to their motion along road segment 1100 (e.g., steering angle, heading, time, position, speed, sensed road geometry, and/or sensed landmarks, among things). The server may reconstruct trajectories for vehicles 200 based on the received data. The server may also generate a target trajectory for guiding navigation of autonomous vehicle that will travel along the same road segment 1100 at a later time based on the first, second, and third trajectories 1101, 1102, and 1103. While a target trajectory may be associated with a single prior traversal of a road segment, in some embodiments, each target trajectory included in sparse map 800 may be determined based on two or more reconstructed trajectories of vehicles traversing the same road segment. In FIG. 11A, the target trajectory is represented by 1110. In some embodiments, the target trajectory 1110 may be generated based on an average of the first, second, and third trajectories 1101, 1102, and 1103. In some embodiments, the target trajectory 1110 included in sparse map 800 may be an aggregation (e.g., a weighted combination) of two or more reconstructed trajectories.

At the mapping server, the server may receive actual trajectories for a particular road segment from multiple harvesting vehicles traversing the road segment. To generate a target trajectory for each valid path along the road segment (e.g., each lane, each drive direction, each path through a junction, etc.), the received actual trajectories may be aligned. The alignment process may include using detected objects/features identified along the road segment along with harvested positions of those detected objects/features to correlate the actual, harvested trajectories with one another. Once aligned, an average or “best fit” target trajectory for each available lane, etc. may be determined based on the aggregated, correlated/aligned actual trajectories.

FIGS. 11B and 11C further illustrate the concept of target trajectories associated with road segments present within a geographic region 1111. As shown in FIG. 11B, a first road segment 1120 within geographic region 1111 may include a multilane road, which includes two lanes 1122 designated for vehicle travel in a first direction and two additional lanes 1124 designated for vehicle travel in a second direction opposite to the first direction. Lanes 1122 and lanes 1124 may be separated by a double yellow line 1123. Geographic region 1111 may also include a branching road segment 1130 that intersects with road segment 1120. Road segment 1130 may include a two-lane road, each lane being designated for a different direction of travel. Geographic region 1111 may also include other road features, such as a stop line 1132, a stop sign 1134, a speed limit sign 1136, and a hazard sign 1138.

As shown in FIG. 11C, sparse map 800 may include a local map 1140 including a road model for assisting with autonomous navigation of vehicles within geographic region 1111. For example, local map 1140 may include target trajectories for one or more lanes associated with road segments 1120 and/or 1130 within geographic region 1111. For example, local map 1140 may include target trajectories 1141 and/or 1142 that an autonomous vehicle may access or rely upon when traversing lanes 1122. Similarly, local map 1140 may include target trajectories 1143 and/or 1144 that an autonomous vehicle may access or rely upon when traversing lanes 1124. Further, local map 1140 may include target trajectories 1145 and/or 1146 that an autonomous vehicle may access or rely upon when traversing road segment 1130. Target trajectory 1147 represents a preferred path an autonomous vehicle should follow when transitioning from lanes 1120 (and specifically, relative to target trajectory 1141 associated with a right-most lane of lanes 1120) to road segment 1130 (and specifically, relative to a target trajectory 1145 associated with a first side of road segment 1130. Similarly, target trajectory 1148 represents a preferred path an autonomous vehicle should follow when transitioning from road segment 1130 (and specifically, relative to target trajectory 1146) to a portion of road segment 1124 (and specifically, as shown, relative to a target trajectory 1143 associated with a left lane of lanes 1124.

Sparse map 800 may also include representations of other road-related features associated with geographic region 1111. For example, sparse map 800 may also include representations of one or more landmarks identified in geographic region 1111. Such landmarks may include a first landmark 1150 associated with stop line 1132, a second landmark 1152 associated with stop sign 1134, a third landmark associated with speed limit sign 1154, and a fourth landmark 1156 associated with hazard sign 1138. Such landmarks may be used, for example, to assist an autonomous vehicle in determining its current location relative to any of the shown target trajectories, such that the vehicle may adjust its heading to match a direction of the target trajectory at the determined location.

In some embodiments, sparse map 800 may also include road signature profiles. Such road signature profiles may be associated with any discernible/measurable variation in at least one parameter associated with a road. For example, in some cases, such profiles may be associated with variations in road surface information such as variations in surface roughness of a particular road segment, variations in road width over a particular road segment, variations in distances between dashed lines painted along a particular road segment, variations in road curvature along a particular road segment, etc. FIG. 11D shows an example of a road signature profile 1160. While profile 1160 may represent any of the parameters mentioned above, or others, in one example, profile 1160 may represent a measure of road surface roughness, as obtained, for example, by monitoring one or more sensors providing outputs indicative of an amount of suspension displacement as a vehicle travels a particular road segment.

Alternatively or concurrently, profile 1160 may represent variation in road width, as determined based on image data obtained via a camera onboard a vehicle traveling a particular road segment. Such profiles may be useful, for example, in determining a particular location of an autonomous vehicle relative to a particular target trajectory. That is, as it traverses a road segment, an autonomous vehicle may measure a profile associated with one or more parameters associated with the road segment. If the measured profile can be correlated/matched with a predetermined profile that plots the parameter variation with respect to position along the road segment, then the measured and predetermined profiles may be used (e.g., by overlaying corresponding sections of the measured and predetermined profiles) in order to determine a current position along the road segment and, therefore, a current position relative to a target trajectory for the road segment.

In some embodiments, sparse map 800 may include different trajectories based on different characteristics associated with a user of autonomous vehicles, environmental conditions, and/or other parameters relating to driving. For example, in some embodiments, different trajectories may be generated based on different user preferences and/or profiles. Sparse map 800 including such different trajectories may be provided to different autonomous vehicles of different users. For example, some users may prefer to avoid toll roads, while others may prefer to take the shortest or fastest routes, regardless of whether there is a toll road on the route. The disclosed systems may generate different sparse maps with different trajectories based on such different user preferences or profiles. As another example, some users may prefer to travel in a fast moving lane, while others may prefer to maintain a position in the central lane at all times.

Different trajectories may be generated and included in sparse map 800 based on different environmental conditions, such as day and night, snow, rain, fog, etc. Autonomous vehicles driving under different environmental conditions may be provided with sparse map 800 generated based on such different environmental conditions. In some embodiments, cameras provided on autonomous vehicles may detect the environmental conditions, and may provide such information back to a server that generates and provides sparse maps. For example, the server may generate or update an already generated sparse map 800 to include trajectories that may be more suitable or safer for autonomous driving under the detected environmental conditions. The update of sparse map 800 based on environmental conditions may be performed dynamically as the autonomous vehicles are traveling along roads.

Other different parameters relating to driving may also be used as a basis for generating and providing different sparse maps to different autonomous vehicles. For example, when an autonomous vehicle is traveling at a high speed, turns may be tighter. Trajectories associated with specific lanes, rather than roads, may be included in sparse map 800 such that the autonomous vehicle may maintain within a specific lane as the vehicle follows a specific trajectory. When an image captured by a camera onboard the autonomous vehicle indicates that the vehicle has drifted outside of the lane (e.g., crossed the lane mark), an action may be triggered within the vehicle to bring the vehicle back to the designated lane according to the specific trajectory.

### Crowdsourcing a Sparse Map

The disclosed sparse maps may be efficiently (and passively) generated through the power of crowdsourcing. For example, any private or commercial vehicle equipped with a camera (e.g., a simple, low resolution camera regularly included as OEM equipment on today's vehicles) and an appropriate image analysis processor can serve as a harvesting vehicle. No special equipment (e.g., high definition imaging and/or positioning systems) are required. As a result of the disclosed crowdsourcing technique, the generated sparse maps may be extremely accurate and may include extremely refined position information (enabling navigation error limits of 10 cm or less) without requiring any specialized imaging or sensing equipment as input to the map generation process. Crowdsourcing also enables much more rapid (and inexpensive) updates to the generated maps, as new drive information is continuously available to the mapping server system from any roads traversed by private or commercial vehicles minimally equipped to also serve as harvesting vehicles. There is no need for designated vehicles equipped with high-definition imaging and mapping sensors. Therefore, the expense associated with building such specialized vehicles can be avoided. Further, updates to the presently disclosed sparse maps may be made much more rapidly than systems that rely upon dedicated, specialized mapping vehicles (which by virtue of their expense and special equipment are typically limited to a fleet of specialized vehicles of far lower numbers than the number of private or commercial vehicles already available for performing the disclosed harvesting techniques).

The disclosed sparse maps generated through crowdsourcing may be extremely accurate because they may be generated based on many inputs from multiple (10 s, hundreds, millions, etc.) of harvesting vehicles that have collected drive information along a particular road segment. For example, every harvesting vehicle that drives along a particular road segment may record its actual trajectory and may determine position information relative to detected objects/features along the road segment. This information is passed along from multiple harvesting vehicles to a server. The actual trajectories are aggregated to generate a refined, target trajectory for each valid drive path along the road segment. Additionally, the position information collected from the multiple harvesting vehicles for each of the detected objects/features along the road segment (semantic or non-semantic) can also be aggregated. As a result, the mapped position of each detected object/feature may constitute an average of hundreds, thousands, or millions of individually determined positions for each detected object/feature. Such a technique may yield extremely accurate mapped positions for the detected objects/features.

In some embodiments, the disclosed systems and methods may generate a sparse map for autonomous vehicle navigation. For example, disclosed systems and methods may use crowdsourced data for generation of a sparse map that one or more autonomous vehicles may use to navigate along a system of roads. As used herein, “crowdsourcing” means that data are received from various vehicles (e.g., autonomous vehicles) travelling on a road segment at different times, and such data are used to generate and/or update the road model, including sparse map tiles. The model or any of its sparse map tiles may, in turn, be transmitted to the vehicles or other vehicles later travelling along the road segment for assisting autonomous vehicle navigation. The road model may include a plurality of target trajectories representing preferred trajectories that autonomous vehicles should follow as they traverse a road segment. The target trajectories may be the same as a reconstructed actual trajectory collected from a vehicle traversing a road segment, which may be transmitted from the vehicle to a server. In some embodiments, the target trajectories may be different from actual trajectories that one or more vehicles previously took when traversing a road segment. The target trajectories may be generated based on actual trajectories (e.g., through averaging or any other suitable operation).

The vehicle trajectory data that a vehicle may upload to a server may correspond with the actual reconstructed trajectory for the vehicle or may correspond to a recommended trajectory, which may be based on or related to the actual reconstructed trajectory of the vehicle, but may differ from the actual reconstructed trajectory. For example, vehicles may modify their actual, reconstructed trajectories and submit (e.g., recommend) to the server the modified actual trajectories. The road model may use the recommended, modified trajectories as target trajectories for autonomous navigation of other vehicles.

In addition to trajectory information, other information for potential use in building a sparse data map 800 may include information relating to potential landmark candidates. For example, through crowd sourcing of information, the disclosed systems and methods may identify potential landmarks in an environment and refine landmark positions. The landmarks may be used by a navigation system of autonomous vehicles to determine and/or adjust the position of the vehicle along the target trajectories.

The reconstructed trajectories that a vehicle may generate as the vehicle travels along a road may be obtained by any suitable method. In some embodiments, the reconstructed trajectories may be developed by stitching together segments of motion for the vehicle, using, e.g., ego motion estimation (e.g., three dimensional translation and three dimensional rotation of the camera, and hence the body of the vehicle). The rotation and translation estimation may be determined based on analysis of images captured by one or more image capture devices along with information from other sensors or devices, such as inertial sensors and speed sensors. For example, the inertial sensors may include an accelerometer or other suitable sensors configured to measure changes in translation and/or rotation of the vehicle body. The vehicle may include a speed sensor that measures a speed of the vehicle.

In some embodiments, the ego motion of the camera (and hence the vehicle body) may be estimated based on an optical flow analysis of the captured images. An optical flow analysis of a sequence of images identifies movement of pixels from the sequence of images, and based on the identified movement, determines motions of the vehicle. The ego motion may be integrated over time and along the road segment to reconstruct a trajectory associated with the road segment that the vehicle has followed.

Data (e.g., reconstructed trajectories) collected by multiple vehicles in multiple drives along a road segment at different times may be used to construct the road model (e.g., including the target trajectories, etc.) included in sparse data map 800. Data collected by multiple vehicles in multiple drives along a road segment at different times may also be averaged to increase an accuracy of the model. In some embodiments, data regarding the road geometry and/or landmarks may be received from multiple vehicles that travel through the common road segment at different times. Such data received from different vehicles may be combined to generate the road model and/or to update the road model.

The geometry of a reconstructed trajectory (and also a target trajectory) along a road segment may be represented by a curve in three dimensional space, which may be a spline connecting three dimensional polynomials. The reconstructed trajectory curve may be determined from analysis of a video stream or a plurality of images captured by a camera installed on the vehicle. In some embodiments, a location is identified in each frame or image that is a few meters ahead of the current position of the vehicle. This location is where the vehicle is expected to travel to in a predetermined time period. This operation may be repeated frame by frame, and at the same time, the vehicle may compute the camera's ego motion (rotation and translation). At each frame or image, a short range model for the desired path is generated by the vehicle in a reference frame that is attached to the camera. The short range models may be stitched together to obtain a three dimensional model of the road in some coordinate frame, which may be an arbitrary or predetermined coordinate frame. The three dimensional model of the road may then be fitted by a spline, which may include or connect one or more polynomials of suitable orders.

To conclude the short range road model at each frame, one or more detection modules may be used. For example, a bottom-up lane detection module may be used. The bottom-up lane detection module may be useful when lane marks are drawn on the road. This module may look for edges in the image and assembles them together to form the lane marks. A second module may be used together with the bottom-up lane detection module. The second module is an end-to-end deep neural network, which may be trained to predict the correct short range path from an input image. In both modules, the road model may be detected in the image coordinate frame and transformed to a three dimensional space that may be virtually attached to the camera.

Although the reconstructed trajectory modeling method may introduce an accumulation of errors due to the integration of ego motion over a long period of time, which may include a noise component, such errors may be inconsequential as the generated model may provide sufficient accuracy for navigation over a local scale. In addition, it is possible to cancel the integrated error by using external sources of information, such as satellite images or geodetic measurements. For example, the disclosed systems and methods may use a GNSS receiver to cancel accumulated errors. However, the GNSS positioning signals may not be always available and accurate. The disclosed systems and methods may enable a steering application that depends weakly on the availability and accuracy of GNSS positioning. In such systems, the usage of the GNSS signals may be limited. For example, in some embodiments, the disclosed systems may use the GNSS signals for database indexing purposes only.

In some embodiments, the range scale (e.g., local scale) that may be relevant for an autonomous vehicle navigation steering application may be on the order of 50 meters, 100 meters, 200 meters, 300 meters, etc. Such distances may be used, as the geometrical road model is mainly used for two purposes: planning the trajectory ahead and localizing the vehicle on the road model. In some embodiments, the planning task may use the model over a typical range of 40 meters ahead (or any other suitable distance ahead, such as 20 meters, 30 meters, 50 meters), when the control algorithm steers the vehicle according to a target point located 1.3 seconds ahead (or any other time such as 1.5 seconds, 1.7 seconds, 2 seconds, etc.). The localization task uses the road model over a typical range of 60 meters behind the car (or any other suitable distances, such as 50 meters, 100 meters, 150 meters, etc.), according to a method called “tail alignment” described in more detail in another section. The disclosed systems and methods may generate a geometrical model that has sufficient accuracy over particular range, such as 100 meters, such that a planned trajectory will not deviate by more than, for example, 30 cm from the lane center.

As explained above, a three dimensional road model may be constructed from detecting short range sections and stitching them together. The stitching may be enabled by computing a six degree ego motion model, using the videos and/or images captured by the camera, data from the inertial sensors that reflect the motions of the vehicle, and the host vehicle velocity signal. The accumulated error may be small enough over some local range scale, such as of the order of 100 meters. All this may be completed in a single drive over a particular road segment.

In some embodiments, multiple drives may be used to average the resulted model, and to increase its accuracy further. The same car may travel the same route multiple times, or multiple cars may send their collected model data to a central server. In any case, a matching procedure may be performed to identify overlapping models and to enable averaging in order to generate target trajectories. The constructed model (e.g., including the target trajectories) may be used for steering once a convergence criterion is met. Subsequent drives may be used for further model improvements and in order to accommodate infrastructure changes.

Sharing of driving experience (such as sensed data) between multiple cars becomes feasible if they are connected to a central server. Each vehicle client may store a partial copy of a universal road model, which may be relevant for its current position. A bidirectional update procedure between the vehicles and the server may be performed by the vehicles and the server. The small footprint concept discussed above enables the disclosed systems and methods to perform the bidirectional updates using a very small bandwidth.

Information relating to potential landmarks may also be determined and forwarded to a central server. For example, the disclosed systems and methods may determine one or more physical properties of a potential landmark based on one or more images that include the landmark. The physical properties may include a physical size (e.g., height, width) of the landmark, a distance from a vehicle to a landmark, a distance between the landmark to a previous landmark, the lateral position of the landmark (e.g., the position of the landmark relative to the lane of travel), the GPS coordinates of the landmark, a type of landmark, identification of text on the landmark, etc. For example, a vehicle may analyze one or more images captured by a camera to detect a potential landmark, such as a speed limit sign.

The vehicle may determine a distance from the vehicle to the landmark or a position associated with the landmark (e.g., any semantic or non-semantic object or feature along a road segment) based on the analysis of the one or more images. In some embodiments, the distance may be determined based on analysis of images of the landmark using a suitable image analysis method, such as a scaling method and/or an optical flow method. As previously noted, a position of the object/feature may include a 2D image position (e.g., an X-Y pixel position in one or more captured images) of one or more points associated with the object/feature or may include a 3D real-world position of one or more points (e.g., determined through structure in motion/optical flow techniques, LIDAR or RADAR information, etc.). In some embodiments, the disclosed systems and methods may be configured to determine a type or classification of a potential landmark. In case the vehicle determines that a certain potential landmark corresponds to a predetermined type or classification stored in a sparse map, it may be sufficient for the vehicle to communicate to the server an indication of the type or classification of the landmark, along with its location. The server may store such indications. At a later time, during navigation, a navigating vehicle may capture an image that includes a representation of the landmark, process the image (e.g., using a classifier), and compare the result landmark in order to confirm detection of the mapped landmark and to use the mapped landmark in localizing the navigating vehicle relative to the sparse map.

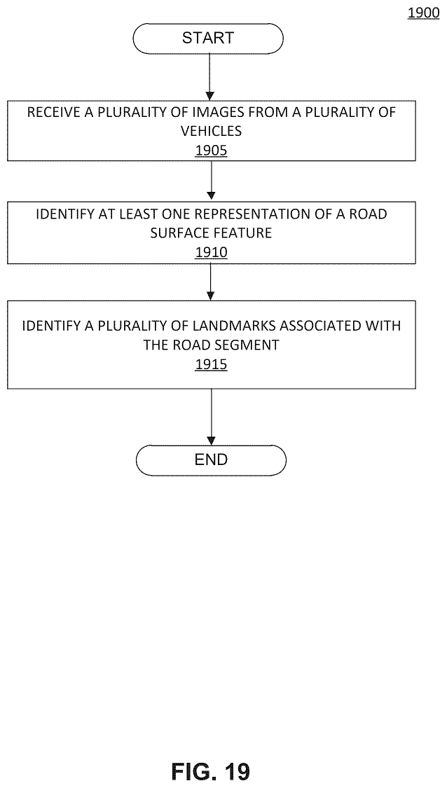

In some embodiments, multiple autonomous vehicles travelling on a road segment may communicate with a server. The vehicles (or clients) may generate a curve describing its drive (e.g., through ego motion integration) in an arbitrary coordinate frame. The vehicles may detect landmarks and locate them in the same frame. The vehicles may upload the curve and the landmarks to the server. The server may collect data from vehicles over multiple drives, and generate a unified road model. For example, as discussed below with respect to FIG. 19, the server may generate a sparse map having the unified road model using the uploaded curves and landmarks.

The server may also distribute the model to clients (e.g., vehicles). For example, the server may distribute the sparse map to one or more vehicles. The server may continuously or periodically update the model when receiving new data from the vehicles. For example, the server may process the new data to evaluate whether the data includes information that should trigger an updated, or creation of new data on the server. The server may distribute the updated model or the updates to the vehicles for providing autonomous vehicle navigation.

The server may use one or more criteria for determining whether new data received from the vehicles should trigger an update to the model or trigger creation of new data. For example, when the new data indicates that a previously recognized landmark at a specific location no longer exists, or is replaced by another landmark, the server may determine that the new data should trigger an update to the model. As another example, when the new data indicates that a road segment has been closed, and when this has been corroborated by data received from other vehicles, the server may determine that the new data should trigger an update to the model.

The server may distribute the updated model (or the updated portion of the model) to one or more vehicles that are traveling on the road segment, with which the updates to the model are associated. The server may also distribute the updated model to vehicles that are about to travel on the road segment, or vehicles whose planned trip includes the road segment, with which the updates to the model are associated. For example, while an autonomous vehicle is traveling along another road segment before reaching the road segment with which an update is associated, the server may distribute the updates or updated model to the autonomous vehicle before the vehicle reaches the road segment.

In some embodiments, the remote server may collect trajectories and landmarks from multiple clients (e.g., vehicles that travel along a common road segment). The server may match curves using landmarks and create an average road model based on the trajectories collected from the multiple vehicles. The server may also compute a graph of roads and the most probable path at each node or conjunction of the road segment. For example, the remote server may align the trajectories to generate a crowdsourced sparse map from the collected trajectories.

The server may average landmark properties received from multiple vehicles that travelled along the common road segment, such as the distances between one landmark to another (e.g., a previous one along the road segment) as measured by multiple vehicles, to determine an arc-length parameter and support localization along the path and speed calibration for each client vehicle. The server may average the physical dimensions of a landmark measured by multiple vehicles travelled along the common road segment and recognized the same landmark. The averaged physical dimensions may be used to support distance estimation, such as the distance from the vehicle to the landmark. The server may average lateral positions of a landmark (e.g., position from the lane in which vehicles are travelling in to the landmark) measured by multiple vehicles travelled along the common road segment and recognized the same landmark. The averaged lateral potion may be used to support lane assignment. The server may average the GPS coordinates of the landmark measured by multiple vehicles travelled along the same road segment and recognized the same landmark. The averaged GPS coordinates of the landmark may be used to support global localization or positioning of the landmark in the road model.

In some embodiments, the server may identify model changes, such as constructions, detours, new signs, removal of signs, etc., based on data received from the vehicles. The server may continuously or periodically or instantaneously update the model upon receiving new data from the vehicles. The server may distribute updates to the model or the updated model to vehicles for providing autonomous navigation. For example, as discussed further below, the server may use crowdsourced data to filter out “ghost” landmarks detected by vehicles.

In some embodiments, the server may analyze driver interventions during the autonomous driving. The server may analyze data received from the vehicle at the time and location where intervention occurs, and/or data received prior to the time the intervention occurred. The server may identify certain portions of the data that caused or are closely related to the intervention, for example, data indicating a temporary lane closure setup, data indicating a pedestrian in the road. The server may update the model based on the identified data. For example, the server may modify one or more trajectories stored in the model.

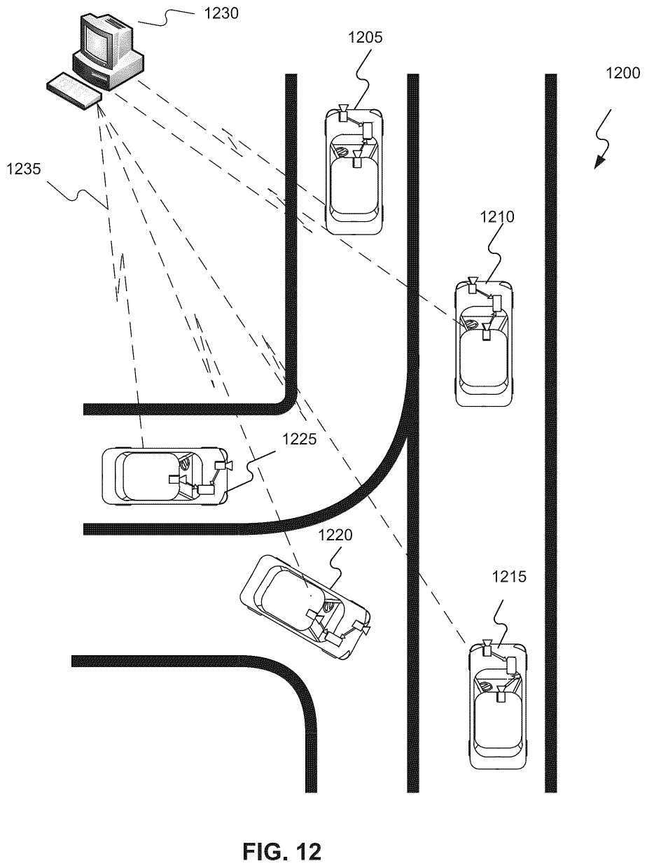

FIG. 12 is a schematic illustration of a system that uses crowdsourcing to generate a sparse map (as well as distribute and navigate using a crowdsourced sparse map). FIG. 12 shows a road segment 1200 that includes one or more lanes. A plurality of vehicles 1205, 1210, 1215, 1220, and 1225 may travel on road segment 1200 at the same time or at different times (although shown as appearing on road segment 1200 at the same time in FIG. 12). At least one of vehicles 1205, 1210, 1215, 1220, and 1225 may be an autonomous vehicle. For simplicity of the present example, all of the vehicles 1205, 1210, 1215, 1220, and 1225 are presumed to be autonomous vehicles.

Each vehicle may be similar to vehicles disclosed in other embodiments (e.g., vehicle 200), and may include components or devices included in or associated with vehicles disclosed in other embodiments. Each vehicle may be equipped with an image capture device or camera (e.g., image capture device 122 or camera 122). Each vehicle may communicate with a remote server 1230 via one or more networks (e.g., over a cellular network and/or the Internet, etc.) through wireless communication paths 1235, as indicated by the dashed lines. Each vehicle may transmit data to server 1230 and receive data from server 1230. For example, server 1230 may collect data from multiple vehicles travelling on the road segment 1200 at different times, and may process the collected data to generate an autonomous vehicle road navigation model, or an update to the model. Server 1230 may transmit the autonomous vehicle road navigation model or the update to the model to the vehicles that transmitted data to server 1230. Server 1230 may transmit the autonomous vehicle road navigation model or the update to the model to other vehicles that travel on road segment 1200 at later times.

As vehicles 1205, 1210, 1215, 1220, and 1225 travel on road segment 1200, navigation information collected (e.g., detected, sensed, or measured) by vehicles 1205, 1210, 1215, 1220, and 1225 may be transmitted to server 1230. In some embodiments, the navigation information may be associated with the common road segment 1200. The navigation information may include a trajectory associated with each of the vehicles 1205, 1210, 1215, 1220, and 1225 as each vehicle travels over road segment 1200. In some embodiments, the trajectory may be reconstructed based on data sensed by various sensors and devices provided on vehicle 1205. For example, the trajectory may be reconstructed based on at least one of accelerometer data, speed data, landmarks data, road geometry or profile data, vehicle positioning data, and ego motion data. In some embodiments, the trajectory may be reconstructed based on data from inertial sensors, such as accelerometer, and the velocity of vehicle 1205 sensed by a speed sensor. In addition, in some embodiments, the trajectory may be determined (e.g., by a processor onboard each of vehicles 1205, 1210, 1215, 1220, and 1225) based on sensed ego motion of the camera, which may indicate three dimensional translation and/or three dimensional rotations (or rotational motions). The ego motion of the camera (and hence the vehicle body) may be determined from analysis of one or more images captured by the camera.

In some embodiments, the trajectory of vehicle 1205 may be determined by a processor provided aboard vehicle 1205 and transmitted to server 1230. In other embodiments, server 1230 may receive data sensed by the various sensors and devices provided in vehicle 1205, and determine the trajectory based on the data received from vehicle 1205.

In some embodiments, the navigation information transmitted from vehicles 1205, 1210, 1215, 1220, and 1225 to server 1230 may include data regarding the road surface, the road geometry, or the road profile. The geometry of road segment 1200 may include lane structure and/or landmarks. The lane structure may include the total number of lanes of road segment 1200, the type of lanes (e.g., one-way lane, two-way lane, driving lane, passing lane, etc.), markings on lanes, width of lanes, etc. In some embodiments, the navigation information may include a lane assignment, e.g., which lane of a plurality of lanes a vehicle is traveling in. For example, the lane assignment may be associated with a numerical value “3” indicating that the vehicle is traveling on the third lane from the left or right. As another example, the lane assignment may be associated with a text value “center lane” indicating the vehicle is traveling on the center lane.

Server 1230 may store the navigation information on a non-transitory computer-readable medium, such as a hard drive, a compact disc, a tape, a memory, etc. Server 1230 may generate (e.g., through a processor included in server 1230) at least a portion of an autonomous vehicle road navigation model for the common road segment 1200 based on the navigation information received from the plurality of vehicles 1205, 1210, 1215, 1220, and 1225 and may store the model as a portion of a sparse map. Server 1230 may determine a trajectory associated with each lane based on crowdsourced data (e.g., navigation information) received from multiple vehicles (e.g., 1205, 1210, 1215, 1220, and 1225) that travel on a lane of road segment at different times. Server 1230 may generate the autonomous vehicle road navigation model or a portion of the model (e.g., an updated portion) based on a plurality of trajectories determined based on the crowd sourced navigation data. Server 1230 may transmit the model or the updated portion of the model to one or more of autonomous vehicles 1205, 1210, 1215, 1220, and 1225 traveling on road segment 1200 or any other autonomous vehicles that travel on road segment at a later time for updating an existing autonomous vehicle road navigation model provided in a navigation system of the vehicles. The autonomous vehicle road navigation model may be used by the autonomous vehicles in autonomously navigating along the common road segment 1200.

As explained above, the autonomous vehicle road navigation model may be included in a sparse map (e.g., sparse map 800 depicted in FIG. 8). Sparse map 800 may include sparse recording of data related to road geometry and/or landmarks along a road, which may provide sufficient information for guiding autonomous navigation of an autonomous vehicle, yet does not require excessive data storage. In some embodiments, the autonomous vehicle road navigation model may be stored separately from sparse map 800, and may use map data from sparse map 800 when the model is executed for navigation. In some embodiments, the autonomous vehicle road navigation model may use map data included in sparse map 800 for determining target trajectories along road segment 1200 for guiding autonomous navigation of autonomous vehicles 1205, 1210, 1215, 1220, and 1225 or other vehicles that later travel along road segment 1200. For example, when the autonomous vehicle road navigation model is executed by a processor included in a navigation system of vehicle 1205, the model may cause the processor to compare the trajectories determined based on the navigation information received from vehicle 1205 with predetermined trajectories included in sparse map 800 to validate and/or correct the current traveling course of vehicle 1205.

In the autonomous vehicle road navigation model, the geometry of a road feature or target trajectory may be encoded by a curve in a three-dimensional space. In one embodiment, the curve may be a three dimensional spline including one or more connecting three dimensional polynomials. As one of skill in the art would understand, a spline may be a numerical function that is piece-wise defined by a series of polynomials for fitting data. A spline for fitting the three dimensional geometry data of the road may include a linear spline (first order), a quadratic spline (second order), a cubic spline (third order), or any other splines (other orders), or a combination thereof. The spline may include one or more three dimensional polynomials of different orders connecting (e.g., fitting) data points of the three dimensional geometry data of the road. In some embodiments, the autonomous vehicle road navigation model may include a three dimensional spline corresponding to a target trajectory along a common road segment (e.g., road segment 1200) or a lane of the road segment 1200.

As explained above, the autonomous vehicle road navigation model included in the sparse map may include other information, such as identification of at least one landmark along road segment 1200. The landmark may be visible within a field of view of a camera (e.g., camera 122) installed on each of vehicles 1205, 1210, 1215, 1220, and 1225. In some embodiments, camera 122 may capture an image of a landmark. A processor (e.g., processor 180, 190, or processing unit 110) provided on vehicle 1205 may process the image of the landmark to extract identification information for the landmark. The landmark identification information, rather than an actual image of the landmark, may be stored in sparse map 800. The landmark identification information may require much less storage space than an actual image. Other sensors or systems (e.g., GPS system) may also provide certain identification information of the landmark (e.g., position of landmark). The landmark may include at least one of a traffic sign, an arrow marking, a lane marking, a dashed lane marking, a traffic light, a stop line, a directional sign (e.g., a highway exit sign with an arrow indicating a direction, a highway sign with arrows pointing to different directions or places), a landmark beacon, or a lamppost. A landmark beacon refers to a device (e.g., an RFID device) installed along a road segment that transmits or reflects a signal to a receiver installed on a vehicle, such that when the vehicle passes by the device, the beacon received by the vehicle and the location of the device (e.g., determined from GPS location of the device) may be used as a landmark to be included in the autonomous vehicle road navigation model and/or the sparse map 800.

The identification of at least one landmark may include a position of the at least one landmark. The position of the landmark may be determined based on position measurements performed using sensor systems (e.g., Global Positioning Systems, inertial based positioning systems, landmark beacon, etc.) associated with the plurality of vehicles 1205, 1210, 1215, 1220, and 1225. In some embodiments, the position of the landmark may be determined by averaging the position measurements detected, collected, or received by sensor systems on different vehicles 1205, 1210, 1215, 1220, and 1225 through multiple drives. For example, vehicles 1205, 1210, 1215, 1220, and 1225 may transmit position measurements data to server 1230, which may average the position measurements and use the averaged position measurement as the position of the landmark. The position of the landmark may be continuously refined by measurements received from vehicles in subsequent drives.

The identification of the landmark may include a size of the landmark. The processor provided on a vehicle (e.g., 1205) may estimate the physical size of the landmark based on the analysis of the images. Server 1230 may receive multiple estimates of the physical size of the same landmark from different vehicles over different drives. Server 1230 may average the different estimates to arrive at a physical size for the landmark, and store that landmark size in the road model. The physical size estimate may be used to further determine or estimate a distance from the vehicle to the landmark. The distance to the landmark may be estimated based on the current speed of the vehicle and a scale of expansion based on the position of the landmark appearing in the images relative to the focus of expansion of the camera. For example, the distance to landmark may be estimated by Z=V*dt*R/D, where V is the speed of vehicle, R is the distance in the image from the landmark at time t1 to the focus of expansion, and D is the change in distance for the landmark in the image from t1 to t2. dt represents the (t2−t1). For example, the distance to landmark may be estimated by Z=V*dt*R/D, where V is the speed of vehicle, R is the distance in the image between the landmark and the focus of expansion, dt is a time interval, and D is the image displacement of the landmark along the epipolar line. Other equations equivalent to the above equation, such as Z=V*ω/Δω, may be used for estimating the distance to the landmark. Here, V is the vehicle speed, ω is an image length (like the object width), and Δω is the change of that image length in a unit of time.

When the physical size of the landmark is known, the distance to the landmark may also be determined based on the following equation: Z=f*W/ω, where f is the focal length, W is the size of the landmark (e.g., height or width), ω is the number of pixels when the landmark leaves the image. From the above equation, a change in distance Z may be calculated using ΔZ=f*W*Δω/ω2+f*ΔW/ω, where ΔW decays to zero by averaging, and where Δω is the number of pixels representing a bounding box accuracy in the image. A value estimating the physical size of the landmark may be calculated by averaging multiple observations at the server side. The resulting error in distance estimation may be very small. There are two sources of error that may occur when using the formula above, namely ΔW and Δω. Their contribution to the distance error is given by ΔZ=f*W*Δω/ω2+f*ΔW/ω. However, ΔW decays to zero by averaging; hence ΔZ is determined by Δω (e.g., the inaccuracy of the bounding box in the image).

For landmarks of unknown dimensions, the distance to the landmark may be estimated by tracking feature points on the landmark between successive frames. For example, certain features appearing on a speed limit sign may be tracked between two or more image frames. Based on these tracked features, a distance distribution per feature point may be generated. The distance estimate may be extracted from the distance distribution. For example, the most frequent distance appearing in the distance distribution may be used as the distance estimate. As another example, the average of the distance distribution may be used as the distance estimate.

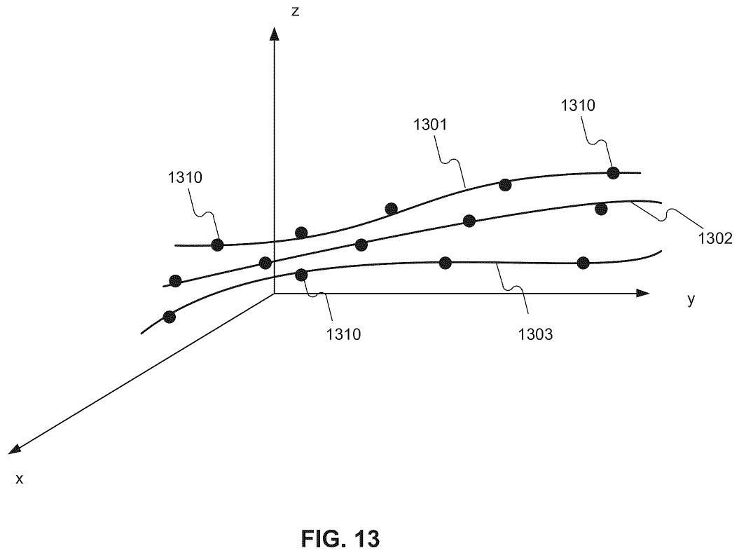

FIG. 13 illustrates an example autonomous vehicle road navigation model represented by a plurality of three dimensional splines 1301, 1302, and 1303. The curves 1301, 1302, and 1303 shown in FIG. 13 are for illustration purpose only. Each spline may include one or more three dimensional polynomials connecting a plurality of data points 1310. Each polynomial may be a first order polynomial, a second order polynomial, a third order polynomial, or a combination of any suitable polynomials having different orders. Each data point 1310 may be associated with the navigation information received from vehicles 1205, 1210, 1215, 1220, and 1225. In some embodiments, each data point 1310 may be associated with data related to landmarks (e.g., size, location, and identification information of landmarks) and/or road signature profiles (e.g., road geometry, road roughness profile, road curvature profile, road width profile). In some embodiments, some data points 1310 may be associated with data related to landmarks, and others may be associated with data related to road signature profiles.

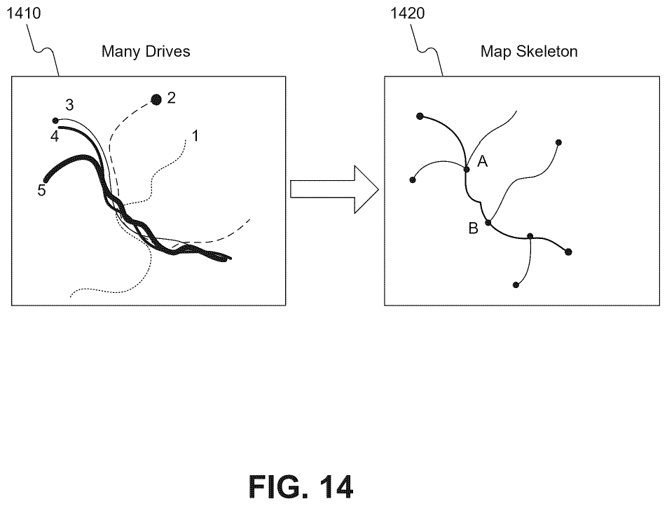

FIG. 14 illustrates raw location data 1410 (e.g., GPS data) received from five separate drives. One drive may be separate from another drive if it was traversed by separate vehicles at the same time, by the same vehicle at separate times, or by separate vehicles at separate times. To account for errors in the location data 1410 and for differing locations of vehicles within the same lane (e.g., one vehicle may drive closer to the left of a lane than another), server 1230 may generate a map skeleton 1420 using one or more statistical techniques to determine whether variations in the raw location data 1410 represent actual divergences or statistical errors. Each path within skeleton 1420 may be linked back to the raw data 1410 that formed the path. For example, the path between A and B within skeleton 1420 is linked to raw data 1410 from drives 2, 3, 4, and 5 but not from drive 1. Skeleton 1420 may not be detailed enough to be used to navigate a vehicle (e.g., because it combines drives from multiple lanes on the same road unlike the splines described above) but may provide useful topological information and may be used to define intersections.

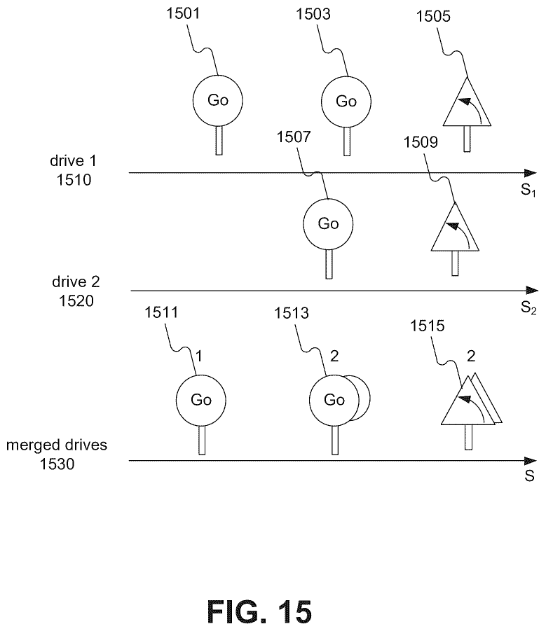

FIG. 15 illustrates an example by which additional detail may be generated for a sparse map within a segment of a map skeleton (e.g., segment A to B within skeleton 1420). As depicted in FIG. 15, the data (e.g., ego-motion data, road markings data, and the like) may be shown as a function of position S (or S1 or S2) along the drive. Server 1230 may identify landmarks for the sparse map by identifying unique matches between landmarks 1501, 1503, and 1505 of drive 1510 and landmarks 1507 and 1509 of drive 1520. Such a matching algorithm may result in identification of landmarks 1511, 1513, and 1515. One skilled in the art would recognize, however, that other matching algorithms may be used. For example, probability optimization may be used in lieu of or in combination with unique matching. Server 1230 may longitudinally align the drives to align the matched landmarks. For example, server 1230 may select one drive (e.g., drive 1520) as a reference drive and then shift and/or elastically stretch the other drive(s) (e.g., drive 1510) for alignment.

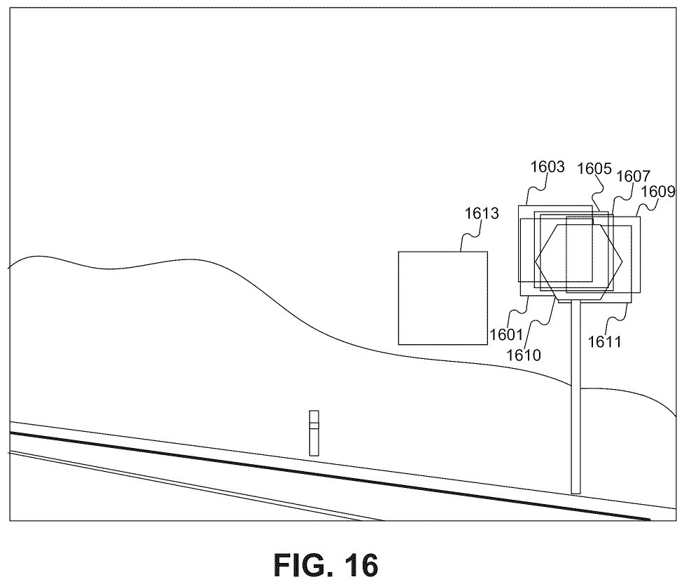

FIG. 16 shows an example of aligned landmark data for use in a sparse map. In the example of FIG. 16, landmark 1610 comprises a road sign. The example of FIG. 16 further depicts data from a plurality of drives 1601, 1603, 1605, 1607, 1609, 1611, and 1613. In the example of FIG. 16, the data from drive 1613 consists of a “ghost” landmark, and the server 1230 may identify it as such because none of drives 1601, 1603, 1605, 1607, 1609, and 1611 include an identification of a landmark in the vicinity of the identified landmark in drive 1613. Accordingly, server 1230 may accept potential landmarks when a ratio of images in which the landmark does appear to images in which the landmark does not appear exceeds a threshold and/or may reject potential landmarks when a ratio of images in which the landmark does not appear to images in which the landmark does appear exceeds a threshold.

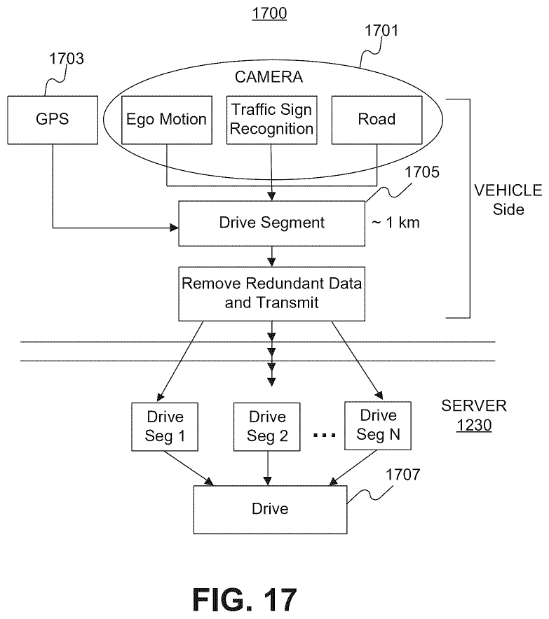

FIG. 17 depicts a system 1700 for generating drive data, which may be used to crowdsource a sparse map. As depicted in FIG. 17, system 1700 may include a camera 1701 and a locating device 1703 (e.g., a GPS locator). Camera 1701 and locating device 1703 may be mounted on a vehicle (e.g., one of vehicles 1205, 1210, 1215, 1220, and 1225). Camera 1701 may produce a plurality of data of multiple types, e.g., ego motion data, traffic sign data, road data, or the like. The camera data and location data may be segmented into drive segments 1705. For example, drive segments 1705 may each have camera data and location data from less than 1 km of driving.

In some embodiments, system 1700 may remove redundancies in drive segments 1705. For example, if a landmark appears in multiple images from camera 1701, system 1700 may strip the redundant data such that the drive segments 1705 only contain one copy of the location of and any metadata relating to the landmark. By way of further example, if a lane marking appears in multiple images from camera 1701, system 1700 may strip the redundant data such that the drive segments 1705 only contain one copy of the location of and any metadata relating to the lane marking.

System 1700 also includes a server (e.g., server 1230). Server 1230 may receive drive segments 1705 from the vehicle and recombine the drive segments 1705 into a single drive 1707. Such an arrangement may allow for reduce bandwidth requirements when transferring data between the vehicle and the server while also allowing for the server to store data relating to an entire drive.

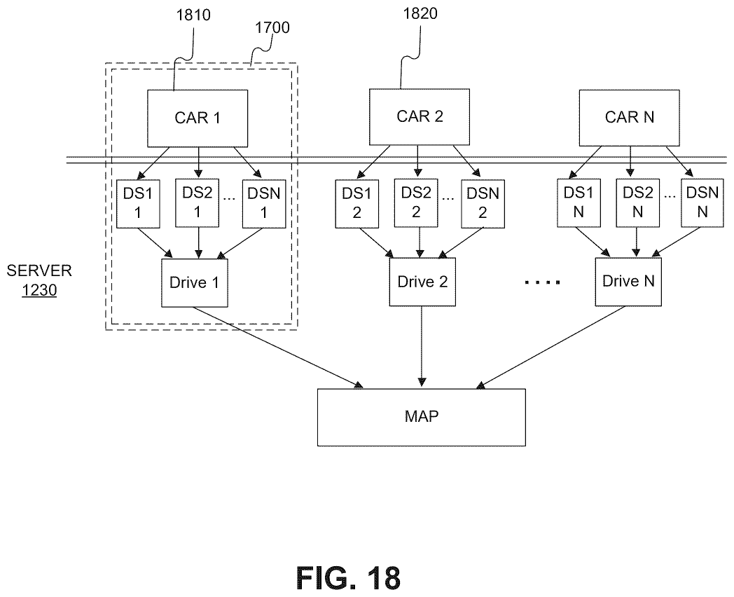

FIG. 18 depicts system 1700 of FIG. 17 further configured for crowdsourcing a sparse map. As in FIG. 17, system 1700 includes vehicle 1810, which captures drive data using, for example, a camera (which produces, e.g., ego motion data, traffic sign data, road data, or the like) and a locating device (e.g., a GPS locator). As in FIG. 17, vehicle 1810 segments the collected data into drive segments (depicted as “DS1 1,” “DS2 1,” “DSN 1” in FIG. 18). Server 1230 then receives the drive segments and reconstructs a drive (depicted as “Drive 1” in FIG. 18) from the received segments.

As further depicted in FIG. 18, system 1700 also receives data from additional vehicles. For example, vehicle 1820 also captures drive data using, for example, a camera (which produces, e.g., ego motion data, traffic sign data, road data, or the like) and a locating device (e.g., a GPS locator). Similar to vehicle 1810, vehicle 1820 segments the collected data into drive segments (depicted as “DS1 2,” “DS2 2,” “DSN 2” in FIG. 18). Server 1230 then receives the drive segments and reconstructs a drive (depicted as “Drive 2” in FIG. 18) from the received segments. Any number of additional vehicles may be used. For example, FIG. 18 also includes “CAR N” that captures drive data, segments it into drive segments (depicted as “DS1 N,” “DS2 N,” “DSN N” in FIG. 18), and sends it to server 1230 for reconstruction into a drive (depicted as “Drive N” in FIG. 18).

As depicted in FIG. 18, server 1230 may construct a sparse map (depicted as “MAP”) using the reconstructed drives (e.g., “Drive 1,” “Drive 2,” and “Drive N”) collected from a plurality of vehicles (e.g., “CAR 1” (also labeled vehicle 1810), “CAR 2” (also labeled vehicle 1820), and “CAR N”).

FIG. 19 is a flowchart showing an example process 1900 for generating a sparse map for autonomous vehicle navigation along a road segment. Process 1900 may be performed by one or more processing devices included in server 1230.

Process 1900 may include receiving a plurality of images acquired as one or more vehicles traverse the road segment (step 1905). Server 1230 may receive images from cameras included within one or more of vehicles 1205, 1210, 1215, 1220, and 1225. For example, camera 122 may capture one or more images of the environment surrounding vehicle 1205 as vehicle 1205 travels along road segment 1200. In some embodiments, server 1230 may also receive stripped down image data that has had redundancies removed by a processor on vehicle 1205, as discussed above with respect to FIG. 17.

Process 1900 may further include identifying, based on the plurality of images, at least one line representation of a road surface feature extending along the road segment (step 1910). Each line representation may represent a path along the road segment substantially corresponding with the road surface feature. For example, server 1230 may analyze the environmental images received from camera 122 to identify a road edge or a lane marking and determine a trajectory of travel along road segment 1200 associated with the road edge or lane marking. In some embodiments, the trajectory (or line representation) may include a spline, a polynomial representation, or a curve. Server 1230 may determine the trajectory of travel of vehicle 1205 based on camera ego motions (e.g., three dimensional translation and/or three dimensional rotational motions) received at step 1905.

Process 1900 may also include identifying, based on the plurality of images, a plurality of landmarks associated with the road segment (step 1910). For example, server 1230 may analyze the environmental images received from camera 122 to identify one or more landmarks, such as road sign along road segment 1200. Server 1230 may identify the landmarks using analysis of the plurality of images acquired as one or more vehicles traverse the road segment. To enable crowdsourcing, the analysis may include rules regarding accepting and rejecting possible landmarks associated with the road segment. For example, the analysis may include accepting potential landmarks when a ratio of images in which the landmark does appear to images in which the landmark does not appear exceeds a threshold and/or rejecting potential landmarks when a ratio of images in which the landmark does not appear to images in which the landmark does appear exceeds a threshold.

Process 1900 may include other operations or steps performed by server 1230. For example, the navigation information may include a target trajectory for vehicles to travel along a road segment, and process 1900 may include clustering, by server 1230, vehicle trajectories related to multiple vehicles travelling on the road segment and determining the target trajectory based on the clustered vehicle trajectories, as discussed in further detail below. Clustering vehicle trajectories may include clustering, by server 1230, the multiple trajectories related to the vehicles travelling on the road segment into a plurality of clusters based on at least one of the absolute heading of vehicles or lane assignment of the vehicles. Generating the target trajectory may include averaging, by server 1230, the clustered trajectories. By way of further example, process 1900 may include aligning data received in step 1905. Other processes or steps performed by server 1230, as described above, may also be included in process 1900.

The disclosed systems and methods may include other features. For example, the disclosed systems may use local coordinates, rather than global coordinates. For autonomous driving, some systems may present data in world coordinates. For example, longitude and latitude coordinates on the earth surface may be used. In order to use the map for steering, the host vehicle may determine its position and orientation relative to the map. It seems natural to use a GPS device on board, in order to position the vehicle on the map and in order to find the rotation transformation between the body reference frame and the world reference frame (e.g., North, East and Down). Once the body reference frame is aligned with the map reference frame, then the desired route may be expressed in the body reference frame and the steering commands may be computed or generated.

The disclosed systems and methods may enable autonomous vehicle navigation (e.g., steering control) with low footprint models, which may be collected by the autonomous vehicles themselves without the aid of expensive surveying equipment. To support the autonomous navigation (e.g., steering applications), the road model may include a sparse map having the geometry of the road, its lane structure, and landmarks that may be used to determine the location or position of vehicles along a trajectory included in the model. As discussed above, generation of the sparse map may be performed by a remote server that communicates with vehicles travelling on the road and that receives data from the vehicles. The data may include sensed data, trajectories reconstructed based on the sensed data, and/or recommended trajectories that may represent modified reconstructed trajectories. As discussed below, the server may transmit the model back to the vehicles or other vehicles that later travel on the road to aid in autonomous navigation.

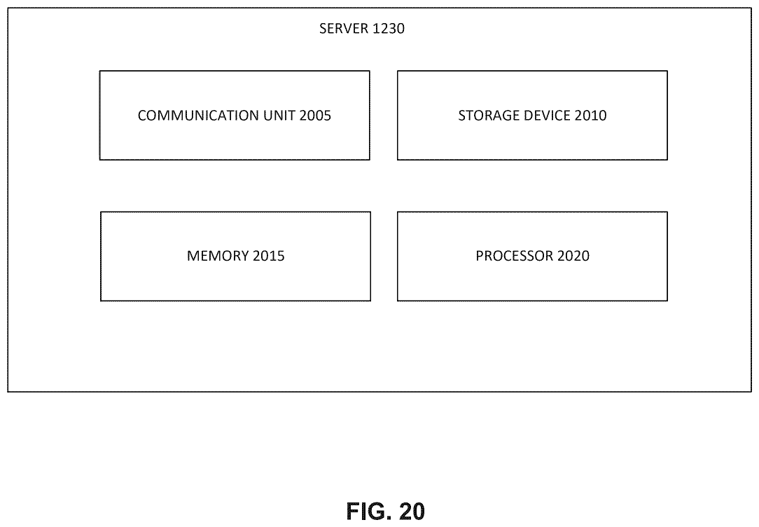

FIG. 20 illustrates a block diagram of server 1230. Server 1230 may include a communication unit 2005, which may include both hardware components (e.g., communication control circuits, switches, and antenna), and software components (e.g., communication protocols, computer codes). For example, communication unit 2005 may include at least one network interface. Server 1230 may communicate with vehicles 1205, 1210, 1215, 1220, and 1225 through communication unit 2005. For example, server 1230 may receive, through communication unit 2005, navigation information transmitted from vehicles 1205, 1210, 1215, 1220, and 1225. Server 1230 may distribute, through communication unit 2005, the autonomous vehicle road navigation model to one or more autonomous vehicles.

Server 1230 may include at least one non-transitory storage medium 2010, such as a hard drive, a compact disc, a tape, etc. Storage device 1410 may be configured to store data, such as navigation information received from vehicles 1205, 1210, 1215, 1220, and 1225 and/or the autonomous vehicle road navigation model that server 1230 generates based on the navigation information. Storage device 2010 may be configured to store any other information, such as a sparse map (e.g., sparse map 800 discussed above with respect to FIG. 8).

In addition to or in place of storage device 2010, server 1230 may include a memory 2015. Memory 2015 may be similar to or different from memory 140 or 150. Memory 2015 may be a non-transitory memory, such as a flash memory, a random access memory, etc. Memory 2015 may be configured to store data, such as computer codes or instructions executable by a processor (e.g., processor 2020), map data (e.g., data of sparse map 800), the autonomous vehicle road navigation model, and/or navigation information received from vehicles 1205, 1210, 1215, 1220, and 1225.

Server 1230 may include at least one processing device 2020 configured to execute computer codes or instructions stored in memory 2015 to perform various functions. For example, processing device 2020 may analyze the navigation information received from vehicles 1205, 1210, 1215, 1220, and 1225, and generate the autonomous vehicle road navigation model based on the analysis. Processing device 2020 may control communication unit 1405 to distribute the autonomous vehicle road navigation model to one or more autonomous vehicles (e.g., one or more of vehicles 1205, 1210, 1215, 1220, and 1225 or any vehicle that travels on road segment 1200 at a later time). Processing device 2020 may be similar to or different from processor 180, 190, or processing unit 110.

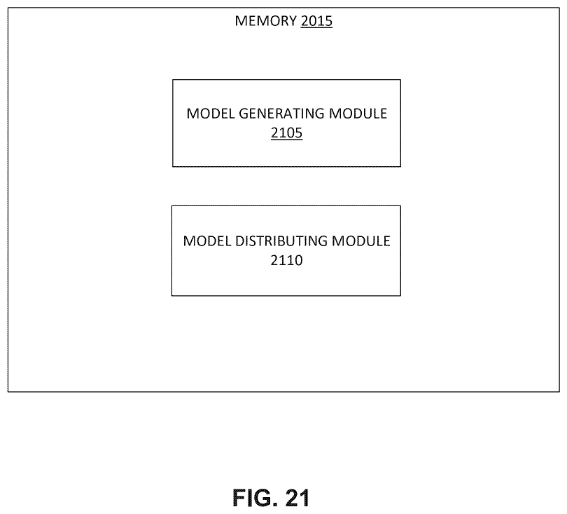

FIG. 21 illustrates a block diagram of memory 2015, which may store computer code or instructions for performing one or more operations for generating a road navigation model for use in autonomous vehicle navigation. As shown in FIG. 21, memory 2015 may store one or more modules for performing the operations for processing vehicle navigation information. For example, memory 2015 may include a model generating module 2105 and a model distributing module 2110. Processor 2020 may execute the instructions stored in any of modules 2105 and 2110 included in memory 2015.

Model generating module 2105 may store instructions which, when executed by processor 2020, may generate at least a portion of an autonomous vehicle road navigation model for a common road segment (e.g., road segment 1200) based on navigation information received from vehicles 1205, 1210, 1215, 1220, and 1225. For example, in generating the autonomous vehicle road navigation model, processor 2020 may cluster vehicle trajectories along the common road segment 1200 into different clusters. Processor 2020 may determine a target trajectory along the common road segment 1200 based on the clustered vehicle trajectories for each of the different clusters. Such an operation may include finding a mean or average trajectory of the clustered vehicle trajectories (e.g., by averaging data representing the clustered vehicle trajectories) in each cluster. In some embodiments, the target trajectory may be associated with a single lane of the common road segment 1200.

The road model and/or sparse map may store trajectories associated with a road segment. These trajectories may be referred to as target trajectories, which are provided to autonomous vehicles for autonomous navigation. The target trajectories may be received from multiple vehicles, or may be generated based on actual trajectories or recommended trajectories (actual trajectories with some modifications) received from multiple vehicles. The target trajectories included in the road model or sparse map may be continuously updated (e.g., averaged) with new trajectories received from other vehicles.

Vehicles travelling on a road segment may collect data by various sensors. The data may include landmarks, road signature profile, vehicle motion (e.g., accelerometer data, speed data), vehicle position (e.g., GPS data), and may either reconstruct the actual trajectories themselves, or transmit the data to a server, which will reconstruct the actual trajectories for the vehicles. In some embodiments, the vehicles may transmit data relating to a trajectory (e.g., a curve in an arbitrary reference frame), landmarks data, and lane assignment along traveling path to server 1230. Various vehicles travelling along the same road segment at multiple drives may have different trajectories. Server 1230 may identify routes or trajectories associated with each lane from the trajectories received from vehicles through a clustering process.

FIG. 22 illustrates a process of clustering vehicle trajectories associated with vehicles 1205, 1210, 1215, 1220, and 1225 for determining a target trajectory for the common road segment (e.g., road segment 1200). The target trajectory or a plurality of target trajectories determined from the clustering process may be included in the autonomous vehicle road navigation model or sparse map 800. In some embodiments, vehicles 1205, 1210, 1215, 1220, and 1225 traveling along road segment 1200 may transmit a plurality of trajectories 2200 to server 1230. In some embodiments, server 1230 may generate trajectories based on landmark, road geometry, and vehicle motion information received from vehicles 1205, 1210, 1215, 1220, and 1225. To generate the autonomous vehicle road navigation model, server 1230 may cluster vehicle trajectories 1600 into a plurality of clusters 2205, 2210, 2215, 2220, 2225, and 2230, as shown in FIG. 22.

Clustering may be performed using various criteria. In some embodiments, all drives in a cluster may be similar with respect to the absolute heading along the road segment 1200. The absolute heading may be obtained from GPS signals received by vehicles 1205, 1210, 1215, 1220, and 1225. In some embodiments, the absolute heading may be obtained using dead reckoning. Dead reckoning, as one of skill in the art would understand, may be used to determine the current position and hence heading of vehicles 1205, 1210, 1215, 1220, and 1225 by using previously determined position, estimated speed, etc. Trajectories clustered by absolute heading may be useful for identifying routes along the roadways.

In some embodiments, all the drives in a cluster may be similar with respect to the lane assignment (e.g., in the same lane before and after a junction) along the drive on road segment 1200. Trajectories clustered by lane assignment may be useful for identifying lanes along the roadways. In some embodiments, both criteria (e.g., absolute heading and lane assignment) may be used for clustering.

In each cluster 2205, 2210, 2215, 2220, 2225, and 2230, trajectories may be averaged to obtain a target trajectory associated with the specific cluster. For example, the trajectories from multiple drives associated with the same lane cluster may be averaged. The averaged trajectory may be a target trajectory associate with a specific lane. To average a cluster of trajectories, server 1230 may select a reference frame of an arbitrary trajectory C0. For all other trajectories (C1, . . . , Cn), server 1230 may find a rigid transformation that maps Ci to C0, where i=1, 2, . . . , n, where n is a positive integer number, corresponding to the total number of trajectories included in the cluster. Server 1230 may compute a mean curve or trajectory in the C0 reference frame.

In some embodiments, the landmarks may define an arc length matching between different drives, which may be used for alignment of trajectories with lanes. In some embodiments, lane marks before and after a junction may be used for alignment of trajectories with lanes.

To assemble lanes from the trajectories, server 1230 may select a reference frame of an arbitrary lane. Server 1230 may map partially overlapping lanes to the selected reference frame. Server 1230 may continue mapping until all lanes are in the same reference frame. Lanes that are next to each other may be aligned as if they were the same lane, and later they may be shifted laterally.

Landmarks recognized along the road segment may be mapped to the common reference frame, first at the lane level, then at the junction level. For example, the same landmarks may be recognized multiple times by multiple vehicles in multiple drives. The data regarding the same landmarks received in different drives may be slightly different. Such data may be averaged and mapped to the same reference frame, such as the C0 reference frame. Additionally or alternatively, the variance of the data of the same landmark received in multiple drives may be calculated.

In some embodiments, each lane of road segment 120 may be associated with a target trajectory and certain landmarks. The target trajectory or a plurality of such target trajectories may be included in the autonomous vehicle road navigation model, which may be used later by other autonomous vehicles travelling along the same road segment 1200. Landmarks identified by vehicles 1205, 1210, 1215, 1220, and 1225 while the vehicles travel along road segment 1200 may be recorded in association with the target trajectory. The data of the target trajectories and landmarks may be continuously or periodically updated with new data received from other vehicles in subsequent drives.

For localization of an autonomous vehicle, the disclosed systems and methods may use an Extended Kalman Filter. The location of the vehicle may be determined based on three dimensional position data and/or three dimensional orientation data, prediction of future location ahead of vehicle's current location by integration of ego motion. The localization of vehicle may be corrected or adjusted by image observations of landmarks. For example, when vehicle detects a landmark within an image captured by the camera, the landmark may be compared to a known landmark stored within the road model or sparse map 800. The known landmark may have a known location (e.g., GPS data) along a target trajectory stored in the road model and/or sparse map 800. Based on the current speed and images of the landmark, the distance from the vehicle to the landmark may be estimated. The location of the vehicle along a target trajectory may be adjusted based on the distance to the landmark and the landmark's known location (stored in the road model or sparse map 800). The landmark's position/location data (e.g., mean values from multiple drives) stored in the road model and/or sparse map 800 may be presumed to be accurate.

In some embodiments, the disclosed system may form a closed loop subsystem, in which estimation of the vehicle six degrees of freedom location (e.g., three dimensional position data plus three dimensional orientation data) may be used for navigating (e.g., steering the wheel of) the autonomous vehicle to reach a desired point (e.g., 1.3 second ahead in the stored). In turn, data measured from the steering and actual navigation may be used to estimate the six degrees of freedom location.

In some embodiments, poles along a road, such as lampposts and power or cable line poles may be used as landmarks for localizing the vehicles. Other landmarks such as traffic signs, traffic lights, arrows on the road, stop lines, as well as static features or signatures of an object along the road segment may also be used as landmarks for localizing the vehicle. When poles are used for localization, the x observation of the poles (i.e., the viewing angle from the vehicle) may be used, rather than the y observation (i.e., the distance to the pole) since the bottoms of the poles may be occluded and sometimes they are not on the road plane.

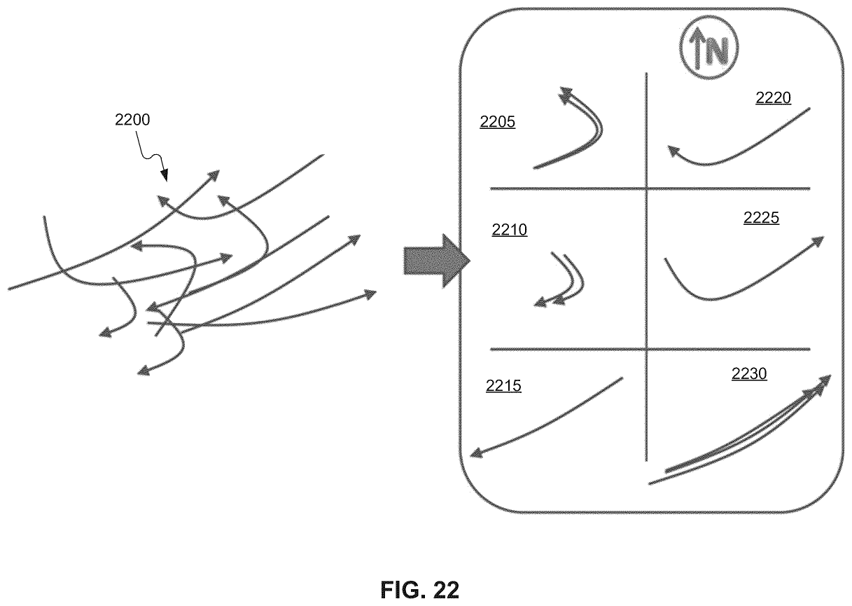

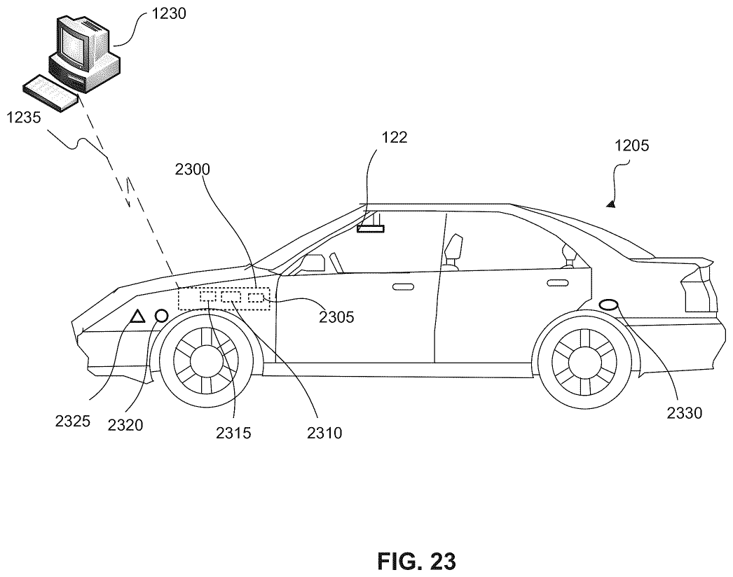

FIG. 23 illustrates a navigation system for a vehicle, which may be used for autonomous navigation using a crowdsourced sparse map. For illustration, the vehicle is referenced as vehicle 1205. The vehicle shown in FIG. 23 may be any other vehicle disclosed herein, including, for example, vehicles 1210, 1215, 1220, and 1225, as well as vehicle 200 shown in other embodiments. As shown in FIG. 12, vehicle 1205 may communicate with server 1230. Vehicle 1205 may include an image capture device 122 (e.g., camera 122). Vehicle 1205 may include a navigation system 2300 configured for providing navigation guidance for vehicle 1205 to travel on a road (e.g., road segment 1200). Vehicle 1205 may also include other sensors, such as a speed sensor 2320 and an accelerometer 2325. Speed sensor 2320 may be configured to detect the speed of vehicle 1205. Accelerometer 2325 may be configured to detect an acceleration or deceleration of vehicle 1205. Vehicle 1205 shown in FIG. 23 may be an autonomous vehicle, and the navigation system 2300 may be used for providing navigation guidance for autonomous driving. Alternatively, vehicle 1205 may also be a non-autonomous, human-controlled vehicle, and navigation system 2300 may still be used for providing navigation guidance.

Navigation system 2300 may include a communication unit 2305 configured to communicate with server 1230 through communication path 1235. Navigation system 2300 may also include a GPS unit 2310 configured to receive and process GPS signals. Navigation system 2300 may further include at least one processor 2315 configured to process data, such as GPS signals, map data from sparse map 800 (which may be stored on a storage device provided onboard vehicle 1205 and/or received from server 1230), road geometry sensed by a road profile sensor 2330, images captured by camera 122, and/or autonomous vehicle road navigation model received from server 1230. The road profile sensor 2330 may include different types of devices for measuring different types of road profile, such as road surface roughness, road width, road elevation, road curvature, etc. For example, the road profile sensor 2330 may include a device that measures the motion of a suspension of vehicle 2305 to derive the road roughness profile. In some embodiments, the road profile sensor 2330 may include radar sensors to measure the distance from vehicle 1205 to road sides (e.g., barrier on the road sides), thereby measuring the width of the road. In some embodiments, the road profile sensor 2330 may include a device configured for measuring the up and down elevation of the road. In some embodiment, the road profile sensor 2330 may include a device configured to measure the road curvature. For example, a camera (e.g., camera 122 or another camera) may be used to capture images of the road showing road curvatures. Vehicle 1205 may use such images to detect road curvatures.

The at least one processor 2315 may be programmed to receive, from camera 122, at least one environmental image associated with vehicle 1205. The at least one processor 2315 may analyze the at least one environmental image to determine navigation information related to the vehicle 1205. The navigation information may include a trajectory related to the travel of vehicle 1205 along road segment 1200. The at least one processor 2315 may determine the trajectory based on motions of camera 122 (and hence the vehicle), such as three dimensional translation and three dimensional rotational motions. In some embodiments, the at least one processor 2315 may determine the translation and rotational motions of camera 122 based on analysis of a plurality of images acquired by camera 122. In some embodiments, the navigation information may include lane assignment information (e.g., in which lane vehicle 1205 is travelling along road segment 1200). The navigation information transmitted from vehicle 1205 to server 1230 may be used by server 1230 to generate and/or update an autonomous vehicle road navigation model, which may be transmitted back from server 1230 to vehicle 1205 for providing autonomous navigation guidance for vehicle 1205.

The at least one processor 2315 may also be programmed to transmit the navigation information from vehicle 1205 to server 1230. In some embodiments, the navigation information may be transmitted to server 1230 along with road information. The road location information may include at least one of the GPS signal received by the GPS unit 2310, landmark information, road geometry, lane information, etc. The at least one processor 2315 may receive, from server 1230, the autonomous vehicle road navigation model or a portion of the model. The autonomous vehicle road navigation model received from server 1230 may include at least one update based on the navigation information transmitted from vehicle 1205 to server 1230. The portion of the model transmitted from server 1230 to vehicle 1205 may include an updated portion of the model. The at least one processor 2315 may cause at least one navigational maneuver (e.g., steering such as making a turn, braking, accelerating, passing another vehicle, etc.) by vehicle 1205 based on the received autonomous vehicle road navigation model or the updated portion of the model.

The at least one processor 2315 may be configured to communicate with various sensors and components included in vehicle 1205, including communication unit 1705, GPS unit 2315, camera 122, speed sensor 2320, accelerometer 2325, and road profile sensor 2330. The at least one processor 2315 may collect information or data from various sensors and components and transmit the information or data to server 1230 through communication unit 2305. Alternatively or additionally, various sensors or components of vehicle 1205 may also communicate with server 1230 and transmit data or information collected by the sensors or components to server 1230.

In some embodiments, vehicles 1205, 1210, 1215, 1220, and 1225 may communicate with each other, and may share navigation information with each other, such that at least one of the vehicles 1205, 1210, 1215, 1220, and 1225 may generate the autonomous vehicle road navigation model using crowdsourcing, e.g., based on information shared by other vehicles. In some embodiments, vehicles 1205, 1210, 1215, 1220, and 1225 may share navigation information with each other and each vehicle may update its own the autonomous vehicle road navigation model provided in the vehicle. In some embodiments, at least one of the vehicles 1205, 1210, 1215, 1220, and 1225 (e.g., vehicle 1205) may function as a hub vehicle. The at least one processor 2315 of the hub vehicle (e.g., vehicle 1205) may perform some or all of the functions performed by server 1230. For example, the at least one processor 2315 of the hub vehicle may communicate with other vehicles and receive navigation information from other vehicles. The at least one processor 2315 of the hub vehicle may generate the autonomous vehicle road navigation model or an update to the model based on the shared information received from other vehicles. The at least one processor 2315 of the hub vehicle may transmit the autonomous vehicle road navigation model or the update to the model to other vehicles for providing autonomous navigation guidance.

### Navigation Based on Sparse Maps

As previously discussed, the autonomous vehicle road navigation model including sparse map 800 may include a plurality of mapped lane marks and a plurality of mapped objects/features associated with a road segment. As discussed in greater detail below, these mapped lane marks, objects, and features may be used when the autonomous vehicle navigates. For example, in some embodiments, the mapped objects and features may be used to localized a host vehicle relative to the map (e.g., relative to a mapped target trajectory). The mapped lane marks may be used (e.g., as a check) to determine a lateral position and/or orientation relative to a planned or target trajectory. With this position information, the autonomous vehicle may be able to adjust a heading direction to match a direction of a target trajectory at the determined position.

Vehicle 200 may be configured to detect lane marks in a given road segment. The road segment may include any markings on a road for guiding vehicle traffic on a roadway. For example, the lane marks may be continuous or dashed lines demarking the edge of a lane of travel. The lane marks may also include double lines, such as a double continuous lines, double dashed lines or a combination of continuous and dashed lines indicating, for example, whether passing is permitted in an adjacent lane. The lane marks may also include freeway entrance and exit markings indicating, for example, a deceleration lane for an exit ramp or dotted lines indicating that a lane is turn-only or that the lane is ending. The markings may further indicate a work zone, a temporary lane shift, a path of travel through an intersection, a median, a special purpose lane (e.g., a bike lane, HOV lane, etc.), or other miscellaneous markings (e.g., crosswalk, a speed hump, a railway crossing, a stop line, etc.).

Vehicle 200 may use cameras, such as image capture devices 122 and 124 included in image acquisition unit 120, to capture images of the surrounding lane marks. Vehicle 200 may analyze the images to detect point locations associated with the lane marks based on features identified within one or more of the captured images. These point locations may be uploaded to a server to represent the lane marks in sparse map 800. Depending on the position and field of view of the camera, lane marks may be detected for both sides of the vehicle simultaneously from a single image. In other embodiments, different cameras may be used to capture images on multiple sides of the vehicle. Rather than uploading actual images of the lane marks, the marks may be stored in sparse map 800 as a spline or a series of points, thus reducing the size of sparse map 800 and/or the data that must be uploaded remotely by the vehicle.

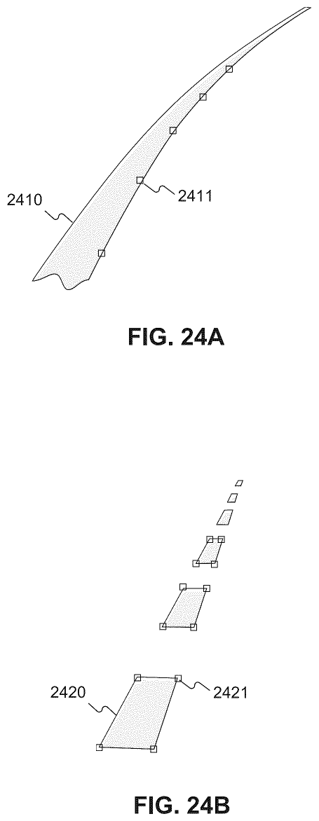

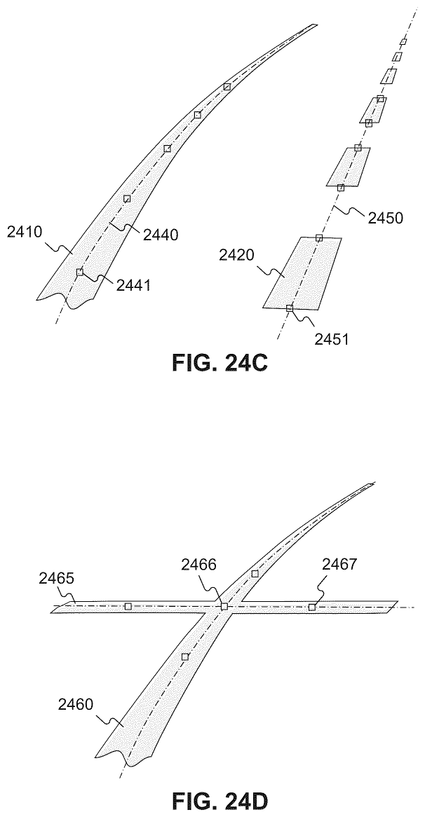

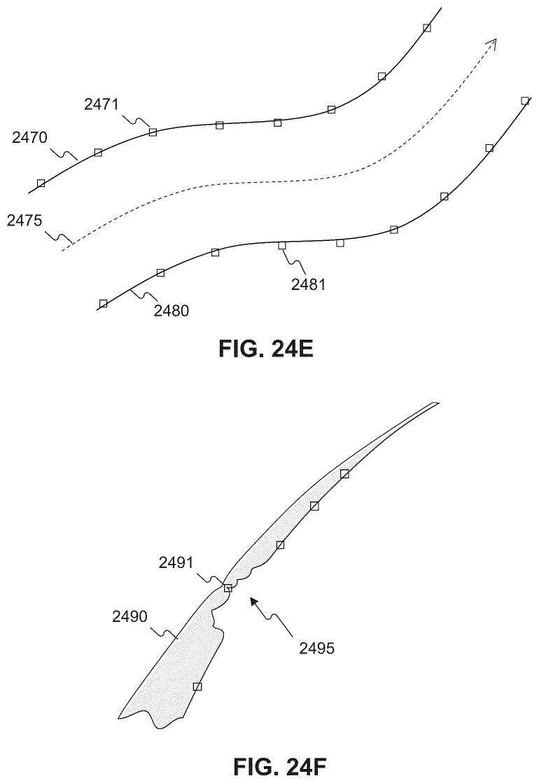

FIGS. 24A-24D illustrate exemplary point locations that may be detected by vehicle 200 to represent particular lane marks. Similar to the landmarks described above, vehicle 200 may use various image recognition algorithms or software to identify point locations within a captured image. For example, vehicle 200 may recognize a series of edge points, corner points or various other point locations associated with a particular lane mark. FIG. 24A shows a continuous lane mark 2410 that may be detected by vehicle 200. Lane mark 2410 may represent the outside edge of a roadway, represented by a continuous white line. As shown in FIG. 24A, vehicle 200 may be configured to detect a plurality of edge location points 2411 along the lane mark. Location points 2411 may be collected to represent the lane mark at any intervals sufficient to create a mapped lane mark in the sparse map. For example, the lane mark may be represented by one point per meter of the detected edge, one point per every five meters of the detected edge, or at other suitable spacings. In some embodiments, the spacing may be determined by other factors, rather than at set intervals such as, for example, based on points where vehicle 200 has a highest confidence ranking of the location of the detected points. Although FIG. 24A shows edge location points on an interior edge of lane mark 2410, points may be collected on the outside edge of the line or along both edges. Further, while a single line is shown in FIG. 24A, similar edge points may be detected for a double continuous line. For example, points 2411 may be detected along an edge of one or both of the continuous lines.

Vehicle 200 may also represent lane marks differently depending on the type or shape of lane mark. FIG. 24B shows an exemplary dashed lane mark 2420 that may be detected by vehicle 200. Rather than identifying edge points, as in FIG. 24A, vehicle may detect a series of corner points 2421 representing corners of the lane dashes to define the full boundary of the dash. While FIG. 24B shows each corner of a given dash marking being located, vehicle 200 may detect or upload a subset of the points shown in the figure. For example, vehicle 200 may detect the leading edge or leading corner of a given dash mark, or may detect the two corner points nearest the interior of the lane. Further, not every dash mark may be captured, for example, vehicle 200 may capture and/or record points representing a sample of dash marks (e.g., every other, every third, every fifth, etc.) or dash marks at a predefined spacing (e.g., every meter, every five meters, every 10 meters, etc.) Corner points may also be detected for similar lane marks, such as markings showing a lane is for an exit ramp, that a particular lane is ending, or other various lane marks that may have detectable corner points. Corner points may also be detected for lane marks consisting of double dashed lines or a combination of continuous and dashed lines.

In some embodiments, the points uploaded to the server to generate the mapped lane marks may represent other points besides the detected edge points or corner points. FIG. 24C illustrates a series of points that may represent a centerline of a given lane mark. For example, continuous lane 2410 may be represented by centerline points 2441 along a centerline 2440 of the lane mark. In some embodiments, vehicle 200 may be configured to detect these center points using various image recognition techniques, such as convolutional neural networks (CNN), scale-invariant feature transform (SIFT), histogram of oriented gradients (HOG) features, or other techniques. Alternatively, vehicle 200 may detect other points, such as edge points 2411 shown in FIG. 24A, and may calculate centerline points 2441, for example, by detecting points along each edge and determining a midpoint between the edge points. Similarly, dashed lane mark 2420 may be represented by centerline points 2451 along a centerline 2450 of the lane mark. The centerline points may be located at the edge of a dash, as shown in FIG. 24C, or at various other locations along the centerline. For example, each dash may be represented by a single point in the geometric center of the dash. The points may also be spaced at a predetermined interval along the centerline (e.g., every meter, 5 meters, 10 meters, etc.). The centerline points 2451 may be detected directly by vehicle 200, or may be calculated based on other detected reference points, such as corner points 2421, as shown in FIG. 24B. A centerline may also be used to represent other lane mark types, such as a double line, using similar techniques as above.

In some embodiments, vehicle 200 may identify points representing other features, such as a vertex between two intersecting lane marks. FIG. 24D shows exemplary points representing an intersection between two lane marks 2460 and 2465. Vehicle 200 may calculate a vertex point 2466 representing an intersection between the two lane marks. For example, one of lane marks 2460 or 2465 may represent a train crossing area or other crossing area in the road segment. While lane marks 2460 and 2465 are shown as crossing each other perpendicularly, various other configurations may be detected. For example, the lane marks 2460 and 2465 may cross at other angles, or one or both of the lane marks may terminate at the vertex point 2466. Similar techniques may also be applied for intersections between dashed or other lane mark types. In addition to vertex point 2466, various other points 2467 may also be detected, providing further information about the orientation of lane marks 2460 and 2465.

Vehicle 200 may associate real-world coordinates with each detected point of the lane mark. For example, location identifiers may be generated, including coordinate for each point, to upload to a server for mapping the lane mark. The location identifiers may further include other identifying information about the points, including whether the point represents a corner point, an edge point, center point, etc. Vehicle 200 may therefore be configured to determine a real-world position of each point based on analysis of the images. For example, vehicle 200 may detect other features in the image, such as the various landmarks described above, to locate the real-world position of the lane marks. This may involve determining the location of the lane marks in the image relative to the detected landmark or determining the position of the vehicle based on the detected landmark and then determining a distance from the vehicle (or target trajectory of the vehicle) to the lane mark. When a landmark is not available, the location of the lane mark points may be determined relative to a position of the vehicle determined based on dead reckoning. The real-world coordinates included in the location identifiers may be represented as absolute coordinates (e.g., latitude/longitude coordinates), or may be relative to other features, such as based on a longitudinal position along a target trajectory and a lateral distance from the target trajectory. The location identifiers may then be uploaded to a server for generation of the mapped lane marks in the navigation model (such as sparse map 800). In some embodiments, the server may construct a spline representing the lane marks of a road segment. Alternatively, vehicle 200 may generate the spline and upload it to the server to be recorded in the navigational model.

FIG. 24E shows an exemplary navigation model or sparse map for a corresponding road segment that includes mapped lane marks. The sparse map may include a target trajectory 2475 for a vehicle to follow along a road segment. As described above, target trajectory 2475 may represent an ideal path for a vehicle to take as it travels the corresponding road segment, or may be located elsewhere on the road (e.g., a centerline of the road, etc.). Target trajectory 2475 may be calculated in the various methods described above, for example, based on an aggregation (e.g., a weighted combination) of two or more reconstructed trajectories of vehicles traversing the same road segment.

In some embodiments, the target trajectory may be generated equally for all vehicle types and for all road, vehicle, and/or environment conditions. In other embodiments, however, various other factors or variables may also be considered in generating the target trajectory. A different target trajectory may be generated for different types of vehicles (e.g., a private car, a light truck, and a full trailer). For example, a target trajectory with relatively tighter turning radii may be generated for a small private car than a larger semi-trailer truck. In some embodiments, road, vehicle and environmental conditions may be considered as well. For example, a different target trajectory may be generated for different road conditions (e.g., wet, snowy, icy, dry, etc.), vehicle conditions (e.g., tire condition or estimated tire condition, brake condition or estimated brake condition, amount of fuel remaining, etc.) or environmental factors (e.g., time of day, visibility, weather, etc.). The target trajectory may also depend on one or more aspects or features of a particular road segment (e.g., speed limit, frequency and size of turns, grade, etc.). In some embodiments, various user settings may also be used to determine the target trajectory, such as a set driving mode (e.g., desired driving aggressiveness, economy mode, etc.).

The sparse map may also include mapped lane marks 2470 and 2480 representing lane marks along the road segment. The mapped lane marks may be represented by a plurality of location identifiers 2471 and 2481. As described above, the location identifiers may include locations in real world coordinates of points associated with a detected lane mark. Similar to the target trajectory in the model, the lane marks may also include elevation data and may be represented as a curve in three-dimensional space. For example, the curve may be a spline connecting three dimensional polynomials of suitable order the curve may be calculated based on the location identifiers. The mapped lane marks may also include other information or metadata about the lane mark, such as an identifier of the type of lane mark (e.g., between two lanes with the same direction of travel, between two lanes of opposite direction of travel, edge of a roadway, etc.) and/or other characteristics of the lane mark (e.g., continuous, dashed, single line, double line, yellow, white, etc.). In some embodiments, the mapped lane marks may be continuously updated within the model, for example, using crowdsourcing techniques. The same vehicle may upload location identifiers during multiple occasions of travelling the same road segment or data may be selected from a plurality of vehicles (such as 1205, 1210, 1215, 1220, and 1225) travelling the road segment at different times. Sparse map 800 may then be updated or refined based on subsequent location identifiers received from the vehicles and stored in the system. As the mapped lane marks are updated and refined, the updated road navigation model and/or sparse map may be distributed to a plurality of autonomous vehicles.

Generating the mapped lane marks in the sparse map may also include detecting and/or mitigating errors based on anomalies in the images or in the actual lane marks themselves. FIG. 24F shows an exemplary anomaly 2495 associated with detecting a lane mark 2490. Anomaly 2495 may appear in the image captured by vehicle 200, for example, from an object obstructing the camera's view of the lane mark, debris on the lens, etc. In some instances, the anomaly may be due to the lane mark itself, which may be damaged or worn away, or partially covered, for example, by dirt, debris, water, snow or other materials on the road. Anomaly 2495 may result in an erroneous point 2491 being detected by vehicle 200. Sparse map 800 may provide the correct the mapped lane mark and exclude the error. In some embodiments, vehicle 200 may detect erroneous point 2491 for example, by detecting anomaly 2495 in the image, or by identifying the error based on detected lane mark points before and after the anomaly. Based on detecting the anomaly, the vehicle may omit point 2491 or may adjust it to be in line with other detected points. In other embodiments, the error may be corrected after the point has been uploaded, for example, by determining the point is outside of an expected threshold based on other points uploaded during the same trip, or based on an aggregation of data from previous trips along the same road segment.

The mapped lane marks in the navigation model and/or sparse map may also be used for navigation by an autonomous vehicle traversing the corresponding roadway. For example, a vehicle navigating along a target trajectory may periodically use the mapped lane marks in the sparse map to align itself with the target trajectory. As mentioned above, between landmarks the vehicle may navigate based on dead reckoning in which the vehicle uses sensors to determine its ego motion and estimate its position relative to the target trajectory. Errors may accumulate over time and vehicle's position determinations relative to the target trajectory may become increasingly less accurate. Accordingly, the vehicle may use lane marks occurring in sparse map 800 (and their known locations) to reduce the dead reckoning-induced errors in position determination. In this way, the identified lane marks included in sparse map 800 may serve as navigational anchors from which an accurate position of the vehicle relative to a target trajectory may be determined.

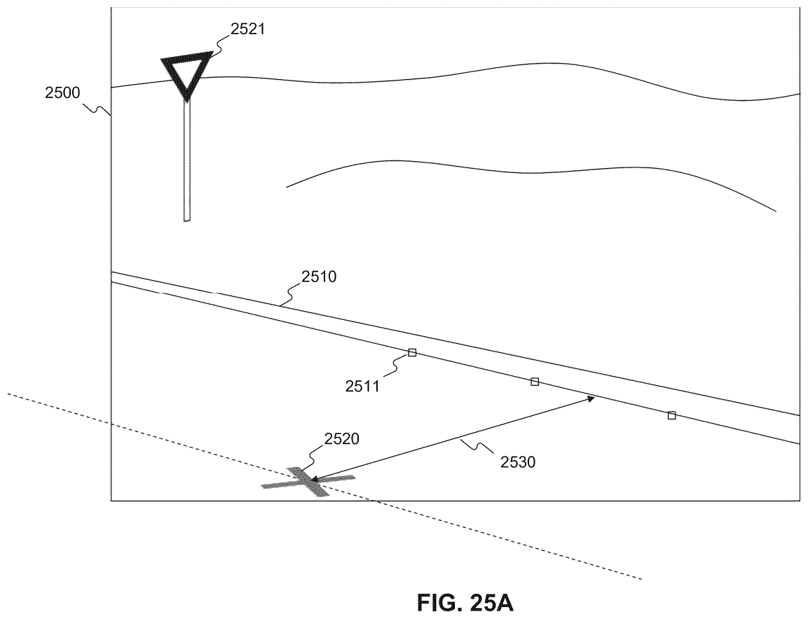

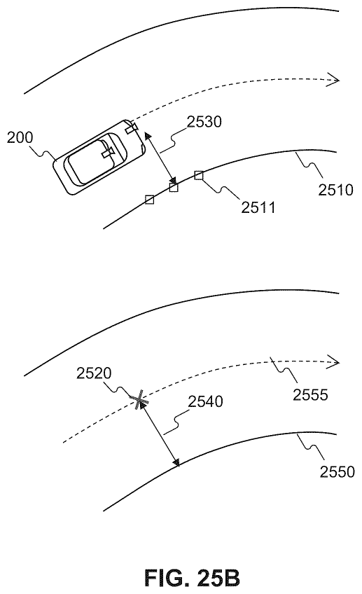

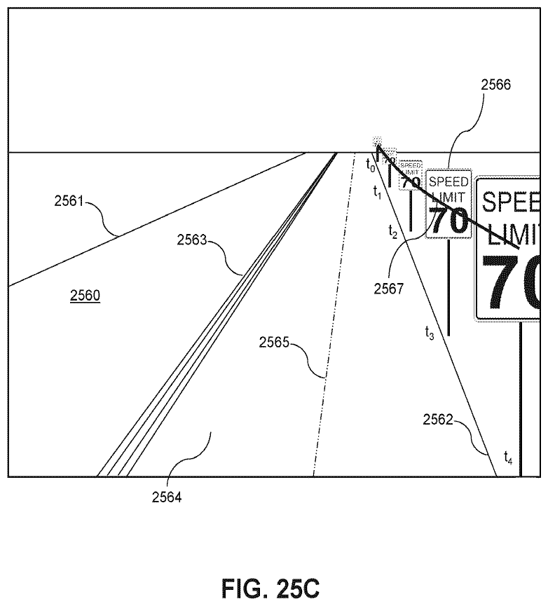

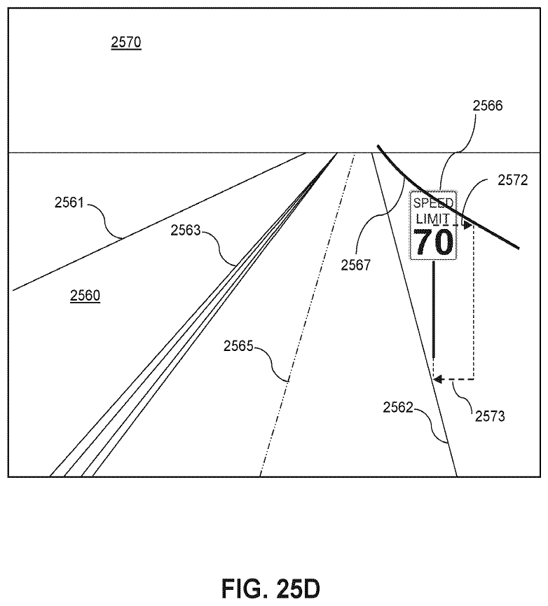

FIG. 25A shows an exemplary image 2500 of a vehicle's surrounding environment that may be used for navigation based on the mapped lane marks. Image 2500 may be captured, for example, by vehicle 200 through image capture devices 122 and 124 included in image acquisition unit 120. Image 2500 may include an image of at least one lane mark 2510, as shown in FIG. 25A. Image 2500 may also include one or more landmarks 2521, such as road sign, used for navigation as described above. Some elements shown in FIG. 25A, such as elements 2511, 2530, and 2520 which do not appear in the captured image 2500 but are detected and/or determined by vehicle 200 are also shown for reference.

Using the various techniques described above with respect to FIGS. 24A-D and 24F, a vehicle may analyze image 2500 to identify lane mark 2510. Various points 2511 may be detected corresponding to features of the lane mark in the image. Points 2511, for example, may correspond to an edge of the lane mark, a corner of the lane mark, a midpoint of the lane mark, a vertex between two intersecting lane marks, or various other features or locations. Points 2511 may be detected to correspond to a location of points stored in a navigation model received from a server. For example, if a sparse map is received containing points that represent a centerline of a mapped lane mark, points 2511 may also be detected based on a centerline of lane mark 2510.

The vehicle may also determine a longitudinal position represented by element 2520 and located along a target trajectory. Longitudinal position 2520 may be determined from image 2500, for example, by detecting landmark 2521 within image 2500 and comparing a measured location to a known landmark location stored in the road model or sparse map 800. The location of the vehicle along a target trajectory may then be determined based on the distance to the landmark and the landmark's known location. The longitudinal position 2520 may also be determined from images other than those used to determine the position of a lane mark. For example, longitudinal position 2520 may be determined by detecting landmarks in images from other cameras within image acquisition unit 120 taken simultaneously or near simultaneously to image 2500. In some instances, the vehicle may not be near any landmarks or other reference points for determining longitudinal position 2520. In such instances, the vehicle may be navigating based on dead reckoning and thus may use sensors to determine its ego motion and estimate a longitudinal position 2520 relative to the target trajectory. The vehicle may also determine a distance 2530 representing the actual distance between the vehicle and lane mark 2510 observed in the captured image(s). The camera angle, the speed of the vehicle, the width of the vehicle, or various other factors may be accounted for in determining distance 2530.

FIG. 25B illustrates a lateral localization correction of the vehicle based on the mapped lane marks in a road navigation model. As described above, vehicle 200 may determine a distance 2530 between vehicle 200 and a lane mark 2510 using one or more images captured by vehicle 200. Vehicle 200 may also have access to a road navigation model, such as sparse map 800, which may include a mapped lane mark 2550 and a target trajectory 2555. Mapped lane mark 2550 may be modeled using the techniques described above, for example using crowdsourced location identifiers captured by a plurality of vehicles. Target trajectory 2555 may also be generated using the various techniques described previously. Vehicle 200 may also determine or estimate a longitudinal position 2520 along target trajectory 2555 as described above with respect to FIG. 25A. Vehicle 200 may then determine an expected distance 2540 based on a lateral distance between target trajectory 2555 and mapped lane mark 2550 corresponding to longitudinal position 2520. The lateral localization of vehicle 200 may be corrected or adjusted by comparing the actual distance 2530, measured using the captured image(s), with the expected distance 2540 from the model.

FIGS. 25C and 25D provide illustrations associated with another example for localizing a host vehicle during navigation based on mapped landmarks/objects/features in a sparse map. FIG. 25C conceptually represents a series of images captured from a vehicle navigating along a road segment 2560. In this example, road segment 2560 includes a straight section of a two-lane divided highway delineated by road edges 2561 and 2562 and center lane marking 2563. As shown, the host vehicle is navigating along a lane 2564, which is associated with a mapped target trajectory 2565. Thus, in an ideal situation (and without influencers such as the presence of target vehicles or objects in the roadway, etc.) the host vehicle should closely track the mapped target trajectory 2565 as it navigates along lane 2564 of road segment 2560. In reality, the host vehicle may experience drift as it navigates along mapped target trajectory 2565. For effective and safe navigation, this drift should be maintained within acceptable limits (e.g., +/−10 cm of lateral displacement from target trajectory 2565 or any other suitable threshold). To periodically account for drift and to make any needed course corrections to ensure that the host vehicle follows target trajectory 2565, the disclosed navigation systems may be able to localize the host vehicle along the target trajectory 2565 (e.g., determine a lateral and longitudinal position of the host vehicle relative to the target trajectory 2565) using one or more mapped features/objects included in the sparse map.

As a simple example, FIG. 25C shows a speed limit sign 2566 as it may appear in five different, sequentially captured images as the host vehicle navigates along road segment 2560. For example, at a first time, t0, sign 2566 may appear in a captured image near the horizon. As the host vehicle approaches sign 2566, in subsequentially captured images at times t1, t2, t3, and t4, sign 2566 will appear at different 2D X-Y pixel locations of the captured images. For example, in the captured image space, sign 2566 will move downward and to the right along curve 2567 (e.g., a curve extending through the center of the sign in each of the five captured image frames). Sign 2566 will also appear to increase in size as it is approached by the host vehicle (i.e., it will occupy a great number of pixels in subsequently captured images).

These changes in the image space representations of an object, such as sign 2566, may be exploited to determine a localized position of the host vehicle along a target trajectory. For example, as described in the present disclosure, any detectable object or feature, such as a semantic feature like sign 2566 or a detectable non-semantic feature, may be identified by one or more harvesting vehicles that previously traversed a road segment (e.g., road segment 2560). A mapping server may collect the harvested drive information from a plurality of vehicles, aggregate and correlate that information, and generate a sparse map including, for example, a target trajectory 2565 for lane 2564 of road segment 2560. The sparse map may also store a location of sign 2566 (along with type information, etc.). During navigation (e.g., prior to entering road segment 2560), a host vehicle may be supplied with a map tile including a sparse map for road segment 2560. To navigate in lane 2564 of road segment 2560, the host vehicle may follow mapped target trajectory 2565.

The mapped representation of sign 2566 may be used by the host vehicle to localize itself relative to the target trajectory. For example, a camera on the host vehicle will capture an image 2570 of the environment of the host vehicle, and that captured image 2570 may include an image representation of sign 2566 having a certain size and a certain X-Y image location, as shown in FIG. 25D. This size and X-Y image location can be used to determine the host vehicle's position relative to target trajectory 2565. For example, based on the sparse map including a representation of sign 2566, a navigation processor of the host vehicle can determine that in response to the host vehicle traveling along target trajectory 2565, a representation of sign 2566 should appear in captured images such that a center of sign 2566 will move (in image space) along line 2567. If a captured image, such as image 2570, shows the center (or other reference point) displaced from line 2567 (e.g., the expected image space trajectory), then the host vehicle navigation system can determine that at the time of the captured image it was not located on target trajectory 2565. From the image, however, the navigation processor can determine an appropriate navigational correction to return the host vehicle to the target trajectory 2565. For example, if analysis shows an image location of sign 2566 that is displaced in the image by a distance 2572 to the left of the expected image space location on line 2567, then the navigation processor may cause a heading change by the host vehicle (e.g., change the steering angle of the wheels) to move the host vehicle leftward by a distance 2573. In this way, each captured image can be used as part of a feedback loop process such that a difference between an observed image position of sign 2566 and expected image trajectory 2567 may be minimized to ensure that the host vehicle continues along target trajectory 2565 with little to no deviation. Of course, the more mapped objects that are available, the more often the described localization technique may be employed, which can reduce or eliminate drift-induced deviations from target trajectory 2565.

The process described above may be useful for detecting a lateral orientation or displacement of the host vehicle relative to a target trajectory. Localization of the host vehicle relative to target trajectory 2565 may also include a determination of a longitudinal location of the target vehicle along the target trajectory. For example, captured image 2570 includes a representation of sign 2566 as having a certain image size (e.g., 2D X-Y pixel area). This size can be compared to an expected image size of mapped sign 2566 as it travels through image space along line 2567 (e.g., as the size of the sign progressively increases, as shown in FIG. 25C). Based on the image size of sign 2566 in image 2570, and based on the expected size progression in image space relative to mapped target trajectory 2565, the host vehicle can determine its longitudinal position (at the time when image 2570 was captured) relative to target trajectory 2565. This longitudinal position coupled with any lateral displacement relative to target trajectory 2565, as described above, allows for full localization of the host vehicle relative to target trajectory 2565, as the host vehicle navigates along road 2560.

FIGS. 25C and 25D provide just one example of the disclosed localization technique using a single mapped object and a single target trajectory. In other examples, there may be many more target trajectories (e.g., one target trajectory for each viable lane of a multi-lane highway, urban street, complex junction, etc.) and there may be many more mapped available for localization. For example, a sparse map representative of an urban environment may include many objects per meter available for localization.

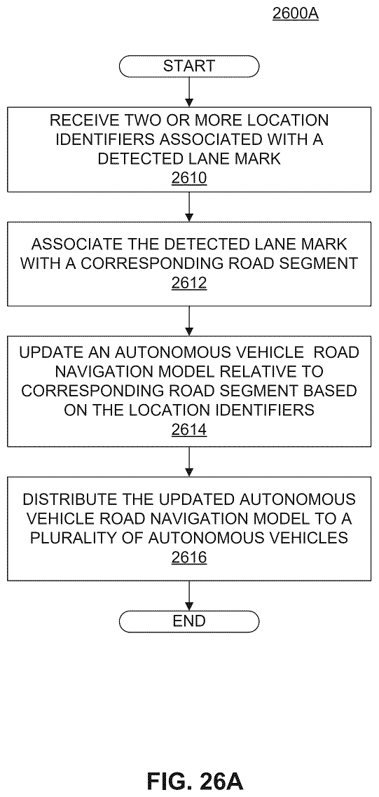

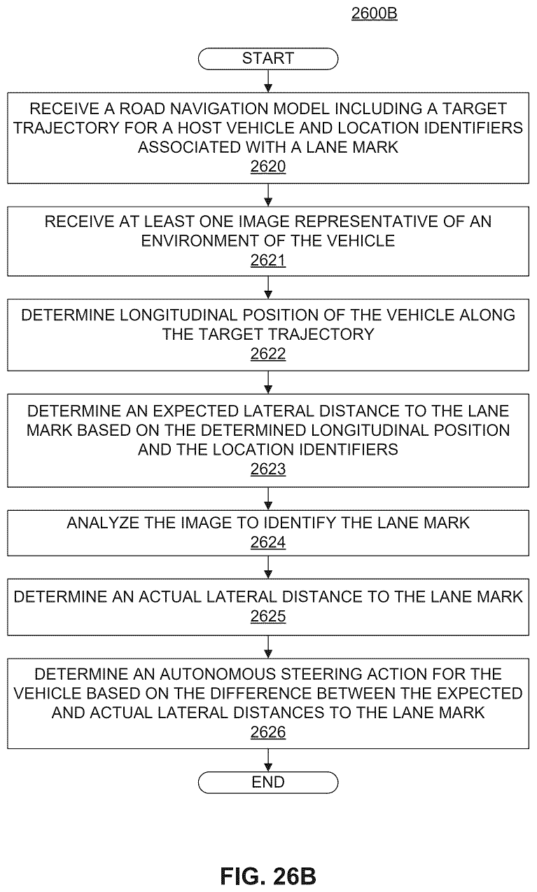

FIG. 26A is a flowchart showing an exemplary process 2600A for mapping a lane mark for use in autonomous vehicle navigation, consistent with disclosed embodiments. At step 2610, process 2600A may include receiving two or more location identifiers associated with a detected lane mark. For example, step 2610 may be performed by server 1230 or one or more processors associated with the server. The location identifiers may include locations in real-world coordinates of points associated with the detected lane mark, as described above with respect to FIG. 24E. In some embodiments, the location identifiers may also contain other data, such as additional information about the road segment or the lane mark. Additional data may also be received during step 2610, such as accelerometer data, speed data, landmarks data, road geometry or profile data, vehicle positioning data, ego motion data, or various other forms of data described above. The location identifiers may be generated by a vehicle, such as vehicles 1205, 1210, 1215, 1220, and 1225, based on images captured by the vehicle. For example, the identifiers may be determined based on acquisition, from a camera associated with a host vehicle, of at least one image representative of an environment of the host vehicle, analysis of the at least one image to detect the lane mark in the environment of the host vehicle, and analysis of the at least one image to determine a position of the detected lane mark relative to a location associated with the host vehicle. As described above, the lane mark may include a variety of different marking types, and the location identifiers may correspond to a variety of points relative to the lane mark. For example, where the detected lane mark is part of a dashed line marking a lane boundary, the points may correspond to detected corners of the lane mark. Where the detected lane mark is part of a continuous line marking a lane boundary, the points may correspond to a detected edge of the lane mark, with various spacings as described above. In some embodiments, the points may correspond to the centerline of the detected lane mark, as shown in FIG. 24C, or may correspond to a vertex between two intersecting lane marks and at least one two other points associated with the intersecting lane marks, as shown in FIG. 24D.

At step 2612, process 2600A may include associating the detected lane mark with a corresponding road segment. For example, server 1230 may analyze the real-world coordinates, or other information received during step 2610, and compare the coordinates or other information to location information stored in an autonomous vehicle road navigation model. Server 1230 may determine a road segment in the model that corresponds to the real-world road segment where the lane mark was detected.

At step 2614, process 2600A may include updating an autonomous vehicle road navigation model relative to the corresponding road segment based on the two or more location identifiers associated with the detected lane mark. For example, the autonomous road navigation model may be sparse map 800, and server 1230 may update the sparse map to include or adjust a mapped lane mark in the model. Server 1230 may update the model based on the various methods or processes described above with respect to FIG. 24E. In some embodiments, updating the autonomous vehicle road navigation model may include storing one or more indicators of position in real world coordinates of the detected lane mark. The autonomous vehicle road navigation model may also include a at least one target trajectory for a vehicle to follow along the corresponding road segment, as shown in FIG. 24E.

At step 2616, process 2600A may include distributing the updated autonomous vehicle road navigation model to a plurality of autonomous vehicles. For example, server 1230 may distribute the updated autonomous vehicle road navigation model to vehicles 1205, 1210, 1215, 1220, and 1225, which may use the model for navigation. The autonomous vehicle road navigation model may be distributed via one or more networks (e.g., over a cellular network and/or the Internet, etc.), through wireless communication paths 1235, as shown in FIG. 12.

In some embodiments, the lane marks may be mapped using data received from a plurality of vehicles, such as through a crowdsourcing technique, as described above with respect to FIG. 24E. For example, process 2600A may include receiving a first communication from a first host vehicle, including location identifiers associated with a detected lane mark, and receiving a second communication from a second host vehicle, including additional location identifiers associated with the detected lane mark. For example, the second communication may be received from a subsequent vehicle travelling on the same road segment, or from the same vehicle on a subsequent trip along the same road segment. Process 2600A may further include refining a determination of at least one position associated with the detected lane mark based on the location identifiers received in the first communication and based on the additional location identifiers received in the second communication. This may include using an average of the multiple location identifiers and/or filtering out “ghost” identifiers that may not reflect the real-world position of the lane mark.

FIG. 26B is a flowchart showing an exemplary process 2600B for autonomously navigating a host vehicle along a road segment using mapped lane marks. Process 2600B may be performed, for example, by processing unit 110 of autonomous vehicle 200. At step 2620, process 2600B may include receiving from a server-based system an autonomous vehicle road navigation model. In some embodiments, the autonomous vehicle road navigation model may include a target trajectory for the host vehicle along the road segment and location identifiers associated with one or more lane marks associated with the road segment. For example, vehicle 200 may receive sparse map 800 or another road navigation model developed using process 2600A. In some embodiments, the target trajectory may be represented as a three-dimensional spline, for example, as shown in FIG. 9B. As described above with respect to FIGS. 24A-F, the location identifiers may include locations in real world coordinates of points associated with the lane mark (e.g., corner points of a dashed lane mark, edge points of a continuous lane mark, a vertex between two intersecting lane marks and other points associated with the intersecting lane marks, a centerline associated with the lane mark, etc.).

At step 2621, process 2600B may include receiving at least one image representative of an environment of the vehicle. The image may be received from an image capture device of the vehicle, such as through image capture devices 122 and 124 included in image acquisition unit 120. The image may include an image of one or more lane marks, similar to image 2500 described above.

At step 2622, process 2600B may include determining a longitudinal position of the host vehicle along the target trajectory. As described above with respect to FIG. 25A, this may be based on other information in the captured image (e.g., landmarks, etc.) or by dead reckoning of the vehicle between detected landmarks.

At step 2623, process 2600B may include determining an expected lateral distance to the lane mark based on the determined longitudinal position of the host vehicle along the target trajectory and based on the two or more location identifiers associated with the at least one lane mark. For example, vehicle 200 may use sparse map 800 to determine an expected lateral distance to the lane mark. As shown in FIG. 25B, longitudinal position 2520 along a target trajectory 2555 may be determined in step 2622. Using spare map 800, vehicle 200 may determine an expected distance 2540 to mapped lane mark 2550 corresponding to longitudinal position 2520.

At step 2624, process 2600B may include analyzing the at least one image to identify the at least one lane mark. Vehicle 200, for example, may use various image recognition techniques or algorithms to identify the lane mark within the image, as described above. For example, lane mark 2510 may be detected through image analysis of image 2500, as shown in FIG. 25A.

At step 2625, process 2600B may include determining an actual lateral distance to the at least one lane mark based on analysis of the at least one image. For example, the vehicle may determine a distance 2530, as shown in FIG. 25A, representing the actual distance between the vehicle and lane mark 2510. The camera angle, the speed of the vehicle, the width of the vehicle, the position of the camera relative to the vehicle, or various other factors may be accounted for in determining distance 2530.

At step 2626, process 2600B may include determining an autonomous steering action for the host vehicle based on a difference between the expected lateral distance to the at least one lane mark and the determined actual lateral distance to the at least one lane mark. For example, as described above with respect to FIG. 25B, vehicle 200 may compare actual distance 2530 with an expected distance 2540. The difference between the actual and expected distance may indicate an error (and its magnitude) between the vehicle's actual position and the target trajectory to be followed by the vehicle. Accordingly, the vehicle may determine an autonomous steering action or other autonomous action based on the difference. For example, if actual distance 2530 is less than expected distance 2540, as shown in FIG. 25B, the vehicle may determine an autonomous steering action to direct the vehicle left, away from lane mark 2510. Thus, the vehicle's position relative to the target trajectory may be corrected. Process 2600B may be used, for example, to improve navigation of the vehicle between landmarks.

Processes 2600A and 2600B provide examples only of techniques that may be used for navigating a host vehicle using the disclosed sparse maps. In other examples, processes consistent with those described relative to FIGS. 25C and 25D may also be employed.

In some embodiments, the disclosed systems, methods, and non-transitory computer-readable media may use one or more AV maps. An autonomous vehicle (AV) map (or AV map) may include information to support and/or implement one or more autonomous vehicle (AV) functions of a vehicle in manner such that the vehicle operates in a safe manner and/or navigates in an accurate manner. The AV functions supported and/or implemented by an autonomous vehicle (or a semi-autonomous vehicle) may include one or more autonomously controlled functions (e.g., functions determined, selected, and/or implemented based on instructions executed by at least one processor) such as steering, accelerating, and/or braking the vehicle. The AV functions may be part of a driving policy, such as RSS, for example, which was developed and is implemented by Mobileye, of Jerusalem, Israel. The information for operating the vehicle in a safe manner may include, but is not limited to, information pertaining to one or more regulations applicable to a location of the vehicle or a jurisdiction (e.g., a right-hand traffic or left-hand traffic jurisdiction), information related to an environment in which the vehicle is located (e.g., information related to a drivable path, stop sign, traffic light, speed limit, lane markings, landmarks, free space, virtual or physical stop lines, traffic light relevancy information, etc.), and/or information related to adjusting and/or adapting navigation of the vehicle to account for one or more objects (e.g., other vehicles, pedestrians, objects, obstacles, occlusions, hazards, road work zones, traffic cones, etc.) in an environment of the vehicle. The vehicle may sense objects in the environment of the vehicle using one or more sensors (e.g., cameras, radar, lidar), as discussed herein. The AV map may serve as a redundant source of information for the sensed information and, in some cases, may also supplement the sensed information (e.g., provide a location of a virtual stop line, where no stop line is marked on the road). In some embodiments, operating the vehicle in a safe manner may further include operating the vehicle to maintain a comfort level for one or more passengers in the vehicle. The comfort level may include one or more predetermined criteria (e.g., related to speed, acceleration, and/or turning) selected to cause the vehicle to operate in a manner that meets or exceeds a designated or selected level of passenger comfort. The level of comfort may be formalized and expressed in appropriate mathematical formulae. For example, mathematical formulae that limit the extent of jerk or acceleration in different directions that is applied to a passenger may be used. The information for operating the vehicle in an accurate manner may include, but is not limited to, information pertaining to a planned or designated navigational path (e.g., a trajectory, as discussed herein) or a route (e.g., from a particular location, such as a starting location, to a destination). In some embodiments, the information included in an AV map may further include information that supports and/or implements one or more AV functions in an efficient manner. The information for operating the vehicle in an efficient manner may include information pertaining to speed, acceleration, lane changes, and/or lane positioning, and/or traveling and/or selecting a path or route based on traffic conditions (e.g., traveling a route that is a greater distance than a shorter route experiencing traffic conditions) and/or other factors or attributes related to potential routes (e.g., weather conditions, road conditions, or other characteristics of routes, such as traveling a highway without traffic lights instead of a road with traffic lights). In some embodiments, the AV map may further include at least some information from a high-definition (HD) map. In some embodiments, the AV map may be a sparse map, as described above. In some embodiments, the AV map may be crowdsourced, as discussed herein. In this disclosure, the terms “AV map” and “sparse map” are used interchangeably.

### Determining Ambient Light Level of Image Using Camera Properties and Internal Camera Parameters

Autonomous and semi-autonomous vehicles may measure ambient light levels for various applications. Some applications relate to comfort features, such as adjusting brightness, contrast, or colors of a dashboard or a head-up display to improve visibility for a driver or passenger. A head-up display projects information onto a transparent surface, such as a windshield, allowing a driver to view navigation data, speed, or other vehicle information while maintaining visual attention on the road ahead. The visibility and readability of the projected information may depend on the contrast between the projection and the background environment visible through the windshield. In bright environments, the projection may need to be adjusted to remain visible against the illuminated background, while in darker environments, the projection may need different adjustments to avoid being overly bright or distracting.

Other applications relate to safety requirements, including determining when to activate or adjust headlights of a vehicle. In some jurisdictions, headlight regulations may require headlights to be activated when ambient light levels fall below a threshold (e.g., 1000 LUX) and may allow headlights to be deactivated when ambient light levels exceed another threshold (e.g., 7000 LUX). Between such thresholds (e.g., between 1000 LUX and 7000 LUX), a vehicle system may have discretion regarding headlight activation states.

Conventional approaches to measuring ambient light levels in vehicles may involve installing a lux meter (also referred to as a light sensor) in the vehicle. A lux meter is a dedicated module configured to measure ambient light by summing incoming light reaching a sensor surface of the lux meter. However, lux meters may have limitations for advanced vehicle applications that require wider coverage areas and more accurate light level measurements than those provided by a lux meter.

A lux meter typically points upward to the sky, which may provide a general indication of overall illumination level in an environment. However, a lux meter that sums all incoming light reaching the sensor surface of the lux meter may not distinguish between different scene illumination scenarios. For example, a lux meter may not distinguish between a uniformly gray scene and a dark scene with a strong light source in a small portion of the scene, because both scenarios may result in similar total photon counts reaching the sensor surface of the lux meter.

The shortcomings of a lux meter may be overcome by using cameras, already mounted on a vehicle, to measure the ambient light surrounding the vehicle. Using cameras for ambient light detection may provide several advantages over traditional lux meters. From a cost perspective, using cameras that are already implemented on the vehicle for other purposes, such as autonomous driving or advanced driver assistance systems (ADAS), may eliminate the need for a separate lux meter, thereby reducing overall system cost and complexity. Additionally, using cameras for ambient light detection may provide redundancy in the system, for example, if a lux meter fails or if lux meter measurements and camera-based measurements perform better in different scenarios, the system may benefit from having both measurement approaches available. Furthermore, camera-based systems may allow for an adjustable region of interest, such that even in implementations where the system outputs a single numerical value similar to a lux meter, this value may pertain to relevant parts of the environment, allowing the system to focus on areas where ambient light measurement is important and to ignore potential interferences from other regions. Camera-based systems may also provide different illumination values for different directions in the environment, enabling more spatially resolved ambient light measurements compared to a single aggregate value from a lux meter. Moreover, cameras may provide chromatic illumination values, capturing color information about the ambient light, as well as chromatic data that may be useful for adjusting display parameters such as those of a head-up display. The adjustable region of interest, directional illumination values, and chromatic illumination values may be defined dynamically based on various factors, such as the ambient light level, scene understanding derived from image analysis, map information, or the operational state of vehicle systems.

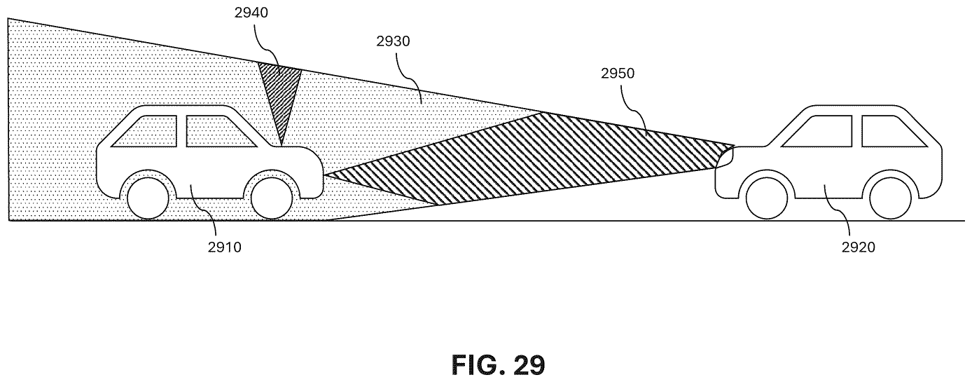

FIG. 29 is a diagram illustrating a comparison between a field of view of a lux meter and a field of view of a camera placed at a front of a vehicle for detecting light from headlights of another vehicle. A first vehicle 2910 is positioned ahead of a second vehicle 2920 on a road surface, driving towards vehicle 2920. The second vehicle 2920 has front lights that illuminate an area reached by front lights of second vehicle 2930, which extends forward from the second vehicle 2920 toward the first vehicle 2910.

With continued reference to FIG. 29, an overlap between area 2930 and a field of view of lux meter is shown as region 2940. Because the lux meter points upward to the sky and the headlights of the second vehicle 2920 are directed horizontally, the overlap between area 2930 and the field of view of lux meter 2940 may be limited.

In such perpendicular situations where vehicle headlights are directed horizontally while the lux meter measures light arriving from above, the lux meter may provide erroneous measurements because the direction of the headlights and the field of view of the lux meter are near perpendicular. This geometric mismatch between the orientation of the lux meter and the direction of incoming light from vehicle headlights may result in the lux meter failing to detect or significantly underestimating the intensity of light emitted by approaching vehicles. Because lux meters are typically installed in vehicles with their sensor surfaces oriented upward toward the sky to capture ambient illumination from overhead sources such as sunlight or streetlights, the lux meter may not effectively capture light that propagates horizontally along the roadway. Consequently, when a vehicle with illuminated headlights approaches from ahead, the light from those headlights travels in a direction that is substantially orthogonal to the upward-facing sensor surface of the lux meter, causing the lux meter to register a lower light intensity than what is actually present in the forward direction of travel. This limitation may be particularly problematic in scenarios where accurate detection of oncoming vehicle headlights is important for determining appropriate headlight states for the host vehicle, such as when deciding whether to switch from high beams to low beams to avoid blinding drivers of approaching vehicles.

As further shown in FIG. 29, an overlap between area 2930 and field of view of a camera is shown as a region 2950 extending horizontally between the first vehicle 2910 and the second vehicle 2920. The overlap between area 2930 and field of view of the camera placed front of vehicle 2950 demonstrates that a forward-facing camera may detect the headlights of the second vehicle 2920 more effectively than the lux meter because the camera field of view is oriented in a direction that aligns with the direction of the headlights.

In some embodiments, using onboard cameras that are already installed in a vehicle for navigation purposes as light measurement modules may provide several advantages over conventional lux meter approaches. A camera-based system may provide a wider field of view than a lux meter, allowing the system to detect light sources across a broader area of the environment. A camera-based system may also provide improved resolution, enabling the system to provide brightness level scores at camera resolution for higher resolution than lux meters. In some embodiments, multiple cameras with overlapping fields of view may be used to verify measurement results and provide more accurate data. Using cameras that are already installed in the vehicle may also eliminate the need for a dedicated lux sensor, which may reduce cost and complexity of the overall vehicle system.

The disclosed system and method may determine an ambient light level using one or more cameras onboard a vehicle.

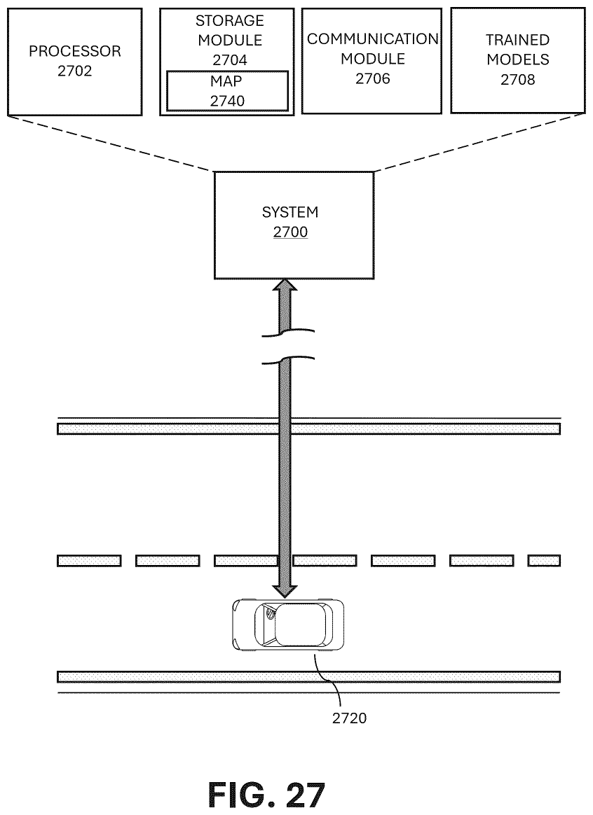

FIG. 27 illustrates a host vehicle navigation system 2700, consistent with disclosed embodiments. System 2700 may include at least one processor 2702, as shown. In addition to processor 2702, system 2700 may include a storage module 2704 and a communication module 2706, which may communicate with processor 2702. Image data, for example, captured by a camera onboard a host vehicle 2720, and any other type of sensor information or driving state information may be received via communication module 2706.

Processor 2702 may include various types of processing devices. For example, processor 2702 may include one or more microprocessors, preprocessors, a central processing unit (CPU), support circuits, digital signal processors, integrated circuits, memory, or any other types of devices suitable for running applications. Communication module 2706 may include one or more devices configured to receive one or more instructions from processor 2702 and/or exchange transmissions over an air interface to one or more networks (e.g., cellular, the Internet, etc.) by use of a radio frequency, infrared frequency, magnetic field, or an electric field. Storage module 2704 may receive data and/or instructions from processor 2702. Storage module 2704 may include one or more of random-access memory (RAM), read-only memory (ROM), flash memory, disk drives, optical storage, tape storage, removable storage and/or any other types of storage. Communication module 2706 may use any known standard to transmit and/or receive data (e.g., Wi-Fi, Bluetooth®, Bluetooth Smart, 3102.15.4, ZigBee, etc.). Such transmissions may include communications from system 2700 to at least one remotely located vehicle.

In some cases, storage module 2704 may store a map 2740 (e.g., a REM map as described above) of one or more road segments or geographic regions. In some examples, map 2740 includes a certain number of map tiles (e.g., 1-8 REM map tiles) that may be downloaded from a mapping server on demand and based on the needs, current location, planned route, etc. of a host vehicle navigation system.

Additionally, in some embodiments, system 2700 may be capable of communicating with at least one trained model. Communicating with at least one trained model may include inputting one or more different data entries to the trained model as well as reading or extracting one or more outputs from the trained model. In some embodiments, the at least one trained model may be local to the system. For example, as shown in FIG. 27, system 2700 may comprise trained model 2708. Alternatively, in some embodiments, the at least one trained model may be external to the system, and the at least one processor may communicate with the at least one trained model using any known means for sending and/or receiving data. For example, the at least one processor 2702 may use communication module 2706 to interact and communicate with an external trained model.

In some embodiments, the trained model or trained system may include various types of machine learning architectures suitable for processing sensor data and making predictions or classifications in the context of autonomous or semi-autonomous vehicles. For example, the trained system may include a convolutional neural network configured to analyze image data captured by cameras onboard the host vehicle. The trained system may include a recurrent neural network or a long short-term memory network configured to process sequential data such as time-series sensor readings or video frames. In some embodiments, the trained system may include a transformer-based architecture that applies attention mechanisms to identify relevant features within input data. The trained system may include a deep neural network with multiple hidden layers configured to learn hierarchical representations of input data. In some cases, the trained system may include an encoder-decoder architecture where an encoder extracts features from input data and a decoder generates predictions or classifications based on the extracted features. The trained system may include a generative adversarial network configured to generate synthetic data for training purposes or to perform image enhancement tasks. In some embodiments, the trained system may include a reinforcement learning model configured to learn optimal actions or decisions based on environmental feedback. The trained system may include an ensemble of multiple models that combine predictions from different architectures to improve accuracy and robustness. In some cases, the trained system may include a neural network configured for semantic segmentation, object detection, depth estimation, or other computer vision tasks relevant to autonomous vehicle navigation. The trained system may be trained using supervised learning techniques with labeled training data, unsupervised learning techniques to discover patterns in unlabeled data, or semi-supervised learning techniques that combine labeled and unlabeled data during training.

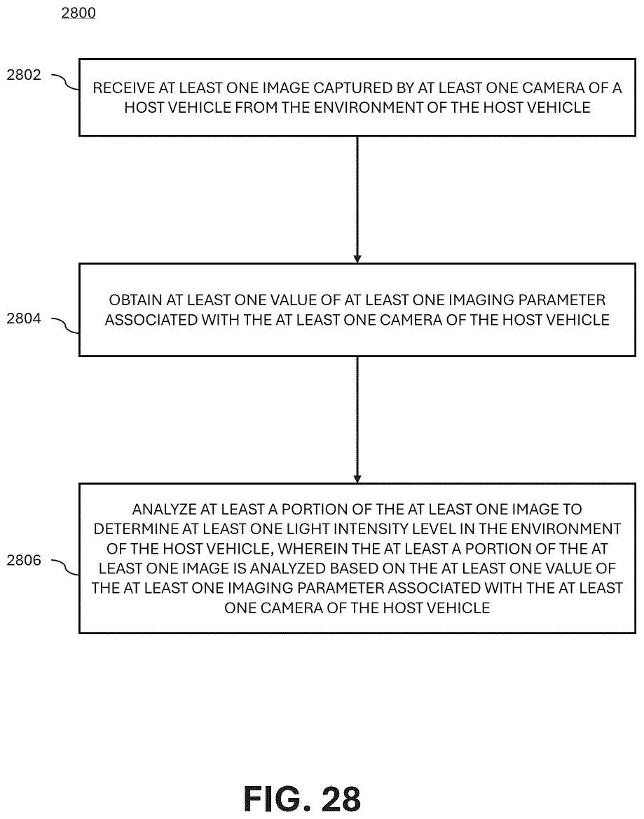

FIG. 28 is a flowchart showing an illustrative method 2800 according to the embodiments of the present disclosure. The steps of method 2800 will be described hereafter.

According to the embodiments of the present disclosure, a system may be used to determine an ambient light level in an environment of a host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

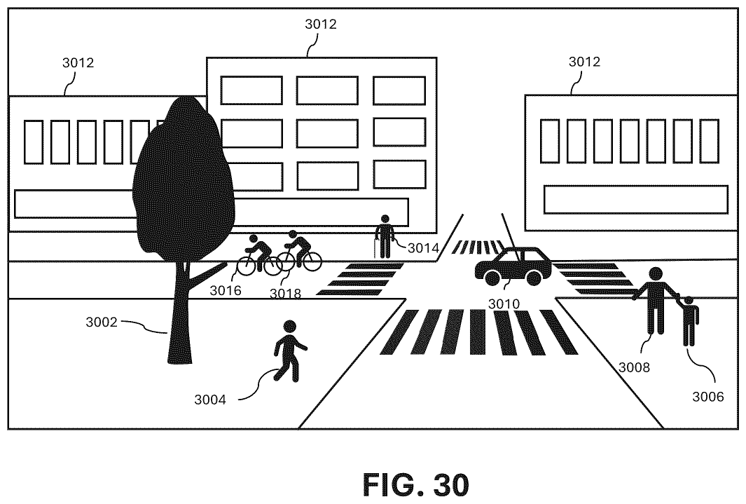

In step 2802, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30.

In some embodiments, different cameras may be used for capturing the at least one image. For example, the at least one camera may include a front camera positioned at a front portion of the host vehicle and oriented to capture images of the environment ahead of the host vehicle. Additionally, or alternatively, the at least one camera may include a rear camera positioned at a rear portion of the host vehicle and oriented to capture images of the environment behind the host vehicle. In some embodiments, the at least one camera may include one or more corner cameras positioned at corner portions of the host vehicle to capture images of the environment at various angles relative to the host vehicle. The use of multiple cameras positioned at different locations on the host vehicle may provide a wider field of view coverage for ambient light level determination compared to a single camera or a traditional lux meter.

In some embodiments, different camera sensor types may be used for capturing the at least one image in step 2802. For example, the at least one camera may include an RGB sensor configured to capture color image data across red, green, and blue color channels. In some embodiments, the at least one camera may include an RYYCy sensor configured to capture image data using a red, yellow, yellow, and cyan color filter arrangement. In some embodiments, the at least one camera may include an IR sensor configured to capture infrared image data. The RGB sensor may be configured to capture visible light across the standard color spectrum that corresponds to human visual perception, providing color information that may be useful for detecting visible light sources and distinguishing between different types of illumination in the environment. The RYYCy sensor may be configured with a different color filter arrangement that provides enhanced sensitivity to certain wavelengths, particularly in low-light conditions, as the yellow and cyan filters may allow more light to reach the sensor compared to traditional RGB arrangements. The IR sensor may be configured to capture infrared radiation that is not visible to the human eye, which may be useful for detecting heat sources or for imaging in conditions where visible light is limited. The differences between these sensor types may be used to determine an ambient light level in various ways. For example, the RGB sensor may provide accurate color temperature information that indicates whether the ambient light is from natural sunlight or artificial sources. The RYYCy sensor may provide improved low-light performance, allowing for more accurate ambient light level determination in dim conditions where an RGB sensor may have reduced sensitivity. The IR sensor may detect ambient thermal radiation that correlates with environmental lighting conditions, and the difference between IR sensor readings and visible light sensor readings may indicate the presence of artificial light sources versus natural illumination. In some embodiments, multiple sensor types may be used together, and the comparison of readings from different sensor types may provide a more comprehensive determination of ambient light levels across different spectral ranges. The selection of camera sensor type may depend on the particular application or environmental conditions in which the ambient light level determination is performed.

In step 2804, the system obtains at least one value of at least one imaging parameter associated with the at least one camera of the host vehicle. The at least one imaging parameter may be associated with how the at least one camera captures images from the environment of the host vehicle.

In some embodiments, the at least one imaging parameter associated with the at least one camera of the host vehicle may be at least one light-adaptive imaging parameter.

Light-adaptive imaging parameters may include parameters that the camera adjusts in response to varying light conditions in the environment. Light-adaptive imaging parameters may, for example, include ISO sensitivity, which determines how sensitive the camera sensor is to incoming light. A high ISO value selected by the camera may indicate a low ambient light level in the environment, as the camera increases sensor sensitivity to compensate for reduced illumination, whereas a low ISO value may indicate a bright ambient light level. Other examples of light-adaptive imaging parameters may include shutter speed, where a longer shutter speed selected by the camera may indicate darker ambient conditions requiring more time to gather sufficient light, while a shorter shutter speed may indicate brighter conditions. White balance settings that adjust color temperature compensation based on ambient lighting conditions may also be indicative of ambient light levels, as different white balance values may correspond to different types of illumination such as daylight, overcast conditions, or artificial lighting. Automatic exposure compensation values may similarly indicate ambient light levels, where positive compensation values may suggest the camera is attempting to brighten an image in darker conditions and negative compensation values may suggest the camera is reducing brightness in overly bright conditions. In some embodiments, light-adaptive imaging parameters may further include high dynamic range (HDR) settings, where activation of HDR mode may indicate challenging lighting conditions with significant contrast between bright and dark regions in the environment. Gamma correction values and automatic brightness control parameters that the camera uses to optimize image capture across different illumination levels in the environment of the host vehicle may also serve as indicators of ambient light levels, as these parameters are adjusted by the camera in response to the overall brightness of the scene being captured.

In some embodiments, the at least one imaging parameter associated with the at least one camera of the host vehicle may include an exposure time or an aperture size. Exposure time may refer to the duration during which the camera sensor is exposed to light when capturing an image. Aperture size may refer to the size of the opening through which light enters the camera. Both exposure time and aperture size may affect the brightness of a captured image and may be adjusted by the camera in response to ambient light conditions.

In some embodiments, the at least one imaging parameter associated with the at least one camera of the host vehicle may include a camera gain or other internal parameters for determining an ambient light level. Camera gain may refer to an amplification factor applied to the signal from the camera sensor. The camera gain may be adjusted by the camera in response to ambient light conditions, with higher gain values used in darker environments and lower gain values used in brighter environments. By obtaining the camera gain value, the system may infer the overall brightness of the scene captured by the at least one camera without analyzing individual pixel values. The system may then use the inferred overall scene brightness to adjust display parameters of a head-up display or a dashboard of the host vehicle for example.

In step 2806, the system analyzes at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

In some embodiments, the at least one light intensity level may be an environmental light intensity level. As used herein, an environmental light intensity level may refer to a measure of the overall illumination present in the surroundings of the host vehicle, encompassing light from various sources such as sunlight, streetlights, vehicle headlights, and reflected light from surfaces in the environment. The environmental light intensity level may represent an aggregate or representative value characterizing the brightness conditions in which the host vehicle is operating.

In some embodiments, the at least one light intensity level may be a photometric light intensity level. As used herein, a photometric light intensity level may refer to a measurement of light that is weighted according to the spectral sensitivity of human vision, such that the measurement corresponds to how bright the light would appear to a human observer. Photometric measurements may be expressed in units such as lux or candela and may account for the varying sensitivity of the human eye to different wavelengths of visible light.

In some embodiments, the at least one light intensity level may be a radiometric light intensity level. As used herein, a radiometric light intensity level may refer to a measurement of electromagnetic radiation without weighting for human visual perception, representing the total power of light across a range of wavelengths regardless of how visible those wavelengths are to the human eye.

In some embodiments, the at least one light intensity level may be a directional light intensity level. As used herein, a directional light intensity level may refer to a measurement of light intensity associated with a particular direction or region within the environment of the host vehicle, rather than an aggregate measurement across the entire field of view.

In some embodiments, the at least one light intensity level may be a spectral light intensity level. As used herein, a spectral light intensity level may refer to a measurement of light intensity at one or more specific wavelengths or wavelength ranges, which may be useful for characterizing the color temperature or spectral composition of ambient illumination.

The analysis may involve mapping pixel intensity values from the captured image to corresponding light intensity values (e.g., candela or lux values) using the obtained imaging parameters such as exposure time and aperture size. By correlating the brightness levels observed in the image with the camera settings that were active during image capture, the system may derive an accurate representation of the ambient light conditions present in the environment of the host vehicle.

The intensity value may be expressed in units such as candela, which measures luminous intensity in a given direction. Candela is a base unit that quantifies the luminous power emitted by a light source in a particular direction per unit solid angle. The candela measurement accounts for the sensitivity of the human eye to different wavelengths of light, with the luminous intensity being weighted according to the luminosity function that represents the average spectral sensitivity of human visual perception. When a camera captures an image of a light source, the pixel intensity values in the captured image correspond to the amount of light reaching the camera sensor from that direction. By knowing the camera properties such as exposure time, aperture size, and sensor sensitivity, along with internal parameters such as the camera's spectral response characteristics and gain settings for example, the system may calculate the luminous intensity of the light source in candela. This calculation may involve determining the relationship between the digital pixel values recorded by the camera sensor and the actual photometric quantities of the light entering the camera lens. The camera effectively acts as a calibrated photometer when the imaging parameters are known, allowing the system to convert the captured image intensity data into standardized photometric measurements that can be used for ambient light level determination

Additionally, or alternatively, the luminous intensity may be measured in lux, which measures illuminance as the amount of luminous flux per unit area. In some embodiments, the system may convert between different photometric units depending on the application requirements. For example, candela measurements may be useful for characterizing directional light sources such as headlights of approaching vehicles, while lux measurements may be more appropriate for determining overall ambient illumination levels in the environment of the host vehicle. By analyzing the brightness levels of pixels in the at least one image in conjunction with the at least one imaging parameter, the system may determine the intensity of light sources present in the environment. For example, if the camera has a short exposure time and a small aperture size, a bright pixel in the captured image may correspond to a high-intensity light source. Conversely, if the camera has a long exposure time and a large aperture size, a similarly bright pixel may correspond to a lower-intensity light source.

In some embodiments, analyzing a portion of the at least one image rather than the entire image may provide several advantages for ambient light level determination. Selective region analysis may enable the system to distinguish between regions containing data suitable for analysis and regions containing data that may introduce noise or inaccuracies into the light level measurements.

In some embodiments, the portion of the at least one image selected for analysis may be defined according to various numerical criteria. For example, the portion of the at least one image may correspond to a solid angle of at least 10 millisteradians, at least 100 millisteradians, or at least 500 millisteradians. In some embodiments, the portion of the at least one image may correspond to a solid angle of at least 50 square degrees, at least 100 square degrees, or at least 500 square degrees. In some embodiments, the portion of the at least one image may correspond to at least 10 percent of a field of view of the at least one camera, at least 20 percent of the field of view, at least 30 percent of the field of view, or at least 50 percent of the field of view. In some embodiments, the portion of the at least one image may correspond to at least 10,000 pixels, at least 50,000 pixels, at least 100,000 pixels, or at least 500,000 pixels of the at least one image. The selection of an appropriate portion size may depend on factors such as the resolution of the at least one camera, the field of view of the at least one camera, the type of ambient light measurement being performed, and the specific application requirements for the ambient light level determination.

In some embodiments, the portion of the at least one image selected for analysis may be a continuous portion or may comprise multiple non-continuous portions. A continuous portion may refer to a single connected region of pixels within the image, such as a rectangular area or an irregularly shaped region where all pixels are adjacent to one another. Non-continuous portions may refer to multiple separate regions of the image that are analyzed together but are not spatially connected. For example, the system may select multiple discrete regions corresponding to different areas of the sky visible in the captured image, or may select separate regions on opposite sides of the image that both contain relevant ambient light information. The selection of continuous or non-continuous portions may depend on the distribution of relevant features within the captured image and the specific requirements of the ambient light level determination.

In some embodiments, the portion of the at least one image selected for analysis may correspond to a percentage of the total image area. For example, the portion may correspond to 10 to 20 percent of the image, 20 to 30 percent of the image, 30 to 40 percent of the image, 40 to 50 percent of the image, or 50 to 60 percent of the image. In some embodiments, the portion may correspond to less than 10 percent of the image when the system identifies a small but highly relevant region for ambient light analysis. In some embodiments, the portion may correspond to more than 60 percent of the image when a large area of the captured image contains relevant ambient light information. The percentage of the image selected for analysis may vary dynamically based on the content of the captured image, the detected objects within the image, and the specific application requirements.

In some embodiments, the portion of the at least one image selected for analysis may correspond to a percentage of the total image area and a portion of at least one subsequent image selected for analysis may correspond to a different percentage of the total image area. The at least one subsequent image may correspond to an image captured after the at least one image. Accordingly, in some embodiments, if host vehicle experiences pitch changes (which in turn move the camera) or other changes, a relevant area of a plurality of image frames captured during the changes may be changed quickly (e.g., under a second), so that the system is adaptive and identifies the relevant area.

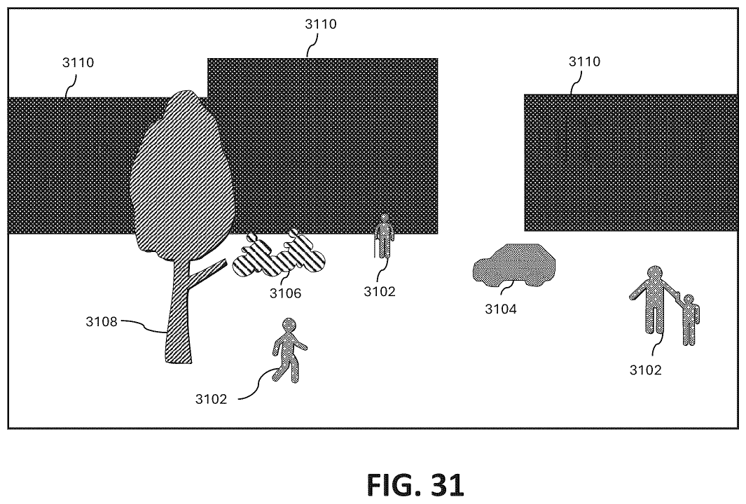

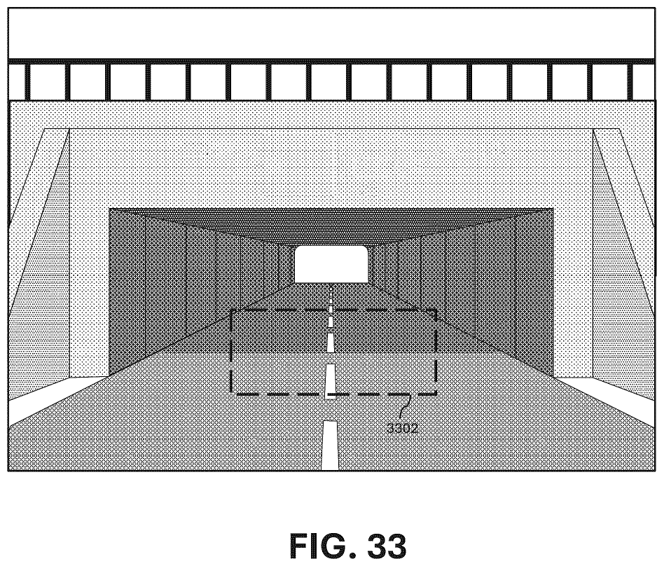

For example, in automotive applications involving lux measurements for headlight activation or deactivation decisions, certain image regions may include elements that could affect measurement accuracy. Regions of the image depicting road surfaces, other vehicles, pedestrians, buildings, or other environmental objects may not provide representative data for determining overall ambient illumination levels. As shown in FIG. 31, an image captured by a camera of a host vehicle may include various objects such as pedestrians 3102, vehicle 3104, cyclists 3106, tree 3108, and buildings 3110. These objects may reflect, absorb, or emit light in ways that differ from the ambient illumination conditions that the system seeks to measure. By identifying and excluding such regions from analysis, the system may obtain more accurate ambient light level measurements that better reflect the actual environmental lighting conditions relevant to headlight control decisions. Additionally, focusing the analysis on specific regions of interest within the image may provide ambient light values that are particularly relevant to the system's operational needs. For example, when an incoming vehicle with headlights is detected ahead, the system may focus analysis on the region containing the approaching vehicle to determine whether the headlights of the host vehicle should be adjusted in response. Similarly, as shown in FIG. 33, when the host vehicle approaches a tunnel entrance, the system may analyze section 3302 corresponding to the tunnel entrance to determine the light intensity change that will occur as the vehicle enters the tunnel, enabling proactive adjustment of headlight states before the vehicle enters the darker environment.

In some embodiments, selective region analysis may enable identification of regions that are of particular interest for specific applications. For example, in head-up display systems, analyzing portions of an image corresponding to areas that will appear in the background of the head-up display from the vantage point of the driver may optimize the relevance of the determined light intensity levels. The system may adjust head-up display brightness, contrast, or color parameters based on the ambient light levels in the specific regions that the driver will view through the head-up display, rather than basing such adjustments on light levels from regions that may not be visible to the driver. This targeted analysis may improve driver visibility and comfort by ensuring that head-up display parameters are optimized for the actual viewing conditions experienced by the driver or user.

In some embodiments, analyzing selected portions of an image may reduce computational requirements compared to analyzing the entire image. By focusing processing resources on regions most relevant to the ambient light level determination, the system may achieve faster response times while maintaining measurement accuracy. This may be beneficial in automotive applications where timely adjustments to headlight states or display parameters may enhance safety and driver comfort.

In some embodiments, analyzing at least a portion of at least one image may include determining a portion of the at least one image for analysis. The at least a portion of at least one image may be determined based on any criteria, e.g., taking into account pitch or changes or other changes to a host vehicle and a camera's orientation in order to identify a relevant portion of across a plurality of image frames.

In some embodiments, analyzing at least a portion of at least one image may include determining a portion of the at least one image for analysis using at least one image segmentation process.

Image segmentation processes may be used to identify and classify different regions within a captured image, allowing the system to select appropriate portions of the image for ambient light level analysis. Image segmentation algorithms may operate by partitioning an image into multiple segments or regions based on characteristics such as color, intensity, texture, or spatial proximity of pixels. These algorithms analyze pixel-level information to group pixels that share similar attributes and to separate pixels that differ significantly from one another. Various image segmentation algorithms may be employed for determining portions of an image suitable for ambient light analysis, some examples are provided hereafter. Threshold-based segmentation algorithms may classify pixels based on intensity values relative to one or more threshold values, where pixels above a threshold may be assigned to one region and pixels below the threshold may be assigned to another region. Edge detection algorithms, such as Canny edge detection or Sobel operators, may identify boundaries between regions by detecting discontinuities in pixel intensity values, which may be useful for distinguishing between sky regions and ground regions in an image. Region-growing algorithms may start from seed pixels and iteratively add neighboring pixels that satisfy similarity criteria, thereby expanding regions until boundaries are reached. Clustering-based algorithms, such as k-means clustering, may group pixels into clusters based on feature similarity in color space or other feature spaces, where each cluster may represent a distinct region in the image. Watershed segmentation algorithms may treat the image as a topographic surface and identify catchment basins that correspond to distinct regions. Graph-based segmentation algorithms may represent the image as a graph where pixels are nodes and edges connect neighboring pixels, with edge weights representing dissimilarity between pixels, and may partition the graph to identify distinct regions. Semantic segmentation algorithms, which may be implemented using convolutional neural networks or other deep learning architectures, may classify each pixel in an image according to predefined categories such as sky, road, vehicle, pedestrian, or building, providing pixel-level classification that may be particularly useful for identifying regions relevant to ambient light analysis in automotive applications.

By segmenting the image into distinct regions, the system may distinguish between areas that provide useful data for light intensity determination and areas that may introduce noise or inaccuracies into the analysis. For example, regions containing other vehicles, road surfaces, or buildings may be treated differently than regions containing sky or open areas when determining ambient light levels.

FIG. 30 depicts an urban street scene in an environment of a host vehicle as captured by a camera of the host vehicle. The scene includes a tree 3002 positioned on the left side of the scene. Multiple pedestrians are shown throughout the scene, including a pedestrian 3004 walking on the left side of the scene near the tree 3002, a pedestrian 3006 located on the right side of the scene, a pedestrian 3008 shown near a right crosswalk area, and a pedestrian 3014 positioned near a crosswalk in the center of the scene. A vehicle 3010 is depicted on the road between crosswalks. Buildings 3012 are positioned in the background of the scene. Two cyclists are shown in the scene, with a cyclist 3016 and a cyclist 3018 positioned near each other on the left portion of the road. The urban street scene of FIG. 30 represents a typical environment that a host vehicle camera system may capture, where various objects and regions may need to be identified and segmented for purposes of ambient light level analysis. Although an urban street scene is provided as an example, the disclosed embodiments are applicable to an environment (e.g., rural, suburban, urban, etc.).

With continued reference to FIG. 30, the image segmentation process may be configured to identify regions of interest that contain good data for ambient light analysis versus regions that contain data that may be ignored or filtered. For example, regions containing pedestrians 3004-3008 and 3014, cyclists 3016-3018, tree 3002, or building 3012 may be identified as regions to exclude from ambient light analysis because these objects do not represent ambient light sources. Conversely, vehicle 3010 may be an element of interest when determining the ambient light level. In some embodiments, the system may distinguish between a gray scene and a dark scene with a strong light in a small portion by analyzing the segmented regions separately and comparing light intensity values across different portions of the image.

FIG. 31 is an exemplary image representation showing an example of a result of a segmentation process for ambient light level analysis in an environment of a host vehicle. The segmented image includes representations of tree 3108, pedestrians 3102, vehicle 3104 cyclists 3106, and buildings 3110. The various shades or patterns applied to the different objects in FIG. 31 represent different segmentation classifications used when analyzing portions of the image to determine ambient light levels.

In some embodiments, following the segmentation process illustrated in FIG. 31, elements that would not qualify as sources of light may be disregarded by the system. For example, tree 3108, pedestrians 3102, cyclists 3106, and buildings 3110 may be identified and excluded from the portion of the image selected for ambient light analysis. By excluding these segmented objects, the system may focus the ambient light analysis on regions of the image that more accurately represent the ambient light conditions in the environment of the host vehicle. Additionally, or alternatively, the system may identify regions of the at least one image exhibiting light intensity values exceeding a predetermined threshold, and may select the at least a portion of the at least one image to exclude these high-intensity regions. Such high-intensity regions may result from active illumination sources, such as headlights of another vehicle in the environment of the host vehicle, or may result from bright reflections from surfaces in the environment, or may result from direct sunlight or solar glare captured in the at least one image. By excluding these high-intensity regions from the at least a portion of the at least one image selected for analysis, the system may reduce bias in the determined at least one light intensity level and may obtain a more accurate representation of the ambient light conditions in the environment of the host vehicle. In some embodiments, the predetermined threshold may be configured based on expected intensity values associated with ambient lighting conditions, such that regions exceeding the predetermined threshold are identified as non-ambient light sources and excluded from the analysis.

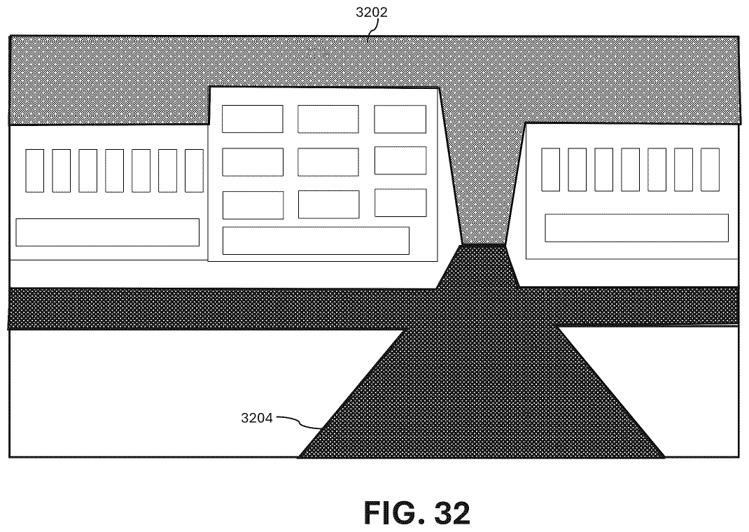

Referring to FIG. 32, an exemplary image representation shows segmentation of different regions that may be used for ambient light level analysis in an environment of a host vehicle. In some embodiments, at least one image segmentation process may be configured to determine a sky region represented in at least one image and a road surface region represented in the at least one image. As shown in FIG. 32, corresponding to a segmented version of FIG. 30, a sky section 3202 is depicted in the upper portion of the image. The sky section 3202 extends across the top of the image and includes cutout regions that may represent areas where other objects such as buildings or structures are present. A road section 3204 is shown in the lower portion of the image.

As used herein, a road surface region may refer to any portion of a captured image that does not correspond to a sky region. The road surface region may include, but is not limited to, the actual road surface, lane markings, sidewalks, curbs, medians, shoulders, parking areas, driveways, intersections, crosswalks, and any paved or unpaved ground surfaces. The road surface region may further include regions depicting buildings, structures, walls, fences, barriers, guardrails, signs, poles, lampposts, traffic lights, vegetation, trees, bushes, landscaping, vehicles, pedestrians, cyclists, animals, and any other objects or features that appear below or outside of the sky region in the captured image. In some embodiments, the road surface region may encompass the entire lower portion of an image extending from the horizon line or sky boundary downward to the bottom edge of the image. The road surface region may also include regions at the sides of the image that do not contain sky, such as areas depicting roadside infrastructure, commercial establishments, residential properties, industrial facilities, construction zones, or natural terrain features including hills, mountains, embankments, ditches, bodies of water, and open fields. In essence, the road surface region may be defined as the complement of the sky region within the captured image, such that any pixel or region not classified as sky may be considered part of the road surface region for purposes of ambient light level analysis.

In some embodiments, the segmentation of the image into the sky section 3202 and the road section 3204 may allow the system to select appropriate portions of the image for ambient light analysis based on the application.

In some embodiments, the portion of the at least one image selected for analysis may include the road surface region (e.g., road section 3204). For example, the road surface region may be selected for analysis when the system is determining ambient light levels for headlight control decisions, as the road surface illumination may be more relevant to determining whether headlights should be activated or adjusted. In another example, the road surface region may be selected when the host vehicle is traveling through an urban environment with tall buildings that may cast shadows on the road while the sky remains bright, and in such scenarios the road surface illumination may provide a more accurate representation of the lighting conditions that affect driver visibility. In yet another example, the road surface region may be selected when the host vehicle is traveling during twilight conditions where the sky may still appear relatively bright while the road surface has become darker, and selecting the road surface region for analysis may enable the system to determine that headlight activation is appropriate despite the presence of residual light in the sky region.

In some embodiments, the portion of the at least one image selected for analysis may include the sky region (e.g., sky section 3202). For example, the sky region may be selected for analysis when the system is determining overall daylight conditions for display brightness adjustments, as the sky illumination may provide a reliable indicator of general ambient light levels in open environments. In another example, the sky region may be selected when the host vehicle is traveling on a highway with minimal overhead obstructions, where the sky region provides a consistent and unobstructed view of ambient lighting conditions. In yet another example, the sky region may be selected when the host vehicle is approaching a tunnel exit, where analyzing the sky region visible through the tunnel opening may allow the system to anticipate the brightness level that the host vehicle will encounter upon exiting the tunnel and prepare appropriate adjustments to headlight states or display parameters. For example, referring to FIG. 33, when the host vehicle is inside a tunnel, the system may be more interested in analyzing the walls, ceiling, road surface, and other vehicles within the tunnel, which provide a more accurate representation of the ambient illumination level experienced by the driver, rather than the bright portion of sky visible through the tunnel opening. In such scenarios, the sky region may represent a small and unrepresentative portion of the overall environment, and including the sky region in the ambient light analysis may result in an overestimation of the actual illumination conditions within the tunnel. In another example, when the host vehicle is traveling under a dense tree canopy, the sky region visible through gaps in the foliage may appear bright while the road surface and surrounding environment remain relatively dark, and in such scenarios the system may ignore or reduce the weight assigned to the sky region to obtain a more accurate assessment of the ambient light conditions affecting driver visibility. In yet another example, when the host vehicle is traveling through an urban canyon with tall buildings on either side, the sky region may be limited to a narrow strip that does not accurately represent the overall lighting conditions at street level, and the system may prioritize analysis of the road surface, building facades, and other ground-level features to determine appropriate headlight or display adjustments.

In some embodiments, analyzing sky regions for ambient light level determination may present challenges because cameras installed on vehicles for driving purposes may be configured to focus on elements relevant to navigation and safety. Such driving cameras may be intentionally designed and positioned to capture road surfaces, other vehicles, pedestrians, road signs, lane markings, and other objects that occupy the line of sight during normal driving operations. As a result, the field of view and imaging parameters of driving cameras may be optimized for detecting and analyzing these ground-level features rather than for capturing unobstructed views of the sky. The sky region visible in images captured by driving cameras may be limited to relatively small portions of the overall image, and these sky portions may be partially obstructed by buildings, trees, overpasses, or other structures in the environment. Despite these limitations, focusing analysis on the available sky portions within captured images, in combination with the imaging parameters associated with the camera, may enable the system to generate ambient light level estimations that are sufficiently accurate for many use cases. By leveraging the relationship between pixel intensity values and the camera's exposure time, aperture size, gain settings, and other imaging parameters, the system may derive meaningful ambient light information even from relatively small sky regions within the captured images.

In some embodiments, when determining ambient light levels for headlight control applications, the road section 3204 may provide more relevant light intensity information than the sky section 3202 because the road surface reflects ambient light conditions that affect visibility for driving. The road surface illumination may more accurately represent the lighting conditions that a driver experiences when navigating the vehicle, as the driver's primary visual attention is directed toward the road ahead rather than toward the sky. Additionally, in dense urban scenarios with large buildings surrounding the vehicle, the sky may not be visible to a forward-facing camera, making road surface analysis particularly valuable for ambient light determination in such environments. Road section 3204 may also capture reflected light from various sources including streetlights, vehicle headlights, and ambient daylight that collectively contribute to the overall illumination conditions relevant to safe vehicle operation. In contrast, the sky section 3202 may be useful for determining overall environmental illumination levels, such as distinguishing between daytime and nighttime conditions or detecting the approach of sunset or sunrise. The sky section 3202 may also provide information about weather conditions that affect ambient light, such as cloud cover that reduces overall illumination levels. In some embodiments, the system may analyze both the sky section 3202 and the road section 3204 and combine the results to obtain a more comprehensive determination of ambient light conditions. For example, a bright sky section 3202 combined with a relatively dark road section 3204 may indicate that the vehicle is approaching a shaded area such as a tunnel entrance or an area under an overpass, which may prompt the system to prepare for a transition in lighting conditions. Conversely, a dark sky section 3202 combined with a bright road section 3204 may indicate the presence of artificial lighting such as streetlights or the headlights of oncoming vehicles.

In some embodiments, analyzing at least a portion of at least one image may include determining a portion of the at least one image for analysis using at least one trained system.

In some embodiments, the at least one trained system may be configured to perform segmentation tasks for determining portions of an image suitable for ambient light analysis. Examples of trained systems that may perform such segmentation tasks include convolutional neural networks, deep learning architectures, and semantic segmentation algorithms as described above. These trained systems may classify pixels according to predefined categories and identify distinct regions within a captured image.

In some embodiments, the trained system may determine a portion of the image for analysis without performing image segmentation. For example, the trained system may be configured to directly output coordinates or bounding boxes that define regions of interest for ambient light analysis based on learned patterns from training data. The trained system may identify a region corresponding to the sky or road surface by recognizing contextual features in the image without explicitly classifying each pixel. In some cases, the trained system may use attention mechanisms to weight different portions of the image according to their relevance for ambient light determination, where the attention weights may indicate which regions should be prioritized for analysis. The trained system may also be configured to output a single representative light intensity value or a set of light intensity values for the image based on learned correlations between image features and ambient light conditions, thereby bypassing explicit region selection. In some embodiments, the trained system may use regression techniques to directly predict ambient light levels from image features extracted by convolutional layers without requiring intermediate segmentation outputs. The trained system may additionally be configured to identify specific features such as the horizon line, vanishing point, or other geometric cues that may be used to infer appropriate regions for analysis without pixel-level classification.

In some embodiments, the trained system may include a neural network. The neural network may be configured to receive image data and output classifications or segmentations that identify different regions within the image. For example, the trained system may be trained using labeled image data that associates pixel regions with corresponding scene elements such as sky, road surfaces, buildings, vegetation, vehicles, pedestrians, or other objects. During operation, the trained system may process a captured image and generate output data indicating which portions of the image correspond to which scene elements.

In some embodiments, the trained system may be configured to determine a sky region represented in the at least one image and a road surface region represented in the at least one image. Referring to FIG. 32, the trained system may distinguish between the sky section 3202 and the road section 3204 based on learned features associated with each region type. For example, the trained system may have learned that sky regions typically exhibit certain color characteristics, texture patterns, or brightness distributions that differ from road surface regions. The trained system may output a segmentation mask or classification data that identifies pixel locations corresponding to the sky section 3202 and pixel locations corresponding to the road section 3204.

In some embodiments, the portion of the at least one image that is analyzed to determine at least one light intensity level may include the road surface region. For example, after the trained system determines the road section 3204 in the image, the system may analyze pixel values within the road section 3204 to determine a light intensity level associated with the road surface in the environment of the host vehicle. Analyzing the road section 3204 may provide light intensity information that is representative of ambient light conditions at ground level, which may differ from light intensity conditions in the sky section 3202.

In some embodiments, the trained system may distinguish between different scene types and provide semantic understanding of the image. For example, the trained system may be configured to detect features such as tunnel entrances, overpasses, bridges, or other structures that may affect ambient light levels in the environment of the host vehicle. The semantic understanding provided by the trained system may allow for faster reaction time when the system detects that the host vehicle is approaching or entering a region where ambient light levels are expected to change. For example, when the trained system detects a tunnel entrance in a captured image, the system may anticipate a decrease in ambient light levels and prepare to adjust vehicle functions such as headlight states or display parameters accordingly.

In some embodiments, analyzing at least a portion of at least one image to determine at least one light intensity level in the environment of the host vehicle may include determining a portion of the at least one image for analysis using map information. Map information may provide contextual data about the environment of the host vehicle that enables the system to identify regions of the captured image that are relevant for ambient light level analysis. For example, map information may include data indicating the presence of buildings, tunnels, overpasses, bridges, or other structures along a route of the host vehicle.

FIG. 33 shows an exemplary image captured by a camera of a host vehicle including a representation of a view of a tunnel entrance from the perspective of the host vehicle. A section to analyze 3302 is indicated in the image, representing a region of interest that may be used for determining ambient light levels in the environment of the host vehicle. The section to analyze 3302 encompasses a portion of the road surface and surrounding area within the tunnel entrance where the light intensity decreases due to entry into the tunnel. In some embodiments, the section to analyze 3302 may be selected using map information. For example, if the system has access to map information indicating that a tunnel is present along the route of the host vehicle, the system may automatically select a section of the image where the light intensity is expected to decrease because of the tunnel. The map information may indicate the location, length, and orientation of the tunnel, enabling the system to anticipate changes in ambient light levels and select appropriate regions of the captured image for analysis.

In some embodiments, the system may use heuristic-based methods to identify portions of the image for analysis. Heuristic-based methods may include rules or algorithms that identify regions of the captured image based on characteristics such as brightness, color, texture, or position within the image. For example, a heuristic-based method may identify a region of the image that is above a horizon line as a potential sky region, or may identify a region of the image that has a uniform dark appearance as a potential tunnel region. Heuristic-based methods may be combined with map information to improve the accuracy of region selection for ambient light level analysis.

In some embodiments, analyzing at least a portion of at least one image to determine at least one light intensity level in the environment of the host vehicle may include determining a portion of the at least one image for analysis using object tracking information. Object tracking information may include data about the position, velocity, trajectory, or classification of objects in the environment of the host vehicle. The system may use object tracking information to identify portions of the captured image that contain objects that may affect ambient light level measurements, such as other vehicles, buildings, or structures. For example, the system may use object tracking information to include portions of the image that contain other vehicles from the ambient light level analysis.

In some embodiments, the object tracking information may include information obtained by a sensor. The sensor may be any sensor associated with the host vehicle that is capable of detecting objects in the environment of the host vehicle. In some embodiments, the sensor may be a lidar or a radar. Lidar sensors may provide distance and position information about objects in the environment of the host vehicle by emitting laser pulses and measuring the time for the pulses to return after reflecting off objects. Radar sensors may provide distance, velocity, and position information about objects in the environment of the host vehicle by emitting radio waves and measuring the characteristics of the reflected signals. The system may use information obtained by a lidar or a radar to identify portions of the captured image that correspond to detected objects, and may exclude such portions from the ambient light level analysis or may analyze such portions separately.

In some embodiments, the at least one image may include a first image and a second image. In such embodiments, analyzing the at least a portion of the at least one image to determine the at least one light intensity level in the environment of the host vehicle may include analyzing the first image to determine a first light intensity level and analyzing the second image to determine a second light intensity level. The first light intensity level and the second light intensity level may correspond to different regions of the environment of the host vehicle, different time instances, or different spectral characteristics depending on the configuration of the cameras and the analysis performed by the system.

In some embodiments, the at least one camera may include a first camera and a second camera, and the first camera may capture the first image and the second camera may capture the second image. The first camera and the second camera may be positioned at different locations on the host vehicle, such as at the front, rear, sides, or corners of the host vehicle. The first camera and the second camera may have different orientations, different fields of view, or different sensor types. For example, the first camera may be an RGB camera while the second camera may be an infrared camera, or both cameras may be RGB cameras positioned to capture different portions of the environment of the host vehicle.

In some embodiments, the first camera and the second camera may have overlapping fields of view. When the fields of view of the first camera and the second camera overlap, the system may use the overlapping region to verify measurement results obtained from the first image and the second image. For example, the system may compare the first light intensity level determined from a portion of the first image corresponding to the overlapping region with the second light intensity level determined from a corresponding portion of the second image. If the first light intensity level and the second light intensity level are consistent within a predetermined tolerance, the system may confirm the accuracy of the light intensity measurements. If the first light intensity level and the second light intensity level differ by more than the predetermined tolerance, the system may apply additional processing to reconcile the measurements or may weight one measurement more heavily than the other based on factors such as camera calibration confidence or image quality.

In some embodiments, the system may combine the first light intensity level and the second light intensity level to determine a combined ambient light level for the environment of the host vehicle. The combined ambient light level may provide a more comprehensive representation of the overall lighting conditions surrounding the host vehicle by incorporating light intensity information from multiple perspectives or regions of the environment. The system may combine the first light intensity level and the second light intensity level using various approaches depending on the configuration of the cameras and the intended application of the combined ambient light level.

In some embodiments, the system may analyze the first image and the second image separately to determine the first light intensity level and the second light intensity level, and then combine the separately determined light intensity levels to produce the combined ambient light level. For example, the system may calculate a weighted average of the first light intensity level and the second light intensity level, where the weights may be based on factors such as the relative sizes of the fields of view of the first camera and the second camera, the relevance of each camera's perspective to a particular vehicle function, or the confidence levels associated with each measurement. In another example, the system may select the minimum, maximum, or median of the first light intensity level and the second light intensity level as the combined ambient light level depending on the intended use case. In yet another example, the system may apply a fusion algorithm that accounts for the spatial relationship between the regions captured by the first camera and the second camera to produce a spatially coherent combined ambient light level.

In some embodiments, the system may combine the first image and the second image prior to analysis to produce a combined image, and then analyze the combined image to determine the combined ambient light level. For example, the system may stitch the first image and the second image together to form a panoramic image that encompasses a wider field of view than either individual image, and then analyze the panoramic image to determine the combined ambient light level. In another example, the system may blend overlapping regions of the first image and the second image to produce a composite image with enhanced coverage of the environment, and then analyze the composite image to determine the combined ambient light level. In yet another example, the system may project the first image and the second image onto a common coordinate frame representing the environment of the host vehicle, and then analyze the projected images collectively to determine the combined ambient light level.

In some embodiments, the system may use the first light intensity level and the second light intensity level for different vehicle functions based on the positions and orientations of the first camera and the second camera. For example, when the first camera is positioned at the front of the host vehicle and oriented to capture the forward environment, the first light intensity level determined from the first image may be used for controlling headlights of the host vehicle. The first light intensity level may indicate the ambient light conditions in the direction of travel, which may be relevant for determining whether to activate headlights, whether to switch between low beam and high beam states, or whether to adjust headlight intensity. When the second camera is positioned at the rear of the host vehicle and oriented to capture the rearward environment, the second light intensity level determined from the second image may be used for controlling rear-facing displays or adjusting parameters of a rearview mirror display. The second light intensity level may indicate the ambient light conditions behind the host vehicle, which may be relevant for determining appropriate brightness levels for displays that present rearward-facing information to the driver.

In some embodiments, when the first camera is positioned to capture a forward environment and the second camera is positioned to capture a side environment of the host vehicle, the first light intensity level may be used for controlling forward-facing headlights while the second light intensity level may be used for controlling side marker lights, turn signal intensity, or side mirror display parameters. In some embodiments, when the first camera is positioned to capture an exterior environment and the second camera is positioned to capture an interior environment of the host vehicle, the first light intensity level may be used for controlling exterior lighting systems while the second light intensity level may be used for controlling interior ambient lighting, dashboard display brightness, or heads-up display parameters. The system may independently adjust different vehicle systems based on the respective light intensity levels determined from cameras positioned to capture the relevant portions of the environment for each vehicle system.

In some embodiments, the system may use the first light intensity level for a first vehicle function and the second light intensity level for a second vehicle function, while also combining the first light intensity level and the second light intensity level for a third vehicle function that benefits from a comprehensive assessment of overall ambient lighting conditions. For example, the first light intensity level from a forward-facing camera may be used for headlight control, the second light intensity level from a rearward-facing camera may be used for rear display brightness control, and the combined ambient light level derived from both the first light intensity level and the second light intensity level may be used for adjusting interior dashboard display parameters that should reflect the overall lighting conditions surrounding the host vehicle rather than the lighting conditions in any single direction.

In some embodiments, the first image and the second image may be captured at different times. When the first image and the second image are captured at different times, the system may use the first light intensity level and the second light intensity level to perform multi-frame calculations that improve robustness of the ambient light level determination compared with a lux meter that provides a single instantaneous reading. For example, the system may analyze a history of light intensity levels determined from images captured across multiple frames to identify trends, filter out transient fluctuations, or detect gradual changes in ambient lighting conditions. The system may use the history of light intensity levels as a form of smoothing that reduces sensitivity to momentary variations in detected light intensity, such as variations caused by passing shadows, reflections from moving objects, or brief occlusions of light sources. By incorporating temporal information from multiple frames, the system may provide more stable and reliable ambient light level determinations than would be possible using a single instantaneous measurement from a lux meter. The multi-frame calculations may include averaging light intensity levels across a sliding window of recent frames, applying exponential smoothing to weight more recent measurements more heavily than older measurements, or detecting outlier measurements that deviate significantly from a trend established by preceding frames. The system may also use multi-frame analysis to distinguish between rapid transient changes in ambient light that should not trigger vehicle system adjustments and sustained changes in ambient light that warrant adjustments to headlight states or display parameters.

In some embodiments, the system may filter noise from the at least image as part of the analysis process. Noise filtering may include applying spatial filters, temporal filters, or a combination of spatial and temporal filters to reduce artifacts caused by sensor noise, compression artifacts, or environmental factors such as rain, fog, or dust on a camera lens. The system may apply different noise filtering parameters to different images based on characteristics of the at least one camera or based on detected noise levels in each image.

In some embodiments, the system may stabilize the at least one image as part of the analysis process. Image stabilization may compensate for motion of the host vehicle, vibrations transmitted through the vehicle structure, or other sources of image blur or displacement. The system may use gyroscope data, accelerometer data, or image-based motion estimation to determine stabilization parameters for the at least one image. Stabilizing the images may improve the accuracy of light intensity measurements by reducing variations in pixel values caused by motion rather than actual changes in ambient light levels.

In some embodiments, the system may detect and classify different light source types represented in the at least one image. Light source types may include direct sun, streetlamps, approaching vehicles, traffic signals, building lights, or reflections from surfaces in the environment of the host vehicle. The system may use image analysis techniques, trained systems, or a combination of image analysis techniques and trained systems to identify regions of the first image and the second image that correspond to different light source types. By classifying light source types, the system may weight contributions from different light sources differently when determining the at least one light intensity level in the environment of the host vehicle. For example, the system may distinguish between a high overall light intensity caused by direct sunlight and a high localized light intensity caused by headlights of an approaching vehicle.

In some embodiments, the system may sample all relevant pixels in the at least one image for mapping to intensity values. In other embodiments, the system may sample a subset of relevant pixels in the at least image for mapping to intensity values. Sampling a subset of relevant pixels may reduce computational requirements while still providing accurate light intensity measurements. The subset of relevant pixels may be selected based on spatial distribution across the image, based on pixel intensity values, based on segmentation results that identify regions of interest, or based on other criteria.

In some embodiments, the at least one imaging parameter associated with the at least one camera of the host vehicle may include or be representative of an exposure time, a f-number, a focal length, or an aperture size.

The system may map the sampled pixels to intensity values using the at least one value of the at least one imaging parameter associated with the at least one camera of the host vehicle, such as exposure time, aperture size, f-number, or focal length to convert pixel brightness values to physical light intensity units. The f-number, which refers to the ratio between the focal length and the aperture diameter, may have a physical correlation to the brightness of the resulting image. As used herein, f-number may also include effective f-number, which accounts for apertures that are not circular. In some embodiments, the system may be implemented with a fixed-aperture camera, a fixed-focal-length camera, or other configurations, and therefore all such parameters may be included to accommodate various camera implementations. This mapping process may be performed by applying a radiometric calibration function that relates the digital pixel values recorded by the camera sensor to the actual luminance or illuminance values in the scene. For example, the system may use a camera response function that characterizes the relationship between scene radiance and pixel intensity for the particular camera sensor. The mapping may involve multiplying the pixel brightness value by a factor that accounts for the exposure time, where longer exposure times result in higher pixel values for the same scene luminance, and dividing by a factor related to the aperture size or f-number, where larger apertures or smaller f-numbers allow more light to reach the sensor. The system may also account for the focal length, which affects the field of view and the amount of light collected from the scene. The system may additionally account for the camera gain or ISO sensitivity setting, which amplifies the sensor signal and affects the relationship between incoming light and recorded pixel values. In some embodiments, the system may use a lookup table that stores precomputed mappings between pixel values and light intensity values for various combinations of imaging parameters, allowing for efficient conversion without requiring real-time calculation of the radiometric relationship. The system may additionally apply corrections for lens vignetting, which causes pixels near the edges of the image to receive less light than pixels near the center, and for sensor non-uniformity, which may cause different pixels to respond differently to the same amount of incoming light. The resulting light intensity values may be expressed in photometric units such as candela per square meter for luminance or lux for illuminance, depending on the application requirements.

In some embodiments, analyzing the at least a portion of the at least one image may include analyzing chromatic information associated with different portions of the at least one image. As used herein, chromatic information refers to wavelength-dependent characteristics of light that capture hue-related properties of the scene, as distinguished from brightness or luminance information that represents overall light intensity without regard to spectral composition. Chromatic information may include hue-related representations, spectrally distinguished information across different wavelength bands, or color channel data that characterizes the spectral distribution of light in the environment. By analyzing chromatic information, the system may determine at least one chromatic light intensity level in the environment of the host vehicle. The chromatic light intensity level may characterize not only the overall brightness of the ambient light but also the spectral composition or color temperature of the illumination. This chromatic analysis may provide information that is not available from traditional lux meters, which typically measure aggregate light intensity without distinguishing between different wavelengths. The chromatic light intensity level may be useful for various vehicle functions, such as adjusting color parameters of a head-up display to maintain contrast against backgrounds of varying color composition, or for night vision analysis where distinguishing between different spectral characteristics of light sources may enhance detection and classification of objects in the environment. For example, the system may use chromatic information to distinguish between warm-toned artificial lighting from streetlamps and cooler-toned ambient light from an overcast sky, enabling more appropriate adjustments to display color settings or headlight color temperature.

In some embodiments, the system may determine a representative brightness value from the sampled pixel data using various approaches. For example, the system may calculate a simple average of the pixel intensity values over the relevant region of the image to obtain a single representative brightness value. Alternatively, the system may calculate a weighted average of the pixel intensity values, where the weights may be assigned based on vertical position within the field of view such that pixels corresponding to regions closer to the road surface or horizon may be weighted differently than pixels corresponding to sky regions, or where the weights may be assigned based on other spatial relevance criteria such as distance from the center of the image or proximity to detected objects of interest. In some embodiments, the system may use statistical approaches to determine the representative brightness value, such as excluding outlier pixel values that fall outside a predetermined range before calculating an average, using percentile-based measures such as the median or a particular percentile of the pixel intensity distribution to reduce sensitivity to extreme values, or assigning higher weight to pixels within certain illumination ranges that are considered more representative of ambient lighting conditions. In some embodiments, the system may use histogram-based approaches to derive a representative brightness value from the pixel intensity distribution, such as identifying a peak or mode of the histogram, calculating a weighted centroid of the histogram, or analyzing the shape of the histogram to characterize the overall brightness characteristics of the scene. The various approaches for determining a representative brightness value from pixel data may be used individually or in combination, and the selection of a particular approach may depend on factors such as the characteristics of the captured image, the computational resources available, or the specific application requirements for ambient light level determination.

In some embodiments, the system may forecast future light levels in the environment of the host vehicle based on analysis of captured images. In addition to determining a current ambient light intensity level, the system may predict changes in light intensity that will occur as the host vehicle travels along a road. For example, the system may predict when the host vehicle is entering or leaving a tunnel based on visual data captured by the at least one camera. When the system detects a tunnel entrance ahead of the host vehicle, the system may forecast that the light intensity level will decrease as the host vehicle enters the tunnel. Similarly, when the system detects a tunnel exit ahead of the host vehicle while the host vehicle is inside the tunnel, the system may forecast that the light intensity level will increase as the host vehicle exits the tunnel.

In some embodiments, the system may determine whether shading detected in captured images is temporary. For example, the system may determine that the host vehicle is temporarily shaded by a bridge passing over the road. In such cases, the system may forecast that the decrease in light intensity is transitory and that the light intensity level will return to a higher level after the host vehicle passes beyond the bridge. The system may distinguish between temporary shading conditions and more sustained changes in light intensity, such as those associated with entering a tunnel, based on analysis of the captured images.

In some embodiments, forecasting of future light levels may be implemented using semantic analysis of the captured images. Semantic analysis may include identifying and classifying objects or structures represented in the captured images, such as tunnels, bridges, overpasses, or other structures that may affect light intensity levels. The system may use a trained system, such as a neural network, to perform semantic analysis and identify such structures in the captured images.

In some embodiments, forecasting of future light levels may be implemented using simpler analysis methods that do not require semantic understanding of the captured images. For example, the system may analyze brightness levels and shade areas in the captured images to predict future changes in light intensity. The system may detect a dark region ahead of the host vehicle in the captured images and forecast a decrease in light intensity as the host vehicle approaches the dark region, without determining whether the dark region corresponds to a tunnel, a bridge shadow, or another structure. Such simpler versions of forecasting may provide predictions of future light levels based on patterns of brightness and shade in the captured images.

In some embodiments, the system may use forecasted light level data to provide pre-planning and advance notice for changes to vehicle systems. The system may be aware of delay times associated with making changes to vehicle systems, such as delay times for changing headlight states or delay times for adjusting brightness, contrast, or colors of a head-up display without distracting a driver of the host vehicle. Based on the forecasted light level data and the delay times, the system may provide instructions or initiate changes to vehicle systems earlier than would be possible using only current light intensity measurements. For example, if the system forecasts that the host vehicle will enter a tunnel in a predetermined time period, the system may initiate a change to headlight state or display parameters before the host vehicle enters the tunnel, accounting for the delay time associated with making the change.

In some embodiments, the system may use forecasted light level data for planning the progression of intended future changes to vehicle systems. Some changes to vehicle systems may benefit from gradual adjustments rather than abrupt changes. For example, changes to brightness, contrast, or colors of a head-up display may be implemented gradually to avoid distracting the driver of the host vehicle. The system may use the forecasted light level data to plan a progression of adjustments over time, such that the adjustments are completed by the time the host vehicle reaches a location where the forecasted light intensity level is expected. The forecasted light level data may also be used to implement non-flickering changes to vehicle systems, such as headlight state changes, where the system may plan the timing of the change based on the forecasted light level data to avoid rapid switching between states.

In some embodiments, the at least a portion of the at least one image may be analyzed using at least one trained model. The trained model may be configured to receive image data as input and generate output indicative of light intensity levels present in the environment represented by the image. In some embodiments, the trained model may include a neural network, such as a convolutional neural network configured to process image data and extract features relevant to light intensity determination. The use of trained models for analyzing captured images to determine ambient light levels will be described in more detail later in this disclosure.

In some embodiments, the system may cause the host vehicle to perform at least one action based on the at least one light intensity level in the environment of the host vehicle. For example, the system may cause the host vehicle to change at least one headlight illumination state of the host vehicle based on the determined light intensity level. Additionally, or alternatively, the system may cause the host vehicle to change at least one value of at least one display parameter associated with at least a region of a display inside the host vehicle based on the determined light intensity level. These applications of the determined light intensity level for controlling headlight states and display parameters will be discussed in more detail later in this disclosure.

In some embodiments, the host vehicle may modify driving policy parameters based on the at least one light intensity level in the environment of the host vehicle. Driving policy parameters may refer to parameters that govern how the host vehicle navigates and operates in various driving scenarios, including parameters that affect speed, following distance, lane positioning, and responsiveness to detected objects or road conditions. The driving policy parameters may be part of a driving policy implemented by the host vehicle for autonomous or semi-autonomous navigation. For example, when the at least one light intensity level indicates low ambient light conditions such as nighttime driving or tunnel entry, the system may modify driving policy parameters to reduce a maximum speed of the host vehicle, increase a following distance maintained behind a leading vehicle, or increase sensitivity thresholds for detecting pedestrians or obstacles in the environment. In another example, when the at least one light intensity level indicates bright ambient light conditions that may cause glare or reduced visibility in certain directions, the system may modify driving policy parameters to adjust lane positioning or to increase caution when approaching intersections where sun glare may affect visibility. The modification of driving policy parameters based on ambient light levels may enhance safety by adapting the behavior of the host vehicle to account for visibility conditions that affect the ability of sensors and drivers to perceive the environment.

In some embodiments, the system may implement smoothing techniques for gradual changes to head-up display brightness or color parameters. The smoothing techniques may reduce or eliminate flickering that could otherwise occur when display parameters are adjusted in response to changing ambient light conditions in an environment of a host vehicle. For example, when a host vehicle transitions from a brightly lit environment to a darker environment, the system may gradually decrease the brightness level of a head-up display over a period of time rather than making an instantaneous change. The gradual decrease may be implemented at a predetermined rate, such as a percentage change per second or a fixed luminance change per unit time. By implementing changes at predetermined rates, the system may ensure that transitions appear smooth to a user of the host vehicle and do not distract a driver during vehicle operation.

In some embodiments, the system may apply smoothing techniques to color adjustments of a head-up display. When the system determines that a color change would improve contrast between displayed content and a background visible through the head-up display, the system may transition from a first color to a second color at a predetermined rate. The predetermined rate may be selected to ensure that the color transition does not create visual artifacts or sudden changes that could draw attention away from driving tasks. The smoothing of color changes may involve interpolating between color values over multiple display update cycles.

In some embodiments, the system may provide non-flickering implementation for binary changes such as headlight state changes. Binary changes may include transitions between an off state and an illuminated state, or transitions between a low beam state and a high beam state. Even though such changes may be binary in nature, the system may implement the changes in a manner that avoids rapid toggling between states. For example, when ambient light levels fluctuate near a threshold value that triggers a headlight state change, the system may apply hysteresis or temporal filtering to prevent the headlights from flickering between states. The system may require that a light intensity level remain above or below a threshold for a predetermined time period before initiating a state change.

In some embodiments, the predetermined rate at which display parameter changes are made may be configurable based on the type of change being implemented. Brightness level changes may be implemented at a first predetermined rate, contrast level changes may be implemented at a second predetermined rate, and color changes may be implemented at a third predetermined rate. The different predetermined rates may be selected based on human perception characteristics and the degree to which each type of change may distract a driver. The system may store the predetermined rates in a memory and retrieve the predetermined rates when implementing display parameter adjustments.

In some embodiments, the system may coordinate smoothing of display parameter changes with forecasted ambient light level changes. When the system predicts that ambient light levels will change in the near future based on analysis of captured images, the system may begin implementing gradual display parameter changes in advance of the predicted light level change. The advance implementation may allow the display parameter changes to be completed by the time the ambient light level change occurs, providing a seamless visual experience for the user of the host vehicle.

In some embodiments, and especially in implementations for head-up displays, the system may identify regions of interest that correspond to areas that will appear in the background of the head-up display from the vantage point of the driver. The region of interest may be determined by transforming a ray between the driver's eyes and the head-up display projection to a corresponding region in an image captured by a camera of the host vehicle. This transformation may account for the geometric relationship between the driver's eye position, the head-up display projection surface, and the field of view of the camera. By identifying the region of interest in the captured image, the system may analyze the brightness and color characteristics of the specific background area that the driver will perceive behind the head-up display projection.

### Determining Ambient Light Level of Image Using Trained System

While the systems and methods described above determine light intensity levels based on imaging parameters associated with the camera of the host vehicle, other approaches for determining light intensity levels in the environment of the host vehicle may be employed. In some embodiments, a system may determine light intensity levels using a trained system, such as a neural network, rather than relying on camera properties and internal parameters. Such a trained system may be configured to receive image data and output light intensity level information based on patterns learned during a training process.

The disclosed system and method may determine an ambient light level using cameras onboard a vehicle and trained models.

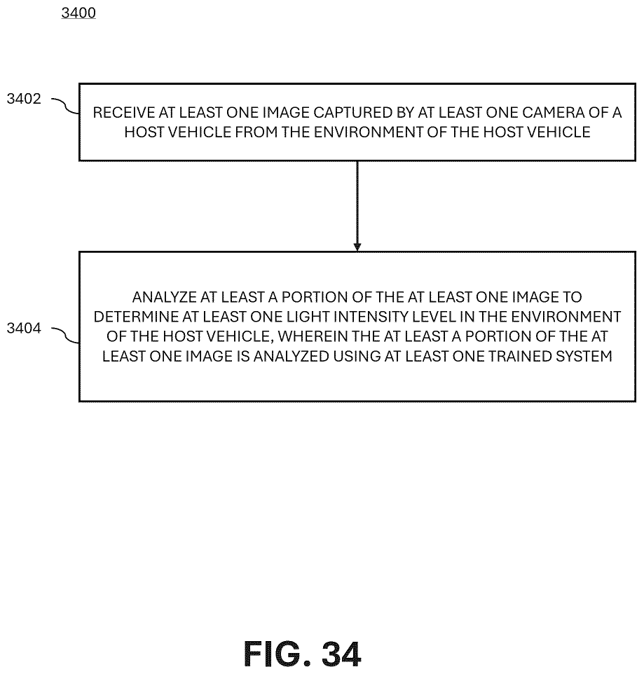

FIG. 34 is a flowchart showing an illustrative method 3400 according to the embodiments of the present disclosure. The steps of method 3400 will be described hereafter.

According to the embodiments of the present disclosure, a system may be used to determine an ambient light level in an environment of a host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

In step 3402, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30. Details regarding the receiving of at least one image captured by at least one camera of a host vehicle from the environment of the host vehicle have been given in relation with FIGS. 28 and 30 and will not be repeated here.

In step 3404, the system analyzes at least a portion of the at least one image to determine at least one light intensity level in the environment of the host vehicle, wherein the at least a portion of the at least one image is analyzed using at least one trained system. The system may determine portions of the image for analysis using various techniques, including image segmentation processes and trained systems.

In some embodiments, analyzing the at least a portion of the at least one image may include determining a portion of the at least one image for analysis using at least one image segmentation process. In some embodiments, the at least one image segmentation process may be configured to determine a sky region represented in the at least one image and a road surface region represented in the at least one image. In some embodiments, the portion of the at least one image may include the road surface region. The segmentation processes have been discussed with respect to FIGS. 28-31 and will not be repeated here.

In some embodiments, analyzing the at least a portion of the at least one image may include determining a portion of the at least one image for analysis using the at least one trained system. In some embodiments, the at least one trained system may include a neural network. In some embodiments, the at least one trained system may be configured to determine a sky region represented in the at least one image and a road surface region represented in the at least one image. In some embodiments, the portion of the at least one image may include the road surface region. Using a trained model for determining the at least one portion has been discussed with respect to FIGS. 28 and 32 and will not be repeated here.

In some embodiments, the system may analyze the at least one image to determine the at least one light intensity level in the environment of the host vehicle using at least one trained system. The trained system may be configured to receive image data as input and generate an output indicative of light intensity levels present in the environment represented by the image. The trained system may learn relationships between image characteristics and corresponding light intensity values through exposure to training data that associates images with known light intensity measurements. By using a trained system, the analysis of the at least one image may account for complex visual patterns and scene characteristics that may be difficult to capture using rule-based approaches alone.

In some embodiments, the at least one trained system may include a neural network. The neural network may be a convolutional neural network configured to process image data and extract features relevant to light intensity determination. The convolutional neural network may include multiple convolutional layers that apply learned filters to the input image to detect patterns at various spatial scales. The neural network may also include pooling layers that reduce the spatial dimensions of feature maps while preserving relevant information for light intensity analysis. Fully connected layers may be included in the neural network to combine extracted features and generate an output representing the determined light intensity level.

In some embodiments, the neural network may be trained using supervised learning techniques. During training, the neural network may receive input images paired with corresponding ground truth light intensity values measured by calibrated light sensors or other reference instruments. The neural network may adjust internal parameters, such as weights and biases, to minimize a loss function that quantifies the difference between predicted light intensity values and ground truth values. Through iterative training over a dataset containing diverse lighting conditions, the neural network may learn to generalize and accurately predict light intensity levels for images not included in the training dataset.

In some embodiments, the trained system may include other types of neural network architectures. For example, the trained system may include a recurrent neural network configured to process sequences of images and determine light intensity levels while accounting for temporal relationships between consecutive frames. The trained system may include a transformer-based architecture that applies attention mechanisms to identify regions of the image most relevant for light intensity determination. The trained system may include an encoder-decoder architecture where an encoder extracts features from the input image and a decoder generates light intensity predictions based on the extracted features.

In some embodiments, the trained system may be configured to output a categorical light intensity classification rather than a continuous light intensity value. For example, the trained system may classify the light intensity level into one of several predefined categories, such as low illumination, medium illumination, or high illumination. The categorical output may correspond to different operational modes for vehicle systems, such as headlight states or display brightness settings. The trained system may output a probability distribution over the predefined categories, allowing the system to assess confidence in the light intensity classification.

In some embodiments, the trained system may be configured to determine light intensity levels for multiple regions of the at least one image. The trained system may generate a spatial map of light intensity values across the image, where each location in the map corresponds to a predicted light intensity for a corresponding region of the image. The spatial map may enable the system to identify variations in light intensity across different portions of the environment of the host vehicle. For example, the spatial map may indicate that a first region of the environment has a higher light intensity than a second region of the environment.

In some embodiments, the trained system may receive additional inputs beyond the at least one image. For example, the trained system may receive values of imaging parameters associated with the at least one camera, such as exposure time or aperture size, as additional inputs. The trained system may use the imaging parameter values to adjust the light intensity determination based on the camera settings used when capturing the at least one image. By incorporating imaging parameter information, the trained system may account for variations in image brightness that result from camera adjustments rather than changes in actual ambient light levels.

In some embodiments, the trained system may be trained using data augmentation techniques to improve generalization performance. Data augmentation may include applying transformations to training images, such as brightness adjustments, contrast modifications, or color shifts, to simulate a wider range of lighting conditions. Data augmentation may also include cropping, rotating, or scaling training images to expose the trained system to variations in image composition. By training on augmented data, the trained system may become more robust to variations in image characteristics encountered during deployment.

Although the steps of method 2800 and method 3400 have been described as separate embodiments, it should be understood that the various embodiments disclosed herein are not mutually exclusive. For example, the techniques described with respect to method 2800, such as obtaining imaging parameters, using image segmentation processes, determining sky regions and road surface regions, using map information, using object tracking information, analyzing multiple images from multiple cameras, forecasting future light levels, and implementing smoothing techniques for display adjustments, may also be applied to method 3400. Similarly, the trained system approaches described with respect to method 3400 may be combined with the imaging parameter-based analysis of method 2800. In some embodiments, a system may use both imaging parameters and a trained system together to determine ambient light levels. For example, the trained system may receive imaging parameter values as additional inputs alongside image data. In some embodiments, the imaging parameter-based analysis may be used to preprocess or normalize image data before the image data is provided to a trained system. In some embodiments, imaging parameter-based analysis may be used to determine light intensity levels, and a trained system may be used to validate or refine the determined light intensity levels. The various embodiments described herein are not intended to be mutually exclusive, and any features, techniques, or approaches from any embodiment may be combined with features, techniques, or approaches from any other embodiment in any suitable combination or permutation. The imaging parameter-based approaches, trained system approaches, image segmentation approaches, environment information approaches, and any other approaches described herein may be used individually, in any combination of two or more approaches, or in any alternative configuration as appropriate for a particular implementation. One of skill in the art will appreciate that the various embodiments described throughout this disclosure represent a spectrum of related techniques that may be mixed, matched, combined, and interchanged freely to achieve desired functionality for determining ambient light levels and adjusting vehicle systems accordingly.

Determining when to Turn on High (or Low) Beams of Vehicle Headlights Based on Ambient Light Level

The ambient light level determination techniques described in the preceding sections may be applied to control headlights of a host vehicle. In some embodiments, a system may use the determined light intensity level in the environment of the host vehicle to adjust a state of the headlights of the host vehicle. For example, the system may cause the headlights to turn on, turn off, or switch between different illumination states based on the ambient light conditions detected using camera-based analysis.

In some embodiments, the headlights of the host vehicle may be switched between low beam and high beam states based on the determined light intensity level. When the system determines that the ambient light level in the environment of the host vehicle has decreased below a threshold, the system may cause the headlights to change from a low beam state to a high beam state. Conversely, when the system determines that the ambient light level has increased above a threshold, the system may cause the headlights to change from a high beam state to a low beam state.

The disclosed system and method may determine adjustments to headlights of a host vehicle based on an ambient light level in an environment of the host vehicle.

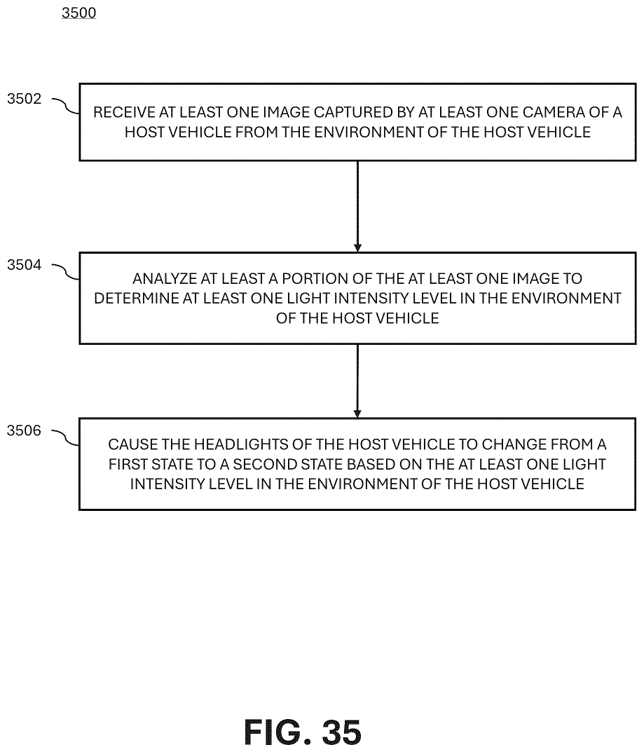

FIG. 35 is a flowchart showing an illustrative method 3500 according to the embodiments of the present disclosure. The steps of method 3500 will be described hereafter.

According to the embodiments of the present disclosure, a system may be used for determining adjustments to headlights of a host vehicle based on an ambient light level in an environment of the host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

In step 3502, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30. Details regarding the receiving of at least one image captured by at least one camera of a host vehicle from the environment of the host vehicle have been given in relation with FIGS. 28 and 30 and will not be repeated here.

In step 3504, the system analyzes at least a portion of the at least one image to determine at least one light intensity level in the environment of the host vehicle.

In some embodiments, the at least a portion of the at least one image may be analyzed based on at least one value of the at least one imaging parameter associated with the at least one camera of the host vehicle. In some embodiments, the at least one imaging parameter associated with the at least one camera of the host vehicle may be obtained prior to the analysis of the at least one portion of the at least one image.

In some embodiments, the at least one imaging parameter may be at least one light-adaptive imaging parameter. In some embodiments, the at least one imaging parameter associated with the camera of the host vehicle may include an exposure time or an aperture size.

Examples of imaging parameters and details regarding obtaining at least one value of at least one imaging parameter associated with the at least one camera of the host vehicle and analyzing at least a portion of the at least one image based on the at least one value of the at least one imaging parameter have been described earlier in this disclosure, for example with regard to FIG. 28 and method 2800, and will not be repeated here for the sake of conciseness.

In some embodiments, the at least a portion of the at least one image may be analyzed using at least one trained model. The system may determine portions of the image for analysis using various techniques, including image segmentation processes and trained systems, as previously described in relation to FIGS. 28-31.

Details regarding analyzing at least a portion of the at least one image using at least one trained system to determine at least one light intensity level in the environment of the host vehicle have been described earlier in this disclosure, for example with regard to FIG. 34 and method 3400, and will not be repeated here.

In step 3506, the system causes the headlights of the host vehicle to change from a first state to a second state based on the at least one light intensity level in the environment of the host vehicle.

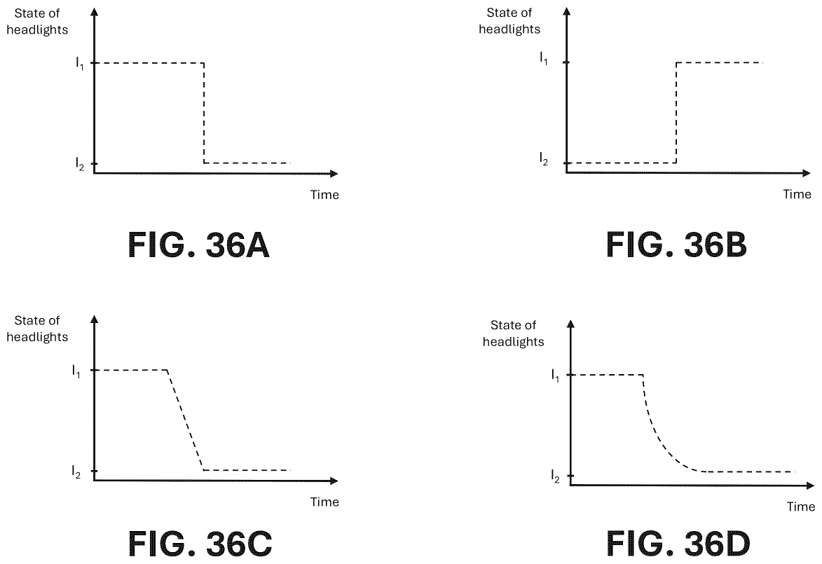

Referring to FIGS. 36A-36D, various situations are illustrated depicting different illumination state (or headlight state) transitions over time that may correspond to different headlight state changes. In some embodiments, as shown in FIG. 36A, the illumination state may remain constant at a first value I₁ and then transition instantaneously to a second value I₂ at a particular point in time, representing an abrupt decrease in illumination state. In some embodiments, as shown in FIG. 36B, the illumination state may remain at a second value I₂ and then transition instantaneously to a first value I₁ at a particular point in time, representing an abrupt increase in illumination state.

In some embodiments, the first state may be an off state and the second state may be an illuminated state. This may correspond to the transition in illumination state illustrated in FIG. 36B when I₂=0. In some embodiments, the first state may be an illuminated state and the second state may be an off state. This may correspond to the transition in illumination state illustrated in FIG. 36A when I₂=0.

In some embodiments, the first state may be a first illumination state and the second state may be a second illumination state. This may correspond to the transition in illumination state illustrated in FIGS. 36A and 36B when none of I₁ or I₂ are equal to 0. The first illumination state and the second illumination state may differ in various characteristics, including illumination level, illumination field of view, illumination spatial distribution, or combinations thereof. For example, the first illumination state and the second illumination state may differ by illumination level, where I₁ may correspond to a high beam state having a higher light output intensity and I₂ may correspond to a low beam state having a lower light output intensity. In another example, the first illumination state and the second illumination state may differ by illumination field of view, where the first illumination state may correspond to a wide beam pattern that illuminates a broader angular range of the environment and the second illumination state may correspond to a narrow beam pattern that concentrates illumination in a more focused angular range. In yet another example, the first illumination state and the second illumination state may differ by illumination spatial distribution, where the first illumination state may correspond to a beam pattern that distributes light more uniformly across the illuminated area and the second illumination state may correspond to a beam pattern that concentrates light in a central region while providing less illumination at peripheral areas. In some embodiments, the first illumination state and the second illumination state may differ by a combination of illumination level and illumination field of view, such as when transitioning from a high beam state with a wide field of view to a low beam state with a narrower field of view. In some embodiments, the first illumination state and the second illumination state may differ by illumination color temperature, where the first illumination state may correspond to a warmer color temperature suitable for foggy conditions and the second illumination state may correspond to a cooler color temperature suitable for clear nighttime driving. In some embodiments, the first illumination state and the second illumination state may differ by illumination pattern shape, where the first illumination state may correspond to a symmetric beam pattern and the second illumination state may correspond to an asymmetric beam pattern that provides additional illumination on one side of the roadway, such as to illuminate road signs or pedestrians on the shoulder of the road.

In some embodiments, the change in headlight illumination state may not be instantaneous or abrupt. The transition between the first state and the second state may be progressive. As illustrated in FIG. 36C, the illumination state may decrease from a first value I₁ to a second value I₂ at a constant rate over a period of time. As shown in FIG. 36D, the rate of change may not be constant throughout the transition, and the illumination state may decrease from a first value I₁ to a second value I₂ following a curved trajectory where the rate varies over time.

A progressive rate of change, rather than an instantaneous transition between headlight states, may provide several advantages. A gradual transition may reduce visual distraction for the driver of the host vehicle, as sudden changes in headlight illumination may momentarily draw the driver's attention away from the road. Progressive transitions may also reduce visual disturbance for other road users, such as drivers of oncoming vehicles or pedestrians, who may otherwise be startled by abrupt changes in headlight brightness. In some cases, a gradual transition may allow the driver's eyes to adapt more naturally to changing illumination conditions, which may improve overall visibility during the transition period. Additionally, progressive transitions may reduce wear on headlight components, as gradual changes in power delivery may place less stress on electrical and mechanical systems compared to instantaneous switching between states.

In some embodiments, the rate of change may be selected based on factors such as the magnitude of the difference between the first state and the second state, the current driving conditions, or user preferences stored in the vehicle system. For example, when the magnitude of the difference between the first state and the second state is large, such as a transition from a fully illuminated high beam state to an off state, the system may select a slower rate of change to allow the driver's eyes to adapt gradually to the changing illumination conditions. Conversely, when the magnitude of the difference is smaller, such as a transition between low beam and high beam states, the system may select a faster rate of change because the visual impact on the driver and other road users may be less pronounced. Current driving conditions may also influence the selected rate of change. For instance, when the host vehicle is traveling at high speed, the system may select a faster rate of change to ensure that headlight adjustments are completed before the vehicle enters a region with different ambient light conditions, such as a tunnel entrance. When the host vehicle is traveling at lower speeds or in congested traffic conditions, the system may select a slower rate of change because there may be more time available for the transition and because other road users in close proximity may benefit from a more gradual change in headlight illumination. User preferences stored in the vehicle system may allow a driver to customize the rate of change according to personal comfort levels. Some drivers may prefer faster transitions that complete headlight adjustments quickly, while other drivers may prefer slower transitions that minimize visual distraction during the adjustment period. The vehicle system may store such preferences in memory and retrieve the stored preferences when determining the rate of change for headlight state transitions.

In certain driving scenarios, different portions of the environment surrounding a host vehicle may exhibit varying ambient light levels. This variation in ambient lighting conditions can make it challenging for a system to determine an appropriate beam illumination state for headlights of the host vehicle, as the system may need to account for both bright and dark regions simultaneously when analyzing captured images. Such situations may arise, for example, when a host vehicle is driving through areas with inconsistent street lighting, passing under bridges or overpasses that create temporary shadows, or navigating through tunnels with intermittent light sources along the tunnel walls. As a specific example, a host vehicle traveling through a generally dark environment may encounter a localized bright spot of light, such as a brightly illuminated road sign, a streetlamp, or headlights from an oncoming vehicle, which creates a localized region of high light intensity within an otherwise low-light scene. In such scenarios, a traditional lux meter may sum incoming light and provide a single aggregate measurement that does not distinguish between a uniformly gray scene and a dark scene containing a strong light source in a small portion of the environment. A camera-based system, by contrast, may provide more nuanced results by analyzing different portions of a captured image separately.

The disclosed system and method may determine whether to adjust headlights of a host vehicle based on an ambient light level in an environment of the host vehicle.

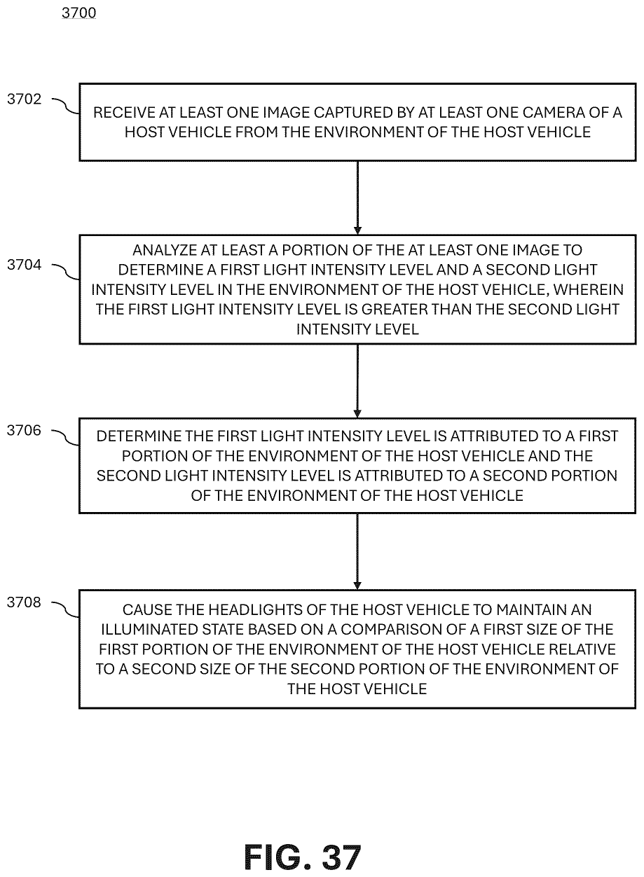

FIG. 37 is a flowchart showing an illustrative method 3700 according to the embodiments of the present disclosure. The steps of method 3700 will be described hereafter.

According to the embodiments of the present disclosure, a system may be used for whether to adjust headlights of a host vehicle based on an ambient light level in an environment of the host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

In step 3702, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30. Details regarding the receiving of at least one image captured by at least one camera of a host vehicle from the environment of the host vehicle have been given in relation with FIGS. 28 and 30 and will not be repeated here.

In step 3704, the system analyzes at least a portion of the at least one image to determine a first light intensity level and a second light intensity level in the environment of the host vehicle, wherein the first light intensity level is greater than the second light intensity level.

The first light intensity level and the second light intensity level may represent a range of illumination conditions present in the environment of the host vehicle. For example, the first light intensity level may correspond to a bright region such as a portion of the image containing direct sunlight, a well-illuminated road surface, or an area with strong artificial lighting, while the second light intensity level may correspond to a darker region such as a shaded area, a portion of the road under an overpass, or a region of the sky during twilight conditions. In some embodiments, the first light intensity level may be characterized as quite bright, corresponding to illumination levels typical of midday sunlight or intense artificial lighting, while the second light intensity level may be characterized as generally dark, corresponding to illumination levels typical of nighttime conditions or heavily shaded areas. In other embodiments, the difference between the first light intensity level and the second light intensity level may be more subtle, such as when the first light intensity level corresponds to a moderately lit region and the second light intensity level corresponds to a slightly dimmer region within the same scene.

Analysis of portions of an image has been discussed previously with reference to FIGS. 28 and 34, including the selection of the portions to analyze and the processes used to analyze the portions. Any process and embodiments described with reference to methods 2800 and 3400 are applicable here. For example, the system may use image segmentation processes, trained systems, map information, or object tracking information to determine which portions of the at least one image to analyze, as described with reference to method 2800. In some embodiments, the system may use a trained system, such as a neural network, to analyze the at least a portion of the at least one image to determine the first light intensity level and the second light intensity level, as described with reference to method 3400. In some embodiments, the system may analyze the at least a portion of the at least one image based on at least one value of at least one imaging parameter associated with the at least one camera of the host vehicle, as described with reference to method 2800.

In step 3706, the system determines the first light intensity level is attributed to a first portion of the environment of the host vehicle and the second light intensity level is attributed to a second portion of the environment of the host vehicle.

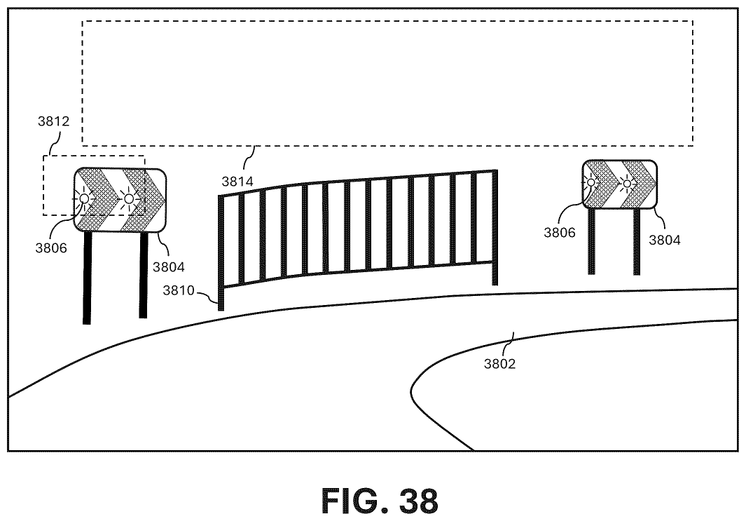

FIG. 38 is a perspective view of an environment of a host vehicle including a road segment 3802 with traffic control elements. A barrier 3810 is positioned along the road segment 3802, and sign posts 3804 are positioned on either side of the barrier 3810, with each sign post 3804 supporting a directional sign that includes light sources 3806. The environment depicted in FIG. 38 includes two distinct portions that may be associated with different light intensity levels. A first portion of the environment of the host vehicle 3812 is indicated by a dashed rectangular boundary encompassing the left sign post 3804 and the associated light source 3806, and the first light intensity level may be associated with this first portion of the environment of the host vehicle 3812. A second portion of the environment of the host vehicle 3814 is indicated by a dashed rectangular boundary that extends across the upper region of the scene, encompassing a sky region, and the second light intensity level may be attributed to this second portion of the environment of the host vehicle 3814.

In some embodiments, the first portion of the environment of the host vehicle 3812 and the second portion of the environment of the host vehicle 3814 may represent two distinct regions within the same captured image. For example, as shown in FIG. 38, the first portion of the environment of the host vehicle 3812 may encompass a region containing a sign post 3804 and an associated light source 3806, while the second portion of the environment of the host vehicle 3814 may encompass a sky region in the upper portion of the scene. In some embodiments, the first portion of the environment of the host vehicle 3812 and the second portion of the environment of the host vehicle 3814 may correspond to regions from two different images captured within the environment of the host vehicle. For example, a first camera of the host vehicle may capture a first image containing the first portion of the environment of the host vehicle 3812, and a second camera of the host vehicle may capture a second image containing the second portion of the environment of the host vehicle 3814.

With continued reference to FIG. 38, the first portion of the environment of the host vehicle 3812 and the second portion of the environment of the host vehicle 3814 may represent different areas of interest within the field of view of the at least one camera of the host vehicle. In some embodiments, the first portion of the environment of the host vehicle 3812 may correspond to a region containing one or more light sources, such as the light source 3806 shown in FIG. 38, while the second portion of the environment of the host vehicle 3814 may correspond to a region representing ambient lighting conditions, such as a sky region or a road surface region. In some embodiments, the first portion of the environment of the host vehicle 3812 may be identified using image segmentation processes or trained systems configured to distinguish between different regions of the captured image based on light intensity characteristics. In some embodiments, the first portion of the environment of the host vehicle 3812 and the second portion of the environment of the host vehicle 3814 may be determined based on map information or object tracking information associated with the environment of the host vehicle.

In step 3708, the system causes the headlights of the host vehicle to maintain an illuminated state based on a comparison of a first size of the first portion of the environment of the host vehicle relative to a second size of the second portion of the environment of the host vehicle.

For example, in some embodiments, the first light intensity level may be greater than the second light intensity level by at least a predetermined light intensity threshold, and the first size of the first portion of the environment of the host vehicle may be less than the second size of the second portion of the environment of the host vehicle by at least a predetermined size threshold.

In such embodiments, the system may determine that although a region of high light intensity exists within the captured image, the region of high light intensity occupies a relatively small area compared to a region of lower light intensity. This situation may represent a case where a bright light source occupies a small portion of the vehicle's environment while the remainder of the environment exhibits lower ambient light levels. Referring to FIG. 38, light sources 3806 attached to sign posts 3804 may emit bright light in an overall dark nighttime environment, yet the first portion of the environment of the host vehicle 3812 encompassing the light sources 3806 occupies a smaller area compared to the second portion of the environment of the host vehicle 3814 encompassing a darker sky region. Maintaining an illuminated state in such situations may enhance safety for the host vehicle. For instance, as shown in FIG. 38, if the headlights of the host vehicle were to transition to an off state based solely on detecting the bright light sources 3806, the driver may have reduced visibility of the road segment 3802 and barrier 3810, which could result in the driver missing the turn indicated by the sign posts 3804 and potentially impacting the barrier 3810.

In some embodiments, the system may cause the headlights of the host vehicle to maintain an illuminated state based on a size criteria pertaining to the first light intensity level. For example, the system may determine that the first portion of the environment of the host vehicle 3812 associated with the first light intensity level occupies less than a predetermined percentage of the field of view of the at least one camera, such as less than 1% of the field of view, less than 2% of the field of view, or less than 5% of the field of view. In such embodiments, the system may decide to ignore any bright light sources that occupy an area smaller than the predetermined percentage of the field of view, regardless of the size of any other region in the captured image. This approach may allow the system to filter out small, localized bright light sources without requiring a comparison between the size of the first portion of the environment and the size of the second portion of the environment. For instance, a small streetlight, a reflective road sign, or headlights of a distant oncoming vehicle may produce a region of high light intensity that occupies only a small fraction of the overall field of view, and the system may determine that such small bright regions should not influence the headlight state of the host vehicle.

In some embodiments, the predetermined light intensity threshold and the predetermined size threshold may be configured based on various factors. The predetermined light intensity threshold may represent a difference in light intensity values, expressed in units such as lux or candela, that distinguishes between regions of significantly different brightness within the environment of the host vehicle. For example, the predetermined light intensity threshold may be set to a value such as 500 lux, 1000 lux, or another suitable value depending on the application requirements and the sensitivity desired for distinguishing between bright and dark regions.

In some embodiments, the predetermined light intensity threshold may be determined based on empirical testing under various lighting conditions. For instance, test drives may be conducted during different times of day, weather conditions, and environmental scenarios to collect data on light intensity variations encountered in typical driving situations. The collected data may be analyzed to identify threshold values that effectively distinguish between localized bright light sources and overall ambient lighting conditions without triggering unnecessary headlight state changes.

In some embodiments, the predetermined size threshold may represent a ratio or percentage that compares the size of a first portion of the environment to the size of a second portion of the environment. For example, the predetermined size threshold may be set such that the first portion occupies less than 10%, less than 20%, or less than 30% of the total analyzed image area relative to the second portion. The predetermined size threshold may also be expressed as an absolute pixel count or as a percentage of the total field of view captured by the at least one camera.

In some embodiments, the predetermined light intensity threshold and the predetermined size threshold may be adjustable based on user preferences or vehicle configuration settings. A driver or vehicle operator may select different sensitivity levels for headlight control, where a higher sensitivity setting may use lower threshold values that cause the system to maintain illuminated headlight states more readily, while a lower sensitivity setting may use higher threshold values that allow headlight state changes to occur more frequently.

In some embodiments, the predetermined light intensity threshold and the predetermined size threshold may be dynamically adjusted based on current driving conditions. For example, when the host vehicle is traveling at higher speeds, the system may use more conservative threshold values that favor maintaining illuminated headlight states to provide enhanced visibility. When the host vehicle is traveling at lower speeds or in well-lit urban environments, the system may use different threshold values that allow for more responsive headlight state adjustments.

In some embodiments, the predetermined light intensity threshold and the predetermined size threshold may be determined using machine learning techniques. A trained system may analyze historical data from multiple vehicles and driving scenarios to identify threshold values that optimize headlight control decisions across a range of conditions. The trained system may learn correlations between threshold values, environmental conditions, and driver feedback to refine the threshold values over time.

In some embodiments, the system may use multiple threshold values for different types of light sources or environmental features. For example, a first set of threshold values may be used when the detected bright region corresponds to headlights of an oncoming vehicle, while a second set of threshold values may be used when the detected bright region corresponds to a stationary light source such as a streetlamp or illuminated sign. The system may identify the type of light source using image analysis techniques or trained systems and select appropriate threshold values accordingly.

In some embodiments, the transition of the illumination state of the headlights of the host vehicle may not be based solely on image analysis, but may also be based on knowledge of the environment of the host vehicle. For example, knowing the environment of the host vehicle in addition to performing image analysis may improve the comfort and safety of other road users by avoiding flickering of the lights of the host vehicle. Avoiding flickering may be particularly beneficial when the host vehicle is navigating a road segment with varying light intensity levels, such as a dense urban area where buildings, overpasses, or other structures may cause rapid changes in ambient light conditions.

The disclosed system and method may determine whether to adjust headlights of a host vehicle based on an ambient light level in an environment of the host vehicle.

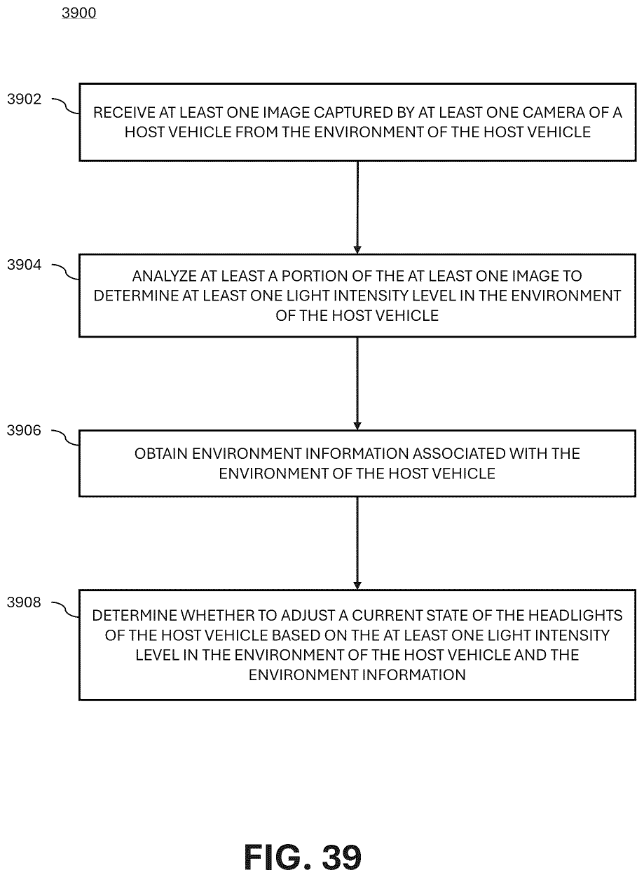

FIG. 39 is a flowchart showing an illustrative method 3900 according to the embodiments of the present disclosure. The steps of method 3900 will be described hereafter.

According to the embodiments of the present disclosure, a system may be used for whether to adjust headlights of a host vehicle based on an ambient light level in an environment of the host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

In step 3902, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30. Details regarding the receiving of at least one image captured by at least one camera of a host vehicle from the environment of the host vehicle have been given in relation with FIGS. 28 and 30 and will not be repeated here.

In step 3904, the system analyzes at least a portion of the at least one image to determine at least one light intensity level in the environment of the host vehicle.

Analysis of portions of an image has been discussed previously with reference to FIGS. 28 and 34, including the selection of the portions to analyze and the processes used to analyze the portions. Any process and embodiments described with reference to methods 2800 and 3400 are applicable here. For example, the system may use image segmentation processes, trained systems, map information, or object tracking information to determine which portions of the at least one image to analyze, as described with reference to method 2800. In some embodiments, the system may use a trained system, such as a neural network, to analyze the at least a portion of the at least one image to determine the first light intensity level and the second light intensity level, as described with reference to method 3400. In some embodiments, the system may analyze the at least a portion of the at least one image based on at least one value of at least one imaging parameter associated with the at least one camera of the host vehicle, as described with reference to method 2800.

In step 3906, the system obtains environment information associated with the environment of the host vehicle and determines whether to adjust a current state of the headlights of the host vehicle based on the at least one light intensity level in the environment of the host vehicle and the environment information.

Environment information may include any data that provides context about the surroundings of the host vehicle beyond the light intensity levels determined from the captured images. In some embodiments, environment information may include map information, sensor data, weather data, time of day information, geographic location data, or any combination thereof. The environment information may be used in conjunction with the determined light intensity levels to make more informed decisions about headlight adjustments, particularly in scenarios where temporary or localized changes in ambient light may not warrant a change in headlight state.

In some embodiments, the environment information may include map information. Map information may indicate various features of the road environment that could affect ambient light levels, such as tunnels, overpasses, bridges, underpasses, covered roadways, parking structures, or areas with dense tree coverage. The map information may be stored in a storage module associated with the host vehicle or may be retrieved from a remote server. In some embodiments, the map information may include three-dimensional representations of structures along the roadway, allowing the system to anticipate changes in ambient light levels before the host vehicle reaches those locations. The map information may also include historical data about lighting conditions at various locations, such as areas known to have streetlights, areas with frequent shadows at certain times of day, or areas where ambient light levels are typically lower due to surrounding structures.

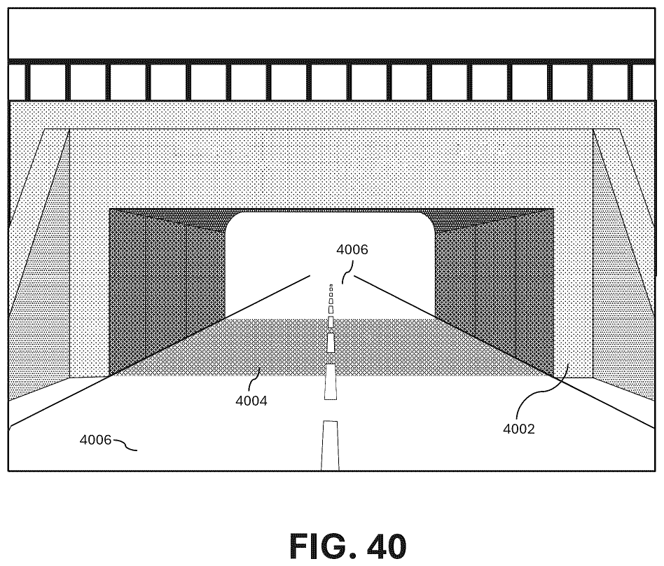

FIG. 40 shows an environment of a host vehicle where a road segment passes under an overpass 4002. The map information may indicate that an overpass 4002 is present in the environment of the host vehicle. When the system determines that the host vehicle is approaching the overpass 4002, the system may use this map information to anticipate a temporary decrease in ambient light levels as the host vehicle passes beneath the overpass 4002. A lower light intensity portion of the road 4004 is shown in the area beneath the overpass 4002, where the structure of the overpass 4002 blocks ambient light from above and creates a shaded region. A higher light intensity portion of the road 4006 is visible in the foreground before the host vehicle enters the underpass and in the area visible through the underpass opening where the road continues beyond the overpass 4002.

In some embodiments, the environment information may be obtained from at least one sensor of the host vehicle. The at least one sensor may include a lidar sensor, a radar sensor, an ultrasonic sensor, an infrared sensor, or any other sensor capable of detecting features of the environment of the host vehicle. In some embodiments, the sensor may detect the presence of structures such as overpasses, bridges, or tunnels in the environment of the host vehicle. The sensor may also detect other vehicles, pedestrians, or objects in the environment that may affect the determination of whether to adjust the headlight state. For example, a radar sensor may detect an approaching vehicle, and the system may use this information in conjunction with the determined light intensity levels to determine whether to adjust the headlights from a high beam state to a low beam state to avoid blinding the driver of the approaching vehicle. In some embodiments, the sensor may provide distance information that allows the system to estimate how long the host vehicle will be in a region of reduced ambient light, which may inform the decision of whether to adjust the headlight state.

In step 3908, the system determines whether to adjust a current state of the headlights of the host vehicle based on the at least one light intensity level in the environment of the host vehicle and the environment information. The system may evaluate the at least one light intensity level in conjunction with the environment information to determine an appropriate response for the headlights of the host vehicle. In some embodiments, the system may compare the at least one light intensity level against one or more thresholds while also considering contextual information provided by the environment information to determine whether a change in headlight state is warranted.

In some embodiments, the combination of the at least one light intensity level and the environment information may lead the system to adjust the current state of the headlights. For example, if the at least one light intensity level indicates a low ambient light condition and the environment information from map data indicates that the host vehicle is entering a tunnel, the system may cause the headlights to transition from an off state to an illuminated state or from a low beam state to a high beam state. In another example, if the at least one light intensity level indicates a high ambient light condition and the environment information indicates that the host vehicle has exited a tunnel into daylight, the system may cause the headlights to transition from an illuminated state to an off state or from a high beam state to a low beam state.

In some embodiments, the combination of the at least one light intensity level and the environment information may lead the system to maintain the current state of the headlights of the host vehicle. For example, if the at least one light intensity level indicates a decrease in ambient light and the environment information from map data indicates that an overpass is present in the environment of the host vehicle, the system may determine that the decrease in light intensity is transient and maintain the current state of the headlights rather than adjusting the headlights in response to the temporary change. Referring to FIG. 40, when the host vehicle approaches the overpass 4002, the system may detect a lower light intensity portion of the road 4004 beneath the overpass 4002 where the structure blocks ambient light from above and creates a shaded region. At the same time, the system may detect a higher light intensity portion of the road 4006 in the foreground before the vehicle enters the underpass and in the area visible through the underpass opening where the road continues beyond the overpass 4002. Based on the map information indicating the presence of the overpass 4002, the system may determine that the decrease in ambient light levels associated with the lower light intensity portion of the road 4004 is temporary and localized. Accordingly, the system may maintain the current state of the headlights of the host vehicle rather than adjusting the headlights in response to the temporary decrease in light intensity as the host vehicle passes beneath the overpass 4002. In another example, if the at least one light intensity level indicates a brief shadow condition and the environment information from a sensor indicates that the host vehicle is passing under a bridge structure, the system may maintain the current headlight state because the lighting change is expected to be short-lived. In yet another example, if the at least one light intensity level indicates a localized dark region but the environment information indicates that the host vehicle is traveling on an open road with no tunnels or covered structures ahead, the system may maintain the current headlight state because the dark region may be attributed to a passing cloud or other temporary obstruction.

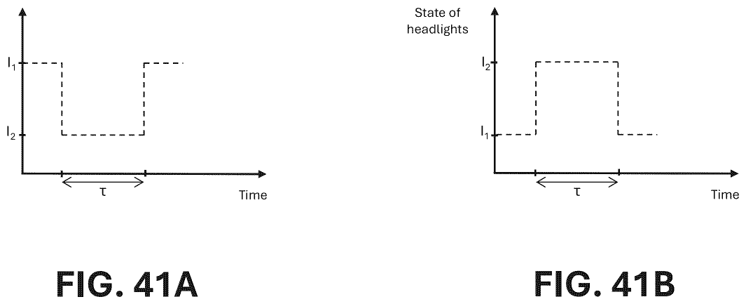

In some embodiments, the current state of the headlights of the host vehicle may be decreased to a lower state having an intensity less than the current state for a predetermined time period and increased to the current state after the predetermined time period. FIG. 41A depicts a graph showing a state of headlights transition where a first state I₁ is greater than a second light intensity level I₂. The state transitions from the first light intensity level I₁ to the second light intensity level I₂, remains at the second light intensity level I₂ for a duration t, and then transitions back to the first light intensity level I₁. This type of transition may occur, for example, when the host vehicle passes through a short tunnel or under an overpass, and the system temporarily increases the headlight intensity during the predetermined time period τ to provide additional illumination before restoring the headlights to the current state upon exiting the darker region.

In some embodiments, the current state of the headlights of the host vehicle may be increased to a higher state having an intensity greater than the current state for a predetermined time period and decreased to the current state after the predetermined time period. Referring to FIG. 41B, a graph is shown that depicts a state of headlights transition where a first light intensity level I₁ is lower than a second light intensity level I₂. The state transitions from the first light intensity level I₁ to the second light intensity level I₂, remains at the second light intensity level I₂ for a duration t, and then transitions back to the first light intensity level I₁. This type of transition may occur, for example, when the host vehicle approaches a brightly lit area such as a well-illuminated intersection or a section of road with streetlights, and the system temporarily decreases the headlight intensity to avoid excessive illumination during the predetermined time period τ before restoring the headlights to the current state.

The predetermined time period τ may be selected or calculated based on various factors. In some embodiments, the predetermined time period τ may be determined based on a length of a structure causing the temporary lighting change, such as a length of an overpass or a bridge, as indicated by the environment information from map data. In some embodiments, the predetermined time period τ may be calculated based on a speed of the host vehicle and a distance associated with the temporary lighting condition. For example, if the environment information indicates that an overpass has a length of 50 meters and the host vehicle is traveling at 25 meters per second, the predetermined time period τ may be calculated as approximately 2 seconds. In some embodiments, the predetermined time period τ may be a fixed value stored in the system based on typical durations of temporary lighting changes encountered during vehicle operation. In some embodiments, the predetermined time period τ may be dynamically adjusted based on real time analysis of the at least one light intensity level, where the system monitors the light intensity and determines when the temporary lighting condition has ended.

In some embodiments, the current state of the headlights of the host vehicle may be decreased to a lower state having an intensity less than the current state at a predetermined rate. In some embodiments, the current state of the headlights of the host vehicle may be increased to a higher state having an intensity greater than the current state at a predetermined rate. Referring to FIG. 36C, a graph is show that depicts a headlight state that begins at a value I₁ and gradually decreases over time following a linear trajectory until reaching a value I₂. This gradual decrease at a predetermined rate may provide a smooth transition in headlight intensity, which may reduce distraction to the driver and other road users. For example, when the host vehicle exits a tunnel into daylight, the system may gradually decrease the headlight intensity at a predetermined rate rather than abruptly turning off the headlights. Referring to FIG. 36D, a graph is shown that depicts a light intensity level that begins at a value I₁ and gradually decreases over time until reaching a value I₂ following a curved trajectory. The curved trajectory shown in FIG. 36D may represent a non-linear rate of change that varies over the duration of the transition. For example, the rate of change may be faster at the beginning of the transition and slower as the illumination state approaches the target value I₂, or the rate of change may follow an exponential decay pattern, a logarithmic pattern, or a sigmoidal pattern. Such non-linear transitions may more closely approximate natural lighting changes that occur in the environment, such as the gradual dimming of light as a vehicle enters a tunnel or the gradual brightening as a vehicle exits a shaded area. The curved trajectory may also be selected to optimize driver comfort by avoiding abrupt changes in the rate of illumination adjustment. In some embodiments, the shape of the curved trajectory may be determined based on factors such as the magnitude of the difference between I₁ and I₂, the current driving speed of the host vehicle, or the type of lighting transition being performed. For instance, a transition from high beam to low beam may follow a different curved trajectory than a transition from an illuminated state to an off state. The system may store multiple predefined curve profiles and select an appropriate profile based on the specific headlight state transition being executed.

### Adjusting Brightness, Contrast, or Colors of Dashboard or Head-Up Display Based on Ambient Light Level

The methods for determining ambient light levels in an environment of a host vehicle, as described above, may be applied to various vehicle systems beyond headlight control. In some embodiments, the ambient light intensity information derived from camera-based analysis may be used to adjust display parameters of one or more displays inside the host vehicle. Such displays may include, for example, a heads-up display, a dashboard display, an instrument cluster, an infotainment display, or any other visual output device positioned within the interior of the host vehicle.

In some embodiments, the system may determine different types of light intensity levels depending on the application requirements. For general ambient light assessment, the system may determine an overall environmental light intensity level that characterizes the general illumination conditions in the environment of the host vehicle. Such an overall environmental light intensity level may be similar to measurements provided by a traditional lux meter and may be sufficient for certain applications such as headlight control decisions. For example, determining whether the environment corresponds to daytime conditions, dawn or dusk conditions, or nighttime conditions may be adequate for deciding whether to activate headlights or for selecting between low beam and high beam states. The overall environmental light intensity level may be determined by analyzing a broad portion of the captured image or by aggregating light intensity values across multiple regions of the environment.

In some embodiments, particularly for display adjustment applications such as head-up display parameter control, the system may determine a localized light intensity level associated with a specific region of interest within the environment of the host vehicle. The localized light intensity level may correspond to a much more specific area of the environment compared to the overall environmental light intensity level. For example, even when the host vehicle is operating during nighttime conditions with generally low ambient illumination, a small region of the environment visible behind the head-up display from the perspective of the driver may overlap with a localized bright area such as a streetlight, an illuminated sign, or headlights of an oncoming vehicle. In such scenarios, the system may determine the localized light intensity level associated with the specific region that serves as the background for the head-up display projection, rather than relying solely on the overall environmental light intensity level.

In some embodiments, the system may determine both an overall environmental light intensity level and a localized light intensity level for a region of interest. The overall environmental light intensity level may be used to estimate a general adaptation state of the eyes of the driver, such as the degree of pupil dilation that would be expected under the prevailing ambient lighting conditions. The localized light intensity level associated with the region of interest may be used to determine specific display parameter adjustments that optimize visibility and contrast for the head-up display projection against the particular background region that the driver will perceive. By considering both the overall environmental light intensity level and the localized light intensity level, the system may account for the interaction between the driver's visual adaptation state and the specific background conditions behind the displayed information.

In some embodiments, the system may use chromatic information from the captured images to adjust display parameters without necessarily deriving an overall brightness value from the camera. For example, when a brightness level of the head-up display is maintained at a constant value, the system may still adjust colors of displayed content such as fonts, icons, or graphical elements based on chromatic characteristics of the environment. The system may determine different intensity levels associated with different portions of the visible spectrum, such as intensity levels in red, green, and blue wavelength ranges. Based on the chromatic analysis, the system may select display colors that provide contrast against the specific color composition of the background region visible behind the head-up display. For instance, if the background region exhibits predominantly warm tones from sunset lighting or artificial illumination, the system may select cooler display colors to enhance visibility, or vice versa. This chromatic-based adjustment approach may be used independently or in combination with brightness-based adjustments to optimize display readability under varying environmental conditions.

The disclosed system and method may determine adjustments to a display of a host vehicle.

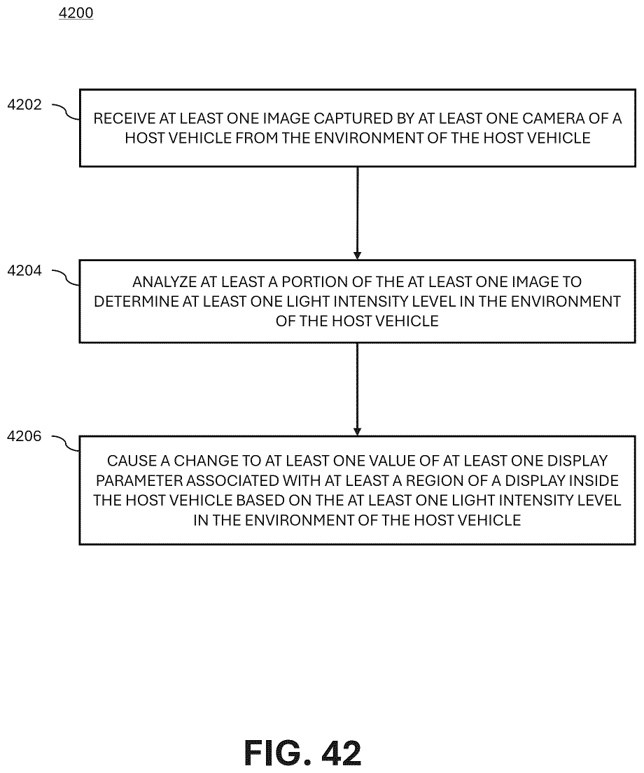

FIG. 42 is a flowchart showing an illustrative method 4200 according to the embodiments of the present disclosure. The steps of method 4200 will be described hereafter.

According to the embodiments of the present disclosure, a system may be used for determining adjustments to headlights of a host vehicle based on an ambient light level in an environment of the host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

In step 4202, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30. Details regarding the receiving of at least one image captured by at least one camera of a host vehicle from the environment of the host vehicle have been given in relation with FIGS. 28 and 30 and will not be repeated here.

In step 4204, the system analyzes at least a portion of the at least one image to determine at least one light intensity level in the environment of the host vehicle.

In some embodiments, analyzing the at least a portion of the at least one image may include determining a portion of the at least one image for analysis using at least a position of a head of a user of the host vehicle. The position of the head of the user may be determined using various techniques. For example, the position of the head of the user may be determined using a driver monitoring system camera positioned within the interior of the host vehicle and directed toward the user. The driver monitoring system camera may capture images of the user, and the system may analyze the captured images to identify facial features, head orientation, or head position within the interior of the host vehicle. In some embodiments, the position of the head of the user may be determined using depth sensing techniques, such as structured light projection or time-of-flight sensing, to obtain three-dimensional position information. In some embodiments, the position of the head of the user may be determined based on seat location information or seat position settings associated with the seat occupied by the user. The determination of the position of the head of a user of the host vehicle will be disclosed in more detail later in this disclosure.

The portion of the at least one image selected for analysis may depend on the position of the head of the user because the position of the head affects which region of the environment serves as the background for a display, such as a head-up display, from the vantage point of the user. A head-up display projects information onto a transparent surface, such as a windshield, and the projected information appears to overlay the environment visible through the windshield. The specific portion of the environment that appears behind the projected information depends on the viewing angle of the user, which is determined by the position of the user's head relative to the display surface. By determining the position of the head of the user, the system may identify the corresponding portion of the captured image that represents the background against which the user will perceive the displayed information. The system may then analyze the light intensity level and color characteristics of that specific portion of the image to determine appropriate display parameter adjustments that maintain visibility and contrast for the user based on the actual background conditions the user will experience.

In some embodiments, the at least a portion of the at least one image may be analyzed based on at least one value of the at least one imaging parameter associated with the at least one camera of the host vehicle. In some embodiments, the at least one imaging parameter associated with the at least one camera of the host vehicle may be obtained prior to the analysis of the at least one portion of the at least one image.

In some embodiments, the at least one imaging parameter may be at least one light-adaptive imaging parameter. In some embodiments, the at least one imaging parameter associated with the camera of the host vehicle may include an exposure time or an aperture size.

Examples of imaging parameters and details regarding obtaining at least one value of at least one imaging parameter associated with the at least one camera of the host vehicle and analyzing at least a portion of the at least one image based on the at least one value of the at least one imaging parameter have been described earlier in this disclosure, for example with regard to FIG. 28 and method 2800, and will not be repeated here.

In some embodiments, the at least a portion of the at least one image may be analyzed using at least one trained model. In some embodiments, the at least one trained model may include a neural network.

Details regarding analyzing at least a portion of the at least one image using at least one trained system to determine at least one light intensity level in the environment of the host vehicle have been described earlier in this disclosure, for example with regard to FIG. 34 and method 3400, and will not be repeated here.

The system may determine portions of the image for analysis using various techniques, including image segmentation processes and trained systems, as previously described in relation to FIGS. 28-31.

In step 4206, the system causes a change to at least one value of at least one display parameter associated with at least a region of a display inside the host vehicle based on the at least one light intensity level in the environment of the host vehicle. In some embodiments, the display may be a head-up display or a dashboard. In some embodiments, a display parameter for a head-up display may need to be changed when the ambient light conditions in the environment of the host vehicle vary, such as when the host vehicle enters a tunnel, passes under an overpass, or transitions between daytime and nighttime driving conditions. In some embodiments, a display parameter for a dashboard may need to be changed based on general ambient light levels detected in the environment of the host vehicle, such as when the host vehicle transitions from a brightly lit urban area to a darker rural road or when weather conditions affect the overall illumination in the environment.

In some embodiments, the at least one display parameter may be a brightness level. A brightness level may refer to the intensity of light emitted by the display, which affects how luminous the displayed content appears to a user of the host vehicle. In some embodiments, the change may increase or decrease the brightness level of the region of the display. In some embodiments, the brightness level may need to be increased when the ambient light level in the environment of the host vehicle is high, such as during bright daylight conditions, to ensure that the displayed content remains visible against the bright background. In some embodiments, the brightness level may need to be decreased when the ambient light level in the environment of the host vehicle is low, such as during nighttime driving or when the host vehicle is inside a tunnel, to prevent the display from being overly bright and potentially distracting to the user. For a heads-up display, adjusting the brightness level based on the ambient light conditions may help maintain visibility of projected information against the varying background of the environment visible through the windshield.

In some embodiments, the at least one display parameter may be a contrast level. A contrast level may refer to the difference in luminance or color between different elements displayed on the display, which affects how distinguishable the displayed content is from surrounding elements or the background. In some embodiments, the change may increase or decrease the contrast level of the region of the display. In some embodiments, the contrast level may need to be increased when the background of the environment of the host vehicle has similar luminance characteristics to the displayed content, making the content difficult to distinguish. In some embodiments, the contrast level may need to be decreased when the background of the environment of the host vehicle has significantly different luminance characteristics from the displayed content, and a high contrast level would be unnecessary or visually uncomfortable for the user.

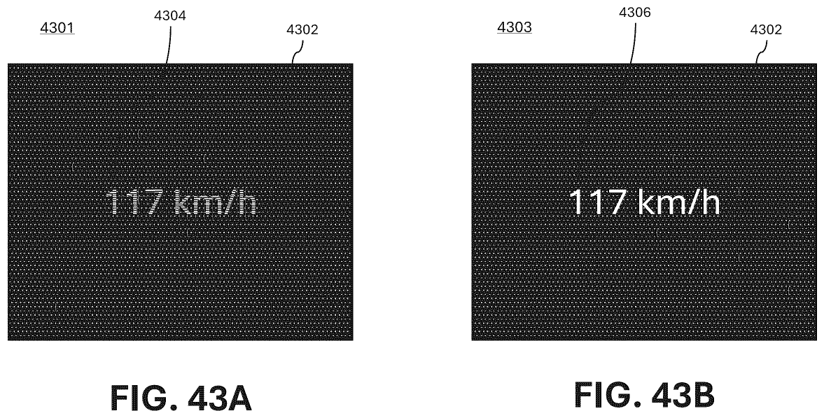

Referring to FIGS. 43A and 43B, exemplary display states are shown that illustrate adjustments to a display of a host vehicle based on ambient light levels in an environment of the host vehicle. FIG. 43A depicts a display in a first display state 4301 with a background color of the environment of the host vehicle 4302 shown as a dark field. A region of the display having a first display parameter 4304 is shown displaying a speed reading, where the text appears with reduced visibility against the background color of the environment of the host vehicle 4302. FIG. 43B depicts the same display in a second display state 4303 with the background color of the environment of the host vehicle 4302 shown as a dark field. A region of the display having a second display parameter 4306 is shown displaying the same speed reading, where the text appears with enhanced visibility and contrast against the background color of the environment of the host vehicle 4302. The comparison between FIG. 43A and FIG. 43B illustrates how the display parameter associated with the region displaying the speed information may be adjusted to improve readability based on the ambient light conditions in the environment of the host vehicle, where the region of the display having a second display parameter 4306 in FIG. 43B exhibits improved contrast compared to the region of the display having a first display parameter 4304 in FIG. 43A.

In some embodiments, the at least one display parameter may be a color. In some embodiments, the change may modify the color of the region of the display from a first color to a second color. In some embodiments, the change modifies the color of the region of the display to contrast with a color of a different region of the display. In some embodiments, the change modifies the color of the region of the display to contrast with one or more colors in the environment of the host vehicle. A color of the display may need to be changed when the background of the environment of the host vehicle, as visible through the windshield behind a heads-up display projection, has a color that is similar to the color of the displayed content. For example, if the displayed content is rendered in a green color and the environment of the host vehicle includes a large area of green foliage visible through the windshield, the system may change the color of the displayed content to a contrasting color such as orange or white to improve visibility. In some embodiments, the system may analyze the colors present in the environment of the host vehicle using the at least one image captured by the at least one camera and select a display color that provides contrast against the detected colors in the environment. In some embodiments, the system may change the color of one region of the display to contrast with another region of the display when multiple pieces of information are displayed simultaneously and need to be visually distinguished from one another.

In some embodiments, the system may determine an optimal display color based on a color analysis of the at least one image captured by the at least one camera. The color analysis may include identifying dominant colors present in the environment of the host vehicle, calculating color histograms for regions of the captured image, or determining average color values for portions of the image that correspond to the background visible behind the head-up display projection. The system may use color space representations such as RGB, HSV, or LAB color spaces to analyze the colors in the environment and to select a display color that maximizes contrast. For example, the system may calculate the color distance between a current display color and the dominant colors in the environment using metrics such as Euclidean distance in a color space, and may select a new display color that maximizes the color distance to improve visibility.

In some embodiments, the system may maintain a set of predefined display colors and may select from the set of predefined display colors based on the colors detected in the environment of the host vehicle. The set of predefined display colors may include colors that are known to provide good visibility under various environmental conditions, such as white, yellow, orange, cyan, magenta, or other high-contrast colors. The system may cycle through the set of predefined display colors or may select a specific color from the set based on which color provides the greatest contrast against the detected environmental colors.

In some embodiments, the system may adjust the saturation or intensity of the display color in addition to or instead of changing the hue of the display color. For example, if the environment of the host vehicle includes pastel or desaturated colors, the system may increase the saturation of the display color to improve contrast. Conversely, if the environment includes highly saturated colors, the system may adjust the display color to have a different hue or may increase the brightness of the display to maintain visibility.

In some embodiments, the system may consider the time of day, weather conditions, or other environmental factors when selecting a display color. For example, during sunset or sunrise conditions when the environment may include warm orange and red tones, the system may select a cooler display color such as blue or cyan to provide contrast. During overcast conditions when the environment may appear gray or desaturated, the system may select a more saturated display color to improve visibility.

In some embodiments, the system may use different colors for different types of information displayed on the heads-up display or dashboard. For example, navigation information may be displayed in a first color, speed information may be displayed in a second color, and warning or alert information may be displayed in a third color. The system may adjust each of these colors independently based on the colors present in the corresponding regions of the environment visible behind each portion of the display. This approach may allow the system to optimize visibility for each type of displayed information while also maintaining visual distinction between different categories of information.

In some embodiments, the system may store user preferences for display parameters and may use the user preferences as a starting point when determining display parameters adjustments. The system may attempt to maintain display parameters that are close to the user's preferred parameters while still ensuring adequate display of information. If the user's preferred parameters does not provide, for example, sufficient contrast against the current environmental conditions, the system may temporarily override the user preference and select a higher-contrast parameter, potentially returning to the user's preferred parameter when environmental conditions change.

In some embodiments, the system may cause non-uniform changes to display parameters across different regions of the display. The system may adjust display parameters differently for different portions of the display based on variations in the background visible behind each portion. For example, when the left side of the environment visible through the windshield has a bright sky background and the right side has a darker tree canopy background, the system may increase the brightness level of the left region of the head-up display to maintain visibility against the bright sky while maintaining or decreasing the brightness level of the right region of the head-up display where the darker background provides sufficient contrast. In some embodiments, the system may divide the display into multiple zones and independently adjust display parameters for each zone based on the ambient light characteristics of the corresponding background region. The zones may be defined as fixed regions of the display, such as left, center, and right zones, or may be dynamically defined based on the content being displayed and the characteristics of the background environment. In some embodiments, the system may apply a gradient of display parameter values across the display, where the parameter values transition smoothly from one side of the display to another based on a corresponding gradient in background illumination. For example, if the background transitions from a bright region on the left to a dark region on the right, the system may apply a corresponding gradient to the brightness level of the display, with higher brightness on the left and lower brightness on the right. This non-uniform adjustment approach may provide improved visibility across the entire display by accounting for spatial variations in the background environment rather than applying a single uniform adjustment based on an average ambient light level.

In some embodiments, the system may implement display parameter changes gradually to avoid distracting the driver of the host vehicle. The system may transition from a first display parameter to a second display parameter over a period of time, interpolating between the two parameters to provide a smooth visual transition. The rate of parameter transition may be selected based on factors such as the magnitude of the parameter change, the current driving conditions, or user preferences stored in the vehicle system.

In some embodiments, changes to head-up display parameters may be implemented gradually rather than instantaneously. Gradual changes may reduce distraction to the user and may provide a smoother visual experience. Because changes to head-up display parameters may be gradual, the system may benefit from analyzing a broader area of the environment to anticipate how the background of the head-up display may change as the vantage point of the user shifts or as the host vehicle moves through the environment. The system may use the analysis of the broader area to plan a progression of display parameter changes that maintains readability and contrast for the user over time.

In some embodiments, the change of at least one value of at least one display parameter associated with at least a region of a display inside the host vehicle may not be based solely on analysis of images captured by the at least one camera of the host vehicle. The system may incorporate knowledge of the environment of the host vehicle in addition to image analysis when determining whether to cause a change to display parameters. For example, the system may obtain environment information associated with the environment of the host vehicle, such as map information indicating the presence of overpasses, tunnels, bridges, or other structures that may cause temporary changes in ambient light levels. The system may use the environment information in combination with the determined light intensity level to determine whether to adjust display parameters.

In some embodiments, the combined approach of using image analysis together with environment information may improve comfort and safety for a driver of the host vehicle. By incorporating knowledge of the environment of the host vehicle, the system may anticipate changes in ambient light levels before the changes occur. The system may use forecasted light level predictions to provide instructions or adjustments earlier, based on the forecasting. The system may also use the environment information to determine whether a detected change in light intensity is temporary or sustained, which may affect whether and how display parameters are adjusted.

In some embodiments, a benefit of incorporating environment information when determining display parameter adjustments may be avoiding flickering of displays of the host vehicle. Flickering may occur when display parameters are adjusted rapidly in response to transient changes in ambient light levels. For example, when the host vehicle navigates road segments with varying light intensity levels, such as dense urban areas with buildings that cast shadows on the roadway, the ambient light level detected by the camera may fluctuate frequently. Without incorporating environment information, the system may cause rapid changes to display parameters in response to each fluctuation, resulting in flickering that may distract or discomfort the driver of the host vehicle.

In some embodiments, the system may use environment information to determine that a detected change in light intensity is attributable to a temporary condition, such as the host vehicle passing under an overpass or through a shadow cast by a building. In such scenarios, the system may determine to maintain current display parameter values rather than adjusting the display parameters in response to the temporary change. Alternatively, the system may determine to adjust display parameters at a gradual rate or for a predetermined time period based on the environment information. The incorporation of environment information may allow the system to provide a smoothed signal for display parameter adjustments, reducing flickering and improving the visual experience for the driver of the host vehicle.

The disclosed system and method may determine whether to adjust a display of a host vehicle based on an ambient light level in an environment of the host vehicle.

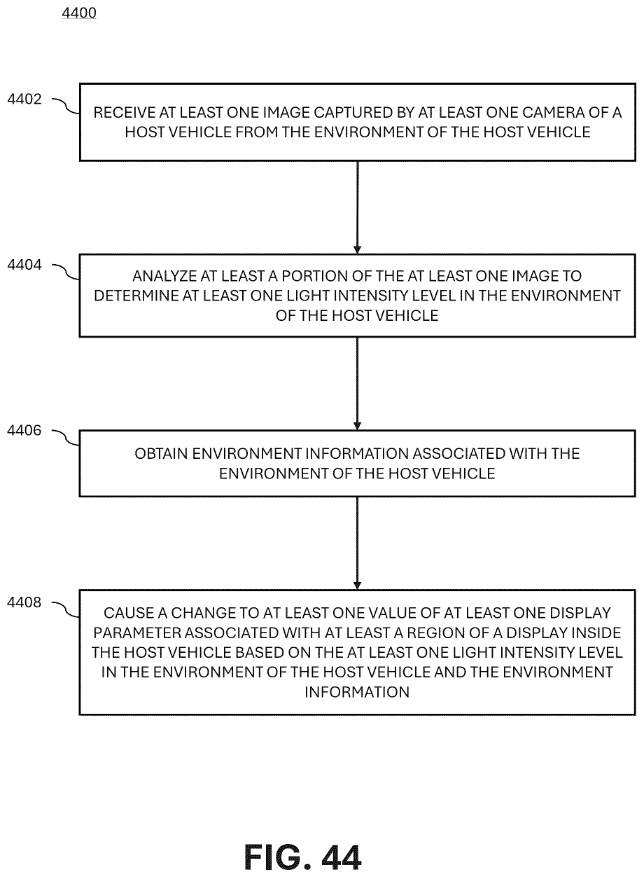

FIG. 44 is a flowchart showing an illustrative method 3900 according to the embodiments of the present disclosure. The steps of method 4400 will be described hereafter.

According to the embodiments of the present disclosure, a system may be used for determining adjustments to a display of a host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

In step 4402, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30. Details regarding the receiving of at least one image captured by at least one camera of a host vehicle from the environment of the host vehicle have been given in relation with FIGS. 28 and 30 and will not be repeated here.

In step 4404, the system analyzes at least a portion of the at least one image to determine at least one light intensity level in the environment of the host vehicle.

Analysis of portions of an image has been discussed previously with reference to FIGS. 28 and 34, including the selection of the portions to analyze and the processes used to analyze the portions. Any process and embodiments described with reference to methods 2800 and 3400 are applicable here. For example, the system may use image segmentation processes, trained systems, map information, or object tracking information to determine which portions of the at least one image to analyze, as described with reference to method 2800. In some embodiments, the system may use a trained system, such as a neural network, to analyze the at least a portion of the at least one image to determine the first light intensity level and the second light intensity level, as described with reference to method 3400. In some embodiments, the system may analyze the at least a portion of the at least one image based on at least one value of at least one imaging parameter associated with the at least one camera of the host vehicle, as described with reference to method 2800.

In step 4406, the system obtains environment information associated with the environment of the host vehicle and determines whether to adjust a current state of the headlights of the host vehicle based on the at least one light intensity level in the environment of the host vehicle and the environment information.

In some embodiments, the environment information may include map information. In some embodiments, the map information may indicate an overpass is present in the environment of the host vehicle.

In some embodiments, the environment information may obtained from at least one sensor of the host vehicle.

Map information and environment information obtained from at least one sensor of the host vehicle have been discussed previously with reference to FIG. 39 and method 3900 and will not be repeated here.

In step 4408, the system causes a change to at least one value of at least one display parameter associated with at least a region of a display inside the host vehicle based on the at least one light intensity level in the environment of the host vehicle and the environment information. The system may evaluate the at least one light intensity level determined in step 4404 in conjunction with the environment information obtained in step 4406 to determine an appropriate response for the display inside the host vehicle.

In some embodiments, the at least one value of the at least one display parameter of the display may be maintained. The system may determine that the at least one value of the at least one display parameter should remain unchanged based on the environment information indicating that a detected change in the at least one light intensity level is temporary or transient. For example, when the environment information includes map information indicating that an overpass (for example overpass 4002) is present in the environment of the host vehicle, the system may determine that a decrease in the at least one light intensity level is temporary and that the at least one value of the at least one display parameter should be maintained rather than adjusted. In another example, when the environment information indicates that the host vehicle is passing under a bridge or through a shadow cast by a building, the system may maintain the at least one value of the at least one display parameter to avoid unnecessary adjustments that would be reversed shortly thereafter.

In some embodiments, the at least one value of the at least one display parameter of the display may be changed to a new value for a predetermined time period and restored to the at least one value of the at least one display parameter after the predetermined time period. Referring to FIGS. 41A and 41B, the graphs depicted in FIGS. 41A and 41B may represent transitions in display parameter values over time. As shown in FIG. 41A, a display parameter value may transition from a first value I₁ to a second value I₂, remain at the second value I₂ for a duration t, and then transition back to the first value I₁, where the second value I₂ is smaller than the first value I₁. As shown in FIG. 41B, a display parameter value may transition from a first value I₁ to a second value I₂, remain at the second value I₂ for a duration t, and then transition back to the first value I₁, where the second value I₂ is greater than the first value I₁. The predetermined time period τ may correspond to a duration during which the host vehicle passes through a region of different ambient light conditions, such as when the host vehicle passes under an overpass 4002 as depicted in FIG. 40.

In some embodiments, the at least one value of the at least one display parameter may represent a brightness level of the at least one region of the display. The brightness level may be temporarily increased or decreased for the predetermined time period and then restored to a previous brightness level after the predetermined time period. In some embodiments, the at least one value of the at least one display parameter may represent a contrast level of the at least one region of the display. The contrast level may be temporarily adjusted for the predetermined time period to improve visibility of information displayed on the display and then restored after the predetermined time period. In some embodiments, the at least one value of the at least one display parameter may represent a color of the at least one region of the display. The color may be temporarily modified for the predetermined time period to provide improved contrast with the background color of the environment of the host vehicle and then restored after the predetermined time period.

In some embodiments, the at least one value of at the at least one display parameter may be changed to a new value at a predetermined rate. This may be illustrated in FIGS. 36C and 36D if the graphs represent a value of a display parameter instead of a headlight state. As shown in FIG. 36C, a display parameter value may begin at a first value and gradually decrease over time following a linear trajectory until reaching a second value, representing a gradual decrease in the display parameter value at a constant rate. As shown in FIG. 36D, a display parameter value may begin at a first value and gradually decrease over time following a curved trajectory until reaching a second value, representing a gradual decrease in the display parameter value with a varying rate. The gradual change in the at least one value of the at least one display parameter at a predetermined rate may provide a smooth transition that avoids abrupt changes that could distract a user of the host vehicle.

In some embodiments, the at least one value of the at least one display parameter may represent a brightness level of the at least one region of the display. The brightness level may be gradually increased or decreased at the predetermined rate to provide a smooth transition in display brightness as ambient light conditions change in the environment of the host vehicle.

In some embodiments, the at least one value of the at least one display parameter may represent a contrast level of the at least one region of the display. The contrast level may be gradually adjusted at the predetermined rate to maintain readability of information displayed on the display while avoiding abrupt visual changes.

In some embodiments, the at least one value of the at least one display parameter may represent a color of the at least one region of the display. The color may be gradually modified at the predetermined rate to transition between color schemes that provide improved contrast with changing background colors in the environment of the host vehicle.

In some embodiments, the various techniques and approaches described above with reference to FIG. 42 and method 4200 for adjusting brightness, contrast, and color parameters may be equally applicable to method 4400. For example, the approaches for selecting appropriate parameter values to improve visibility and readability, and the methods for implementing parameter changes to avoid distracting a user of the host vehicle as described with reference to method 4200 may also be applied when the system determines whether to cause a change to display parameters based on the combination of light intensity levels and environment information in method 4400. The display types, including head-up displays and dashboards, the various display parameter adjustments, and the techniques for analyzing portions of captured images to determine light intensity levels as described with reference to FIG. 42 and method 4200 may be used in conjunction with the environment information considerations of method 4400.

In some embodiments, the techniques and approaches described with reference to headlight state changes may also be applied to display parameter adjustments. For example, the predetermined time period t, the predetermined rates of change, the use of environment information to determine whether changes are temporary, and the smoothing techniques described in connection with headlight control may also be used when determining whether and how to adjust display parameters. The system may apply similar logic for maintaining, temporarily changing, or gradually adjusting display parameter values as described for headlight illumination states. Any examples and embodiments discussed above with regard to changes in state of headlights, including the transitions depicted in FIGS. 36A-36D and FIGS. 41A-41B, the use of map information and sensor data, and the approaches for avoiding flickering, may be equally applicable to display parameter adjustments described herein.

### Adjusting Brightness, Contrast, or Colors of Head-Up Display Based on Ambient Light Level and Looking Direction of User

Adjusting display parameters for a head-up display may present additional considerations compared to adjusting display parameters for a dashboard or other vehicle displays. A head-up display projects information onto a transparent surface, such as a windshield, such that the projected information appears to overlay the environment visible through the windshield from the perspective of a user of the host vehicle. Because the projected information overlays the environment, the background against which the projected information appears may vary depending on the viewing angle of the user and the content of the environment visible through the windshield at any given moment. In contrast, a dashboard display typically has a fixed background that does not change based on the environment outside the vehicle, and adjustments to dashboard display parameters may be based on general ambient light levels in the environment of the host vehicle rather than on illumination characteristics of a specific area of the environment.

To adjust display parameters of a head-up display in a manner that maintains readability and contrast for a user, a system may determine what portion of the environment of the host vehicle serves as the background for the head-up display from the vantage point of the user. The system may analyze light intensity levels and color characteristics of the portion of the environment that corresponds to the background of the head-up display as perceived by the user. The system may then adjust brightness, contrast, or color parameters of the head-up display based on the analyzed light intensity levels and color characteristics of the background portion of the environment.

The disclosed system and method may determine adjustments to a display of a host vehicle.

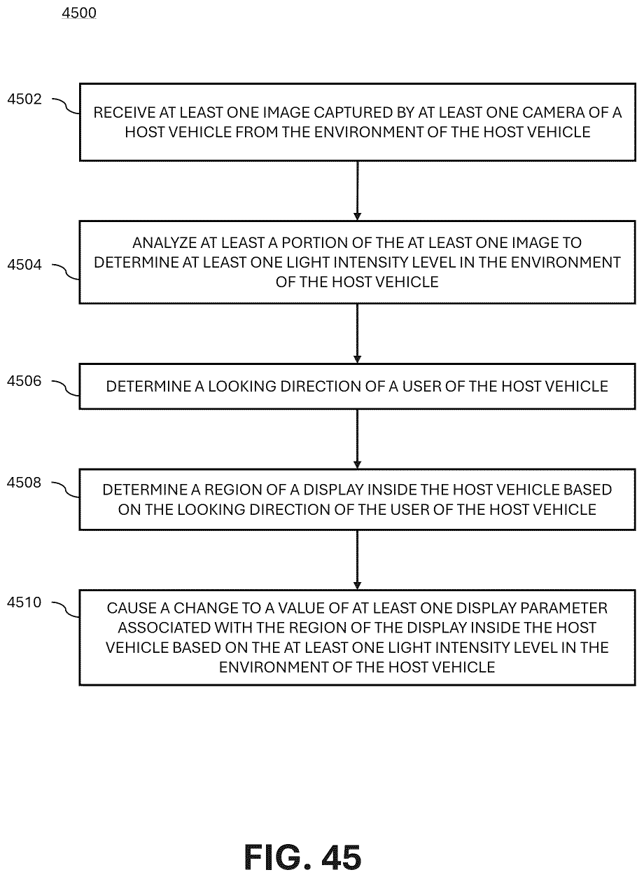

FIG. 45 is a flowchart showing an illustrative method 4500 according to the embodiments of the present disclosure. The steps of method 4500 will be described hereafter.

According to the embodiments of the present disclosure, a system may be used for determining adjustments to a display of a host vehicle. The system may correspond to any suitable computing system, and may, for example, comprise system 2700 or system 100 described above. The system may include at least one processor comprising circuitry and a memory, with the memory storing instructions that when executed by the processor cause the processor to carry functions associated with embodiments described herein.

In step 4502, the system receives at least one image captured by at least one camera of a host vehicle from the environment of the host vehicle. The at least one image may be representative of the environment surrounding the host vehicle and may include representations of various objects, light sources, and environmental features present in the field of view of the at least one camera. An exemplary image captured by a camera of a host vehicle is shown in FIG. 30. Details regarding the receiving of at least one image captured by at least one camera of a host vehicle from the environment of the host vehicle have been given in relation with FIGS. 28 and 30 and will not be repeated here.

In step 4504, the system analyzes at least a portion of the at least one image to determine at least one light intensity level in the environment of the host vehicle.

In some embodiments, the at least a portion of the at least one image may be analyzed based on at least one value of the at least one imaging parameter associated with the at least one camera of the host vehicle. In some embodiments, the at least one imaging parameter associated with the at least one camera of the host vehicle may be obtained prior to the analysis of the at least one portion of the at least one image.

In some embodiments, the at least one imaging parameter may be at least one light-adaptive imaging parameter. In some embodiments, the at least one imaging parameter associated with the camera of the host vehicle may include an exposure time or an aperture size.

Examples of imaging parameters and details regarding obtaining at least one value of at least one imaging parameter associated with the at least one camera of the host vehicle and analyzing at least a portion of the at least one image based on the at least one value of the at least one imaging parameter have been described earlier in this disclosure, for example with regard to FIG. 28 and method 2800, and will not be repeated here.

In some embodiments, the at least a portion of the at least one image may be analyzed using at least one trained model. The system may determine portions of the image for analysis using various techniques, including image segmentation processes and trained systems, as previously described in relation to FIGS. 28-31.

Details regarding analyzing at least a portion of the at least one image using at least one trained system to determine at least one light intensity level in the environment of the host vehicle have been described earlier in this disclosure, for example with regard to FIG. 34 and method 3400, and will not be repeated here.

In step 4506, the system determines a looking direction of a user of the host vehicle. A looking direction may refer to an orientation or direction in which a user, such as a driver or passenger of the host vehicle, is gazing or focusing visual attention. The looking direction may be represented as a vector extending from a position of the user's eyes toward a point or region in the environment of the host vehicle or toward a region of a display inside the host vehicle.

In some embodiments, determining the looking direction of the user may include identifying at least one object in the at least one image and determining the looking direction of the user based on the at least one image. For example, the system may analyze the at least one image captured by the at least one camera of the host vehicle to identify objects present in the environment of the host vehicle. Based on the identified objects, the system may infer or estimate where the user is likely directing visual attention. In some embodiments, determining the looking direction of the user may further include determining that the looking direction of the user is associated with a spatial location of the object.

In some embodiments, the spatial location of the object may be determined using depth information derived from the at least one image, stereo camera analysis, or information from other sensors associated with the host vehicle. Depth information derived from the at least one image may be obtained through monocular depth estimation techniques, where the system analyzes visual cues such as object size, texture gradients, perspective convergence, and occlusion relationships to infer distances to objects within the captured image. For example, the system may use a trained neural network configured to estimate depth maps from single images, where the neural network has learned correlations between image features and corresponding depth values through exposure to training data that associates images with known depth measurements. Stereo camera analysis may involve capturing images from two or more cameras positioned at different locations on the host vehicle, where the displacement between the cameras provides parallax information that enables triangulation of object positions in three-dimensional space. The system may calculate disparity values between corresponding pixels in images captured by the stereo cameras, where larger disparity values correspond to objects that are closer to the host vehicle and smaller disparity values correspond to objects that are farther from the host vehicle. Information from other sensors associated with the host vehicle may include distance measurements from lidar sensors, which emit laser pulses and measure the time for the pulses to return after reflecting off objects in the environment, or from radar sensors, which emit radio waves and analyze characteristics of reflected signals to determine distances and velocities of objects. The system may fuse depth information from multiple sources, such as combining monocular depth estimates with lidar point cloud data, to obtain more accurate and robust spatial location determinations for objects identified in the at least one image.

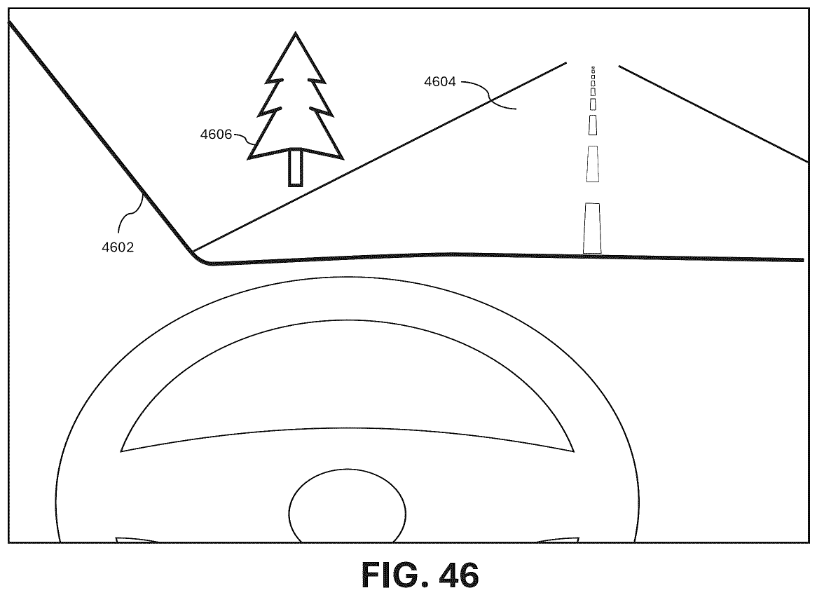

FIG. 46 illustrates a view from inside a host vehicle showing an environment of the host vehicle as seen through a windshield 4602. A road segment 4604 extends forward from the host vehicle into the distance. A tree 4606 is positioned on the left side of the environment. In some embodiments, the system may identify the tree 4606 in the at least one image and determine that the looking direction of the user is associated with a spatial location of the tree 4606. For example, the system may infer that the user would look at the tree 4606, which would provide an indication of the looking direction of the user.

Other objects that may be identified in the at least one image for determining the looking direction of the user may include vehicles, pedestrians, cyclists, traffic signs, traffic lights, buildings, or other road features visible through the windshield 4602. In some embodiments, the system may identify multiple objects in the at least one image and determine the looking direction of the user based on characteristics of the identified objects, such as proximity to the host vehicle, motion relative to the host vehicle, or visual salience within the captured image. For example, an approaching vehicle with illuminated headlights may have high visual salience and the system may infer that the user is likely directing visual attention toward the approaching vehicle. Similarly, a pedestrian crossing the road ahead of the host vehicle may draw the visual attention of the user, and the system may determine that the looking direction of the user is associated with the spatial location of the pedestrian. Traffic signs displaying speed limits, warnings, or directional information may also attract the visual attention of the user, particularly when the host vehicle is approaching an intersection or navigating an unfamiliar route. The system may use object detection algorithms, trained systems such as neural networks, or image segmentation processes to identify and classify objects within the at least one image. Based on the identified objects and their characteristics, the system may estimate a probability distribution over possible looking directions of the user, where objects with higher visual salience or greater relevance to the driving task may be associated with higher probabilities. In some embodiments, the system may track the positions of identified objects over multiple captured images to determine whether the user is likely following a moving object with visual attention, such as tracking a vehicle that is changing lanes or a cyclist that is approaching an intersection.

In some embodiments, determining the looking direction of the user may include determining a position of at least a portion of a body of the user. The position of at least a portion of the body of the user may be determined relative to at least one reference point in three-dimensional space. For example, the reference point may be a fixed location within the interior of the host vehicle, such as a location on the dashboard, a location on the windshield, a location on the steering column, or a location associated with the display. In some embodiments, the reference point may be a location associated with a seat of the host vehicle, such as a headrest position or a seat back position. The position of the portion of the body of the user relative to the reference point may be expressed as a set of three-dimensional coordinates, as a distance and direction from the reference point, or as any other suitable spatial representation.

In some embodiments, the at least a portion of the body of the user may be a head of the user. Determining the position of the head of the user may provide information regarding the vantage point from which the user views the display and the environment of the host vehicle visible through the windshield. The position of the head of the user may be determined using a driver monitoring system camera positioned within the interior of the host vehicle and directed toward the user. The driver monitoring system camera may capture images of the user, and the system may analyze the captured images to identify facial features, head orientation, or head position within the interior of the host vehicle. In some embodiments, the position of the head of the user may be determined using depth sensing techniques, such as structured light projection or time-of-flight sensing, to obtain three-dimensional position information. In such embodiments, the fixed location within the interior of the vehicle may be the location of the camera directed towards the user.

In some embodiments, the position of the head of the user may be determined based on seat location information or seat position settings associated with the seat occupied by the user. For example, the system may receive information indicating a current position of the seat along a seat track, a current recline angle of the seat back, or a current height adjustment of the seat. Based on the seat position settings, the system may estimate a position of the head of the user using predetermined relationships between seat positions and expected head positions for users of various sizes. In some embodiments, the system may use average head position data provided by a vehicle manufacturer to estimate the position of the head of the user based on the seat position settings.

In some embodiments, the portion of the body of the user for which the position is determined may include other body parts in addition to or instead of the head of the user. For example, the system may determine a position of the eyes of the user, a position of the shoulders of the user, or a position of the torso of the user. Determining the position of the eyes of the user may provide a more precise indication of the vantage point from which the user views the display compared to determining the position of the head of the user. The position of the eyes of the user may be determined using eye tracking techniques applied to images captured by the driver monitoring system camera. In some embodiments, the system may determine positions of multiple portions of the body of the user and combine the determined positions to estimate the looking direction of the user with increased accuracy.

In some embodiments, the system may determine a region that encompasses a range of positions in which the head or eyes of the user may reasonably be located in the near future. The region may account for expected movements of the user due to vehicle motion, such as movements caused by acceleration, deceleration, or turning of the host vehicle. By determining display parameter adjustments based on a region rather than a single point position, the system may provide a cushioning effect that accommodates unexpected deviations from an assumed position of the user. The cushioning effect may be beneficial given that changes to display parameters such as brightness or color may be implemented gradually rather than instantaneously.

In step 4508, the system determines a region of a display inside the host vehicle based on the looking direction of the user of the host vehicle. The region of the display may correspond to a portion of a head-up display or a dashboard that is within the field of view of the user based on the determined looking direction. In some embodiments, the system may map the looking direction of the user to a corresponding area of the display by projecting a ray from the user's eyes through the display and into the environment of the host vehicle. The system may then identify the region of the display that intersects with the projected ray as the region to be adjusted based on ambient light conditions.

In some embodiments, the system may determine the region of the display by calculating a geometric relationship between the position of the user's eyes and the display surface. For example, the system may use triangulation parameters to identify which portion of the display the user is viewing based on the looking direction. The triangulation parameters may be based on average data provided by a vehicle manufacturer or on sensing data from a driver monitoring system camera. In some embodiments, the system may determine a broader area of the display that encompasses a range of positions where the user's eyes may reasonably be located in the near future, providing a cushioning effect for unexpected deviations from an assumed position due to movements of the vehicle.

In some embodiments, the region of the display may be further determined based on a position of at least one portion of a body of the user of the host vehicle. The position of the at least one portion of the body of the user may include a position of a head of the user relative to the display. In some embodiments, the position of the at least one portion of the body of the user may include a position of eyes of the user, which may provide a more precise indication of the vantage point from which the user views the display compared to the position of the head alone. In some embodiments, the position of the at least one portion of the body of the user may include a position of shoulders of the user, which may be used to infer an approximate head position and orientation. In some embodiments, the position of the at least one portion of the body of the user may include a position of a torso of the user, which may provide information about the overall posture and seating position of the user within the vehicle. In some embodiments, the position of the at least one portion of the body of the user may include a position of a neck of the user, which may be used in combination with head position information to determine the orientation of the user's gaze. In some embodiments, the system may determine positions of multiple portions of the body of the user, such as a combination of head position, eye position, and shoulder position, and combine the determined positions to estimate the looking direction of the user and the corresponding region of the display with increased accuracy. The system may use the position of the head of the user, the position of the eyes of the user, the position of the shoulders of the user, the position of the torso of the user, or any combination thereof in combination with the looking direction to more accurately determine which region of the display the user is viewing. For example, if the user's head is positioned closer to the left side of the vehicle, the system may determine that the user is viewing a different region of the display than if the user's head were positioned closer to the center of the vehicle. Similarly, if the user's shoulders indicate a rotated posture, the system may adjust the determined region of the display accordingly to account for the user's body orientation.

In step 4510, the system causes a change to a value of at least one display parameter associated with the region of the display inside the host vehicle based on the at least one light intensity level in the environment of the host vehicle.

In some embodiments, the display is a head-up display or a dashboard. A head-up display may project information onto a windshield or a transparent screen positioned in front of the user, allowing the user to view the information while looking toward the environment of the host vehicle. A dashboard may include one or more screens or displays positioned on an instrument panel of the host vehicle.

In some embodiments, the at least one display parameter may be a brightness level. For example, the change may increase or decrease the brightness level of the region of the display.

In some embodiments, the at least one display parameter may be a contrast level. For example, the change may increase or decrease the contrast level of the region of the display.

In some embodiments, the at least one display parameter may be a color. For example, the change may modify the color of the region of the display from a first color to a second color. Additionally, or alternatively, the change may modify the color of the region of the display to contrast with a color of a different region of the display. The change may modify the color of the region of the display to contrast with one or more colors in the environment of the host vehicle.

A change in brightness, contrast, and/or color have been discussed with reference to FIG. 42 and method 4200 for example, and will not be repeated here for the sake of conciseness.

In some embodiments, the techniques and approaches described with reference to headlight adjustments and display parameter adjustments may be combined. For example, the system may simultaneously determine whether to adjust a state of the headlights of the host vehicle and whether to cause a change to at least one value of at least one display parameter based on the at least one light intensity level in the environment of the host vehicle. In some embodiments, the system may coordinate headlight state changes with display parameter adjustments to provide a consistent visual experience for a user of the host vehicle. For example, when the system causes the headlights to transition from a low beam state to a high beam state in response to decreased ambient light levels, the system may also cause a corresponding adjustment to the brightness level of a heads-up display or dashboard to account for the changed lighting conditions inside the host vehicle. In some embodiments, the system may use the same environment information to inform both headlight adjustments and display parameter adjustments. For example, when map information indicates that the host vehicle is approaching a tunnel, the system may prepare both headlight state changes and display parameter changes in anticipation of the lighting transition. In some embodiments, the predetermined time periods, predetermined rates of change, and smoothing techniques described herein may be applied to both headlight adjustments and display parameter adjustments in a coordinated manner.

Additionally, the various embodiments described above may be used in combination with one another. For example, multiple analysis techniques for determining ambient light levels may be used together to achieve improved accuracy or faster processing results. The imaging parameter-based analysis techniques, trained system-based analysis techniques, image segmentation processes, and environment information-based approaches may be combined in various configurations to provide robust ambient light level determination under diverse environmental conditions. Furthermore, any of the analysis techniques described herein may be applied to modify one or more parameters of the host vehicle, including but not limited to headlight states, heads-up display parameters, dashboard display parameters, or other vehicle systems that may benefit from ambient light level information. The combination of multiple analysis techniques and the application of determined light intensity levels to multiple vehicle parameters may provide a comprehensive approach to adapting vehicle behavior and user interface characteristics in response to changing lighting conditions in the environment of the host vehicle.

According to the embodiments of the present disclosure, a system for determining adjustments to a display of a host vehicle is disclosed. The system may correspond to any suitable computing system and may include at least one processor comprising circuitry and a memory, with the memory storing instructions that when executed by the circuitry cause the at least one processor to carry out functions associated with embodiments described herein.

In some embodiments, the system receives at least one image captured by at least one camera of a host vehicle from an environment of the host vehicle. The at least one camera may be a forward-facing camera, a rear-facing camera, a side-facing camera, or any combination thereof. The at least one image may be representative of lighting conditions in the environment surrounding the host vehicle.

In some embodiments, the system analyzes at least a first portion of the at least one image to determine at least one first light intensity level associated with a first region within the environment that overlaps a displayable area of the display from a point of view of a driver of the vehicle. The displayable area of the display may correspond to a head-up display (HUD) projection area visible through a windshield of the host vehicle. The first region within the environment may correspond to a background region that appears behind the displayable area from the perspective of the driver. In some embodiments, the at least one first light intensity level may be determined based on pixel brightness values within the first portion of the at least one image, and the determination may account for camera properties and internal parameters of the at least one camera.

In some embodiments, the system analyzes at least a second portion of the at least one image to determine at least one second light intensity level associated with a region of the environment outside the first region. The region of the environment outside the first region may correspond to portions of the environment that do not overlap the displayable area of the display from the point of view of the driver. In some embodiments, the at least one second light intensity level may be used to determine overall ambient lighting conditions in the environment, which may affect pupil dilation of the driver and thereby influence visibility of the display.

In some embodiments, the system causes a change to a value of at least one display parameter associated with the displayable area of the display based on the at least one first light intensity level. The at least one display parameter may include a brightness level, a contrast level, a color, or any combination thereof. In some embodiments, when the at least one first light intensity level indicates a dark background behind the displayable area, the system may cause the display to increase brightness or adjust colors to enhance contrast. In some embodiments, when the at least one first light intensity level indicates a bright background behind the displayable area, the system may cause the display to decrease brightness or adjust colors to maintain visibility.

In some embodiments, the system may determine the point of view of the driver based on a position of a head of the driver. The position of the head of the driver may be detected using a driver monitoring system (DMS) camera. The DMS camera may be included as part of the system or may be external to the system. In some embodiments, the DMS camera captures images of the driver and the system processes the images to identify a location of the head of the driver relative to the display and relative to the windshield of the host vehicle.

In some embodiments, the position of the head of the driver may be assumed based on data provided by a vehicle manufacturer. For example, the vehicle manufacturer may provide average head position data based on seat configurations, vehicle interior dimensions, or ergonomic studies. The system may use the assumed head position data to determine the first region within the environment that overlaps the displayable area of the display.

In some embodiments, the system may determine a looking direction of the driver. The looking direction may be determined based on gaze tracking performed using the DMS camera. In some embodiments, the looking direction may be determined based on a detected orientation of the head of the driver. The system may map the looking direction of the driver to a corresponding region of the environment visible through the windshield, and the system may determine the first region based on the mapped looking direction.

In some embodiments, the system may take into account multiple head positions when determining the first region within the environment. The multiple head positions may be detected using the DMS camera over a period of time. In some embodiments, the multiple head positions may be determined based on car seat sensors that detect adjustments to a seat position of the driver. In some embodiments, the multiple head positions may be determined based on data from other sensors associated with the host vehicle.

In some embodiments, the system may account for a range of positions to which the head of the driver may move in a near future time period. The system may define a volume around a detected or assumed position of the head of the driver, and the system may determine the first region based on the defined volume. The defined volume may serve as a safety margin to ensure that display parameter adjustments remain appropriate even if the head of the driver moves within the defined volume. In some embodiments, the defined volume may be larger than a detected instantaneous position of the head to accommodate expected movements of the driver during normal driving operations.

In some embodiments, the system may determine an expanded area within the environment that corresponds to the defined volume around the position of the head of the driver. The expanded area may encompass multiple potential first regions that would overlap the displayable area from different positions within the defined volume. The system may analyze the expanded area to determine light intensity levels and may cause changes to display parameters based on the light intensity levels within the expanded area.

In some embodiments, the system may determine the first region based on a transformation between coordinates of the at least one image captured by the at least one camera and coordinates associated with the point of view of the driver. The transformation may account for a position of the at least one camera relative to the position of the head of the driver and relative to the display. In some embodiments, the system may project a ray from the position of the head of the driver through the displayable area of the display and determine where the ray intersects the environment represented in the at least one image.

In some embodiments, the at least one second light intensity level may be used in combination with the at least one first light intensity level to determine the change to the value of the at least one display parameter. For example, the system may determine a ratio or difference between the at least one first light intensity level and the at least one second light intensity level, and the system may adjust the at least one display parameter based on the ratio or difference. In some embodiments, the at least one second light intensity level may be used to estimate an adaptation state of the eyes of the driver, and the system may adjust the at least one display parameter to account for the estimated adaptation state.

The embodiments may further be described using the following clauses:

Clause 1. A system for determining an ambient light level in an environment of a host vehicle, the system comprising: at least one processor comprising circuitry and a memory, wherein the memory includes instructions that when executed by the circuitry cause the at least one processor to: receive at least one image captured by at least one camera of a host vehicle from the environment of the host vehicle; obtain at least one value of at least one imaging parameter associated with the at least one camera of the host vehicle; and analyze at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

Clause 2. The system of clause 1, wherein the at least one imaging parameter associated with the at least one camera of the host vehicle is at least one light-adaptive imaging parameter.

Clause 3. The system of clause 1 or 2, wherein the at least one imaging parameter associated with the at least one camera of the host vehicle includes an exposure time or an aperture size.

Clause 4. The system of clauses 1-3, wherein analyzing the at least a portion of the at least one image includes determining a portion of the at least one image for analysis using at least one image segmentation process.

Clause 5. The system of clause 4, wherein the at least one image segmentation process is configured to determine a sky region represented in the at least one image and a road surface region represented in the at least one image.

Clause 6. The system of clause 5, wherein the portion of the at least one image includes the road surface region.

Clause 7. The system of clauses 1-6, wherein analyzing the at least a portion of the at least one image includes determining a portion of the at least one image for analysis using at least one trained system.

Clause 8. The system of clause 7, wherein the at least one trained system includes a neural network.

Clause 9. The system of clause 7 or 8, wherein the at least one trained system is configured to determine a sky region represented in the at least one image and a road surface region represented in the at least one image.

Clause 10. The system of clause 9, wherein the portion of the at least one image includes the road surface region.

Clause 11. The system of clauses 1-10, wherein analyzing the at least a portion of the at least one image includes determining a portion of the at least one image for analysis using map information.

Clause 12. The system of clauses 1-11, wherein analyzing the at least a portion of the at least one image includes determining a portion of the at least one image for analysis using object tracking information, and, optionally, wherein the object tracking information includes information obtained by a sensor, and, optionally, wherein the sensor is a lidar or a radar.

Clause 13. The system of clauses 1-12 wherein the at least a portion of the at least one image is analyzed using at least one trained system.

Clause 14. The system of clause 13, wherein the at least one trained system includes a neural network.

Clause 15. The system of clauses 1-14, wherein the at least one image includes a first image and a second image, and wherein analyzing the at least a portion of the at least one image to determine the at least one light intensity level in the environment of the host vehicle includes analyzing the first image to determine a first light intensity level and analyzing the second image to determine a second light intensity level.

Clause 16. The system of clause 15, wherein the at least one camera includes a first camera and a second camera, and wherein the first camera captured the first image and the second camera captured the second image.

Clause 17. A method for determining an ambient light level in an environment of a host vehicle, the method comprising: receiving at least one image captured by at least one camera of a host vehicle from the environment of the host vehicle; obtaining at least one value of at least one imaging parameter associated with the at least one camera of the host vehicle; and analyzing at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

Clause 18. The method of clause 17, wherein the at least one imaging parameter associated with the at least one camera of the host vehicle is at least one light-adaptive imaging parameter.

Clause 19. The method of clause 17 or 18, wherein analyzing the at least a portion of the at least one image includes determining a portion of the at least one image for analysis using at least one image segmentation process, and/or wherein analyzing the at least a portion of the at least one image includes determining a portion of the at least one image for analysis using at least one trained system.

Clause 20. The method of clauses 17-19, wherein analyzing the at least a portion of the at least one image includes determining a portion of the at least one image for analysis using map information.

Clause 21. The method of clauses 17-20, wherein analyzing the at least a portion of the at least one image includes determining a portion of the at least one image for analysis using object tracking information.

Clause 22. The method of clauses 1-11 wherein the at least a portion of the at least one image is analyzed using at least one trained system, and, optionally, wherein the at least one trained system includes a neural network.

Clause 23. The method of clauses 17-22, wherein the at least one image includes a first image and a second image, and wherein analyzing the at least a portion of the at least one image to determine the at least one light intensity level in the environment of the host vehicle includes analyzing the first image to determine a first light intensity level and analyzing the second image to determine a second light intensity level.

Clause 24. A non-transitory computer readable medium for determining an ambient light level in an environment of a host vehicle according to a method, the method comprising: receiving at least one image captured by at least one camera of a host vehicle from the environment of the host vehicle; obtaining at least one value of at least one imaging parameter associated with the at least one camera of the host vehicle; and analyzing at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

Clause 25. The non-transitory computer readable medium of clause 24, wherein the at least one imaging parameter associated with the at least one camera of the host vehicle is at least one light-adaptive imaging parameter.

Clause 26. The non-transitory computer readable medium of clause 24 or 25, wherein analyzing the at least a portion of the at least one image includes determining a portion of the at least one image for analysis using at least one image segmentation process.

Clause 27. The non-transitory computer readable medium of clauses 24-26, wherein analyzing the at least a portion of the at least one image includes determining a portion of the at least one image for analysis using at least one trained system, and/or wherein analyzing the at least a portion of the at least one image includes determining a portion of the at least one image for analysis using map information.

Clause 28. The non-transitory computer readable medium of clauses 24-27 wherein the at least a portion of the at least one image is analyzed using at least one trained system, and, optionally, wherein the at least one trained system includes a neural network.

Clause 29. The non-transitory computer readable medium of clauses 24-28, wherein analyzing the at least a portion of the at least one image includes determining a portion of the at least one image for analysis using object tracking information.

Clause 30. The non-transitory computer readable medium of clauses 24-29, wherein the at least one image includes a first image and a second image, and wherein analyzing the at least a portion of the at least one image to determine the at least one light intensity level in the environment of the host vehicle includes analyzing the first image to determine a first light intensity level and analyzing the second image to determine a second light intensity level.

Clause 31. A system for determining an ambient light level in an environment of a host vehicle, the system comprising: at least one processor comprising circuitry and a memory, wherein the memory includes instructions that when executed by the circuitry cause the at least one processor to: receive at least one image captured by at least one camera of a host vehicle from an environment of the host vehicle; and analyze at least a portion of the at least one image to determine at least one light intensity level in the environment of the host vehicle, wherein the at least a portion of the at least one image is analyzed using at least one trained system.

Clause 32. The system of clause 31, wherein the at least one trained system includes a neural network.

Clause 33. The system of clause 31 or 32, wherein analyzing the at least a portion of the at least one image includes determining a portion of the at least one image for analysis using at least one image segmentation process.

Clause 34. The system of clause 33, wherein the at least one image segmentation process is configured to determine a sky region represented in the at least one image and a road surface region represented in the at least one image.

Clause 35. The system of clause 34, wherein the portion of the at least one image includes the road surface region.

Clause 36. The system of clause 35, wherein analyzing the at least a portion of the at least one image includes determining a portion of the at least one image for analysis using the at least one trained system.

Clause 37. The system of clause 36, wherein the at least one trained system includes a neural network.

Clause 38. The system of clause 36 or 37, wherein the at least one trained system is configured to determine a sky region represented in the at least one image and a road surface region represented in the at least one image.

Clause 39. The system of clause 38, wherein the portion of the at least one image includes the road surface region.

Clause 40. A method for determining an ambient light level in an environment of a host vehicle, the method comprising: receiving at least one image captured by at least one camera of a host vehicle from an environment of the host vehicle; and analyzing at least a portion of the at least one image to determine at least one light intensity level in the environment of the host vehicle, wherein the at least a portion of the at least one image is analyzed using at least one trained system.

Clause 41. The method of clause 40, wherein analyzing the at least a portion of the at least one image includes determining a portion of the at least one image for analysis using at least one image segmentation process.

Clause 42. The method of clause 40 or 41, wherein analyzing the at least a portion of the at least one image includes determining a portion of the at least one image for analysis using the at least one trained system.

Clause 43. A non-transitory computer-readable medium for determining an ambient light level in an environment of a host vehicle according to a method, the method comprising: receiving at least one image captured by at least one camera of a host vehicle from an environment of the host vehicle; and analyzing at least a portion of the at least one image to determine at least one light intensity level in the environment of the host vehicle, wherein the at least a portion of the at least one image is analyzed using at least one trained system.

Clause 44. The non-transitory computer-readable medium of clause 43, wherein analyzing the at least a portion of the at least one image includes determining a portion of the at least one image for analysis using at least one image segmentation process.

Clause 45. The non-transitory computer-readable medium of clause 43 or 44, wherein analyzing the at least a portion of the at least one image includes determining a portion of the at least one image for analysis using the at least one trained system.

Clause 46. A system for determining adjustments to headlights of a host vehicle based on an ambient light level in an environment of the host vehicle, the system comprising: at least one processor comprising circuitry and a memory, wherein the memory includes instructions that when executed by the circuitry cause the at least one processor to: receive at least one image captured by at least one camera of a host vehicle from the environment of the host vehicle; analyze at least a portion of the at least one image to determine at least one light intensity level in the environment of the host vehicle; and cause the headlights of the host vehicle to change from a first state to a second state based on the at least one light intensity level in the environment of the host vehicle.

Clause 47. The system of clause 46, wherein the first state is an off state and the second state is an illuminated state.

Clause 48. The system of clause 46 or 47, wherein the first state is an illuminated state and the second state is an off state.

Clause 49. The system of clauses 46-48, wherein the first state is a first illumination state and the second state is a second illumination state.

Clause 50. The system of clauses 46-49, wherein the at least a portion of the at least one image is analyzed based on at least one value of at least one imaging parameter associated with the at least one camera of the host vehicle.

Clause 51. The system of clause 50, wherein the at least one imaging parameter is at least one light-adaptive imaging parameter.

Clause 52. The system of clause 50 or 51, wherein the at least one imaging parameter associated with the camera of the host vehicle includes an exposure time or an aperture size.

Clause 53. A method for determining adjustments to headlights of a host vehicle based on an ambient light level in an environment of the host vehicle, the method comprising: receiving at least one image captured by at least one camera of a host vehicle from the environment of the host vehicle; analyzing at least a portion of the at least one image to determine at least one light intensity level in the environment of the host vehicle; and causing the headlights of the host vehicle to change from a first state to a second state based on the at least one light intensity level in the environment of the host vehicle.

Clause 54. The method of clause 53, wherein the first state is an off state and the second state is an illuminated state.

Clause 55. The method of clause 53 or 54, wherein the first state is an illuminated state and the second state is an off state.

Clause 56. The method of clauses 53-55, wherein the first state is a first illumination state and the second state is a second illumination state.

Clause 57. The method of clauses 53-56, wherein the at least a portion of the at least one image is analyzed based on at least one value of at least one imaging parameter associated with the at least one camera of the host vehicle.

Clause 58. A non-transitory computer-readable medium for determining adjustments to headlights of a host vehicle based on an ambient light level in an environment of the host vehicle according to a method, the method comprising: receiving at least one image captured by at least one camera of a host vehicle from the environment of the host vehicle; analyzing at least a portion of the at least one image to determine at least one light intensity level in the environment of the host vehicle; and causing the headlights of the host vehicle to change from a first state to a second state based on the at least one light intensity level in the environment of the host vehicle.

Clause 59. The non-transitory computer-readable medium of clause 58, wherein the first state is an off state and the second state is an illuminated state.

Clause 60. The non-transitory computer-readable medium of clause 58 or 59, wherein the first state is an illuminated state and the second state is an off state.

Clause 61. The non-transitory computer-readable medium of clauses 58-60, wherein the first state is a first illumination state and the second state is a second illumination state.

Clause 62. The non-transitory computer-readable medium of clause 58-61, wherein the at least a portion of the at least one image is analyzed based on at least one value of at least one imaging parameter associated with the at least one camera of the host vehicle.

Clause 63. A system for determining whether to adjust headlights of a host vehicle based on an ambient light level in an environment of the host vehicle, the system comprising: at least one processor comprising circuitry and a memory, wherein the memory includes instructions that when executed by the circuitry cause the at least one processor to: receive at least one image captured by at least one camera of a host vehicle from the environment of the host vehicle; analyze at least a portion of the at least one image to determine a first light intensity level and a second light intensity level in the environment of the host vehicle, wherein the first light intensity level is greater than the second light intensity level; determine the first light intensity level is attributed to a first portion of the environment of the host vehicle and the second light intensity level is attributed to a second portion of the environment of the host vehicle; and cause the headlights of the host vehicle to maintain an illuminated state based on a comparison of a first size of the first portion of the environment of the host vehicle relative to a second size of the second portion of the environment of the host vehicle.

Clause 64. The system of clause 63, wherein the first light intensity level is greater than the second light intensity level by a predetermined light intensity threshold, and the first size of the first portion of the environment of the host vehicle is less than the second size of the second portion of the environment of the host vehicle by a predetermined size threshold.

Clause 65. A method for determining whether to adjust headlights of a host vehicle based on an ambient light level in an environment of the host vehicle, the method comprising: receiving at least one image captured by at least one camera of a host vehicle from the environment of the host vehicle; analyzing at least a portion of the at least one image to determine a first light intensity level and a second light intensity level in the environment of the host vehicle, wherein the first light intensity level is greater than the second light intensity level; determining the first light intensity level is attributed to a first portion of the environment of the host vehicle and the second light intensity level is attributed to a second portion of the environment of the host vehicle; and causing the headlights of the host vehicle to maintain an illuminated state based on a comparison of a first size of the first portion of the environment of the host vehicle relative to a second size of the second portion of the environment of the host vehicle.

Clause 66. The method of clause 65, wherein the first light intensity level is greater than the second light intensity level by a predetermined light intensity threshold, and the first size of the first portion of the environment of the host vehicle is less than the second size of the second portion of the environment of the host vehicle by a predetermined size threshold.

Clause 67. A non-transitory computer-readable medium for determining whether to adjust headlights of a host vehicle based on an ambient light level in an environment of the host vehicle according to a method, the method comprising: receiving at least one image captured by at least one camera of a host vehicle from the environment of the host vehicle; analyzing at least a portion of the at least one image to determine a first light intensity level and a second light intensity level in the environment of the host vehicle, wherein the first light intensity level is greater than the second light intensity level; determining the first light intensity level is attributed to a first portion of the environment of the host vehicle and the second light intensity level is attributed to a second portion of the environment of the host vehicle; and causing the headlights of the host vehicle to maintain an illuminated state based on a comparison of a first size of the first portion of the environment of the host vehicle relative to a second size of the second portion of the environment of the host vehicle.

Clause 68. The non-transitory computer-readable medium of clause 67, wherein the first light intensity level is greater than the second light intensity level by a predetermined light intensity threshold, and the first size of the first portion of the environment of the host vehicle is less than the second size of the second portion of the environment of the host vehicle by a predetermined size threshold.

Clause 69. A system for determining whether to adjust headlights of a host vehicle based on an ambient light level in an environment of the host vehicle, the system comprising: at least one processor comprising circuitry and a memory, wherein the memory includes instructions that when executed by the circuitry cause the at least one processor to: receive at least one image captured by at least one camera of a host vehicle from the environment of the host vehicle; analyze at least a portion of the at least one image to determine at least one light intensity level in the environment of the host vehicle; obtain environment information associated with the environment of the host vehicle; and determine whether to adjust a current state of the headlights of the host vehicle based on the at least one light intensity level in the environment of the host vehicle and the environment information.

Clause 70. The system of clause 69, wherein the environment information includes map information.

Clause 71. The system of clause 70, wherein the map information indicates an overpass is present in the environment of the host vehicle.

Clause 72. The system of clauses 69-71, wherein environment information is obtained from at least one sensor of the host vehicle.

Clause 73. The system of clauses 69-72, wherein the current state of the headlights of the host vehicle is maintained.

Clause 74. The system of clauses 69-73, wherein the current state of the headlights of the host vehicle is decreased to a lower state having an intensity less than the current state for a predetermined time period and increased to the current state after the predetermined time period.

Clause 75. The system of clauses 69-74, wherein the current state of the headlights of the host vehicle is increased to a higher state having an intensity greater than the current state for a predetermined time period and decreased to the current state after the predetermined time period.

Clause 76. The system of clauses 69-75, wherein the current state of the headlights of the host vehicle is decreased to a lower state having an intensity less than the current state at a predetermined rate.

Clause 77. The system of clauses 69-76, wherein the current state of the headlights of the host vehicle is increased to a higher state having an intensity greater than the current state at a predetermined rate.

Clause 78. A method for determining whether to adjust headlights of a host vehicle based on an ambient light level in an environment of the host vehicle, the method comprising: receiving at least one image captured by at least one camera of a host vehicle from the environment of the host vehicle; analyzing at least a portion of the at least one image to determine at least one light intensity level in the environment of the host vehicle; obtaining environment information associated with the environment of the host vehicle; and determining whether to adjust a current state of the headlights of the host vehicle based on the at least one light intensity level in the environment of the host vehicle and the environment information.

Clause 79. The method of clause 78, wherein the environment information includes map information.

Clause 80. The method of clause 78 or 79, wherein environment information is obtained from at least one sensor of the host vehicle.

Clause 81. The method of clauses 78-80, wherein the current state of the headlights of the host vehicle is maintained.

Clause 82. The method of clauses 78-81, wherein the current state of the headlights of the host vehicle is decreased to a lower state having an intensity less than the current state for a predetermined time period and increased to the current state after the predetermined time period.

Clause 83. The method of clauses 78-82, wherein the current state of the headlights of the host vehicle is increased to a higher state having an intensity greater than the current state for a predetermined time period and decreased to the current state after the predetermined time period.

Clause 84. The method of clauses 78-83, wherein the current state of the headlights of the host vehicle is decreased to a lower state having an intensity less than the current state at a predetermined rate.

Clause 85. The method of clauses 78-84, wherein the current state of the headlights of the host vehicle is increased to a higher state having an intensity greater than the current state at a predetermined rate.

Clause 86. A non-transitory computer-readable for determining whether to adjust headlights of a host vehicle based on an ambient light level in an environment of the host vehicle according to a method, the method comprising: receiving at least one image captured by at least one camera of a host vehicle from the environment of the host vehicle; analyzing at least a portion of the at least one image to determine at least one light intensity level in the environment of the host vehicle; obtaining environment information associated with the environment of the host vehicle; and determining whether to adjust a current state of the headlights of the host vehicle based on the at least one light intensity level in the environment of the host vehicle and the environment information.

Clause 87. The non-transitory computer-readable of clause 86, wherein the environment information includes map information.

Clause 88. The non-transitory computer-readable of clause 86 or 87, wherein environment information is obtained from at least one sensor of the host vehicle.

Clause 89. The non-transitory computer-readable of clauses 86-88, wherein the current state of the headlights of the host vehicle is maintained.

Clause 90. The non-transitory computer-readable of clauses 86-89, wherein the current state of the headlights of the host vehicle is decreased to a lower state having an intensity less than the current state for a predetermined time period and increased to the current state after the predetermined time period.

Clause 91. The non-transitory computer-readable of clauses 86-90, wherein the current state of the headlights of the host vehicle is increased to a higher state having an intensity greater than the current state for a predetermined time period and decreased to the current state after the predetermined time period.

Clause 92. The non-transitory computer-readable of clauses 86-91, wherein the current state of the headlights of the host vehicle is decreased to a lower state having an intensity less than the current state at a predetermined rate.

Clause 93. The non-transitory computer-readable of clauses 86-92, wherein the current state of the headlights of the host vehicle is increased to a higher state having an intensity greater than the current state at a predetermined rate.

Clause 94. A system for determining adjustments to a display of a host vehicle, the system comprising: at least one processor comprising circuitry and a memory, wherein the memory includes instructions that when executed by the circuitry cause the at least one processor to: receive at least one image captured by at least one camera of a host vehicle from an environment of the host vehicle; and analyze at least a portion of the at least one image to determine at least one light intensity level in the environment of the host vehicle; and cause a change to at least one value of at least one display parameter associated with at least a region of a display inside the host vehicle based on the at least one light intensity level in the environment of the host vehicle.

Clause 95. The system of clause 94, wherein the display is a heads-up display or a dashboard.

Clause 96. The system of clause 94 or 95, wherein the at least one display parameter is a brightness level.

Clause 97. The system of clause 96, wherein the change increases or decreases the brightness level of the region of the display.

Clause 98. The system of clauses 94-97, wherein the at least one display parameter is a contrast level.

Clause 99. The system of clause 98, wherein the change increases or decreases the contrast level of the region of the display.

Clause 100. The system of clauses 94-99, wherein the at least one display parameter is a color.

Clause 101. The system of clause 100, wherein the change modifies the color of the region of the display from a first color to a second color.

Clause 102. The system of clause 100 or 101, wherein the change modifies the color of the region of the display to contrast with a color of a different region of the display.

Clause 103. The system of clauses 100-102, wherein the change modifies the color of the region of the display to contrast with one or more colors in the environment of the host vehicle.

Clause 104. The system of clauses 94-103, wherein the at least a portion of the at least one image is analyzed based on at least one value of at least one imaging parameter associated with the camera of the host vehicle.

Clause 105. The system of clause 104, wherein the at least one imaging parameter is at least one light-adaptive imaging parameter, and optionally, wherein the at least one imaging parameter associated with the camera of the host vehicle includes an exposure time or an aperture size.

Clause 106. The system of claim 94, wherein analyzing the at least a portion of the at least one image includes determining a portion of the at least one image for analysis using at least a position of a head of a user of the host vehicle.

Clause 107. The system of clauses 94-106, wherein the at least a portion of the at least one image is analyzed using at least one trained system.

Clause 108. The system of clause 107, wherein the at least one trained system includes a neural network.

Clause 109. A method for determining adjustments to a display of a host vehicle, the method comprising: receiving at least one image captured by at least one camera of a host vehicle from an environment of the host vehicle; and analyzing at least a portion of the at least one image to determine at least one light intensity level in the environment of the host vehicle; and causing a change to at least one value of at least one display parameter associated with at least a region of a display inside the host vehicle based on the at least one light intensity level in the environment of the host vehicle.

Clause 110. The method of clause 109, wherein the display is a heads-up display or a dashboard.

Clause 111. The method of clause 109 or 110, wherein the at least one display parameter is a brightness level.

Clause 112. The method of clauses 109-111, wherein the at least one display parameter is a contrast level.

Clause 113. The method of clauses 109-112, wherein the at least one display parameter is a color.

Clause 114. The method of clauses 109-113, wherein the at least a portion of the at least one image is analyzed based on at least one value of at least one imaging parameter associated with the camera of the host vehicle.

Clause 115. The method of clauses 109-114, wherein the at least a portion of the at least one image is analyzed using at least one trained system.

Clause 116. A non-transitory computer-readable medium for determining adjustments to a display of a host vehicle according to a method, the method comprising: receiving at least one image captured by at least one camera of a host vehicle from an environment of the host vehicle; and analyzing at least a portion of the at least one image to determine at least one light intensity level in the environment of the host vehicle; and causing a change to at least one value of at least one display parameter associated with at least a region of a display inside the host vehicle based on the at least one light intensity level in the environment of the host vehicle.

Clause 117. The non-transitory computer-readable medium of clause 116, wherein the display is a heads-up display or a dashboard.

Clause 118. The non-transitory computer-readable medium of clause 116 or 117, wherein the at least one display parameter is a brightness level.

Clause 119. The non-transitory computer-readable medium of clauses 116-118, wherein the at least one display parameter is a contrast level.

Clause 120. The non-transitory computer-readable medium of clauses 116-119, wherein the at least one display parameter is a color.

Clause 121. The non-transitory computer-readable medium of clauses 116-120, wherein the at least a portion of the at least one image is analyzed based on at least one value of at least one imaging parameter associated with the camera of the host vehicle.

Clause 122. The non-transitory computer-readable medium of clauses 116-121, wherein the at least a portion of the at least one image is analyzed using at least one trained system.

Clause 123. A system for determining adjustments to a display of a host vehicle, the system comprising: at least one processor comprising circuitry and a memory, wherein the memory includes instructions that when executed by the circuitry cause the at least one processor to: receive at least one image captured by at least one camera of a host vehicle from an environment of the host vehicle; analyze at least a portion of the at least one image to determine at least one light intensity level in the environment of the host vehicle; obtain environment information associated with the environment of the host vehicle; and determine whether to cause a change to at least one value of at least one display parameter associated with at least a region of a display inside the host vehicle based on the at least one light intensity level in the environment of the host vehicle and the environment information.

Clause 124. The system of clause 123, wherein the environment information includes map information.

Clause 125. The system of clause 124, wherein the map information indicates an overpass is present in the environment of the host vehicle.

Clause 126. The system of clauses 123-125, wherein environment information is obtained from at least one sensor of the host vehicle.

Clause 127. The system of clauses 123-126, wherein the at least one value of the at least one display parameter of the display is maintained.

Clause 128. The system of clauses 123-127, wherein the at least one value of the at least one display parameter of the display is changed to a new value for a predetermined time period and restored to the at least one value of the at least one display parameter after the predetermined time period.

Clause 129. The system of clause 128, wherein the at least one value of the at least one display parameter represents a brightness level of the at least one region of the display.

Clause 130. The system of clause 128 or 129, wherein the at least one value of the at least one display parameter represents a contrast level of the at least one region of the display.

Clause 131. The system of clauses 128-130, wherein the at least one value of the at least one display parameter represents a color of the at least one region of the display.

Clause 132. The system of clauses 123-131, wherein the at least one value of at the at least one display parameter is changed to a new value at a predetermined rate.

Clause 133. The system of clause 132, wherein the at least one value of the at least one display parameter represents a brightness level of the at least one region of the display.

Clause 134. The system of clause 132 or 133, wherein the at least one value of the at least one display parameter represents a contrast level of the at least one region of the display.

Clause 135. The system of clauses 132-134, wherein the at least one value of the at least one display parameter represents a color of the at least one region of the display.

Clause 136. A method for determining adjustments to a display of a host vehicle, the method comprising: receiving at least one image captured by at least one camera of a host vehicle from an environment of the host vehicle; analyzing at least a portion of the at least one image to determine at least one light intensity level in the environment of the host vehicle; obtaining environment information associated with the environment of the host vehicle; and determining whether to cause a change to at least one value of at least one display parameter associated with at least a region of a display inside the host vehicle based on the at least one light intensity level in the environment of the host vehicle and the environment information.

Clause 137. The method of clause 136, wherein the environment information includes map information.

Clause 138. The method of clause 136 or 137, wherein environment information is obtained from at least one sensor of the host vehicle.

Clause 139. The method of clauses 136-138, wherein the at least one value of the at least one display parameter of the display is maintained.

Clause 140. The method of clauses 136-139, wherein the at least one value of the at least one display parameter of the display is changed to a new value for a predetermined time period and restored to the at least one value of the at least one display parameter after the predetermined time period.

Clause 141. The method of clause 140, wherein the at least one value of the at least one display parameter represents at least one of a brightness level, a contrast level, or a color of the at least one region of the display.

Clause 142. The method of clauses 136-141, wherein the at least one value of at the at least one display parameter is changed to a new value at a predetermined rate.

Clause 143. The method of clause 142, wherein the at least one value of the at least one display parameter represents at least one of a brightness level, a contrast level, or a color of the at least one region of the display.

Clause 144. A non-transitory computer-readable medium for determining adjustments to a display of a host vehicle according to a method, the method comprising: receiving at least one image captured by at least one camera of a host vehicle from an environment of the host vehicle; analyzing at least a portion of the at least one image to determine at least one light intensity level in the environment of the host vehicle; obtaining environment information associated with the environment of the host vehicle; and determining whether to cause a change to at least one value of at least one display parameter associated with at least a region of a display inside the host vehicle based on the at least one light intensity level in the environment of the host vehicle and the environment information.

Clause 145. The non-transitory computer-readable medium of clause 144, wherein the environment information includes map information.

Clause 146. The non-transitory computer-readable medium of clause 144 or 145, wherein environment information is obtained from at least one sensor of the host vehicle.

Clause 147. The non-transitory computer-readable medium of clauses 144-146, wherein the at least one value of the at least one display parameter of the display is maintained.

Clause 148. The non-transitory computer-readable medium of clauses 144-147, wherein the at least one value of the at least one display parameter of the display is changed to a new value for a predetermined time period and restored to the at least one value of the at least one display parameter after the predetermined time period.

Clause 149. The non-transitory computer-readable medium of clause 148, wherein the at least one value of the at least one display parameter represents at least one of a brightness level, a contrast level, or a color of the at least one region of the display.

Clause 150. The non-transitory computer-readable medium of clauses 144-149, wherein the at least one value of at the at least one display parameter is changed to a new value at a predetermined rate.

Clause 151. The non-transitory computer-readable medium of clause 150, wherein the at least one value of the at least one display parameter represents at least one of a brightness level, a contrast level, or a color of the at least one region of the display.

Clause 152. A system for determining adjustments to a display of a host vehicle, the system comprising: at least one processor comprising circuitry and a memory, wherein the memory includes instructions that when executed by the circuitry cause the at least one processor to: receive at least one image captured by at least one camera of a host vehicle from an environment of the host vehicle; analyze at least a portion of the at least one image to determine at least one light intensity level in the environment of the host vehicle; determine a looking direction of a user of the host vehicle; determine a region of a display inside the host vehicle based on the looking direction of the user of the host vehicle; and cause a change to a value of at least one display parameter associated with the region of the display inside the host vehicle based on the at least one light intensity level in the environment of the host vehicle.

Clause 153. The system of clause 152, wherein determining the looking direction of the user includes: identifying at least one object in the at least one image; and determining the looking direction of the user based on the at least one image.

Clause 154. The system of clause 153, wherein determining the looking direction of the user further includes determining that the looking direction of the user is associated with a spatial location of the object.

Clause 155. The system of clauses 152-154, wherein determining the looking direction of the user includes determining a position of at least a portion of a body of the user.

Clause 156. The system of clause 155, wherein the position of the at least a portion of the body of the user is relative to at least one reference point in three-dimensional space.

Clause 157. The system of clause 155 or 156, wherein the at least a portion of the body of the user is a head of the user.

Clause 158. The system of clauses 152-157, wherein the display is a heads-up display or a dashboard.

Clause 159. The system of clauses 152-158, wherein the at least one display parameter is a brightness level.

Clause 160. The system of clause 159, wherein the change increases or decreases the brightness level of the region of the display.

Clause 161. The system of clauses 152-160, wherein the at least one display parameter is a contrast level.

Clause 162. The system of clause 161, wherein the change increases or decreases the contrast level of the region of interest of the display.

Clause 163. The system of clauses 152-162, wherein the at least one display parameter is a color.

Clause 164. The system of clause 163, wherein the change to the value modifies the color of the region of the display from a first color to a second color.

Clause 165. The system of clause 163 or 164, wherein the change to the value modifies the color of the region of the display to contrast with a color of a different region of the display.

Clause 166. The system of clauses 163-165, wherein the change to the value modifies the color of the region of the display to contrast with one or more colors in the environment of the host vehicle.

Clause 167. The system of clauses 152-166, wherein the region of the display is further determined based on a position of at least one portion of a body of the user of the host vehicle.

Clause 168. The system of clauses 152-167, wherein the at least a portion of the at least one image is analyzed based on a value of at least one imaging parameter associated with the camera of the host vehicle.

Clause 169. The system of clause 168, wherein the at least one imaging parameter is at least one light-adaptive imaging parameter.

Clause 170. The system of clause 168 or 169, wherein the at least one imaging parameter associated with the camera of the host vehicle includes an exposure time or an aperture size.

Clause 171. A method for determining adjustments to a display of a host vehicle, the method comprising: receiving at least one image captured by at least one camera of a host vehicle from an environment of the host vehicle; analyzing at least a portion of the at least one image to determine at least one light intensity level in the environment of the host vehicle; determining a looking direction of a user of the host vehicle; determining a region of a display inside the host vehicle based on the looking direction of the user of the host vehicle; and causing a change to a value of at least one display parameter associated with the region of the display inside the host vehicle based on the at least one light intensity level in the environment of the host vehicle.

Clause 172. The method of clause 171, wherein determining the looking direction of the user includes: identifying at least one object in the at least one image; and determining the looking direction of the user based on the at least one image.

Clause 173. The method of clause 172, wherein determining the looking direction of the user further includes determining that the looking direction of the user is associated with a spatial location of the object.

Clause 174. The method of clauses 171-173, wherein determining the looking direction of the user includes determining a position of at least a portion of a body of the user.

Clause 175. The method of clause 174, wherein the position of the at least a portion of the body of the user is relative to at least one reference point in three-dimensional space.

Clause 176. The method of clauses 171-175, wherein the region of the display is further determined based on a position of at least one portion of a body of the user of the host vehicle.

Clause 177. The method of clauses 171-176, wherein the at least a portion of the at least one image is analyzed based on a value of at least one imaging parameter associated with the camera of the host vehicle.

Clause 178. A non-transitory computer-readable medium for determining adjustments to a display of a host vehicle according to a method, the method comprising: receiving at least one image captured by at least one camera of a host vehicle from an environment of the host vehicle; analyzing at least a portion of the at least one image to determine at least one light intensity level in the environment of the host vehicle; determining a looking direction of a user of the host vehicle; determining a region of a display inside the host vehicle based on the looking direction of the user of the host vehicle; and causing a change to a value of at least one display parameter associated with the region of the display inside the host vehicle based on the at least one light intensity level in the environment of the host vehicle.

Clause 179. The non-transitory computer-readable medium of clause 178, wherein determining the looking direction of the user includes: identifying at least one object in the at least one image; and determining the looking direction of the user based on the at least one image.

Clause 180. The non-transitory computer-readable medium of clause 179, wherein determining the looking direction of the user further includes determining that the looking direction of the user is associated with a spatial location of the object.

Clause 181. The non-transitory computer-readable medium of clauses 178-1880, wherein determining the looking direction of the user includes determining a position of at least a portion of a body of the user.

Clause 182. The non-transitory computer-readable medium of clause 181, wherein the position of the at least a portion of the body of the user is relative to at least one reference point in three-dimensional space.

Clause 183. The non-transitory computer-readable medium of clauses 178-182, wherein the region of the display is further determined based on a position of at least one portion of a body of the user of the host vehicle.

Clause 184. The non-transitory computer-readable medium of clauses 178-183, wherein the at least a portion of the at least one image is analyzed based on a value of at least one imaging parameter associated with the camera of the host vehicle.

Clause 185. A system for determining adjustments to a display of a host vehicle, the system comprising: at least one processor comprising circuitry and a memory, wherein the memory includes instructions that when executed by the circuitry cause the at least one processor to: receive at least one image captured by at least one camera of a host vehicle from an environment of the host vehicle; analyze at least a first portion of the at least one image to determine at least one first light intensity level associated with a first region within the environment that overlaps a displayable area of the display from a point of view of a driver of a vehicle; analyze at least a second portion of the at least one image to determine at least one second light intensity level associated with a region of the environment outside the first region; cause a change to a value of at least one display parameter associated with the displayable area of the display based on the at least one first light intensity level.

Clause 186. The system of claim 185, wherein the point of view of the driver of the vehicle is determined based on images from a DMS camera onboard the host vehicle.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A system for determining an ambient light level in an environment of a host vehicle, the system comprising:
at least one processor comprising circuitry and a memory, wherein the memory includes instructions that when executed by the circuitry cause the at least one processor to:
receive at least one image captured by at least one camera of a host vehicle from the environment of the host vehicle;
obtain at least one value of at least one imaging parameter associated with the at least one camera of the host vehicle; and
analyze at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

2. (canceled)

3. The system of claim 1, wherein the at least one imaging parameter associated with the at least one camera of the host vehicle includes an exposure time, f-number, focal length, or an aperture size.

4. (canceled)

5. The system of claim 1, wherein analyzing the at least a portion of the at least one image includes determining a portion of the at least one image for analysis using at least one image segmentation process.

6. (canceled)

7. The system of claim 1, wherein analyzing the at least a portion of the at least one image includes determining a portion of the at least one image for analysis using at least one trained system.

8. (canceled)

9. The system of claim 7, wherein the at least one trained system is configured to determine a sky region represented in the at least one image and a road surface region represented in the at least one image.

10. The system of claim 9, wherein the portion of the at least one image includes the road surface region.

11. The system of claim 1, wherein analyzing the at least a portion of the at least one image includes determining a portion of the at least one image for analysis using map information or object tracking information.

12-14. (canceled)

15. The system of claim 1, wherein the at least one image includes a first image and a second image, and wherein analyzing the at least a portion of the at least one image to determine the at least one light intensity level in the environment of the host vehicle includes analyzing the first image to determine a first light intensity level and analyzing the second image to determine a second light intensity level.

16. The system of claim 15, wherein the at least one camera includes a first camera and a second camera, and wherein the first camera captured the first image and the second camera captured the second image.

17. The system of claim 1, wherein the processor is further configured to cause to host vehicle to perform at least one of:
change at least one headlight illumination state of the host vehicle; or
change to at least one value of at least one display parameter associated with at least a region of a display inside the host vehicle.

18. A method for determining an ambient light level in an environment of a host vehicle, the method comprising:
receiving at least one image captured by at least one camera of a host vehicle from the environment of the host vehicle;
obtaining at least one value of at least one imaging parameter associated with the at least one camera of the host vehicle; and
analyzing at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

19. The method of claim 18, wherein the at least one imaging parameter associated with the at least one camera of the host vehicle is at least one light-adaptive imaging parameter.

20. The method of claim 18, wherein analyzing the at least a portion of the at least one image includes determining a portion of the at least one image for analysis using at least one image segmentation process.

21. The method of claim 18, wherein analyzing the at least a portion of the at least one image includes determining a portion of the at least one image for analysis using at least one trained system.

22. The method of claim 18, wherein analyzing the at least a portion of the at least one image includes determining a portion of the at least one image for analysis using map information or object tracking information.

23. (canceled)

24. A non-transitory computer readable medium for determining an ambient light level in an environment of a host vehicle according to a method, the method comprising:
receiving at least one image captured by at least one camera of a host vehicle from the environment of the host vehicle;
obtaining at least one value of at least one imaging parameter associated with the at least one camera of the host vehicle; and
analyzing at least a portion of the at least one image to determine at least one light intensity level in the environment of the host vehicle, wherein the at least a portion of the at least one image is analyzed based on the at least one value of the at least one imaging parameter associated with the at least one camera of the host vehicle.

25. The non-transitory computer readable medium of claim 24, wherein the at least one imaging parameter associated with the at least one camera of the host vehicle is at least one light-adaptive imaging parameter.

26. The non-transitory computer readable medium of claim 24, wherein analyzing the at least a portion of the at least one image includes determining a portion of the at least one image for analysis using at least one image segmentation process.

27. The non-transitory computer readable medium of claim 24, wherein analyzing the at least a portion of the at least one image includes determining a portion of the at least one image for analysis using at least one trained system.

28. The non-transitory computer readable medium of claim 24, wherein analyzing the at least a portion of the at least one image includes determining a portion of the at least one image for analysis using map information or object tracking information.

29-180. (canceled)
